(19) United States
(12) Patent Application Publication
(10) Pub. No.: US 2025/0209360 A1
(43) Pub. Date: Jun. 26, 2025

(54) QUANTUM COMPUTER SYSTEM AND METHOD FOR OPERATING A MOVABLE QUANTUM COMPUTER

(71) Applicant: SaxonQ GmbH, Leipzig (DE)

(72) Inventors: Bernd Burchard, Essen (DE); Robert Staacke, Leipzig (DE); Jan Meijer, Bochum (DE); Marius GRUNDMANN, Leipzig (DE)

(73) Assignee: SaxonQ GmbH, Leipzig (DE)

(21) Appl. No.: 18/844,031

(22) PCT Filed: Mar. 7, 2023
(86) PCT No.: PCT/EP2023/055729

§ 371 Date: Mar. 17, 2025

(30) Foreign Application Priority Data
Mar. 8, 2022 (DE) 10 2022 004 989.9
Mar. 8, 2022 (DE) 10 2022 105 464.0
Mar. 8, 2022 (DE) 10 2022 105 465.9
May 17, 2022 (DE) 10 2022 112 269.7
May 20, 2022 (DE) 10 2022 112 677.3
Jan. 9, 2023 (DE) 10 2023 100 265.1
Jan. 28, 2023 (DE) 10 2023 102 094.3
Jan. 28, 2023 (DE) 20 2023 100 401.6
Feb. 6, 2023 (DE) 10 2023 102 766.2
Feb. 6, 2023 (DE) 10 2023 102 767.0
Feb. 6, 2023 (DE) 10 2023 102 852.9
Feb. 6, 2023 (DE) 20 2023 100 548.9
Feb. 20, 2023 (DE) 10 2023 104 158.4
Feb. 20, 2023 (DE) 10 2023 104 159.2
Feb. 20, 2023 (DE) 20 2023 100 801.1
Mar. 6, 2023 (DE) 10 2023 105 495.3
Mar. 6, 2023 (DE) 10 2023 105 496.1
Mar. 6, 2023 (DE) 20 2023 101 056.3

(51) Int. Cl. G06N 10/40; G06F 1/20; G06N 10/70

(52) U.S. Cl. CPC G06N 10/40; G06F 1/206; G06N 10/70

(57) ABSTRACT

A quantum computer system comprising a relocatable quantum computer and a power supply device for at least partially supplying the quantum computer with electrical energy is provided. The quantum computer system is characterized in that the energy supply device is designed to be relocatable, and in that the energy supply device has a first voltage regulation stage and a second voltage regulation stage and is set up to regulate an electrical energy provided by an energy source to a predetermined voltage value by means of a multi-stage voltage regulation by means of the first voltage regulation stage and the second voltage stage for at least partially supplying the quantum computer.

### CROSS-REFERENCE TO RELATED APPLICATIONS

This application is a National Phase of International Application Number PCT/EP2023/055729, filed Mar. 7, 2023, which claims priority to German Application Numbers: 10 2022 105 464.0, filed Mar. 8, 2022; 10 2022 105 465.9, filed Mar. 8, 2022; 10 2022 004 989.9, filed Mar. 8, 2022; 10 2022 112 269.7, filed May 17, 2022; 10 2022 112 677.3, filed May 20, 2022; 10 2023 100 265.1, filed Jan. 9, 2023; 10 2023 102 094.3 filed Jan. 28, 2023; 20 2023 100 401.6 filed Jan. 28, 2023; 10 2023 102 767.0 filed Feb. 6, 2023; 10 2023 102 766.2 filed Feb. 6, 2023; and 10 2023 102 852.9 filed Feb. 6, 2023; the entire disclosures of each of which are incorporated herein by reference.

### BACKGROUND

Provided are a quantum computer system, a mobile data processing device, a vehicle, a weapon system, a use of a relocatable power supply device, a method for operating a relocatable quantum computer, a use, a use of a closed-loop helium gas cooling system, and a method for controlling a relocatable weapon system. The embodiments are thus particularly in the fields of quantum computer systems and their applications.

Traditionally, quantum computer systems require a laboratory environment with precisely defined and controlled properties in order to operate. In particular, quantum computer systems often require cryogenic temperatures and an extremely stable power supply to enable their operation. This significantly restricts the operation of quantum computing systems and traditionally only allows quantum computing systems to operate in a dedicated environment.

The disclosure is therefore based on the task of increasing the flexibility for the operation of a quantum computer system and optionally enabling the operation of a quantum computer system outside of special laboratory environments.

### SUMMARY

The problem is solved by the objects of the respective independent claims. Optional embodiments are given in the subclaims and in the description.

In a first aspect, a quantum computer system is provided, comprising a relocatable quantum computer and a power supply device for at least partially supplying the quantum computer with electrical energy. The quantum computer system is characterized in that the energy supply device is designed to be relocatable. In addition, the energy supply device has a first voltage regulation stage and a second voltage regulation stage and is set up to regulate an electrical energy provided by an energy source to a predetermined voltage value by means of a multi-stage voltage regulation using the first voltage regulation stage and the second voltage stage for at least partially supplying the quantum computer.

An energy supply device can be a device for supplying the quantum computer and any other components provided for the operation of the quantum computer system with electrical energy.

A voltage regulation stage can be an electrical and/or electronic circuit which is suitable for controlling and/or regulating an electrical voltage and/or an electrical current and/or an electrical power which is provided to the quantum computer for its operation. A multi-stage voltage regulator is an electrical and/or electronic circuit in which the electrical voltage and/or the electrical current and/or the electrical power is successively conditioned to predetermined values and/or properties. The fact that the energy supply device is set up to at least partially supply the quantum computer with electrical energy means that the quantum computer is optionally supplied with electrical energy at all times by the energy supply device. Rather, at some points in time, energy can be supplied by other energy sources, for example at times and/or in periods of time in which the quantum computer is not performing any quantum operations and/or is not executing any quantum computer programs.

A quantum computer system designed in this way offers the advantage that interference originating from the power supply can be effectively kept away from the quantum computer, and in this way undesirable influences of the power supply on the operation of the quantum computer can be avoided. This also offers the advantage that the quantum computer system can be operated with a variety of different sources of electrical energy, since any fluctuations and/or changes in the voltage and/or current provided can be reduced or even completely avoided by the power supply device. For example, a supply voltage provided by a vehicle electrical system can vary over a wide range, such as in the range from 4 V to 24 V. Reliable operation of a quantum computer with electrical energy provided by such an on-board power supply may therefore require a corresponding flexibility of the quantum computer system, which enables a sufficiently noise-free and/or interference-free power supply for the operation of the quantum computer despite any fluctuations. This can be achieved by a power supply device with multi-stage voltage regulation, as indicated above. Thus, a quantum computer system with the above features provides a flexibility that allows a quantum computer to be operated in environments with different electrical power supplies. Accordingly, this offers the advantage that the flexibility for the operation of the quantum computer is increased and also a relocatability of the quantum computer system is enabled.

The first voltage regulation stage can optionally have a voltage transformer and/or a voltage regulator and/or a current regulator or be designed as a voltage transformer or voltage regulator or current regulator. Optionally, the first voltage regulation stage can have a switching regulator, which is designed to bring about a voltage reduction. The second voltage regulation stage can optionally have a linear regulator or be designed as such. The second voltage regulator can optionally be used for fine regulation of the voltage or current. As a result, the energy consumption of the multi-stage voltage regulation can be kept low. In addition, this can offer the advantage that a low-interference or low-transient voltage supply can be provided for the quantum computer system or for the quantum computer, which can promote reliable operation of the quantum computer.

The second voltage regulation stage can be connected downstream of the first voltage regulation stage. In other words, the multi-stage voltage regulation can take place sequentially. This can be particularly advantageous for shielding the quantum computer from interference and/or fluctuations originating from the power supply.

Optionally, the quantum computer system may further comprise at least one energy reserve, wherein the at least one energy reserve may be designed to serve as an energy source and to provide the electrical energy for the energy supply device for the multi-level voltage regulation. In addition, the quantum computer system may optionally comprise a charging device, wherein the charging device may be adapted to charge the at least one energy reserve. The charging device can optionally have a switching power supply or be designed as such. This can be particularly advantageous in order to avoid any interference of the quantum computer when performing quantum operations by the charging devices. Furthermore, the quantum computer system may further comprise a disconnecting device designed to connect and disconnect the power reserve and the charging device in a controllable manner. This can offer the advantage that the quantum computer system can be at least partially and/or at least temporarily supplied with electrical energy by the energy source provided and is then optionally not dependent on the provision of electrical energy by an external energy source. The fact that the quantum computer system is at least partially supplied with energy by the energy reserve means that at least some, but optionally all, components of the quantum computer system can be supplied with electrical energy, while optionally other components can be supplied with energy by other means. For example, some components may have one or more energy reserves of their own. The provision of an isolating device can offer the advantage that any interference and/or fluctuations originating from an external energy source can be kept away from the quantum computer particularly effectively.

The at least one energy reserve may comprise one or more of the following elements: a battery, an accumulator, a capacitor, an interconnection of at least one battery and/or at least one accumulator and/or at least one capacitor. This enables electrical energy to be stored and made available for the operation of the quantum computer if no suitable external energy source is available. This can therefore be advantageous for mobile use of the quantum computer system, since independence from an external energy source is created at least for a predetermined period of time. Optionally, the type of energy reserve can be selected according to the stability of the electrical energy to be provided and/or according to the amount of electrical energy to be provided. The amount of electrical energy that can be provided by the energy reserve can have an influence on the period of time over which the quantum computer system can operate the quantum computer independently of an external energy source.

The quantum computer system can thereby be operable in a first operating mode, wherein the quantum computer system is configured in the first operating mode such that the disconnecting device interconnects the charging device and the energy reserve, and the charging device charges the energy reserve with electrical energy from an external energy supply. In other words, the quantum computing system may be in a charging state in the first operating mode.

In the first operating mode, the quantum computer system can be configured in such a way that the charging device in conjunction with the external power supply serves as an energy source that provides the electrical energy of the external power supply to the power supply device for the multilevel voltage regulation. In other words, in the first operating mode, the quantum computer system can be operated directly with energy from the external energy supply via the charging device. This means that, optionally, in the first operating mode, the quantum computer system and/or the quantum computer is not supplied with energy from the energy reserve of the quantum computer system, but with energy from the external energy supply, which can be prepared or conditioned by the charging device and the multi-stage voltage regulation. As a result, the energy reserve of the quantum computer system can optionally be conserved in the first operating mode and kept ready for situations in which the quantum computer and/or quantum computer system cannot be supplied by a suitable external energy supply.

The quantum computing system may optionally be operable in a second mode of operation, wherein the quantum computing system may be configured in the second mode of operation such that the isolating device isolates the charging device and the power reserve from each other. In addition, the quantum computer system may be configured in the second operating mode such that the disconnecting device disconnects the charging device and the power supply device from each other, and such that the power reserve serves as a power source and provides the electrical power to the power supply device for the multi-level voltage regulation. In other words, in the second mode of operation, the quantum computing system may optionally be arranged for the isolating device to isolate the quantum computing system from the external power supply and optionally from the charging device, and for the quantum computer and/or the quantum computing system to be powered by the power reserve of the quantum computing system. This can offer the advantage that the quantum computer system can be operated independently of an external energy supply and/or that any interference and/or fluctuations originating from an external energy supply device can be kept away from the quantum computer.

The quantum computer system may optionally be arranged to be operated in the second operating mode while the quantum computer is performing a quantum operation and/or executing a quantum computer program. This may offer the advantage that the risk of any interference with the quantum operation and/or the execution of the quantum computer program may be reduced, and the reliability of quantum operations and/or the execution of quantum computer programs may be increased.

The quantum computer and/or the quantum computer system may optionally comprise one or more of the following sub-devices: a photodetector, an amplifier, a light source driver, a light source, devices (mWA, MW/RF-AWFG) for generating an electromagnetic wave field, a waveform generator, and a microwave and/or radio wave frequency generator for generating predeterminable waveforms. At least one of the sub-devices and optionally all of the sub-devices can have internal voltage stabilization. These internal voltage stabilizations can be designed in addition to the multi-stage voltage regulation of the quantum computer system. This can further improve the reliability of the operation of the quantum computer.

The energy supply device can be set up to supply the quantum computer system with electrical energy during a relocation of the quantum computer system. In other words, the energy supply device can be designed to be mobile in order to optionally supply the quantum computer system with electrical energy in a location-independent manner. Optionally, the quantum computer system can be designed to be relocatable.

“Relocatable” or “relocatable” in the sense of the disclosure means that the quantum computer system or the respective sub-device is suitable and designed to be moved from a first location to a second location in a short time, and to be operated both at the first location and at the second location and/or during the movement from the first location to the second location. By “short time” (suggestion) is typically meant here a time shorter than a day, better shorter than 12 h, better shorter than 6 h, better shorter than 2 h, better shorter than 1 h, better shorter than 30 min, better shorter than 15 min, better shorter than 5 min, better shorter than 2 min, better shorter than 1 min. The time for moving the device from a first location to a second location can also be 0 s if the device is virtually immediately ready for use from the user's point of view and/or is permanently ready for use and, for example, simply moves, i.e. remains ready for use during the movement. Whereby “operational readiness” or “ready for use” here means, in the sense of the document presented here, being ready for intended use. In particular, operational readiness may include the ability to perform quantum operations and/or to execute quantum computer programs.

The relocatable quantum computer QC optionally receives its energy via a power supply EV. A charging device LDV of the energy supply EV optionally receives its energy externally from an energy source PWR.

A good overview of possible electrical energy sources can be found in the book: Vasily Y. Ushakov (Author), “Electrical Power Engineering: Current State, Problems and Perspectives (Green Energy and Technology)”, Paperback-Aug. 18, 2018, Springer; 1st ed. 2018 Edition (Aug. 18, 2018), ISBN-10:3319872850, ISBN-13:978-3319872858. The entire contents of this document are incorporated herein by reference.

The energy source can optionally have one or more of the energy sources mentioned below. The energy source can form part of the energy supply device of the quantum computer system or be designed separately from the energy supply device.

### Electric Generator

The energy source can optionally be designed as an electrical generator or comprise one that is designed to convert mechanical energy into electrical energy. The mechanical energy can optionally be energy transmitted via a shaft or the energy of a moving fluid. It may optionally be an electrical machine, such as a synchronous or asynchronous or direct current motor, a linear motor, a reluctance motor and/or a BLDC motor or the like, which can convert the mechanical energy of a linear and/or rotational movement into electrical energy by means of induction in lines of a stator and/or rotor. It can optionally also be a magnetohydrodynamic generator, or MHD generator for short, which converts the movement of an electrically conductive fluid into electrical energy. The fluid can optionally be a plasma and/or an electrically conductive liquid, for example a salt solution and/or a molten metal. The energy source may optionally comprise or be designed as a nuclear reactor, an internal combustion engine, a heating device, a jet engine, a rocket engine, a marine propulsion system, a Stirling engine, a turbine, a water turbine, a gas turbine, a wind turbine, a tidal power plant, and/or a wave power plant and/or the like. Magnetohydrodynamic generators are known, for example, from the following publications: EN 20 2021 101 169 U1, WO 2021 159 117 A1, EP 3 863 165 A1, U.S. Pat. No. 2,021,147 061 A1, CN 108 831 576 B, U.S. Pat. No. 2,019,368 464 A1, WO 2019 143 396 A2, EP 3 646 452 B1, CN 20 634 1126 U, EP 3 279 603 B1, EP 3 400 642 B1, EP 3 345 290 B1, EP 3 093 966 B1, WO 2016 100 008 A2, DE 10 2014 225 346 A1, RU 2014 143 858 A, EP 3 007 350 B1, U.S. Pat. No. 2,016,377 029 A1, RU 2 566 620 C2, EP 3 075 064 A1, EP 2 874 292 B1, EP 2 986 852 B1, CN 10 385 5907 B, RU 126 229 U1, WO 2014 031 037 A2. The disclosures of these documents are incorporated herein by reference. Furthermore, reference is made to the following book with regard to optionally usable energy sources: Hugo K. Messerle (author), “Magnetohydrodynamic Electrical Power Generation (UNESCO Energy Engineering Series)”, John Wiley & Sons Ltd (Aug. 1, 1995), ISBN-10:0471942529, ISBN-13:978-0471942528. The entire contents of this document are incorporated herein by reference.

### Electrochemical Cell

The energy source can optionally have an electrochemical cell or be designed as such. This may, for example, be an electrochemical cell in the broadest sense, which provides electrical energy by means of chemical reactions. These electrochemical cells include, for example, accumulators, batteries and fuel cells.

### Nuclear Energy Sources

In the case of nuclear energy sources, the document presented here distinguishes between those that first convert nuclear energy into mechanical energy, for example by means of steam cycles and turbines, and then convert it into electrical energy, for example by means of one or more of the above-mentioned generators, and those that convert nuclear energy directly into electrical energy. The paper presented here mentions betavoltaic cells and thermonuclear generators as examples. The latter can be advantageous in that they can be made mobile with reasonable technical effort. The radionuclide batteries contemplated herein are optionally designed to utilize one or more of the following isotopes: ⁶⁰Co, ⁹⁰Sr, ¹⁰⁶Ru, ¹⁴⁴Cs, ¹⁴⁷Pm, ²¹⁰Pm, ²¹⁰Po, ²³⁸Pu, ²⁴² Cm, ²⁴¹Am, ²⁴³Am. Optionally, the relocatable quantum computer QC is protected from the radiation of such a nuclear energy source by a radiation shield, optionally made of lead. Radionuclide batteries also include beta-voltaic cells, for example, which can convert beta radiation from beta emitters directly into electrical energy.

Such radionuclide batteries are known, for example, from the following documents: DE 1 240 967 B, DE 1 564 070 B1, DE 2 124 465 B2, DE 7 219 216 U, DE 19 782 844 538 B1, DE 69 411 078 T2, U.S. Pat. Nos. 5,443,657 A, 5,859,484 A, DE 19 602 875 A1, DE 19 738 066 A1, DE 19 957 669 A1, DE 19 957 669 A1, U.S. Pat. No. 8,552,616 B2, WO 2009 103 974 A1 and U.S. Pat. No. 2,018,226 165 A1. The disclosures of these documents are incorporated herein by reference.

The energy source can optionally also have one or more renewable energy sources, such as a solar cell and/or a hydroelectric power plant with a water turbine and a generator and/or a wind power plant with a wind turbine and a generator, or be designed as such.

The energy source may optionally comprise or be designed as a conventional coal, lignite, oil and/or gas-fired power plant which burns carbonaceous and/or hydrocarbonaceous fuels to generate thermal energy and then convert the thermal energy into mechanical energy and then convert the mechanical energy into electrical energy.

The energy source can optionally have so-called energy harvesting devices or be designed as such. These are devices that use energy differences already present in the environment or elsewhere to generate electrical energy, for example from the kinetic energy of a person or another moving object or from thermal differences, such as in heating systems or the like.

Finally, the energy source can simply be the power grid, whereby the primary energy source that feeds the electrical energy into the power grid can remain undefined in this case.

The quantum computer system optionally has a charging device LDV. The charging device LDV can form part of the energy supply device or be formed separately upstream of the energy supply device. Optionally, the charging device LDV prepares the energy of the energy supply PWR of the charging device LDV to such an extent that the charging device LDV can charge one or more energy reserves BENG, BENG2 with the energy of the energy supply PWR. For example, the charging device LDV can have a voltage converter and/or a buck converter and/or a boost converter and/or a buck-boost converter for this purpose, depending on the type of energy supply PWR. Optionally, the charging device LDV monitors the charging process of the respective energy reserve BENG, BENG2 when it is charging it.

If the quantum computer QC is not executing a quantum computer program and/or is not performing any quantum operations, the charging device LDV can optionally also supply device parts of the relocatable quantum computer QC via respective energy preparation devices SRG, SRG2. Optionally, the charging device LDV then also charges one or more of the energy reserves BENG, BENG2 of the relocatable quantum computer QC. In the example of FIG. 1, the proposed relocatable quantum computer QC has, by way of example, two energy reserves BENG, BENG2 and two energy conditioning devices SRG, SRG2. The document presented here points out that the number of energy reserves, energy preparation devices and charging devices and isolating devices may differ from the details in the examples presented. The charging device LDV optionally represents a barrier for transients of the power supply PWR. According to some optional embodiments, the charging device LDV cannot completely suppress these transient disturbances of the power supply PWR. Also, the charging device LDV, for example if the charging device LDV is a switching power supply, may optionally cause transient disturbances itself. It may therefore be advantageous to provide one or more low-noise energy reserves BENG, BENG2 for the supply of particularly interference-prone device parts of the quantum computer system, such as the photodetector PD, the amplifier V, the light source driver LDRV, the light source LD and/or, if applicable, for magnetic field-generating device parts. for magnetic field generating device parts MFSx, MFSy, MFSz, MGx, MGy, MGz and device parts with a particularly time-sensitive signal scheme, such as the waveform generator WFG, and/or the microwave and/or radio wave frequency generator MW/RF-AWFG for generating largely freely predeterminable waveforms (arbitrary waveform generator). Optionally, these device parts are set up to further condition and/or stabilize their internal supply voltages within these device parts in order to suppress the noise and/or disturbances of the power supply to a maximum extent. Optionally, the quantum computer QC comprises one or more energy conditioning devices SRG, SRG2 for supplying the device parts from the one energy reserve or the plurality of energy reserves BENG, BENG2. The energy conditioning devices optionally adapt the voltage level supplied by the charging device LDV or the energy reserves BENG, BENG2 to a suitable voltage level of the respectively supplied device part of the quantum computer QC, optionally with a voltage hold-off. In a second control stage, which is optionally a linear regulator or has such a linear regulator, these linear regulators can then, for example, use the voltage hold-up in order to precisely adjust the actual supply voltage of the relevant device parts of the quantum computer system with low noise.

Optionally, one or more isolating devices TS isolate the one charging device or the plurality of charging devices LDV from the one energy conditioning device or the plurality of energy conditioning devices SRG, SRG2 and/or the one low-noise energy reserve or the plurality of low-noise energy reserves BENG, BENG2 when the quantum computer executes a quantum computer program and/or performs a quantum operation. The one or more isolating devices can each form part of the energy supply device or be formed separately from it. A quantum operation as defined herein is a manipulation of a quantum dot NV1, NV2, NV3 and/or a nuclear quantum dot CI1₁, CI1₂, CI1₃, CI2₁, CI2₂, CI2₃, CI3₁, CI3₂, CI3₃. A quantum computer program, as defined herein, is a program that comprises at least one quantum operation. Optionally, one or more binary data in the memory NVN, RAM of the control device μC of the relocatable quantum computer QC encode such a quantum operation. For example, it may be a predetermined data word. A quantum operation as defined herein optionally manipulates at least the quantum state of at least one quantum dot of the quantum dots NV1, NV2, NV3 of the relocatable quantum computer QC and/or optionally manipulates at least the quantum state of at least one nuclear quantum dot of the nuclear quantum dots CI1₁, CI1₂, CI1₃, CI2₁, CI2₂, CI2₃, CI3₁, CI3₂, CI3₃ of the relocatable quantum computer QC. The data word symbolizing such a quantum operation is also referred to as a quantum op-code by the technical teaching of the paper presented herein. A quantum computer program optionally comprises at least one quantum op code. In the above case, when the relocatable quantum computer QC executes a quantum computer program and/or performs a quantum operation, the one power reserve or the plurality of power reserves BENG, BENG2 optionally supply the one power conditioning device or the plurality of power conditioning devices SRG, SRG2 optionally with electric power that is particularly low in noise.

Optionally, one or more disconnecting devices TS connect the one charging device or the plurality of charging devices LDV to the one energy conditioning device or the plurality of energy conditioning devices SRG, SRG2 and/or the one low-noise energy reserve or from the plurality of low-noise energy reserves BENG, BENG2 when the relocatable quantum computer QC is not executing a quantum computer program and/or is not performing a quantum operation. In this case, the charging device LDV optionally charges the one energy reserve or the multiple energy reserves BENG, BENG2 and, if necessary, supplies the one energy conditioning device or the multiple energy conditioning devices SRG, SRG2 with electrical energy, which is typically now less low-noise.

Optionally, the quantum computer system described above also has at least one magnetic field sensor system and at least one magnetic field generator. The quantum computer system is optionally set up to determine a change in a prevailing magnetic field by means of the at least one magnetic field sensor system and to at least partially compensate for the determined change in the magnetic field at the location of the quantum computer by means of the magnetic field generator.

In a further aspect, a quantum computer system comprising a relocatable quantum computer is provided, wherein the quantum computer system is characterized in that the quantum computer system further comprises at least one magnetic field sensor system and at least one magnetic field generator. The quantum computer system is set up to determine a change in a prevailing magnetic field by means of the at least one magnetic field sensor system and to at least partially compensate for the determined change in the magnetic field at the location of the quantum computer by means of the magnetic field generator.

A magnetic field sensor system is a system with one or more magnetic field sensors. The magnetic field sensor system can optionally have further components that may be advantageous or necessary for the operation of one or more magnetic field sensors.

A magnetic field generator is a device that is designed to generate and/or change a magnetic field in a controllable manner. Thus, the magnetic field generator can be designed to provide a magnetic field in a controllable manner in such a way that any external magnetic field and/or a change in an external magnetic field is at least partially compensated in order to attenuate or completely compensate for an undesired effect of the external magnetic field or its change.

A quantum computer system according to this aspect offers the advantage that undesired influences of magnetic fields, in particular of external magnetic fields, on the quantum computer and optionally on other components of the quantum computer system can be reliably reduced or even minimized or even eliminated. As a result, undesirable impairments of the quantum computer can be avoided and the reliability of the operation of the quantum computer can be increased. Optionally, any error rates of the quantum computer when performing quantum operations and/or when executing quantum computer programs can thereby be reduced, and the accuracy and/or reliability of the quantum computer system can be increased accordingly.

Optionally, the magnetic field sensor system is designed to detect the magnetic field in three spatial directions. The quantum computer system can be designed to determine the three-dimensional change in the prevailing magnetic field. This can offer the possibility of at least partially shielding the quantum computer from undesired magnetic fields and/or undesired changes in magnetic fields in all three spatial directions and enabling the quantum computer to operate as free of interference and/or errors as possible.

The magnetic field sensor system can be designed to measure a three-dimensional vector of a magnetic flux density B at the location of the quantum computer and/or in the immediate vicinity of the quantum computer. This can offer the advantage that the most accurate possible knowledge of the magnetic field to be compensated and/or stabilized can be obtained and in this way the most interference-free and/or error-free operation of the quantum computer system can be achieved.

The at least one magnetic field generator may comprise at least one magnetic field generating means The at least one magnetic field generating means may optionally comprise one or more of the following elements: at least one permanent magnet, at least one electromagnet, at least one Helmholtz coil, and at least one pair of Helmholtz coils. Optionally, several Helmholtz coils and/or several Helmholtz coil pairs can be oriented and arranged in different spatial directions so that the magnetic field at the location of the quantum computer can be at least partially compensated or stabilized in several spatial directions. Optionally, the at least one magnetic field generating means can form a magnetic circuit.

The magnetic field generator can optionally have at least one positioning device, which is designed to change a position and/or orientation of the at least one magnetic field generating means relative to the quantum computer. This can enable simple adjustment of the magnetic field generated by the magnetic field generator. In particular, this may allow one or more permanent magnets to be used to generate the magnetic field while still providing the ability to adjust the magnetic field provided by the magnetic field generator at the location of the quantum computer in a controlled manner.

The quantum computer system can also be set up to at least partially compensate for a geomagnetic field at the location of the quantum computer. This can offer the possibility of specifically attenuating or compensating for undesirable influences of the earth's magnetic field on the quantum computer.

The quantum computer system may optionally further comprise a position determination device. In addition, the quantum computer system can also be set up to determine a position and/or orientation of the quantum computer relative to the earth using the position determination device and to determine the earth's magnetic field to be compensated at the location of the quantum computer on the basis of the determined position and/or orientation of the quantum computer relative to the earth. This can offer the possibility of weakening, compensating and/or stabilizing the earth's magnetic field or a change in the earth's magnetic field in an automated manner, in particular when the quantum computer system is moving in the earth's magnetic field. The quantum computer system can optionally also be designed to determine a change in position and/or orientation of the quantum computer and to generate a prediction for an expected change in the geomagnetic field to be compensated at the location of the quantum computer. The quantum computer system may further be designed to use cartographic information about the geomagnetic field for the prediction of the expected geomagnetic field and/or an expected change in the geomagnetic field to be compensated.

The quantum computer system may further comprise a shielding, wherein the quantum computer system is designed to shield at least some sub-devices of the quantum computer system at least partially from electric fields and/or magnetic fields by means of the shielding. This can further reduce the undesirable influence of external magnetic fields on the quantum computer and/or reduce the effort required to attenuate and/or compensate for magnetic fields and/or the change in magnetic fields at the location of the quantum computer.

The quantum computer system may further comprise a housing, wherein the shielding is at least partially arranged within the housing and/or at least partially integrated into the housing. This may reduce the number of components and/or the complexity of the structure of the quantum computing system. The housing can be designed to form a Faraday cage around the quantum computer. As a result, the quantum computer can be at least partially shielded from external electrical fields by the housing and the stability of the operation of the quantum computer can be increased accordingly. The shielding can optionally be designed in such a way that the shielding shields the quantum computer from other components of the quantum computer system. This can be advantageous in order to reduce the undesirable influence of such components of the quantum computer system, which generate electric and/or magnetic fields, on the quantum computer. The housing may optionally comprise a plurality of partial housings, wherein the quantum computer is arranged in one of the plurality of partial housings and wherein the partial housing in which the quantum computer is arranged comprises at least a part of the shielding which shields the quantum computer from other components of the quantum computer system.

The shielding and/or the housing can optionally be at least partially made of a μ-metal or comprise a μ-metal. This can provide particularly effective shielding of the quantum computer against external magnetic fields.

Optionally, the energy supply device of the quantum computer system can be arranged at least partially within the shielding. This can offer the advantage that the energy supply device can be at least partially protected from undesired influences by external electric and/or magnetic fields.

The optional features of the magnetic field sensor system and the magnetic field generator, as well as their mode of operation in the quantum computer system, are explained below.

In order to reduce the influence of external magnetic fields, it is useful to provide the proposed quantum computer QC with a shield AS against these external magnetic fields. This shielding can, for example, be a passive shielding AS, for example in the form of μ-metal mats and/or an active shielding AS in the form of a magnetic field-generating system that generates a magnetic counter-field to an external magnetic interference field and thereby reduces and/or even compensates for its effect. Optionally, the proposed quantum computer therefore comprises one or more magnetic field sensors MSx, MSy, MSz for detecting the strength of the magnetic flux density B and/or the magnetic field strength H. The magnetic field sensors are (proposal: here) also referred to as sensors. Optionally, the control device μC uses the values of the magnetic flux density B and/or the magnetic field strength H detected by the one or more sensors MSx, MSy, MSz to control magnetic field generating means MGx, MGy, MGz. The magnetic field generating means MGx, MGy, MGz optionally generate a compensating magnetic flux density B of an opposing magnetic field, which compensates for the magnetic flux density B of the magnetic interference field.

Optionally, a first sensor MSx detects the strength of the magnetic flux density B and/or the magnetic field strength H in a first direction, for example along an X-axis. A first magnetic field controller MFSx optionally supplies a first magnetic field generating means MGx of the magnetic field generator with electrical energy. The first magnetic field generating means MGx optionally generates a magnetic flux density Bₓ, which optionally essentially has a direction that optionally corresponds to the first direction, for example the direction of the X axis. The first magnetic field control MFSx of the magnetic field generator optionally energizes the first magnetic field generating means MGx with a first electric current Ix. Optionally, a control device μC of the quantum computer system controls the first magnetic field generating means MGx via the first magnetic field control MFSx. Optionally, the first magnetic field controller MFSx controls the generation of the magnetic flux density Bₓ by the first magnetic field generating means MGx in such a way that the magnetic flux density B or the magnetic field strength H detected by the first sensor MSx corresponds to a first value. Optionally, this first value is zero. For this purpose, the first magnetic field control MFSx optionally evaluates the value of the magnetic flux density B detected by the first sensor MSx or the value of the magnetic field strength H detected by the first sensor MSx.

Optionally, a second sensor MSy of the magnetic field sensor system detects the strength of the magnetic flux density B and/or the magnetic field strength H in a second direction, for example a Y-axis. Optionally, the direction of the Y-axis is perpendicular to the direction of the X-axis. A second magnetic field control MFSy of the magnetic field generator optionally supplies a second magnetic field generating means MGy of the magnetic field generator with electrical energy. The second magnetic field generating means MGy optionally generates a magnetic flux density B_{y}, which optionally essentially has a direction that optionally corresponds to the second direction, for example the direction of the Y-axis. The second magnetic field control MFSy optionally energizes the second magnetic field generating means MGy with a second electric current Iy. Optionally, the control device μC controls the second magnetic field generating means MGy via the second magnetic field control MFSy. Optionally, the second magnetic field controller MFSy controls the generation of the magnetic flux density B_{y} by the second magnetic field generating means MGy in such a way that the magnetic flux density B detected by the second sensor MSy or the magnetic field strength H detected by the second sensor MSy corresponds to a second value. Optionally, this second value is zero. For this purpose, the second magnetic field control MFSy evaluates the value of the magnetic flux density B detected by the second sensor MSy or the value of the magnetic field strength H detected by the second sensor MSy.

Optionally, a third sensor MSz of the magnetic field sensor system detects the strength of the magnetic flux density B and/or the magnetic field strength H in a third direction, for example a Z-axis. Optionally, the direction of the Z-axis is perpendicular to the direction of the X-axis and perpendicular to the direction of the Y-axis. A third magnetic field control MFSz of the magnetic field generator optionally supplies a third magnetic field generating means MGz of the magnetic field generator with electrical energy. The third magnetic field generating means MGz optionally generates a magnetic flux density B_{z}, which optionally essentially has a direction that optionally corresponds to the third direction, for example the direction of the Z-axis. The third magnetic field control MFSz optionally energizes the third magnetic field generating means MGz with a third electric current Iz. Optionally, the control device μC controls the third magnetic field generating means MGz via the third magnetic field control MFSz. Optionally, the third magnetic field control MFSz controls the generation of the magnetic flux density B_{z} by the third magnetic field generating means MGz in such a way that the magnetic flux density B or the magnetic field strength H detected by the third sensor MSz corresponds to a third value. Optionally, this third value is zero. For this purpose, the third magnetic field control MFSz evaluates the value of the magnetic flux density B detected by the third sensor MSz or the value of the magnetic field strength H detected by the third sensor MSz.

The quantum computer QC of the quantum computer system has an optional optical system OS, which allows the light source LED to irradiate the quantum dots NV1, NV2, NV3 with pump radiation LB. Optionally, the OS optical system is a confocal microscope. Optionally, however, the optical system OS also enables an optical readout of the state of quantum dots NV1, NV2, NV3 of the relocatable quantum computer QC. For this purpose, the relocatable quantum computer QC of the relocatable quantum computer system QUSYS optionally has, for example, a dichroic mirror DBS, which allows the fluorescence radiation FL emitted by the quantum dots NV1, NV2, NV3 to pass through, and deflects the pump radiation LB of the light source LD onto the quantum dots NV1, NV2, NV3, and deflects the pump radiation LB from the photodetector PD for detecting the fluorescence radiation FL. Instead of a dichroic mirror DBS, the relocatable quantum computer QC of the quantum computer system QUSYS can also have a dichroic mirror DBS, for example, which deflects the fluorescence emitted by the quantum dots NV1, NV2, NV3 and allows the pump radiation LB of the light source LD to pass via the optical system OS to the quantum dots NV1, NV2, NV3, so that the pump radiation LB of the light source LD irradiates these quantum dots NV1, NV2, NV3 with pump radiation LB of the pump radiation wavelength λₚₘₚ. In this case, the optical system OS optionally detects the fluorescence radiation FL of the quantum dots NV1, NV2, NV3 and the dichroic mirror DBS reflects this fluorescence radiation FL onto the photodetector PD to detect the fluorescence radiation FL. The quantum computer QC can thus comprise, in particular if it uses an optical readout of the states of the quantum dots NV1, NV2, NV3, a photodetector PD for detecting the fluorescence radiation FL of the quantum dots NV1, NV2, NV3. The photodetector PD optionally generates a received signal S0 as a function of the fluorescence radiation FL. A downstream amplifier V in the signal path optionally amplifies and filters the received signal S0 to an amplified received signal S1. The amplifier V can thus be used to amplify and/or filter the output signal of the photodetector PD, which is typically the received signal S0. Optionally, the amplified received signal S1 is a digitized signal consisting of one or more sampled values. Optionally, the control device μC detects the value of the amplified received signal S1, for example by means of an analog-to-digital converter ADCV. The quantum computer system can thus, if it uses an electronic readout of the states of the quantum dots NV1, NV2, NV3, comprise a corresponding device for electronically reading out the states of the quantum dots NV1, NV2, NV3. At this point, the document presented here expressly refers again to DE 10 2020 125 189 A1. Optionally, these device parts of the quantum computer system are accommodated in an optionally common housing GH, which is optionally part of the quantum computer system within the meaning of the paper presented here. Optionally, the quantum dots NV1, NV2, NV3 and the nuclear quantum dots CI1₁, CI1₂, CI1₃, CI2₁, CI2₂, CI2₃, CI3₁, CI3₂, CI3₃ are located within a substrate D of the quantum computer. Optionally, the substrate D is doped with dopants. Optionally, the substrate D essentially comprises atoms without a magnetic moment at least in the effective range of the quantum dots NV1, NV2, NV3. In the case of diamond as the material of the substrate D, the diamond optionally essentially comprises ¹²C isotopes. Optionally, in the case of the use of NV centers in diamond as quantum dots NV1, NV2, NV3, oxygen atoms ¹⁶O, ¹⁸O and/or phosphorus and/or sulfur atoms ³²S, ³⁴S, ³⁶S without a magnetic moment in the substrate D form the doping in the region of the quantum dots NV1, NV2, NV3. This doping in the region of the quantum dots NV1, NV2, NV3 can offer the following two advantages in particular. Firstly, these dopant atoms can change the Fermi level E_{F} in the region of the quantum dots NV1, NV2, NV3. In the case of using NV centers as quantum dots NV1, NV2, NV3, this doping with said dopant atoms can shift the Fermi level E_{F} in the region of these quantum dots NV1, NV2, NV3. In the case of n-doping, this can shift the Fermi level E_{F} in the area of these quantum dots NV1, NV2, NV3 in such a way that the Fermi level is raised and that the energetically lower lying NV centers are then optionally electrically negatively charged. The NV centers can then represent NV⁻ centers. Since NV⁻ centers have a magnetic moment of this electron configuration due to the negative charge electron, NV⁻ centers can therefore be particularly suitable for use as quantum dots NV1, NV2, NV3. Secondly, this doping, which is optionally an n-doping, can lead to the vacancies in the diamond being electrically charged during implantation to form the NV centers and therefore not clustering together due to the electrical repulsion of the negatively charged single vacancies. This allows the concentration of single vacancies to be kept at a high level, which increases the probability of NV centers forming when nitrogen is implanted in diamond. Good results can be achieved, for example, by doping a diamond substrate D with sulfur prior to nitrogen implantation. Doping with a sulfur isotope without a nuclear magnetic momentum is an option. Such isotopes are the isotopes ³²S, ³⁴S, ³⁶S. Doping with the oxygen isotopes ¹⁶O, ¹⁸O can be an alternative. Alternatively, or additionally, n-doping with phosphorus can be used. However, phosphorus has a magnetic nuclear moment. An n-doping with atoms that do not have a magnetic nuclear moment may be desirable. A shift of the Fermi level E_{F} by other means, for example by means of optionally very thin electrodes pre-charged to a suitable potential with respect to the substrate D, can also bring about the desired effects. Optionally, the substrate D of the relocatable quantum computer can thus at least temporarily exhibit a local shift of the Fermi level E_{F}, so that this is then energetically shifted in such a way that the yield of quantum dots NV1, NV2, NV3 in the form of NV centers is increased during the implantation of the nitrogen atoms. In an analogous manner, the Fermi level E_{F} of other substrate materials and/or in relation to other paramagnetic centers (e.g. the ST1 center) can optionally be influenced during the formation of these paramagnetic centers. Optionally, the light source LD and the light source driver LDRV and the substrate D and the devices for generating the electromagnetic wave field MW/RF-AWFG, mWA, MGx, MGy, MGz and the control device μC and the memories RAM, NVM of the control device μC and the optical system OS and possibly the amplifier V and the shield AS are located inside the housing GH, whereby they are optionally shielded from electromagnetic interference radiation penetrating from the outside. For this purpose, the material of the housing GH optionally comprises an electrically conductive material. Optionally, the housing GH forms a Faraday cage. Optionally, the material of the housing GH also comprises a material for shielding magnetostatic and/or quasistatic magnetic fields. For this purpose, the material of the housing GH optionally comprises so-called μ-metal, which can be a particularly soft magnetic material. This can particularly favor shielding against magnetic fields.

The optional μ-metal (mumetal or permalloy) proposed here for use in a quantum computer system and in quantum technological devices typically belongs to a group of soft magnetic nickel-iron alloys, which optionally have a proportion of 72% to 80% nickel as well as proportions of copper, molybdenum, cobalt and/or chromium, and which have a high magnetic permeability, which can be advantageously used in the proposed relocatable quantum computer system or the proposed quantum technological device for shielding AS low-frequency external magnetic fields. the proposed quantum technology device for shielding AS low-frequency external magnetic fields.

Such μ-metal can have a high permeability (for example in a range of μᵣ=50,000 to 140,000 or more), which causes the magnetic flux of the external low-frequency magnetic fields to concentrate in the material of the housing GH of the relocatable quantum computer system. This effect can lead to considerable shielding attenuation when shielding AS from low-frequency or static magnetic interference fields. Thus, the quantum dots NV1, NV2, NV3 and nuclear quantum dots CI1₁, CI1₂, CI1₃, CI2₁, CI2₂, CI2₃, CI3₁, CI3₂, CI3₃ are shielded against such external magnetic fields even if the relocatable quantum computer QC changes its spatial orientation and/or location during relocation, whereby such a change in the orientation of the relocatable quantum computer QC and/or the change in location of such a relocatable quantum computer QC may be accompanied by a change in the orientation and/or the strength of the magnetic fields acting on the relocatable quantum computer QC relative to the relocatable quantum computer QC. This can be particularly advantageous if the relocatable quantum computer QC does not have active shielding or protection against external magnetic fields or active reduction or compensation of the magnetic field, e.g. to save weight, which would detect the interfering magnetic field by means of a magnetic field sensor MSX, MSy, MSz and generate an opposing magnetic field for compensation by means of suitable means MFSx, MFSy, MFSz, MGX, MGy, MGz.

The shield AS of the quantum computer system may form a part of the housing GH of the relocatable quantum computer QC or constitute the housing GH of the relocatable quantum computer QC itself. As already described, the control device μC can control the light source LD with the aid of said light source driver LDRV. In doing so, the control device μC optionally generates a light source control signal, which may for example be the transmission signal S5, by suitable means. The light source driver LDRV then optionally supplies the light source LD with electrical energy as a function of the light source control signal from the control device μC. The light source LD optionally generates the pump radiation LB as a function of the light source control signal of the control device μC. The light source LD thus optionally generates the pump radiation LB as a function of the transmission signal S5. In the case of FIG. 1, the control device μC optionally transmits the light source control signal via the control data bus SDB and the waveform generator WFG as transmit signal S5. In the following, the reader can therefore assume for simplification and better understanding that in FIG. 1 the light source control signal is equal to the transmission signal S5. The light source LD can then irradiate the quantum dot or the multiple quantum dots NV1, NV2, NV3 with pump radiation LB of a pump radiation wavelength λₚₘₚ. by means of the optical system OS. The pump radiation wavelength λₚₘₚ is optionally between 400 nm and 700 nm and/or between 450 nm and 650 nm and/or 500 nm and 550 nm and/or 515 nm and 540 nm and/or at a wavelength of 532 nm. In the case of NV centers in diamond, the use of an OSRAM laser diode of the type PLT5 520B with a wavelength of 520 nm can be used as an exemplary source of the pump radiation LB for the irradiation of NV centers in diamond as the material of the substrate D. The quantum dots NV1, NV2, NV3 then optionally emit fluorescence radiation FL with a fluorescence wavelength λ_{fl} as a function of their state and of the pump radiation LB. In the case of NV centers as paramagnetic centers of quantum dots, the fluorescence wavelength can optionally be in a wavelength range around 638 nm. The intensity In of the fluorescence radiation FL can depend on the intensity Iₚₘₚ of the pump radiation LB and thus also on the light source control signal. The one quantum dot or the multiple quantum dots NV1, NV2, NV3 can thus emit fluorescence radiation FL with a fluorescence radiation wavelength λ_{fl} when irradiated with electromagnetic radiation, the pump radiation wavelength λₚₘₚ. In the case of an optical readout of the state of the quantum dots NV1, NV2, NV3 or the quantum dot, the photodetector PD can detect the fluorescence radiation FL by means of the optical system OS and convert the fluorescence radiation FL into a receiver output signal S0. The receiver output signal S0 can depend on the fluorescent radiation FL that hits the photodetector PD. Optionally, the receiver output signal S0 depends on the intensity I_{fl} of the fluorescent radiation FL that hits the photodetector PD. In the case of optical readout of the state of the quantum dot(s) NV1, NV2, NV3, the amplifier V optionally amplifies and/or filters the receiver output signal S0 and optionally makes the signal available to the computer core CPU of the control device μC as an amplified receive signal S1. Optionally, the amplifier V stores the values of the samples of the amplified received signal S1, which have been digitized by means of an analog-to-digital converter of the amplifier V, in a memory of the amplifier V. The computer core CPU of the control device μC of the relocatable quantum computer QC can then query these samples of the amplified received signal S1 from the memory of the amplifier V via the control data bus SDB, for example, and process them further. In the case of electronic readout of the quantum dots NV1, V2, NV3, devices HS1 to HS3 and VS1 for electronic readout of the states of the quantum dots NV1, NV2, NV3 with a control unit B CBB, not shown in FIG. 1, generate a second receive signal. As already described, the control device μC of the relocatable quantum computer QC can control the one or more devices for generating an electromagnetic wave field at the respective location of the quantum dots NV1, NV2, NV3 and at the respective location of the nuclear quantum dots CI1₁, CI1₂, CI1₃, CI2₁, CI2₂, CI2₃, CI3₁, CI3₂, CI3₃. By controlling the one or more devices (LH1, LH2, LH3, LV1) for generating an electromagnetic wave field at the respective location of the quantum dots NV1, NV2, NV3 and at the respective location of the nuclear quantum dots CI1₁, CI1₂, CI1₃, CI2₁, CI2₂, CI2₃, CI3₁, CI3₂, CI3₃ and/or by controlling the emission of the light source LD, the control device μC of the relocatable quantum computer QC can thus change the states of the quantum dots NV1, NV2, NV3 and/or nuclear quantum dots CI1₁, CI1₂, CI1₃, CI2₁, CI2₂, CI2₃, CI3₁, CI3₂, CI3₃ and/or couple them to one another. Optionally, the control device μC of the relocatable quantum computer QC has means for generating a measured value signal with one or more measured values from one or more received signals, in particular from the first received signal and or the second received signal. Since these received signals depend on the states of the quantum dots NV1, NV2, NV3 and/or nuclear quantum dots CI1₁, CI1₂, CI1₃, CI2₁, CI2₂, CI2₃, CI3₁, CI3₂, CI3₃ the measured value signal typically also depends on the states of the quantum dots NV1, NV2, NV3 and/or nuclear quantum dots CI1₁, CI1₂, CI1₃, CI2₁, CI2₂, CI2₃, CI3₁, CI3₂, CI3₃.

To achieve deployability, the use of a room-temperature relocatable quantum computer QC based on paramagnetic centers as quantum dots NV1, NV2, NV3 using nuclear magnetic moments as nuclear quantum dots CI1₁, CI1₂, CI1₃, CI2₁, CI2₂, CI2₃, CI3₁, CI3₂, CI3₃ with optical pump radiation LB and optical state readout or electronic state readout of the quantum dot states of the quantum dots NV1, NV2, NV3 and a suitable, relocatable, preferably passive shielding AS.

The present proposal now suggests that the relocatable quantum computer system QC and/or the mobile device optionally comprises a relocatable energy supply EV or energy supply device for supplying the relocatable quantum computer QC with energy, as described above. This may favor the deployability of the quantum computer system. Optionally, the energy supply EV or energy supply device is located within the housing GH. The housing GH can comprise a partial housing with a magnetically shielded area in which the partial devices of the relocatable quantum computer system that are sensitive to magnetic fields are located. Outside this partial housing, but still inside the housing GH, there are optionally the parts of the relocatable quantum computer system that are not sensitive or less sensitive to external magnetic and electromagnetic interference fields and/or generate electromagnetic and/or magnetic interference fields themselves. The power supply device is therefore optionally placed outside the partial housing but inside the housing GH of the relocatable quantum computer system. The quantum computers QC1 to QC16 of a quantum computer system QUSYS can also have a common housing GH.

Optionally, the relocatable quantum computer system comprises a system for compensating for external magnetic fields and the earth's magnetic field. This external magnetic field compensation system may include the magnetic field sensor system and the magnetic field generator. Accordingly, the proposed mobile, relocatable quantum computer system optionally has a magnetic field sensor system, which may also be referred to as a sensor system, for three-dimensionally detecting the three-dimensional vector of magnetic flux density B. Optionally, the sensor system for three-dimensional detection of the three-dimensional vector of the magnetic flux density B detects this three-dimensional vector of the magnetic flux density B in the vicinity of the substrate D. For example, the sensor system for three-dimensional detection of the three-dimensional vector of the magnetic flux density B can comprise three magnetic field sensors MSx, MSy, MSz for the three spatial directions X, Y and Z. It is conceivable to use a single sensor system if the orientation of the magnetic field allows it. For example, the quantum computer system can comprise a magnetic field sensor MSx for the magnetic flux density Bₓ in the direction of the X axis. Optionally, the quantum computer QC can comprise a magnetic field sensor MSy for the magnetic flux density B_{y} in the direction of the Y-axis. Optionally, the quantum computer QC may comprise a magnetic field sensor MSz for the magnetic flux density B_{z} in the direction of the Z-axis.

Optionally, the proposed mobile quantum computing system comprises a magnetic field generator, i.e. one or more magnetic field generating devices PM, MGx, MGy, MGz, also referred to as magnetic field generating means in the present disclosure. The magnetic field generating devices may optionally comprise permanent magnets PM and/or coils MGx, MGy, MGz, in particular Helmholtz coils and Helmholtz coil pairs, as magnetic field generating means. The permanent magnets PM permanently generate a magnetic flux density. The coils MGx, MGy, MGz generate a magnetic flux density corresponding to their electrical current. Optionally, the permanent magnets PM and the magnetic field generating means MGx, MGy, MGz are part of a magnetic circuit. Optionally, but not necessarily, the magnetic circuit comprises a yoke. Optionally, the permanent magnet PM is located in an air gap. Optionally, the magnetic field generator has one or more positioning devices PV for repositioning the permanent magnet PM relative to substrate D and/or in the air gap and thus changing the magnetic flux density B acting on the substrate D with the quantum dots.

Optionally, the quantum computer system and optionally the control device μC of the quantum computer system comprises a navigation device GPS, which communicates the current position to the computer core CPU of the control device μC. Optionally, the control device μC can use geomagnetic maps of the earth's magnetic field to determine the resulting earth's magnetic field strength and its magnetic flux density component. If the quantum computer QC is moved translationally or rotated, the computer core CPU of the control device μC can, for example, receive predicted values for future translational coordinates and/or future rotations via the external data bus EXTDB, or predict them from received or determined velocity values and rotation velocity values. Therefore, optionally, the computer core CPU of the control device μC can then predict changes in the future velocity and rotation velocity acting on the quantum dots NV1, NV2, NV3 and the nuclear quantum dots CI1₁, CI1₂, CI1₃, CI2₁, CI2₂, CI2₃, CI3₁, CI3₂, CI3₃ and compensate for them by changing the magnetic field generated in the quantum computer QC using the magnetic field generating devices PM, MGx, MGy, MGz.

An optional method for preventing interference with the operation of the relocatable quantum computer QC by changes in external magnetic fields due to movement of the relocatable quantum computer QC may optionally comprise the following steps.

In a first step a), the control device μC optionally determines the currently acting external magnetic field, for example by means of magnetic field sensors MSx, MSy, MSz of a magnetic field sensor system. In a second step, the control device μC optionally records the current coordinates and/or the current speed and/or acceleration by means of a navigation system NAV and/or a position determination device GPS. On the basis of this data and possibly additional data, such as an electronic map of the earth's magnetic field, the control device μC of the relocatable quantum computer system can optionally determine the new external magnetic field to be expected and optionally adjust the current supply to the magnetic field generating means MGx, MGy, MGz of the magnetic field generator in such a way that this change in the external magnetic field is essentially not effective due to the movement of the relocatable quantum computer system and essentially does not influence the calculation results of quantum computer programs of the relocatable quantum computer system.

To simplify the illustration, we assume here that the GPS navigation device determines not only the translational coordinates, for example the position on the earth's surface, but also the angular orientation of the relocatable quantum computer QC and the angular velocity of the change in these angles. By taking into account the translational changes and the rotational changes in the position and orientation of the relocatable quantum computer QC, the computer system CPU of the relocatable quantum computer system can predict the necessary adaptation of the magnetic field generation particularly accurately and control the magnetic field-generating devices PM, MGx, MGy, MGz of the magnetic field generator appropriately.

For this purpose, the computer core CPU of the control device μC can, for example, cause the first magnetic field control MFSx of the magnetic field generator to adjust the current supply to the first magnetic field generating means MGx, which optionally generates a magnetic flux density Bₓ, with electric current.

For this purpose, the computer core CPU of the control device μC can optionally also cause the second magnetic field control MFSy to adjust the energization of the second magnetic field generating means MGy, which optionally generates a magnetic flux density B_{y}, with electric current. For this purpose, the computer core CPU of the control device μC can optionally also cause the third magnetic field control MFSz to adjust the current supply of the third magnetic field generating means MGz, which optionally generates a magnetic flux density B_{z}, with electric current.

For this purpose, the computer core CPU of the control device μC can optionally also cause the positioning device PV of the permanent magnet PM to spatially adjust the positioning of the permanent magnet PM, which optionally generates a permanent, inhomogeneous magnetic flux density B and thus adjust the magnetic flux density at the location of the quantum dots NV1, NV2, NV3 and the nuclear quantum dots CI1₁, CI1₂, CI1₃, CI2₁, CI2₂, CI2₃, CI3₁, CI3₂, CI3₃.

The computer core CPU of the control device μC optionally detects the actual magnetic field by means of said magnetic field sensors MSx, MSy, MSz and optionally adjusts the magnetic flux density by means of the actuators described immediately above in the form of the magnetic field generating devices PM, MGx, MGy, MGz in order to compensate for deviations between the detected vector of magnetic flux density and the desired vector of magnetic flux density.

Optionally, the quantum computer system comprises an acceleration sensor system which can detect translational and/or rotational accelerations of the quantum computer and/or the quantum computer system, and can supply the corresponding values to the computer core CPU of the control device μC of the quantum computer QC, so that the latter can take countermeasures in the form of counter-accelerations by means of a position control system, if necessary. If necessary, the computer core CPU of the control device μC of the quantum computer system can use the positioning device PV of the permanent magnet PM and/or the translatory positioning device XT in the X-direction and/or the translatory positioning device YT in the Y-direction for some of such countermeasures. Also, optionally, the computer core CPU of the control device μC of the relocatable quantum computer QC can modify the focus of the optical system OS depending on such coordinate predictions and/or velocity predictions and/or acceleration predictions for translational movements and rotational movements in order to maintain the focus. Optionally, the computer core CPU of the control device μC of the relocatable quantum computer QC can predict deformations and mechanical vibrations within the relocatable quantum computer QC on the basis of such coordinate predictions and/or velocity predictions and/or acceleration predictions for translational movements and rotational movements and, if necessary, detect and compensate for such by means of suitable sensors such as cameras and position and distance sensors within the quantum computer QC.

Optionally, the quantum computer system can furthermore have a cooling device which is set up to reduce a temperature of quantum dots NV1, NV2, NV3 of the quantum computer and/or the temperature of nuclear quantum dots CI1₁, CI1₂, CI1₃, CI2₁, CI2₂, CI2₃, CI3₁, CI3₂, CI3₃ of the quantum computer and/or a temperature of a substrate D of the quantum computer, the cooling device being designed to be relocatable.

In a further aspect, the disclosure accordingly relates to a quantum computer system comprising a quantum computer, and a cooling device which is designed to control a temperature of quantum dots NV1, NV2, NV3 of the quantum computer and/or the temperature of nuclear quantum dots CI1₁, CI1₂, CI1₃, CI2₁, CI2₂, CI2₃, CI3₁, CI3₂, CI3₃ of the quantum computer and/or a temperature of a substrate D of the quantum computer. The quantum computer system is characterized in that the cooling device is designed to be relocatable.

The fact that the cooling device is designed to reduce a temperature of quantum dots and/or nuclear quantum dots means that the cooling device is designed to reduce the thermal energy of the quantum dots and/or nuclear quantum dots and/or a direct environment of the quantum dots and/or nuclear quantum dots in the substrate.

The fact that the cooling device is designed to be relocatable means that the cooling device can be relocated with the quantum computer system, “relocatable” being understood in the sense of the above explanations. In particular, the cooling device may optionally be suitable and/or designed to cool the quantum computer of the quantum computer system during a movement of the quantum computer system and thereby lower the temperature of the quantum dots and/or nuclear quantum dots or keep it at a lower temperature than the ambient temperature of the quantum computer system.

This offers the advantage that cooling of the quantum computer is also possible in a relocatable quantum computer system and thus operation of the quantum computer in a cooled state is not tied to stationary operation. Rather, the relocatable cooling device can also be used to cool the quantum computer system during relocation, i.e. while the quantum computer system is being moved, for example, and can thereby optionally increase a number of usable quantum dots and/or nuclear quantum dots of the quantum computer, and/or a function of the quantum computer can be improved compared to uncooled operation, for example at room temperature.

Optionally, the cooling device has at least one closed loop helium gas cooling system or is designed as such. This offers the advantage that the cooling system can be designed to be particularly mobile and can accordingly be integrated into or combined with a relocatable quantum computer system without significantly restricting the deployability of the quantum computer system. This also offers the advantage that the cooling device can be used in a very wide temperature range, for example from room temperature to a temperature of around 10 K. Thus, a system based on a closed loop helium gas cooling system offers a very high degree of flexibility, which favors the deployability of the quantum computer system.

Optionally, the quantum computer system is designed to supply the cooling device with electrical energy by means of a relocatable energy supply device of the quantum computer system. This offers the advantage that the cooling device can also be operated during the relocation of the quantum computer system or in other situations in which no external energy source is available. This significantly increases the flexibility of the relocatable quantum computer system.

Thus, the relocatable quantum computer system optionally comprises one or more relocatable cooling devices KV, which are relocatable together with the relocatable quantum computer system. One or more of the relocatable cooling devices KV are optionally suitable and/or provided for lowering the spin temperature of quantum dots NV1, NV2, NV3 and/or nuclear quantum dots CI1₁, CI1₂, CI1₃, CI2₁, CI2₂, CI2₃, CI3₁, CI3₂, CI3₃ and/or the temperature of the substrate D.

Optionally, one or more such cooling devices KV reduce the temperature of quantum dots NV1, NV2, NV3 and/or the temperature of nuclear quantum dots CI1₁, CI1₂, CI1₃, CI2₁, CI2₂, CI2₃, CI3₁, CI3₂, CI3₃ and/or the temperature of the substrate D to such an extent that the relocatable quantum computer QC can operate with a third number of quantum dots NV1, NV2, NV3 that is increased compared to the reduced first number of quantum dots NV1, NV2, NV3. Optionally, one or more such cooling devices KV reduce the temperature of quantum dots NV1, NV2, NV3 and/or the temperature of nuclear quantum dots CI1₁, CI1₂, CI1₃, CI2₁, CI2₂, CI2₃, CI3₁, CI3₂, CI3₃ and/or the temperature of the substrate D to such an extent that the quantum computer QC can operate with an increased fourth number of quantum dots CI1₁, CI1₂, CI1₃, CI2₁, CI2₂, CI2₃, CI3₁, CI3₂, CI3₃ relative to the reduced second number of nuclear quantum dots CI1₁, CI1₂, CI1₃, CI2₁, CI2₂, CI2₃, CI3₁, CI3₂, CI3₃.

Optionally, one or more of the relocatable cooling devices KV of the quantum computer QC comprise one or more Closed Loop Helium Gas Cooling Systems HeCLCS or one or more relocatable Closed Loop Helium Gas Cooling Systems HeCLCS.

Optionally, the relocatable quantum computing system comprises a second relocatable power supply BENG2, which is different from the first relocatable power supply BENG. Optionally, the second relocatable power supply BENG2 supplies power to one or more of the relocatable cooling devices KV and/or one or more of the closed loop helium gas cooling systems HeCLCS. This can offer the advantage that the energy for the operation of the one or more cooling devices can be provided in a different form, such as the energy supply for the quantum computer. For example, a lower degree of stabilization of the electrical energy provided may be sufficient for the operation of the one or more cooling devices than for the operation of the quantum computer. In this way, for example, the amount of energy to be provided, which is stabilized to a particularly high degree, can be reduced, whereby the effort required to stabilize the energy for the quantum computer system can be reduced and the complexity of the quantum computer system can be kept low accordingly.

Optionally, the quantum computer system further comprises a stabilization device and is set up to at least partially compensate for mechanical effects on the quantum computer by means of the stabilization device.

Thus, in a further aspect, a quantum computer system is provided which comprises a relocatable quantum computer and is characterized in that the quantum computer system further comprises a stabilizing device and is arranged to at least partially compensate a mechanical action on the quantum computer by means of the stabilizing device.

The mechanical effects to be compensated for can be those effects that cause an acceleration and/or a change in an acceleration of the quantum computer. The avoidance and/or compensation of such mechanical effects can be regarded as a mechanical stabilization of the quantum computer.

This offers the advantage that even in situations in which mechanical influences on the quantum computer system can occur and/or cannot be avoided, the mechanical influences can be at least partially kept away from the quantum computer. This can further favor the deployability of the quantum computer system and, in particular, enable operation of the quantum computer during deployment of the quantum computer system, even if mechanical impacts on the quantum computer system cannot always be avoided during deployment.

The stabilization device can be set up to determine an acceleration of the quantum computer, and/or to predict an expected acceleration of the quantum computer, and/or to at least partially compensate for an acceleration of the quantum computer, and/or to attenuate an effect of an acceleration on the quantum computer. Similarly, the stabilization device can be set up to predict or compensate for a respective change in acceleration as an alternative to or in addition to the accelerations. This can offer the advantage that mechanical effects can be kept away from the quantum computer particularly reliably and, accordingly, reliable operation can be enabled even if mechanical effects on the quantum computer system cannot be avoided.

The stabilization device may optionally include one or more of the following elements: one or more acceleration sensors and/or one or more acceleration sensor systems for detecting an acceleration of the quantum computer, one or more position displacement sensors for detecting a position displacement of the quantum computer, one or more position control systems for controlling a position of the quantum computer, one or more positioning stages and/or one or more positioning devices for positioning the quantum computer, one or more image acquisition devices and/or one or more image processing devices for acquiring and/or processing images of the quantum computer, and fluorescent defect centers in a substrate of the quantum computer, which have a different fluorescence wavelength than quantum dots of the quantum computer, which are intended for use as quantum bits in the quantum computer. As a result, mechanical effects can be determined and compensated for particularly reliably, in particular on the basis of accelerations and/or changes in accelerations.

The quantum computing system may optionally comprise a plurality of sub-devices, wherein the stabilizing device may further be adapted to attenuate and/or damp a transmission of mechanical shocks and/or mechanical vibrations to at least some of the sub-devices. Alternatively, or additionally, the stabilizing device may further be designed to attenuate and/or dampen a transmission of mechanical shocks and/or mechanical vibrations of at least some of the sub-devices relative to each other. This may enable reliable shielding of the quantum computer from external and internal effects of the quantum computer system.

The stabilization device can optionally comprise means for attenuating and/or damping a transmission of mechanical shocks and/or vibrations to the at least some subdevices, which are inserted in supply lines to optical device parts (D, OS, DBS, STM, PD, CM1, LD) of the quantum computer (QC) and/or to the further auxiliary device parts (KV, XT, YT, MGx, MGy, MGz, MSx, MSy, MSz, MWA, CM2, LM, HECLCS). Alternatively or additionally, the stabilization device may comprise such means which are inserted in data lines (SDA) to optical device parts (D, OS, DBS, STM, PD, CM1, LD) of the quantum computer (QC) and/or to the further auxiliary device parts (KV, XT, YT, MGx, MGy, MGz, MSx, MSy, MSz, MWA, CM2, LM, HECLCS). Alternatively or additionally, the stabilization device may comprise such means which comprise special mechanical, at least sectional formations of supply lines to optical device parts (D, OS, DBS, STM, PD, CM1, LD) of the quantum computer (QC) and/or to the further auxiliary device parts (KV, XT, YT, MGx, MGy, MGz, MSx, MSy, MSz, MWA, CM2, LM, HECLCS). Alternatively or additionally, the stabilization device may comprise such means which comprise special mechanical, at least sectional formations of data lines (SDA) to optical device parts (D, OS, DBS, STM, PD, CM1, LD) of the quantum computer (QC) and/or to the further auxiliary device parts (KV, XT, YT, MGx, MGy, MGz, MSx, MSy, MSz, MWA, CM2, LM, HECLCS). This allows particularly reliable shielding of the quantum computer from mechanical influences on the quantum computer system to be achieved.

The quantum computer system can further be set up to detect the presence of a non-statistical error and/or a non-statistical quantum error of the quantum computer and optionally to perform and/or initiate a countermeasure and/or output a notification signal if a non-statistical error and/or a non-statistical quantum error of the quantum computer is detected. This can reduce the risk of incorrect operation of the quantum computer when performing quantum operations and/or when performing quantum calculations.

Optionally, the μC control device of the quantum computer system is designed to control means for recording measurement results.

The relocatable quantum computer system thus optionally also comprises means (PV, XT, YT, CM1, OS, STM, CIF, μC) that are set up to predict changes in acceleration, in particular during a deployment of the relocatable quantum computer (QC). This optionally enables the initiation and/or preparation of countermeasures before they become necessary. This can be particularly advantageous if coils have to be energized in the course of such countermeasures and/or capacitors or parasitic capacitances have to be recharged in the course of such countermeasures.

The relocatable quantum computer system (QC) also optionally comprises means (PV, XT, YT, CM1, OS, STM, CIF, μC) that are set up to detect changes in acceleration, in particular during a deployment of the relocatable quantum computer (QC). This enables the regulation of countermeasures.

The relocatable quantum computer system (QC) also optionally comprises means (PV, XT, YT, CM1, OS, STM, CIF, μC) which are set up to compensate for changes in acceleration, in particular during a deployment of the relocatable quantum computer (QC). This provides a possible countermeasure for at least partial compensation of the detected accelerations and/or changes in accelerations.

The relocatable quantum computer system (QC) further optionally comprises means (PV, XT, YT, CM1, OS, STM, CIF, μC) adapted to reduce the effect of such changes in acceleration, in particular during a deployment of the relocatable quantum computer (QC). If, for whatever reason, complete compensation is not possible, the quantum computer system can optionally be set up to maintain the operability of the quantum computer in this way.

The means (PV, XT, YT, CM1, OS, STM, CIF, μC) may in particular comprise one or more acceleration sensor systems and/or acceleration sensors and/or one or more position displacement sensors and/or one or more position control systems and/or one or more positioning stages and/or positioning devices and/or one or more image acquisition devices and/or image processing devices. The means (PV, XT, YT, CM1, OS, STM, CIF, μC) may optionally comprise fluorescent defect centers in the substrate D with other fluorescence wavelengths which, when irradiated with a pump radiation matching these other defect centers, emit fluorescence radiation with a fluorescence wavelength different from the fluorescence wavelength λ_{fl} of the quantum dots (NV1, NV2, NV3) of the quantum bits.

Optionally, a light source LD of the quantum computing system may comprise a first pump radiation source for electromagnetic radiation having the first pump radiation wavelength λₚₘₚ for exciting the fluorescence radiation λ_{fl} of a first type of paramagnetic centers of the quantum dots of the quantum bits of the quantum computer QC, for example NV centers.

Optionally, the light source LD may comprise a second pump radiation source for electromagnetic radiation with a second pump radiation wavelength λₚₘₚ for exciting the fluorescence radiation λ_{fl} of a second type of paramagnetic centers of the quantum dots of the quantum bits of the quantum computer QC, for example of SiV centers. Optionally, the light source may comprise further pump radiation sources for providing pump radiation with still further wavelengths. Optionally, the light source LD may comprise an nth pump radiation source for electromagnetic radiation with an nth pump radiation wavelength λₚₘₚ for exciting the fluorescence radiation λ_{fl} of an nth type of paramagnetic centers of the quantum dots of the quantum bits of the quantum computer QC. Optionally, the first variety of paramagnetic centers is different from all other n−1 varieties of paramagnetic centers that the quantum computer QC has as quantum dots of quantum bits of the quantum computer QC. In other words, the varieties of paramagnetic centers are pairwise different.

Typically, the first pump radiation wavelength of the first variety of paramagnetic centers that the quantum computer QC uses as quantum dots of quantum bits of the quantum computer QC is different from the n−1 other pump radiation wavelengths of the other n−1 varieties of paramagnetic centers that the quantum computer QC has as quantum dots of quantum bits of the quantum computer QC. In other words, the pump radiation wavelengths for the respective varieties of paramagnetic centers are pairwise different.

Optionally, the first fluorescence radiation wavelength of the first variety of paramagnetic centers that the quantum computer QC has as quantum dots of quantum bits of the quantum computer QC is different from the n−1 other fluorescence radiation wavelengths of the other n−1 varieties of paramagnetic centers that the quantum computer QC has as quantum dots of quantum bits of the quantum computer QC. In other words, the fluorescence radiation wavelength of the respective varieties of paramagnetic centers is pairwise different.

The quantum computer system can use said other defect centers in a crystal of the substrate D to readjust the positioning for at least partial compensation of mechanical influences on the quantum computer. Upon irradiation with a further pump radiation having a further pump radiation wavelength, said other defect centers emit a further fluorescence radiation having a further fluorescence radiation wavelength. Optionally, the further variety of said other defect centers differs from all other n−1 varieties of paramagnetic centers used by the quantum computer QC as quantum dots of quantum bits of the quantum computer QC. Optionally, the further pump radiation wavelength of said other defect centers differs from the n other pump radiation wavelengths of the other n varieties of paramagnetic centers used by the quantum computer QC as quantum dots of quantum bits of the quantum computer QC.

Typically, the other fluorescence radiation wavelength of said other defect centers is different from the n other fluorescence radiation wavelengths of the other n kinds of paramagnetic centers that the quantum computer QC has as quantum dots of quantum bits of the quantum computer QC. In other words, the fluorescence radiation wavelengths of the associated kinds of defect centers are pairwise different. Optionally, the light source LD may comprise a further pump radiation electromagnetic radiation source having the further pump radiation wavelength λₚₘₚ for exciting the further fluorescence radiation λ_{fl} of said other defect centers.

Optionally, the light source LD has a system of mirrors and/or prisms and/or beam splitters and/or semi-transparent mirrors in order to combine the various light beams of the different pump radiations into a single light beam, with which the optical system OS can then irradiate the substrate D with the paramagnetic centers of the quantum dots and the other defect centers. A frequency-selective prism and/or mirror system, or the like, can then separate the various fluorescence beams from each other again by evaluating the radiation wavelengths. In the example of FIG. 1, the first camera CM1 can optionally determine the position of the other defect centers, for example, and use image processing software to determine the defocusing and the x and y offset of the substrate D relative to the optical system OS. This enables position correction by the translational positioning device in the X direction XT and the translational positioning device in the Y direction YT, as well as refocusing by the optical system OS. Optionally, the quantum computer system QC for the application of this method optionally comprises one semi-transparent mirror STM for each type of paramagnetic center used and one camera CM1 and one camera interface CIF for each of the other defect centers. Optionally, a wavelength-sensitive optical function element is located in the beam path in front of the respective camera, which ensures that only the fluorescence radiation of the respective paramagnetic center or the other defect center reaches the associated camera CM1. The control device μC optionally controls all components of the light source LD. The control device μC optionally controls the position correction by the translational positioning device in the X direction XT and the translational positioning device in the Y direction YT, as well as the refocusing by the optical system OS. The control device μC optionally captures the images captured by the first cameras CM1. The control device μC can optionally evaluate the image of the further fluorescence radiation of the other defect centers captured by the first camera for the other defect centers, and determine a measured value for the defocusing of the optical system OS relative to the substrate D and a measured value for the x-offset of the substrate D relative to the optical system OS and a measured value for the y-offset of the substrate D relative to the optical system OS by means of image processing software. The control device μC optionally uses these measured values to control the position correction by the translatory positioning device in the X direction XT and the translatory positioning device in the Y direction YT, as well as the refocusing by the optical system OS.

The relocatable quantum computer system QC optionally comprises means (PV, XT, YT, CM1, OS, STM, CIF, μC) which are set up to predict an acceleration, in particular during a deployment of the relocatable quantum computer QC, and/or to detect an acceleration, in particular during a deployment of the relocatable quantum computer QC, and/or to compensate for an acceleration, in particular during a deployment of the relocatable quantum computer QC, and/or to determine the effect of an acceleration, in particular during a relocation of the relocatable quantum computer QC, and/or to compensate for an acceleration, in particular during a relocation of the relocatable quantum computer QC, and/or to reduce the effect of an acceleration, in particular during a relocation of the relocatable quantum computer QC. Such third means may comprise, for example, one or more acceleration sensor systems for the substrate D and/or for device parts of the quantum computer QC and/or for the quantum computer QC and/or acceleration sensors for the substrate D and/or for device parts of the quantum computer QC and/or for the quantum computer QC and/or one or more position displacement sensors for the substrate D relative to device parts of the quantum computer QC and/or for device parts of the quantum computer QC relative to each other and/or for the quantum computer QC relative to an external reference point, etc, etc. Such means may optionally comprise one or more position control systems, which may for example be part of the quantum computer QC and/or the control device μC. Such means may comprise, for example, one or more positioning stages which may substantially maintain one or more components of the optical functional elements of the quantum computer system in position relative to each other. The positioning stages can optionally adjust 1 to 6 translational and rotational degrees of freedom. Optionally, the μC control device can control these positioning stages via the SDB control data bus. The positioning device in the X direction XT and the translational positioning device in the Y direction YT are possible configurations of such positioning tables.

The relocatable quantum computing system optionally comprises one or more image capturing devices and/or image processing device as means (PV, XT, YT, CM1, OS, STM, CIF, μC) to be able to detect rotations and/or misalignments of functional elements of the quantum computing system QC. In this regard, the present document has already proposed that the substrate D of the relocatable quantum computer QC optionally comprises other fluorescent defect centers with other fluorescence wavelengths having fluorescence radiation with a fluorescence wavelength different from the fluorescence wavelength λ_{fl} of the quantum dots (NV1, NV2, NV3) of the quantum bits to enable the repositioning of the substrate D with respect to the optical system OS.

Optionally, the quantum computer system QC comprises means QUV which are arranged to prevent and/or damp the transmission of mechanical shocks and/or vibrations between optical device parts (D, OS, DBS, STM, PD, CM1, LD) and/or further auxiliary device parts (KV, XT, YT, MGx, MGy, MGz, MSx, MSy, MSz, MWA, CM2, LM, HECLCS) of the optical subdevices of the quantum computer system. As an alternative or in addition to the positioning devices already named, which can serve this purpose as active functional elements and which the document presented here has already named, the quantum computer system can also have passive functional elements, such as springs and/or shock absorbers and/or elastic mountings with a loss component. A vibration damper is a system for damping mechanical vibrations (vibrations, shocks, impacts). The aim can be to convert kinetic energy into thermal energy. For example, such means can include friction brakes that typically work independently of frequency and are supported by a counterpart that is either at rest or has a different resonant frequency. Optionally, the counterpart is located outside the quantum computer QC or at least mechanically separate from the optical functional elements (LD, DBS, OS, D, KV, XT, YT, MWA, MGX, MGy, MGz, MGz, PM, PV, MSy, MSx, MSz, STM, PD, CM1, CM2) of the quantum computer QC. Optionally, the basic mechanical structure MGK shown schematically in FIG. 17 connects the optical functional elements (LD, DBS, OS, D, KV, XT, YT, MWA, MGX, MGy, MGz, MGz, PM, PV, MSy, MSx, MSz, STM, PD, CM1, CM2) of the quantum computer QC with each other. Optionally, fourth means protect this basic mechanical structure and the optical functional elements connected to it (LD, DBS, OS, D, KV, XT, YT, MWA, MGX, MGy, MGz, MGz, PM, PV, MSy, MSx, MSz, STM, PD, CM1, CM2) of the quantum computer system from vibrations, structure-borne noise and/or small accelerations. The vibration dampers known as “shock absorbers”, for example, which are part of the wheel suspension of most vehicles with suspension, reduce linear vibrations. Torsional vibration dampers, such as plane-surface dampers, reduce torsional vibrations. Vibration dampers tuned to specific frequency ranges that move freely with the vibrating object and do not require external anchoring can limit linear vibrations. One method of influencing the resonant frequency is to change the mass or stiffness of the structure to prevent it from vibrating due to external excitation. Optionally, these means for damping mechanical shocks and/or vibrations are inserted between a mechanical base structure MGK with the optical functional elements (LD, DBS, OS, D, KV, XT, YT, MWA, MGX, MGy, MGz, MGz, PM, PV, MSy, MSx, MSz, STM, PD, CM1, CM2) connected to it on the one hand and the housing GH of the quantum computer QC on the other. In this case, they dampen the transmission of structure-borne noise etc. from the housing GH of the quantum computer QC and from the other device parts of the quantum computer QC to the mechanical base structure MGK with the optical functional elements connected to it (LD, DBS, OS, D, KV, XT, YT, MWA, MGX, MGy, MGz, MGz, PM, PV, MSy, MSx, MSz, STM, PD, CM1, CM2). Optionally, these means are inserted between the housing GH of the quantum computer QC and the supports of the quantum computer QC on which it is mechanically mounted. In this case, they dampen the transmission of structure-borne noise etc. from the mobile device, such as a vehicle (in the sense of the document presented here), to the housing GH of the quantum computer QC and its device parts.

Thus, the quantum computer system optionally has further means which are set up to enable the transmission of mechanical shocks and/or vibrations to optical device parts (D, OS, DBS, STM, PD, CM1, LD) of the quantum computer QC and/or to the other auxiliary device parts (KV, XT, YT, MGx, MGy, MGz, MSx, MSy, MSz, MWA, CM2, LM, HECLCS) of the optical subdevices of the quantum computer QC, in particular via structure-borne sound. These means can, for example, be inserted in supply lines to optical device parts (D, OS, DBS, STM, PD, CM1, LD) of the quantum computer QC and/or to the other auxiliary device parts (KV, XT, YT, MGx, MGy, MGz, MSx, MSy, MSz, MWA, CM2, LM, HECLCS). For example, wires and/or cables in the form of mechanical springs can be designed in a spiral shape to prevent the transmission of forces. Such means can also be inserted, for example, in data lines SDA to optical device parts (D, OS, DBS, STM, PD, CM1, LD) of the quantum computer QC and/or to the other auxiliary device parts (KV, XT, YT, MGx, MGy, MGz, MSx, MSy, MSz, MWA, CM2, LM, HECLCS). Such means may comprise special mechanical, at least sectional, formations (e.g. said springs) of supply lines to optical device parts (D, OS, DBS, STM, PD, CM1, LD) of the quantum computer QC and/or to the further auxiliary device parts (KV, XT, YT, MGx, MGy, MGz, MSx, MSy, MSz, MWA, CM2, LM, HECLCS). Such means may comprise special mechanical formations (e.g. said springs), at least in sections, of data lines SDA to optical device parts (D, OS, DBS, STM, PD, CM1, LD) of the quantum computer QC and/or to the further auxiliary device parts (KV, XT, YT, MGx, MGy, MGz, MSx, MSy, MSz, MWA, CM2, LM, HECLCS).

Optionally, the quantum computer system QC comprises further means, in particular a quantum computer monitoring device QUV, which are set up to detect a non-statistical error of the quantum computer QC and/or to carry out or initiate countermeasures if a non-statistical error of the quantum computer QC occurs. Optionally, the quantum computer QC comprises further means, in particular a quantum computer monitoring device QUV, which are set up to detect a non-statistical error of the quantum computer QC and/or to signal such a non-statistical error to a higher-level system, e.g. a central control unit ZSE, if a non-statistical error of the quantum computer QC occurs.

Optionally, the quantum computer QC comprises further means, in particular a quantum computer monitoring device QUV, which are set up to detect a non-statistical quantum error of the quantum computer QC and/or to perform or initiate countermeasures when a non-statistical error of the quantum computer QC occurs. Optionally, the quantum computer QC comprises further means, in particular a quantum computer monitoring device QUV, which are set up to detect a non-statistical quantum error of the quantum computer QC and/or to signal such a non-statistical quantum error to a higher-level system, e.g. a central control unit ZSE, if a non-statistical error of the quantum computer QC occurs.

Optionally, only the interaction of the various means, sub-devices and features of the quantum computer system achieves the effect of interference-free operation after a relocation of the quantum computer QC and/or during the relocation of the quantum computer QC.

The term “monitoring” is to be understood in such a way that the quantum computer monitoring device QUV can represent an additional device to the sub-devices of the quantum computer QC, which can optionally monitor the other sub-devices. The quantum computer monitoring device QUV can have the function of a watchdog in relation to the control device μC. In relation to the quantum components of the quantum computer QC, the quantum computer monitoring device QUV can have further, additional functions. Since the operation of the quantum components of the quantum computer QC is largely determined by statistical laws and may otherwise also have non-deterministic parts, the use of a conventional watchdog may be advantageous primarily for the control device μC, whereas a conventional watchdog may not be suitable for the application to the quantum components of the quantum computer QC and their interaction with each other and with the control device μC and the other device parts of the quantum computer QC. With the quantum computer monitoring device QUV, the document presented here introduces a new additional device part which also monitors these non-deterministic parts of the quantum computer QC for defects. The term “monitoring” here initially refers to the observation of the processes in the quantum computer QC during normal operation and the evaluation of these observations. The document presented here also proposes that the quantum computer monitoring device QUV is set up to set predefined tasks for the quantum computer QC between two quantum computer program calculations and to statistically evaluate the response of the quantum computer QC according to time and content. Such a quantum computer monitoring device QUV is thus the quantum computer equivalent for a quantum computer QC to a question-and-answer watchdog for a normal processor. Without the quantum computer monitoring device QUV, the quantum computer QC can therefore still represent a functional quantum computer QC. The quantum computer monitoring device QUV is not necessarily a control device μC which initiates program branches and/or jumps in the quantum computer program sequence depending on the detected quantum states of the quantum bits of the quantum computer.

The quantum computer system according to the disclosure may further comprise a rotation sensor, wherein the quantum computer system may be arranged to determine a rotational movement and/or an orientation of the quantum computer by means of the rotation sensor.

In a further aspect, there is provided a quantum computing system comprising a relocatable quantum computer. The quantum computing system is characterized in that the quantum computing system further comprises a rotation sensor and is adapted to determine a rotational movement and/or an orientation of the quantum computer and/or the quantum computing system by means of the rotation sensor. In particular, the rotational movement can be determined during operation of the quantum computer.

This offers the advantage that the alignment and/or rotational movements of the quantum computer can be detected and the effects on the operation of the quantum computer can be determined. This means that the effects can be taken into account when operating the quantum computer and/or measures can be taken to at least partially compensate for and/or avoid the effect. This can make it possible to operate a relocatable quantum computer in motion if changes in the orientation and/or rotational movements of the quantum computer system are to be expected.

In particular, this offers the advantage that operation of the quantum computer can be enabled or improved if some or all quantum bits of the quantum computer can be influenced by a change in the orientation of the quantum computer and, in particular, if different types of quantum bits of the quantum computer, such as quantum bits and nuclear quantum bits, are influenced in different ways by rotational movements. By determining the rotational movements and/or changes in orientation, these can be taken into account when controlling the quantum computer, in particular when manipulating the quantum bits.

The rotation sensor can be designed to determine an orientation and/or a rotational movement and/or a rotational acceleration of the quantum computer. The orientation and/or rotational movement can relate to one axis, two axes or three axes about which the orientation of the quantum computer or quantum computer system can rotate. Optionally, the determination of a rotational movement can comprise a determination of a rotational acceleration.

The quantum computer system may further be arranged to at least partially compensate for or avoid an effect of the determined rotational movement and/or orientation on the quantum computer. This can be advantageous for reliable operation of the quantum computer while it is being moved.

The quantum computer system can be set up to at least partially compensate for the effect of the determined rotational movement and/or orientation during operation of the quantum computer by adjusting a control of the quantum computer. The adjustment of the control of the quantum computer can optionally comprise one or more adjustments of parameters for a manipulation of a quantum bit and/or a nuclear quantum bit of the quantum computer. This can enable or improve operation of the quantum computer during movement of the quantum computer and/or make rotational stabilization of the quantum computer unnecessary.

The adjustment of the control of the quantum computer can optionally have one or more adjustments of the following parameters:
a coupling fundamental frequency and/or a coupling fundamental phase position for a coupling between pairs of couplable quantum bits (QUB1, QUB2);
a coupling fundamental frequency and/or coupling fundamental phase position for a coupling between couplable pairs each consisting of a quantum bit (QUB) and a nuclear quantum bit (CQUB);
a coupling fundamental frequency and/or coupling fundamental phase position for a coupling between pairs of couplable two nuclear quantum bits (CQUB1, CQUB2) with each other.

This allows the effects of changes in the orientation and/or rotational movements of the quantum computer on the different quantum bits to be at least partially compensated for in order to enable reliable operation of the quantum computer.

In a further aspect, a quantum computing system comprising a relocatable quantum computer is provided. The quantum computing system is characterized in that the quantum computing system further comprises a rotational decoupling device. Optionally, the quantum computer is rotatably mounted in the quantum computer. The quantum computer system is arranged to at least partially compensate for or avoid the effect of a rotational movement and/or orientation of the quantum computer at least during operation of the quantum computer by decoupling the quantum computer from its environment by means of the rotational decoupling device.

The rotatable bearing allows changes in the orientation and/or rotational movements of the environment to be kept away from the quantum computer, thus avoiding undesirable effects. This can make other compensation of the change in orientation and/or rotational movements, for example by changing parameters for controlling the quantum computer, unnecessary. This can improve and/or simplify the reliability of the operation of the quantum computer during its movement. The rotational decoupling device can optionally have a Cardanic suspension. This can allow rotational decoupling of the quantum computer from its environment by mechanical means. Optionally, other components of the quantum computer system or all components of the quantum computer system with the quantum computer can also be arranged in the rotational decoupling device.

The rotation decoupling device may further comprise one or more gyroscopes and/or is connected to one or more gyroscopes and is arranged to at least partially reduce or avoid rotation of the quantum computer relative to its environment by means of the one or more gyroscopes and the rotation decoupling device.

The quantum computer can be rotatable relative to an energy supply device of the quantum computer system. This offers the advantage that the energy supply device does not necessarily have to be rotatably mounted if the quantum computer is rotatably mounted. This can reduce the complexity of the quantum computer system. The quantum computer system can also have at least one slip ring, whereby the at least one slip ring connects the quantum computer to the energy supply device. This can ensure a reliable power supply to the quantum computer, even though it is rotatably mounted relative to the power supply device.

The quantum computer system may further be arranged to provide a measured value characterizing the determined rotational motion and/or orientation of the quantum computer. This can offer the advantage that the quantum computer can be used to measure the rotational movement and/or the orientation. Optionally, the quantum computer system or the quantum computer may be designed as a gyrometer or form part of a gyrometer.

The quantum computer system can be designed in such a way that the quantum computer has a substrate with one or more quantum dots arranged in the substrate.

The one or more quantum dots can optionally each be formed by one or more paramagnetic centers, or each comprise a paramagnetic center.

The one or more paramagnetic centers can each be designed as a NV center and/or as a SiV center and/or as a TiV center and/or as a GeV center and/or as a SnV center and/or as a NiN4 center and/or as a PbV center and/or as a TR1 center and/or as a TR12 center.

The following table provides an exemplary overview of optional materials for the crystal of the substrate and possible types of impurity centers together with the associated zero phonon line (ZPL) wavelengths and possible pump wavelength(s) for the optical excitation of the respective type of impurity center. The last column provides references which may contain further information on the respective impurity centers, the disclosure of which, if permitted in the respective jurisdiction, is hereby incorporated by reference into the disclosure of the present document.

| | | | Option. | |
|---|---|---|---|---|
| Material of the | | | Pump | |
| crystal of the | Type of fault | | shaft | |
| substrate D | center | ZPL | length | Reference |
| Diamond | NV-Center | | 520 nm, | |
| | | | 532 nm | |
| Diamond | SiV Center | 738 nm | 685 nm | /2/, /3/, /4/ |
| Diamond | GeV Center | 602 nm | 532 nm | /4/, /5/ |
| Diamond | SnV Center | 620 nm | 532 nm | /4/, /6/ |
| Diamond | PbV Center | 520 nm, 552 nm, 715 nm | 532 nm | /4/, /7/ |
| Diamond | ST1 Center | 555 nm | 532 nm | /15/ |
| Diamond | TR1 / TR12 | 471 nm | 410 nm | /16/ |
| | center | | | |
| Silicon | G-Center | 1278.38 nm | 637 nm | /8/ |
| Silicon carbide | V -Center_{SI} | 862 nm(V1) 4H, | 730 nm, | /1/, /9/, /10/ |
| | | 858.2 nm(V1′) 4H | | |
| | | 917 nm(V2) 4H, | | |
| | | 865 nm(V1) 6H, | | |
| | | 887 nm(V2) 6H, | | |
| | | 907 nm(V3) 6H | | |
| Silicon carbide | DV center | 1,078-1,132 nm | 730 nm | /9/ |
| Silicon carbide | V V -Center_{CSI} | 1:093-1:140 nm 6H | 730 nm | /9/ |
| Silicon carbide | | 648; 7 nm 4H, 6H, 3C | 730 nm | /9/ |
| | | 651.8 nm 4H, 6H, 3C | | |
| | | 665.1 nm 4H, 6H, 3C | | |
| | | 668.5 nm 4H, 6H, 3C | | |
| | | 671.7 nm 4H, 6H, 3C | | |
| | | 673 nm 4H, 6H, 3C | | |
| | | 675.2 nm 4H, 6H, 3C | | |
| | | 676.5 nm 4H, 6H, 3C | | |
| Silicon carbide | N V -Center_{CSI} | 1,180 nm-1,242 nm 6H | 730 nm | /9/, /13/, |
| | | | | /14/ |

The references listed in the table above are as follows, the entire contents of these documents are incorporated herein by reference:

| No. | Reference |
|---|---|
| /1/ | Marina Radulaski, Matthias Widmann, Matthias Niethammer, Jingyuan Linda |
| | Zhang, Sang-Yun Lee, Torsten Rendler, Konstantinos G. Lagoudakis, Nguyen Tien |
| | Son, Erik Janzén, Takeshi Ohshima, Jörg Wrachtrup, Jelena Vučković, “Scalable |
| | Quantum Photonics with Single Color Centers in Silicon Carbide”, Nano Letters 17 |
| | (3), 1782-1786 (2017), DOI: 10.1021/acs.nanolett.6b05102, arXiv: 1612.02874 |
| /2/ | C. Wang, C. Kurtsiefer, H. Weinfurter, and B. Burchard, “Single photon emission |
| | from SiV centers in diamond produced by ion implantation” J. Phys. B: At. Mol. |
| | Opt. Phys., 39(37), (page number? DOI?) 2006 |
| /3/ | Björn Tegetmeyer, “Luminescence properties of SiV-centers in diamond diodes” |
| | PhD thesis, University of Freiburg, 30.01.2018 |
| /4/ | Carlo Bradac, Weibo Gao, Jacopo Forneris, Matt Trusheim, Igor Aharonovich, |
| | “Quantum Nanophotonics with Group IV defects in Diamond”, DOI: |
| | 10.1038/s41467-020-14316-x, arXiv: 1906.10992 |
| /5/ | Rasmus Høy Jensen, Erika Janitz, Yannik Fontana, Yi He, Olivier Gobron, Ilya P. |
| | Radko, Mihir Bhaskar, Ruffin Evans, Cesar Daniel Rodriguez Rosenblueth, Lilian |
| | Childress, Alexander Huck, Ulrik Lund Andersen, “Cavity-Enhanced Photon |
| | Emission from a Single Germanium-Vacancy Center in a Diamond Membrane”, |
| | arXiv: 1912.05247v3 [quant-ph] 25 May 2020 |
| /6/ | Takayuki Iwasaki, Yoshiyuki Miyamoto, Takashi Taniguchi, Petr Siyushev, |
| | Mathias H. Metsch, Fedor Jelezko, Mutsuko Hatano, “Tin-Vacancy Quantum |
| | Emitters in Diamond”, Phys. Rev. Lett. 119, 253601 (2017), DOI: |
| | 10.1103/PhysRevLett.119.253601, arXiv: 1708.03576 [quant-ph] |
| /7/ | Matthew E. Trusheim, Noel H. Wan, Kevin C. Chen, Christopher J. Ciccarino, |
| | Ravishankar Sundararaman, Girish Malladi, Eric Bersin, Michael Walsh, Benjamin |
| | Lienhard, Hassaram Bakhru, Prineha Narang, Dirk Englund, “Lead-Related |
| | Quantum Emitters in Diamond” Phys. Rev. B 99, 075430 (2019), DOI: |
| | 10.1103/PhysRevB.99.075430, arXiv: 1805.12202 [quant-ph] |
| /8/ | M. Hollenbach, Y. Berencén, U. Kentsch, M. Helm, G. V. Astakhov “Engineering |
| | telecom single-photon emitters in silicon for scalable quantum photonics” Opt. |
| | Express 28, 26111 (2020), DOI: 10.1364/OE.397377, arXiv: 2008.09425 |
| | [physics.app-ph] |
| /9/ | Castelletto and Alberto Boretti, “Silicon carbide color centers for quantum |
| | applications” 2020 J. Phys. Photonics2 022001 |
| /10/ | V. Ivády, J. Davidsson, N. T. Son, T. Ohshima, I. A. Abrikosov, A. Gali, |
| | “Identification of Si-vacancy related room-temperature qubits in 4H silicon |
| | carbide”, Phys. Rev. B, 2017, 96, 161114 |
| /11/ | J. Davidsson, V. Ivády, R. Armiento, N. T. Son, A. Gali, I. A. Abrikosov, “First |
| | principles predictions of magneto-optical data for semiconductor point defect |
| | identification: the case of divacancy defects in 4H-SiC”, New J. Phys., 2018, 20, |
| | 023035 |
| /12/ | J. Davidsson, V. Ivády, R. Armiento, T. Ohshima, N. T. Son, A. Gali, I. A. |
| | Abrikosov “Identification of divacancy and silicon vacancy qubits in 6H-SiC”, |
| | Appl. Phys. Lett. 2019, 114, 112107 |
| /13/ | S. A. Zargaleh, S. Hameau, B. Eble, F. Margaillan, H. J. von Bardeleben, J. L. |
| | Cantin, W. Gao, “Nitrogen vacancy center in cubic silicon carbide: a promising |
| | qubit in the 1.5 μm spectral range for photonic quantum networks” Phys. Rev. B, |
| | 2018, 98, 165203 |
| /14/ | S. A. Zargaleh et al “Evidence for near-infrared photoluminescence of nitrogen |
| | vacancy centers in 4H-SiC” Phys. Rev. B, 2016, 94, 060102 |
| /15/ | P. Balasubramanian, M. H. Metsch, Reddy, R. Prithvi, J. Lachlan, N. B. Manson, |
| | M. W. Doherty, F. Jelezko, “Discovery of ST1 centers in natural diamond” |
| | Nanophotonics, Vol. 8, No. 11, 2019, pages 1993-2002. |
| | https://doi.org/10.1515/nanoph-2019-0148 |
| /16/ | J. Foglszinger, A. Denisenko, T. Kornher, M. Schreck, W. Knolle, B. Yavkin, R. |
| | Kolesov, J. Wrachtrup “ODMR on Single TR12 Centers in Diamond” |
| | arXiv: 2104.04746v1 [physics.optics] |

The substrate can be at least partially made of diamond.

The quantum computer can also have one or more nuclear quantum dots.

The quantum computer can also have one, several or all of the following components:
a substrate (D);
one or more quantum dots (NV1, NV2, NV3) arranged in the substrate;
a light source (LD);
a light source driver (LDRV);
one or more devices (mWA, MW/RF-AWFG) for generating an electromagnetic wave field at the respective location of the quantum dots (NV1, NV2, NV3);
a control device (μC);
one or more memories (RAM, NVM) of the control device (μC);
a waveform generator (WFG);
an optical system (OS);
a quantum state readout device, wherein the quantum state readout device optionally comprises a photodetector (PD) and an amplifier (V) and/or a device for electronically reading out the states of the quantum dots (NV1, NV2, NV3).

The substrate (D) can be doped in such a way that the Fermi level in the substrate in the area of the quantum dots (NV1, NV2, NV3) is shifted in such a way that the quantum dots (NV1, NV2, NV3) are electrically charged.

The waveform generator (WFG) can be set up to generate a light source control signal (S5).

The light source driver (LDRV) can be set up to supply the light source (LD) with electrical energy depending on the light source control signal (S5).

The control device (μC) can be set up to control the waveform generator (WFG).

The light source (LD) can be set up to irradiate the one or more quantum dots (NV1, NV2, NV3) with pump radiation (LB) of a pump radiation wavelength (λₚₘₚ) by means of the optical system (OS).

The one or more quantum dots (NV1, NV2, NV3) can be designed to emit fluorescence radiation (FL) with a fluorescence radiation wavelength (λ_{fl}) when irradiated with the pump radiation (LB).

The photodetector (PD) can be set up to detect at least part of the fluorescence radiation (FL) by means of the optical system (OS) and convert it into a receiver output signal (S0), whereby the amplifier (V) can be set up to amplify and filter the receiver output signal into a received signal (S1) and/or whereby the device for electronically reading out the states of the quantum dots (NV1, NV2, NV3) can be set up to generate a received signal (S1).

The control device (μC) can be set up to control the one or more devices (mWA, MW/RF-AWFG) for generating an electromagnetic wave field at the respective location of the quantum dots (NV1, NV2, NV3).

The control device (μC) can be set up to change and/or couple the states of the quantum dots (NV1, NV2, NV3) by controlling one or more devices (mWA, MW/RF-AWFG) to generate an electromagnetic wave field at the respective location of the quantum dots (NV1, NV2, NV3) and/or by controlling the emission of the pump radiation (LB) by the light source (LD).

The control device (μC) can be set up to generate a measured value signal (S4) with one or more measured values from one or more received signals (S1), whereby the measured value signal (S4) depends on the states of the quantum dots (NV1, NV2, NV3).

The quantum computer system and/or the quantum computer can optionally be designed as described in DE 10 2020 101 784 B3. The technical teaching as a whole or individual features of DE 10 2020 101 784 B3 can be used. The contents of DE 10 2020 101 784 B3 are incorporated by reference into the disclosure of the present application text, insofar as this is permissible in the respective jurisdiction.

In a further aspect, a mobile data processing device is provided, which is characterized in that the mobile data processing device comprises a quantum computer system according to one of the preceding claims. This offers the advantage that NP-complete problems can be solved by means of the mobile data processing device. Accordingly, the mobile data processing device can be used to solve NP-complete problems in a flexible and location-independent manner and optionally also during the movement of the data processing device. The data processing device can be designed in various forms and/or integrated into mobile devices of various types. This thus enables the use of a quantum computer in mobile devices.

The mobile data processing device can optionally be designed as one of the following devices:
a portable quantum computer system;
a mobile quantum computer system;
a smartphone;
a tablet computer;
a personal computer;
a laptop computer;
a graphics accelerator; and
a games console.

This offers the advantage that the mobile data processing device comprising a quantum computer can be enabled to solve NP-complete problems and still maintain deployability.

In a further aspect, there is provided a vehicle characterized in that the vehicle comprises a quantum computing system according to any one of the preceding claims. This provides the advantage that the vehicle is capable of solving NP-complete problems.

The vehicle can optionally be designed as one of the following vehicles:
a motor vehicle;
a land vehicle;
a rail-bound land vehicle;
a passenger car,
a truck;
a bus;
a motorcycle;
a tactical vehicle;
a bicycle;
an electric vehicle;
an unmanned vehicle;
a watercraft;
a ship;
a boat;
an unmanned watercraft;
an underwater vehicle;
a floating body;
an underwater floating body;
a buoy;
a torpedo;
an aircraft;
an airplane;
a helicopter;
a rocket;
an unmanned aerial vehicle;
a drone;
a robot drone;
a balloon;
a robot;
a space missile;
a satellite; and
a space station.

This enriches a wide range of computer applications by enabling them to solve NP-complete problems.

In a further aspect, a weapon system is provided, characterized in that the weapon system is relocatable and comprises a quantum computing system according to any one of the preceding claims. This provides the advantage that the weapon system is enabled to solve NP-complete problems, whereby the weapon system may be superior to other weapon systems which are not capable of solving NP-complete problems.

The weapon system can optionally be designed as one of the following weapon systems or can have one or more of the following elements:
a projectile;
a warhead;
a landmine;
a rocket;
a torpedo;
a sea mine;
a tank;
an artillery piece;
a fire control vehicle;
a fighter plane;
a combat helicopter;
a tactical vehicle;
a military watercraft;
a satellite; and
a balloon.

By incorporating a relocatable quantum computer into such a weapon system, its capabilities can be expanded without restricting the mobility of the weapon system.

The weapon system may further comprise a fire control system, wherein the fire control system is adapted to perform target detection and/or target identification and/or target classification and/or target assignment and/or munition selection and/or providing a suggestion for target engagement using the quantum computing system. This offers the advantage that this quantum computer system can use the solution of NP-complete problems to carry out the aforementioned processes. As a result, the fire control system can arrive at better solutions and/or solutions in less time than would be possible without the use of a quantum computer.

In the case of a military vehicle or weapon system, the vehicle or weapon system may optionally use the quantum computer QC to determine a temporal order or prioritization of engagement of multiple targets. In the case of a military vehicle or weapon system, the vehicle or weapon system can optionally determine a time to engage a target using the quantum computer QC. In the case of a military vehicle or weapon system, the vehicle or weapon system may use the quantum computer QC to determine a type of weapon and/or munition to engage a target. Among other possible embodiments, the present document proposes a vehicle that uses the quantum computer QC to determine a route for the vehicle. In the case of a military vehicle or weapon system, the vehicle or weapon system may use the quantum computer QC to determine a route and/or a trajectory for a weapon and/or a warhead and/or a projectile and/or an ammunition and/or another vehicle.

In a further aspect, a use of a relocatable power supply device for at least partially supplying a relocatable quantum computer with electrical energy is provided. The use is characterized in that the relocatable power supply device has a first voltage regulation stage and a second voltage regulation stage and is set up to regulate an electrical energy provided by a power source to a predetermined voltage value by means of a multi-stage voltage regulation by means of the first voltage regulation stage and the second voltage stage for at least partially supplying the quantum computer.

The features and advantages disclosed for the quantum computer system are also to be regarded as disclosed for this use.

In a further aspect, a method of operating a relocatable quantum computer is provided, comprising providing a relocatable power reserve as a power source for electrical power. The method is characterized in that the method further comprises providing a relocatable power supply device having a first voltage regulation stage and a second voltage regulation stage, connecting the power reserve to the power supply device, and providing the electrical energy from the power reserve to the power supply device. Furthermore, the method comprises regulating a voltage of the provided electrical energy to a first voltage value by means of the first voltage regulation stage of the energy supply device, regulating the electrical energy provided by the first voltage regulation stage with the first voltage value to a second voltage value by means of a second voltage regulation stage, and operating the quantum computer with the electrical energy provided by the second voltage regulation stage with the second voltage value and executing a quantum operation and/or a quantum computer program product by means of the quantum computer.

The features and advantages disclosed for a quantum computer system with a power supply device are also to be regarded as disclosed for the method for operating a relocatable quantum computer and vice versa.

In a further aspect, a method for operating a relocatable quantum computer is provided, characterized in that the method comprises determining a change in a prevailing magnetic field by means of a magnetic field sensor system, and at least partially compensating for the change in the magnetic field at the location of the quantum computer by means of a magnetic field generator.

The method may further comprise determining a change in position and/or orientation of the quantum computer relative to the earth and generating a prediction for an expected change in the earth's magnetic field to be compensated at the location of the quantum computer due to the change in position and/or orientation. The at least partial compensation of the change in the magnetic field at the location of the quantum computer can take place taking into account the generated prediction.

The forecast can be generated using cartographic information about the earth's magnetic field.

The features and advantages disclosed for a quantum computer system with a magnetic field sensor system and a magnetic field generator are also to be regarded as disclosed for the method for operating a relocatable quantum computer and vice versa.

In a further aspect, a use of a cartographic information about the earth's magnetic field for determining a magnetic field to be compensated at the location of a relocatable quantum computer and/or for generating a prediction for an expected change of the earth's magnetic field to be compensated at the location of the quantum computer is provided.

The features and advantages disclosed for the quantum computer system are also to be regarded as disclosed for this use.

In a further aspect, a method of operating a relocatable quantum computer comprising a substrate, and one or more quantum dots disposed in the substrate is provided. The method comprises providing a relocatable cooling device and lowering a temperature of the at least one quantum dot in the substrate by means of the relocatable cooling device such that a number of quantum dots available to the quantum computer for performing a quantum operation and/or a quantum computer program is increased.

The features and advantages disclosed for the quantum computer system are also to be regarded as disclosed for this method.

The relocatable cooling device can optionally have at least one closed-loop helium gas cooling system or be designed as such.

In another aspect, use of a closed loop helium gas cooling system for lowering a temperature of at least one quantum dot in a substrate of a relocatable quantum computer is provided.

The features and advantages disclosed for the quantum computer system are also to be regarded as disclosed for this use.

In a further aspect, a method for operating a relocatable quantum computer is provided. The method comprises determining an acceleration of the quantum computer, and at least partially compensating for the acceleration of the quantum computer and/or mitigating an effect of the acceleration on the quantum computer.

The method may further comprise generating a prediction regarding an expected acceleration and/or change of an acceleration of the quantum computer, wherein the at least partial compensation of the acceleration of the quantum computer may be performed using the generated prediction.

The features and advantages disclosed for the quantum computer system are also to be regarded as disclosed for this method.

In a further aspect, a method for controlling a relocatable weapon system with a quantum computer is disclosed. The method comprises detecting environmental data of the weapon system by means of a sensor. In addition, the method comprises evaluating the environment data and identifying one or more objects in the environment of the weapon system by means of the quantum computer, as well as classifying the one or more identified objects with regard to a dangerousness and/or vulnerability and/or strategic effect of the one or more objects by means of the quantum computer. In addition, the method comprises determining one or more of the following parameters: a weapon of the weapon system to be used, a munition of the weapon system to be used, a configuration of the weapon system to be used, a selection of one or more targets to be engaged from the one or more classified objects, and a sequence of a planned engagement of a plurality of targets to be engaged.

The quantum computer can use artificial intelligence to classify the one or more identified objects.

In a further aspect, a method for operating a relocatable quantum computer is provided. The method comprises determining an acceleration of the quantum computer, and at least partially compensating for the acceleration of the quantum computer and/or mitigating an effect of the acceleration on the quantum computer.

This offers the advantage that any undesirable effects of rotational movements and/or accelerations on the quantum computer can be avoided or reduced, thereby improving the reliability of the operation of the quantum computer and/or increasing the accuracy of the quantum computer. This can optionally be advantageous for quantum computers that use different types of quantum bits, whereby the quantum bits can be influenced in different ways by rotational movements and/or accelerations. In order to nevertheless ensure reliable interaction of the quantum bits, undesired effects on the quantum bits can be at least partially reduced or avoided by the disclosed method.

Optionally, the method may further comprise generating a prediction regarding an expected acceleration and/or change in acceleration of the quantum computer. The at least partial compensation of the acceleration of the quantum computer can be carried out using the generated prediction. This can stabilize the operation of the quantum computer in a particularly reliable manner. Optionally, this can be particularly advantageous for an operation of the quantum computer during a movement of the quantum computer, in which rotational movements of the quantum computer cannot be excluded.

In a further aspect, the use of a quantum computer for measuring a rotational movement is provided. This can offer the advantage that rotations and/or rotations and/or changes in the spatial orientation or alignment can be determined particularly accurately. An effect of the rotational movement and/or the orientation of the quantum computer on the operation of the quantum computer, in particular on at least some quantum bits of the quantum computer, can be determined in order to determine a causal change in the spatial orientation of the quantum computer based on this. The spatial orientation of one or more components of the quantum computer system can change together with the orientation of the quantum computer.

In a further aspect, a use of a quantum computer as a gyrometer is provided. This offers the advantage that a gyrometer can be provided with particularly high accuracy.

In a further aspect, a method for measuring a rotational motion is provided. The method comprises providing a quantum computer exposed to the rotational motion. The method further comprises determining a change in one or more of the following parameters:
a coupling fundamental frequency and/or a coupling fundamental phase position for a coupling between pairs of couplable quantum bits (QUB1, QUB2);
a coupling fundamental frequency and/or a coupling fundamental phase position for a coupling between couplable pairs each consisting of a quantum bit (QUB) and a nuclear quantum bit (CQUB);
a coupling fundamental frequency and/or a coupling fundamental phase position for a coupling between pairs of couplable two nuclear quantum bits (CQUB1, CQUB2) with each other.

The method also comprises determining the rotational movement based on the determined change in the one or more parameters.

This offers the advantage of enabling particularly accurate measurement of rotational movements and/or changes in spatial orientation. The particularly high accuracy can be achieved in particular by using one or more quantum effects to determine the rotational movement.

The determination of the rotational movement can be based on the fact that the determined change in one or more parameters is proportional to the characteristic of the rotational movement. The characteristic of the rotational movement can be a qualitative and/or quantitative characteristic. A qualitative characteristic can be, for example, a rotational direction of the rotational movement. A quantitative characteristic can be, for example, a magnitude of an angle of rotation of the rotational movement and/or an angular velocity and/or an angular acceleration of the rotational movement.

In a further aspect, a method of operating a relocatable quantum computer is provided. The method comprises determining a rotational movement and/or an orientation of the quantum computer and compensating for at least a portion of an effect of the determined rotational movement and/or orientation on the quantum computer. This can offer the advantage that undesirable effects on the quantum computer due to a rotational movement and/or a change in the orientation of the quantum computer can be avoided or reduced. This can enable or facilitate operation of the quantum computer even when the quantum computer is in motion and rotational movement and/or a change in the orientation of the quantum computer system comprising the quantum computer cannot be ruled out. This can be optically advantageous if some or all quantum dots or quantum bits of the quantum computer can be influenced by a change in orientation and/or a rotational movement and/or if a control of the quantum bits or quantum dots has to take into account the spatial orientation of the quantum dots or quantum bits.

The at least partial compensation of the determined rotational movement and/or orientation can take place in particular during an operation of the quantum computer. Optionally, the at least partial compensation of the determined rotational movement and/or orientation can take place in particular while the quantum computer is performing a quantum operation and/or executing a quantum computer program and/or reading out and/or manipulating a quantum dot.

Compensating the determined rotational motion and/or alignment to the quantum computer may include adjusting one or more of the following parameters depending on the determined rotational motion:
a coupling fundamental frequency and/or a coupling fundamental phase position for a coupling between pairs of couplable quantum bits (QUB1, QUB2);
a coupling fundamental frequency and/or a coupling fundamental phase position for a coupling between couplable pairs each consisting of a quantum bit (QUB) and a nuclear quantum bit (CQUB);
a coupling fundamental frequency and/or a coupling fundamental phase position for a coupling between pairs of couplable two nuclear quantum bits (CQUB1, CQUB2) with each other.

This offers the advantage that such adjustments can maintain reliable operation of the quantum computer even if the spatial orientation of the quantum computer changes. In addition, this can offer the advantage that mechanical compensation of rotational movements and/or changes in the spatial orientation of the quantum computer can be dispensed with. As a result, the technical complexity of the quantum computer system can be reduced and/or the manufacturing costs and/or the space requirement can be kept low. This can facilitate miniaturization and/or integration of the quantum computer system in mobile devices.

In a further aspect, a method of operating a relocatable quantum computer is provided. The method comprises deployably mounting the quantum computer in a rotational decoupling device. The method further comprises avoiding or reducing an effect of a rotational movement of the quantum computer on the quantum computer by decoupling the quantum computer from its environment by means of the rotational decoupling device. This may allow changes in spatial orientation and/or rotational motion of the quantum computer to occur, thereby avoiding or reducing the occurrence of undesired effects on the quantum computer.

Optionally, the proposed relocatable quantum computer QC together with all necessary means for its operation is part of the relocatable quantum computer system QUSYS, e.g. the smartphone or the portable quantum computer system QUSYS or the vehicle or the relocatable weapon system. The means for operating the relocatable quantum computer QC are thus optionally also designed to be relocatable. The proposed relocatable quantum computer system QUSYS comprises as relocatable means for its operation and in particular optionally one or more relocatable power supplies EV and/or one or more relocatable quantum computers QC. For the purposes of this writing, these means for operating the relocatable quantum computer QC are optionally also part of the smartphone or the garment or the wearable quantum computer system QUSYS or the vehicle or the relocatable weapon system. It is irrelevant for the interpretation of the claims whether the operation of the relocatable quantum computer QC is coupled to means and/or commands external to the quantum computer QC, despite the presence of all means for operating the relocatable quantum computer QC as part of the relocatable quantum computer QC. However, the relocatable quantum computer QC may be operable without means and/or commands from outside the quantum computer system. For example, a relocatable quantum computer system QUSYS that is waiting for an external start command due to the programming of the central control unit ZSE and/or the programming of a control device μC of a quantum computer QC of the quantum computer system QUSYS is still to be encompassed by the claims.

The mobile relocatable energy supply EV optionally comprises one or more relocatable charging devices LDV with one or more energy supplies PWR of the charging devices LDV, one or more relocatable disconnecting devices TS, one or more relocatable energy reserves BENG and one or more relocatable energy conditioning devices SRG. The mobile energy supply EV optionally comprises an energy conditioning device SRG, in particular a voltage converter or a voltage regulator or a current regulator, which prevents changes in the energy content of the energy reserve BENG of the energy supply EV, for example the charge state of an accumulator as energy reserve BENG of the energy supply EV, from having an effect on the relocatable quantum computer QC and/or the quantum computer system QUSYS. In this case, the mobile energy supply EV supplies the energy preparation device SRG with energy and the energy preparation device SRG supplies, for example, the relocatable quantum computer QC and possibly other parts of the quantum computer system QUSYS with electrical energy. In this case, the energy supply EV therefore only supplies the quantum computer QC, for example, with electrical energy indirectly via the energy preparation device SRG.

Optionally, the relocatable quantum computer QC is set up and provided in accordance with the proposal to be able to operate with a reduced first number of quantum dots NV1, NV2, NV3 even at room temperature. For example, a temperature of 20° C. can be assumed as room temperature. Room temperature as the operating temperature of the quantum dots NV1, NV2, NV3 leads to a broadening of the resonances in the resonance spectrum so that they overlap. Optionally, the proposed relocatable quantum computer QC therefore has a relocatable cooling device KV, which can be deployed together with the relocatable quantum computer QC. The relevant relocatable cooling device KV is optionally suitable and/or designed to lower the temperature of the quantum dots NV1, NV2, NV3 and/or nuclear quantum dots CI1₁, CI1₂, CI1₃, CI2₁, CI2₂, CI2₃, CI3₁, CI3₂, CI3₃. Lowering the operating temperature of the quantum dots NV1, NV2, NV3 leads to a narrowing of the resonances in the resonance spectrum, so that these overlap to a lesser extent or do not overlap in the frequency spectrum. Such cooling by means of a cooling device KV optionally lowers the temperature of the quantum dots NV1, NV2, NV3 and/or nuclear quantum dots CI1₁, CI1₂, CI1₃, CI2₁, CI2₂, CI2₃, CI3₁, CI3₂, CI3₃ to such an extent that the quantum computer QC can operate with a second number of quantum dots NV1, NV2, NV3 that is higher than the first number of quantum dots NV1, NV2, NV3.

Optionally, the relocatable quantum computer system comprises a Closed Loop Helium Gas Cooling System HeCLCS, also known as a Closed Cycle Cryocooler, as a relocatable cooling device KV. We refer here, for example, to https://en.wikipedia.org/wiki/Cryocooler.

A further embodiment of the proposal relates to a relocatable quantum computer system having a second relocatable power supply. The second relocatable power supply may be wholly or partially identical to the first relocatable power supply (Bat). Optionally, this second relocatable energy supply BENG supplies the relocatable cooling device KV with energy. This has the advantage that the first power supply is not disturbed by transient disturbances of the electric motors of the relocatable cooling device KV.

Another optional embodiment relates to a relocatable quantum computer QC for use in a mobile device. Optional is a use in a smartphone or a portable quantum computer system QUSYS or in a vehicle motor vehicle or in a weapon system. That is, the present disclosure proposes a relocatable weapon system having a relocatable quantum computer QC that is part of the relocatable weapon system. Optionally, the use of the relocatable quantum computer QC is embodied as part of the fire control system of the weapon system or the navigation system GPS, NAV of the weapon system. Optionally, the weapon system uses the relocatable quantum computer QC to solve NP-complete problems, such as but not limited to target identification, classification of targets, assignment of targets to known enemy objects such as aircraft and/or missile types, vehicle types, ship types, missile types, floating object types, underwater vehicle types, underwater object types, spacecraft types, satellite types, etc., as well as to solve NP-complete problems. Further, the selection of target engagement order and/or the selection of weapon means and/or the selection of munitions to engage the targets may optionally be among the problems that the weapon system solves using the relocatable quantum computer QC. Furthermore, the relocatable weapon system may determine and/or modify and/or monitor the route or trajectory of a respective projectile or warhead or weapon carrier to the target with the aid of the relocatable quantum computer QC.

Such a method can start with the acquisition of environment data by the quantum computer system QUSYS in a step A). The environment data is optionally recorded by means of suitable sensors, which may be part of the quantum computer system QUSYS and/or which are connected to this quantum computer system QUSYS via data links and transmit environment data to the quantum computer system QUSYS. In a step B), the quantum computer system QUSYS can identify objects in the environment of the quantum computer system QUSYS, whereby the environment can also be remote from the quantum computer system QUSYS. In a step C), the quantum computer system QUSYS optionally classifies the identified objects in the environment of the quantum computer system QUSYS. Optionally, in step C), the quantum computer system QUSYS classifies the objects according to dangerousness and/or vulnerability and/or strategic effect in order to maximize a weapon effect. Optionally, this classification in step C) is carried out by means of a neural network model, which the quantum computer system QUSYS optionally executes. Optionally, for this step C), the quantum computer system QUSYS uses one or more quantum operations to manipulate the quantum state of one or more quantum dots NV1, NV2, NV3 of one or more quantum computers QC1 to QC16 of the quantum computer system QUSYS to perform the classification of the objects. In a step D), the quantum computer system QUSYS can determine the weapons and/or the ammunition and/or the configuration and/or the sequence of the attacked objects and/or the attacked objects and/or the non-attacked objects. Optionally, this determination is made in step D) by means of a neural network model, which the quantum computer system QUSYS optionally executes. Optionally, in step D), the quantum computer system QUSYS uses one or more quantum operations to manipulate the quantum state of one or more quantum dots NV1, NV2, NV3 of one or more quantum computers QC1 to QC16 of the quantum computer system QUSYS in order to carry out these determinations. In a step E), the quantum computer system QUSYS optionally suggests one or more of the determined attack scenarios to an operator, for example one or more pilots and/or one or more fire control officers, or the like. If they give the order to fire, the quantum computer system QUSYS can, for example, implement the approved attack scenario in a step F). This is shown in FIG. 12.

Optionally, the relocatable quantum computer system has a shield AS. Optionally, the shielding AS shields the quantum dots NV1, NV2, NV3, for example the NV centers, against electromagnetic fields and/or electromagnetic waves.

The relocatable quantum computer system QC optionally comprises an optical system that directs the electromagnetic radiation of the light source LD to the quantum dots NV1, NV2, NV3, for example the paramagnetic centers or the NV centers. The optical system OS optionally comprises a confocal microscope.

Optionally, the optical system OS comprises a first camera CM1 which is designed to detect the fluorescence radiation FL of the paramagnetic centers NV1, NV2, NV3 and/or of clusters of such paramagnetic centers, for example NV centers and/or clusters of NV centers. Other fluorescent defect centers with other fluorescence wavelengths are conceivable and can optionally also be detected by the first camera or one or more further cameras. Such other fluorescent defect centers with other fluorescence wavelengths can thus have a fluorescence radiation with a fluorescence wavelength that is different from the fluorescence wavelength λ_{fl} of the quantum dots NV1, NV2, NV3 and can therefore be optically separated from the pump radiation LB and the fluorescence radiation FL of the quantum dots NV1, NV2, NV3, for example by means of a dichroic mirror in place of the semi-transparent mirror STM or by means of an optical filter. Optionally, the substrate D is mounted on a positioning stage. The positioning table optionally comprises a translatory positioning device XT in the X direction and a translatory positioning device YT in the Y direction, which optionally controls the control device μC of the quantum computer QC via the control data bus SDB. Optionally, the first camera CM1 detects the position of the substrate D relative to the optical system OS and thus the position of the quantum dots NV1, NV2, NV3 in the substrate D. The first camera CM1 thus detects the position of the paramagnetic centers, for example the NV centers, relative to the optical system OS. If the substrate D is displaced relative to the optical system OS, for example due to mechanical vibrations or other disturbances, an image processing system of the relocatable quantum computer QC can detect this mechanical displacement, for example by evaluating the position of fluorescent paramagnetic defect centers. The image processing system optionally records the fluorescence patterns of the defect centers by means of the first camera CM1 and compares their position on the image with target positions. The image processing system optionally determines a displacement vector and repositions the substrate D relative to the optical system OS using the positioning table XT, YT as a function of the determined displacement vector. The image processing device optionally performs this repositioning in such a way that the position of the quantum dot, for example the paramagnetic center or a cluster of paramagnetic centers, relative to the optical system OS is optionally essentially unchanged after completion of the repositioning. Optionally, the image processing system is part of the relocatable quantum computing system. Typically, the control device μC of the quantum computer operates as the image processing system. However, the image processing system can optionally also be a separate sub-device of the relocatable quantum computer QC. In this case, the control device μC optionally controls the separate image processing system via the control data bus SDB. The image processing system can then be part of the first camera interface CIF, for example. Instead of an image processing system, other position displacement sensors can optionally also detect the displacements of the substrate D relative to the optical system or position displacements of the substrate D relative to the optical system. The proposed quantum computer QC then adjusts the position of the substrate D relative to the optical system OS based on the positional displacement data of such positional displacement sensors. For example, such position displacement sensors can transmit the detected position displacement data to the control device μC of the quantum computer QC via the control data bus SDB, so that the control device μC of the quantum computer QC can, for example, reposition the positioning stage in the X direction by means of the translatory positioning device XT and in the Y direction by means of the translatory positioning device YT relative to the optical system OS as a function of this detected position displacement data, as if essentially no displacement had taken place. This can be advantageous in order to be able to operate the relocatable quantum computer QC even in the event of vibrations, accelerations and the like.

Optionally, the relocatable quantum computer system comprises a photodetector PD and an amplifier V. The photodetector PD detects the fluorescence radiation FL of the quantum dots NV1, NV2, NV3 when the light source LD irradiates them with its electromagnetic radiation, which serves as pump radiation LB. The relocatable quantum computer system optionally uses this to read out the quantum state of the quantum dots NV1, NV2, NV3. Optionally, the quantum dots NV1, NV2, NV3 are paramagnetic centers. Optionally, the paramagnetic centers are NV centers in diamond. The amplifier V may be designed to amplify and/or filter the receiver output signal S0 of the photodetector PD to an amplified receiver output signal S1. The amplified receiver output signal can optionally also be an ordered set of data in a memory of the amplifier V, wherein the computer core CPU of the control device μC can optionally read out this memory of the amplifier V at least partially via the control data bus SDB.

Furthermore, the relocatable quantum computer system QC can be designed to also perform an electronic readout of quantum dots NV1, NV2, NV3 in parallel or as an alternative to this optical readout of the state of quantum dots NV1, NV2, NV3. For this purpose, the relocatable quantum computer system can have, as an alternative or in parallel to the photodetector PD and the amplifier V, a device for electronically reading out the states of the quantum dots NV1, NV2, NV3. Optionally, the device for electronically reading out the states of the quantum dots NV1, NV2, NV3 comprises electrically conductive lines for applying electric fields in the effective range of the quantum dots NV1, NV2, NV3 and contacts for extracting charge carriers in the region of the quantum dots NV1, NV2, NV3. Furthermore, the device optionally comprises devices for electronically reading out the states of the quantum dots NV1, NV2, NV3 for providing the control signals for actuating said electrically conductive lines for applying electric fields in the effective range of the quantum dots NV1, NV2, NV3. Furthermore, the device optionally comprises one or more amplifiers for electronically reading out the states of the quantum dots NV1, NV2, NV3 for amplifying the electrical currents of charge carriers extracted via the contacts for extracting charge carriers in the area of the quantum dots NV1, NV2, NV3. Optionally, the quantum computer system has one or more digital-to-analog converters that participate in generating the control signals for driving said electrically conductive lines LH1, LH2, LH3, LV1 to apply electric fields in the area of action of the quantum dots NV1, NV2, NV3. Optionally, the first horizontal driver stage HD1 has an analog-to-digital converter for driving the first quantum dot NV1 to be driven, which the computer core CPU of the control device μC can optionally control via the control data bus STB. Optionally, the second horizontal driver stage HD2 has an analog-to-digital converter for controlling the second quantum dot NV2 to be controlled, which the computer core CPU of the control device μC can optionally control via the control data bus STB. Optionally, the third horizontal driver stage HD3 has an analog-to-digital converter for controlling the third quantum dot NV3 to be controlled, which the computer core CPU of the control device μC can optionally control via the control data bus STB. Optionally, the control device μC controls one or more of these digital-to-analog converters via an internal control data bus SDB of the relocatable quantum computer system.

In another aspect, a quantum computer is provided, wherein the quantum computer comprises a quantum computing stack comprising nuclear quantum bits and electronic quantum bits, and wherein the electronic quantum bits are paramagnetic centers.

The qubits of the quantum computer can be formed from nuclear quantum bits (¹³C) in a diamond material The qubits can be connected to each other via NV centers as electronic quantum bits within a quantum ALU. In this context, reference is made by way of example to the patent family of the German patent application DE102020125169A1, the disclosure of which is part of this application, if allowed in the respective jurisdiction. The nuclear and electronic quantum bits are part of the quantum computer and can interact with each other via further hardware elements, as described, for example, in the patent applications of the patent family of the German patent application DE102020125169A1. The entire disclosures of each of which are incorporated herein by reference.

The quantum computer (Q-circuit hardware model) can comprise radio wave lines and components, microwave lines and components (RF, HF lines), an optical system (ca system), and an electric grid, as shown for example in DE102020125169A1 in its FIG. 20. Reference is also made here to FIG. 23 of DE102020125169A1 and its associated description. The optical system can optionally be a confocal microscope with a pulsed laser.

A gate pulse timing device can generate the control signals for the timely generation of the signals on the radio wave lines and microwave lines. A laser control device can control the laser used to power the optical system. An input-output (I/O) signal can control the electrical grid. A sequence controller (SPC) can control the entire process. Optionally, the optical system includes a photodetector for detecting electromagnetic radiation from the quantum dots with amplifier, filter, etc.

The architecture of the hardware of the quantum computer (Q-circuit hardware model) can thus optionally essentially correspond to the architecture of FIG. 23 of DE102020125169A1.

The quantum computer can be connected to a central control unit (reference sign ZSE in FIG. 38 of DE102020125169A1). The central control unit can execute a control method (transcompiler) in the form of a control program called a transcompiler, which converts control commands (mnemonics) into specific control signals for the hardware components, which are transmitted via this one or more data buses. An optimizer in the form of an optimization procedure, which the central control unit typically executes, optimizes any setting parameters and any filter parameters and processes any measurement signals from the optical system. An error correction procedure (QEC) in the form of an error correction program, which the central control unit can typically execute, optionally corrects the errors that can occur due to the statistical behavior of the quantum bits. The control procedures that the central control unit can optionally execute and that symbolize the control instructions (mnemonics) optionally correspond essentially to abstract quantum operations (Abstract Q-circuit models) that the central control unit optionally executes. The central control unit can execute summaries of such procedures as quantum algorithms. In addition to these quantum-specific components, a device according to the proposal can have classical computer hardware in Harvard or Von Neumann architecture (classical hardware). Optionally, the central control unit is such classical hardware. The classical hardware optionally executes classical procedures (classical software, classical algorithms). The central control unit then executes mixed procedures (quantum classical hybrid software) of classical data processing and quantum processing. The user can then apply the mixed procedure provided by the central control unit to specific real-world problems. (real-world problem and data sets). Furthermore, a procedure is provided that can be subdivided into these sub-procedures. Such a procedure can be referred to as a quantum computer stack.

Further provided is a mobile device according to an optional embodiment, wherein the mobile device comprises a relocatable quantum computing system (QUSYS) according to the present disclosure. The quantum computer system (QUSYS) thereby comprises at least one quantum computer (QC1, QC2). Furthermore, the mobile device according to the optional embodiment comprises one or more sensors (SENS) and/or measuring means, wherein the sensors (SENS) and/or measuring means are designed to detect measured values about the environment of the mobile device and/or about states of the mobile device and/or about states of occupants of the mobile device and/or about users of the mobile device and/or about states of the payload of the mobile device and to supply them to the quantum computer system (QUSYS). The one or more sensors (SENS) and/or measuring means of the mobile device may be designed to comprise at least one of the following sensors (SENS) providing measured values as a subsystem:
a radar sensor and/or
a microphone and/or
an ultrasonic microphone and/or
an infrasonic microphone and/or
an ultrasonic transducer and/or
an infrared sensor and/or
a gas sensor and/or
an acceleration sensor and/or
a speed sensor and/or
a radiation detector and/or
an imaging system and/or
a camera and/or
an infrared camera and/or
a multispectral camera and/or
a LIDAR system and/or
an ultrasonic measuring system and/or
a Doppler radar system and/or
a quantum radar system and/or
a quantum sensor and/or
a position sensor and/or
a navigation system and/or
a GPS sensor (or a functionally equivalent device) and/or
a position sensor and/or
a particle counter and/or
a detection system for biological substances, in particular for biological warfare agents, and/or
a gravimeter and/or
a compass and/or
a gyroscope and/or
a MEMS sensor and/or
a pressure sensor and/or
an inclination angle sensor and/or
a temperature sensor and/or
a humidity sensor and/or
a wind speed sensor and/or
a wavefront sensor and/or
a microfluidic measuring system and/or
a distance measuring system and/or
a length measuring system and/or
a biological sensor for detecting biological markers and/or viruses and/or microbes or the like and/or
a sensor system for detecting biological measurement values of vehicle occupants and/or for detecting biological measurement values of living cargo, in particular animals and/or biological materials, and/or
a seat occupancy measuring system and/or
a voltage sensor and/or a current sensor and/or a power sensor and/or
a radar sensor and/or
a LIDAR sensor and/or
an ultrasonic sensor and/or
a camera-based sensor and/or
a quantum sensor and/or
a sonar sensor.

The quantum computer QC can be designed to determine a position assessment for the overall state of the mobile device and/or the environment of the mobile device and/or the states of the mobile device and/or the states of vehicle occupants and/or users of the mobile device and/or states of the payload of the mobile device as a function of these measured values.

Depending on these measured values, the quantum computer QC can optionally control the mobile device and/or device parts of the mobile device and/or influence a control of the mobile device or a device part of the mobile device.

The sensors of the mobile device can have one or more of the following sensors: Radar sensors, lidar sensors, ultrasonic sensors, camera-based sensors, quantum sensors, and sonar sensors.

The sensors (SENS) can transmit sensor data to the quantum computer system (QUSYS) and the quantum computer system (QUSYS) can be set up to execute one or more quantum algorithms which increase the performance of sensors (SENS) and/or which accelerate the processing of the data and the sensor data of the sensors (SENS) and/or other data.

The mobile device can be set up to use at least one quantum computer (QC1, QC2) of the quantum computer system (QUSYS) to solve processing and/or optimization tasks in sensor remote sensing and/or exploration of the earth's surface and/or in sonar exploration and/or in ultrasound exploration and/or in image recognition and/or in image processing and/or in exploration of the water surface and/or in exploration of a sea volume and/or of the air space and/or of the sea area by means of the sensors (SENS).

The mobile device can be set up to execute quantum computing routines and/or quantum computing methods in the field of radar data processing and/or sonar data processing and/or ultrasound data processing and/or LIDAR data processing using at least one quantum computer (QC1, QC2) of the quantum computer system (QUSYS).

The mobile device can be set up to focus raw sensor data using at least one quantum computer (QC1, QC2) of the quantum computer system (QUSYS).

The mobile device can be set up to carry out methods of radar interferometry and/or sonar interferometry using at least one quantum computer (QC1, QC2) of its quantum computer system (QUSYS).

The mobile device can be set up to generate and/or evaluate radar images and/or LIDAR images and/or sonar images and/or images based on the sensor data of the sensors (SENS) and/or satellite data and/or other data using at least one quantum computer (QC1, QC2) of the quantum computer system (QUSYS).

The mobile device can be part of a swarm of such mobile devices.

In a further aspect, a quantum computer (QC) is provided, wherein the quantum computer (QC) comprises a control device (μC) and wherein the quantum computer (QC) comprises first quantum bits (QUB) and/or electronic quantum bits (QUB) with quantum dots (NV) and wherein the quantum computer (QC) comprises second quantum bits (CQUB) and/or second nuclear quantum bits (CQUB) with nuclear quantum dots (CI) and wherein the quantum computer (QC) comprises first means for influencing the first quantum bits (QUB) and the quantum computer (QC) having second means for influencing the first quantum bits (QUB) and for influencing the second quantum bits (CQUB) by means of the first quantum bits (QUB), and wherein the first means may comprise the second means or the second means may comprise the first means, and wherein the quantum computer (QC) comprises third means for detecting the quantum state of the first quantum bits (QUB), and
wherein the first quantum bits (QUB) and/or the first electronic quantum bits (QUB) with quantum dots (NV) comprise device parts with an electronic spin and wherein the second quantum bits (CQUB) and/or the first nuclear quantum bits (CQUB) with nuclear quantum dots (CI) comprise device parts with a nuclear spin and wherein the electronic spin of the first quantum bits (QUB) substantially rotates with the quantum computer (QC) when the quantum computer (QC) rotates, and
wherein the nuclear spin of the second quantum bits (CQUB) essentially does not rotate with the quantum computer (QC) when the quantum computer (QC) rotates, and wherein the quantum computer (QC) is arranged to have a direction of movement and/or an axis of rotation (AX1, AX2) and wherein the quantum computer (QC) is arranged to be subjected to accelerations perpendicular to its direction of movement and/or rotational accelerations about the axis of rotation (AX1, AX2), and
wherein the control device (μC) is arranged to execute a quantum computer program, and
wherein the quantum computer program comprises quantum op codes, and wherein each quantum op-code symbolizes a manipulation and/or a readout of the quantum state of at least a first quantum bit (QUB) and/or the quantum state of a second quantum bit (CQUB), which the control device (μC) performs with the aid of the first means and/or the second means and/or the third means when executing the quantum op-code.

The quantum computer (QC) can have at least two first quantum bits (QUB1, QUB2) and wherein the first first quantum bit (QUB1) can be coupled and/or entangled with the second first quantum bit (QUB2).

The quantum computer (QC) may further comprise at least two first quantum bits (QUB1, QUB2) and wherein the first first quantum bit (QUB1) is directly couplable and/or entanglable with the second first quantum bit (QUB2) by means of direct dipole-dipole coupling between the first first quantum bit (QUB1) and the second first quantum bit (QUB2).

The quantum computer (QC) can have at least a first quantum bit (QUB) and a second quantum bit (CQUB), wherein the first quantum bit (QUB) can be coupled and/or entangled with the second quantum bit (CQUB).

The quantum computer (QC) can optionally have at least two first quantum bits (NV1, NV2), wherein the quantum computer (QC) optionally has at least two second quantum bits (CQUB1, CQUB2) and wherein the first first quantum bit (QUB1) is couplable and/or entanglable with the first second quantum bit (CQUB1) and wherein the second first quantum bit (QUB2) is couplable and/or entanglable with the second second quantum bit (CQUB2) and wherein the first first quantum bit (QUB1) is couplable and/or entanglable with the second first quantum bit (QUB2).

The first quantum bits (QUB, QUB1, QUB2) can optionally comprise paramagnetic centers and/or NV centers in diamond and/or SiV centers in diamond.

The second quantum bits (CQUB, CQUB1, CQUB2) can comprise nuclear spins of ¹³C isotopes or ¹⁴N isotopes or ¹⁵N isotopes or other isotopes with a nuclear spin.

The quantum computer (QC) can comprise device components that:
Alignment measurement values for rotations about one axis and/or two axes (AX1, AX2) and/or three axes and/or Rotation values for rotations about one axis and/or two axes (AX1, AX2) and/or three axes and/or
Rotational acceleration values for rotations around one axis and/or around two axes (AX1, AX2) and/or three axes Rotational acceleration values and/or
determine acceleration values for one translational degree of freedom and/or two translational degrees of freedom and/or three translational degrees of freedom for the quantum computer QC and/or permit such a determination.

The quantum computer (QC) can be set up to determine the coupling frequencies and/or coupling phase positions between the pairs of coupleable first two quantum bits (QUB1, QUB2) and/or
between the coupleable pairs of a first quantum bit (QUB) and a second quantum bit (CQUB) and/or
between the pairs of two second quantum bits (CQUB1, CQUB2) that can be coupled to each other
and store them as coupling fundamental frequencies and/or coupling fundamental phases to be used.

The quantum computer (QC) may comprise a rotation sensor (RTS) for detecting rotation values and/or rotational acceleration values for rotations about one axis or a rotation sensor (RTS) for detecting rotation values and/or rotational acceleration values for rotations about two axes (AX1, AX2) or a rotation sensor (RTS) for detecting rotation values and/or rotational acceleration values for rotations about three axes, and wherein the rotation sensor (RTS) of the quantum computer (QC) can detect the current orientation of the quantum computer (QC) in the form of one or more orientation measurement values and/or wherein the rotation sensor (RTS) of the quantum computer (QC) can detect the current rotation speed of the quantum computer (QC) in the form of one or more rotation values and/or wherein the rotation sensor (RTS) of the quantum computer (QC) can detect the current rotational acceleration of the quantum computer (QC) in the form of one or more rotational acceleration values, and wherein the quantum computer (QC) can be set up to determine the coupling frequencies and/or coupling phase positions to be used as a function of the measured alignment values and/or the rotation values and/or the rotation acceleration values
between the pairs of coupleable first two quantum bits (QUB1, QUB2) and/or
between the coupleable pairs of a first quantum bit (QUB) and a second quantum bit (CQUB) and/or
between the pairs of two second quantum bits (CQUB1, CQUB2) that can be coupled to each other to be determined from the coupling fundamental frequencies and/or coupling fundamental phases to be used, and
wherein the quantum computer (QC) is arranged to use the coupling frequencies and/or coupling phase positions thus determined to be used when manipulating the first quantum bits (QUB, QUB1, QUB2) and/or second quantum bits (CQUB, CQUB1, CQUB2) by means of the first means and/or the second means.

The quantum computer (QC) can be set up to determine the coupling frequencies and/or coupling phase positions between pairs of couplable first two quantum bits (QUB1, QUB2) and/or
between couplable pairs each consisting of a first quantum bit (QUB) and a second quantum bit (CQUB) and/or between pairs of two second quantum bits (CQUB1, CQUB2) that can be coupled with each other
at a first point in time and store them as coupling fundamental frequencies and/or coupling phase positions and wherein the quantum computer (QC) can be set up to determine the coupling frequencies and/or coupling phase positions between pairs of couplable first two quantum bits (QUB1, QUB2) and/or
between couplable pairs each consisting of a first quantum bit (QUB) and a second quantum bit (CQUB) and/or between pairs of two second quantum bits (CQUB1, CQUB2) that can be coupled with each other
at a second point in time after the first point in time and to use these as coupling frequencies and/or coupling phase positions, and wherein the quantum computer (QC) may be arranged to determine a current alignment of the quantum computer (QC) in the form of one or more alignment measurement values from one or more coupling fundamental frequencies and/or coupling fundamental phases and one or more coupling frequencies and/or coupling phase positions, and/or wherein the quantum computer (QC) can be set up to determine a current rotational speed of the quantum computer (QC) in the form of one or more measured rotational values from one or more coupling fundamental frequencies and/or coupling fundamental phases and one or more coupling frequencies and/or coupling phases, and/or wherein the quantum computer (QC) can be set up to determine a current rotational acceleration of the quantum computer (QC) in the form of one or more rotational acceleration measured values from one or more coupling fundamental frequencies and/or coupling fundamental phases and one or more coupling frequencies and/or coupling phases, and/or
wherein the quantum computer (QC) can be set up to determine the current acceleration, in particular gravitational acceleration, of the quantum computer (QC) in the form of one or more acceleration measurement values from one or more coupling fundamental frequencies and/or coupling fundamental phases and one or more coupling frequencies and/or coupling phase positions, and/or
wherein the quantum computer (QC) can be set up to determine the current speed of the quantum computer (QC) in the form of one or more speed measurement values from one or more coupling fundamental frequencies and/or coupling fundamental phases and one or more coupling frequencies and/or coupling phases.

The quantum computer (QC) or parts of the quantum computer (QC) or an arrangement of first electronic quantum bits (QUB, QUB1, QUB2) and or of and/or of first electronic quantum bits (QUB, QUB1, QUB2) with quantum dots (NV, NV1, NV2) and/or of second nuclear quantum bits (CQUB, CQUB1, CQUB2) and/or of second nuclear quantum bits (CQUB, CQUB1, CQUB2) with nuclear quantum dots (CI, CI1, CI2) and/or an arrangement of paramagnetic centers of the quantum computer (QC) can be mounted rotatably about one axis or can be mounted rotatably about two axes (AX1, AX2) or can be mounted rotatably about three axes.

The quantum computer (QC) can have one or more energy couplings (EK1, EK2), wherein an energy coupling (EK1, EK2) can in each case be set up to connect the quantum computer (QC) or parts of the quantum computer (QC) or the arrangement of first electronic quantum bits (QUB, QUB1, QUB2) and or of and/or of first electronic quantum bits (QUB, QUB1, QUB2) with quantum dots (NV, NV1, NV2) and/or of second nuclear quantum bits (CQUB, CQUB1, CQUB2) and/or of second nuclear quantum bits (CQUB, CQUB1, CQUB2) with nuclear quantum dots (CI, CI1, CI2) and/or an arrangement of paramagnetic centers of the quantum computer (QC) with electrical or electromagnetic energy and wherein the respective energy coupling (EK1, EK2) can be set up so that a rotation of the quantum computer (QC) or of parts of the quantum computer (QC) or of the arrangement of first electronic quantum bits (QUB, QUB1, QUB2) and or of and/or of first electronic quantum bits (QUB, QUB1, QUB2) with quantum dots (NV, NV1, NV2) and/or of second nuclear quantum bits (CQUB, CQUB1, CQUB2) and/or of second nuclear quantum bits (CQUB, CQUB1, CQUB2) with nuclear quantum dots (CI, CI1, CI2) and/or the arrangement of paramagnetic centers of the quantum computer (QC) about an associated axis (AX1, AX2) does not have to rotate the energy supply, and
wherein the respective energy coupling (EK1, EK2) can be set up to transport the energy from the energy supply to the quantum computer (QC) in such a way that a twisting of the quantum computer (QC) or of parts of the quantum computer (QC) or of the arrangement of first electronic quantum bits (QUB, QUB1, QUB2) and or of and/or of first electronic quantum bits (QUB, QUB1, QUB2) with quantum dots (NV, NV1, NV2) and/or of second nuclear quantum bits (CQUB, CQUB1, CQUB2) and/or of second nuclear quantum bits (CQUB, CQUB1, CQUB2) with nuclear quantum dots (CI, CI1, CI2) and/or the arrangement of paramagnetic centers of the quantum computer (QC) relative to the energy supply is possible at any angle about the associated axis (AX1, AX2).

The energy coupling (EK1, EK2) can have slip rings and sliding contacts for transporting the energy of the energy supply to the quantum computer (QC) or to parts of the quantum computer (QC) or for arranging first electronic quantum bits (QUB, QUB1, QUB2) and or of and/or of first electronic quantum bits (QUB, QUB1, QUB2) with quantum dots (NV, NV1, NV2) and/or of second nuclear quantum bits (CQUB, CQUB1, CQUB2) and/or of second nuclear quantum bits (CQUB, CQUB1, CQUB2) with nuclear quantum dots (CI, CI1, CI2) and/or for the arrangement of paramagnetic centers of the quantum computer (QC) and/or wherein the energy coupling (EK1, EK2) may be arranged to couple the energy of the energy supply by means of inductive coupling to the quantum computer (QC) or to parts of the quantum computer (QC) or to the arrangement of first electronic quantum bits (QUB, QUB1, QUB2) and or of and/or of first electronic quantum bits (QUB, QUB1, QUB2) with quantum dots (NV, NV1, NV2) and/or of second nuclear quantum bits (CQUB, CQUB1, CQUB2) and/or of second nuclear quantum bits (CQUB, CQUB1, CQUB2) with nuclear quantum dots (CI, CI1, CI2) and/or for the arrangement of paramagnetic centers of the quantum computer (QC) and/or
whereby the energy coupling (EK1, EK2) can be set up for this purpose, the energy of the energy supply by means of electromagnetic waves and/or electromagnetic radiation to the quantum computer (QC) or to parts of the quantum computer (QC) or to the arrangement of first electronic quantum bits (QUB, QUB1, QUB2) and or of and/or of first electronic quantum bits (QUB, QUB1, QUB2) with quantum dots (NV, NV1, NV2) and/or of second nuclear quantum bits (CQUB, CQUB1, CQUB2) and/or of second nuclear quantum bits (CQUB, CQUB1, CQUB2) with nuclear quantum dots (CI, CI1, CI2) and/or for the arrangement of paramagnetic centers of the quantum computer (QC), wherein an irradiation of quantum dots (NV, NV1, NV2) with a pump radiation (LB) is an energy supply within the meaning of this claim.

The quantum computer (QC) can be mounted rotatably about one axis or two axes (AX1, AX2) or three axes by means of a Cardanic suspension (KAH), whereby the quantum computer (QC) can comprise one or more gyroscopes (KR) or can be connected to these, so that its orientation is not changed by rotations of the Cardanic suspension (KAH) about this one axis or these two axes (AX1, AX2) or these three axes.

One or more gyros of the gyros (KR) can have a drive and wherein the one gyros or the several gyros (KR) and the drive of the one gyros or the drives of the gyros (KR) can be a part of the quantum computer system or quantum computer in the sense of the claims claimed herein.

In a further aspect, a use of an above-described quantum computer as a gyrometer is provided.

The quantum computer (QC) can be set up to determine the current alignment of the quantum computer (QC) in the form of one or more alignment measurement values and/or in the form of one or more nth-order temporal derivatives of alignment measurement values and/or in the form of one or more nth-order temporal integrals of alignment measurement values and/or in the form of filtered values of alignment measurement values by determining one or more fundamental coupling frequencies and/or fundamental coupling phases and by determining one or more coupling frequencies and/or coupling phases, and/or to determine the current alignment of the quantum computer (QC) in the form of one or more alignment measurement values and/or in the form of one or more nth-order temporal derivatives of alignment measurement values and/or in the form of one or more nth-order temporal integrals of alignment measurement values and/or in the form of filtered values of alignment measurement values wherein the quantum computer (QC) can be set up to determine the current rotational speed of the quantum computer (QC) in the form of one or more rotational measured values and/or in the form of one or more nth-order temporal derivatives of rotational measured values and/or in the form of one or more nth-order temporal integrals of rotational measured values and/or in the form of filtered values of rotational measured values by determining one or more fundamental coupling frequencies and/or fundamental coupling phases and by determining one or more coupling frequencies and/or coupling phases, and/or wherein the quantum computer (QC) can be set up for this purpose, determining the current rotational acceleration of the quantum computer (QC) in the form of one or more rotational acceleration measured values and/or in the form of one or more nth-order temporal derivatives of rotational acceleration measured values and/or in the form of one or more nth-order temporal integrals of rotational acceleration measured values and/or in the form of filtered values of rotational acceleration measured values by determining one or more fundamental coupling frequencies and/or fundamental coupling phases and by determining one or more coupling frequencies and/or coupling phases, and/or wherein the quantum computer (QC) can be set up to determine the current speed of the quantum computer (QC) in the form of one or more speed measurement values and/or in the form of one or more nth-order temporal derivatives of speed measurement values and/or in the form of one or more nth-order temporal integrals of speed measurement values and/or in the form of filtered values of speed measurement values by determining one or more fundamental coupling frequencies and/or fundamental coupling phases and by determining one or more coupling frequencies and/or coupling phases, and/or wherein the quantum computer (QC) can be set up to determine the current acceleration of the quantum computer (QC) in the form of one or more acceleration measurement values and/or in the form of one or more nth-order time derivatives of acceleration measurement values and/or in the form of one or more nth-order time integrals of acceleration measurement values and/or in the form of filtered values of acceleration measurement values by determining one or more coupling fundamental frequencies and/or coupling fundamental phases and by determining one or more coupling frequencies and/or coupling phase positions, and/or
wherein the quantum computer (QC) can be set up to determine the current location coordinate of the quantum computer (QC) in the form of one or more coordinate measurement values and/or in the form of one or more nth-order temporal derivatives of coordinate measurement values and/or in the form of one or more nth-order temporal integrals of coordinate measurement values and/or in the form of filtered values of coordinate measurement values by determining one or more fundamental coupling frequencies and/or fundamental coupling phases and by determining one or more coupling frequencies and/or coupling phases.

The quantum computer (QC) can be set up to determine measured values of physical parameters, in particular such as orientation, angular velocity (rotational velocity), angular acceleration (rotational acceleration), gravitational acceleration, acceleration, velocity and/or location coordinate, by executing quantum op codes.

In a further aspect, a relocatable quantum computer (QC) is provided, in particular according to any of the preceding claims, in a mobile device, in particular for use in a smartphone or a portable quantum computer system (QUSYS) or in a vehicle or in a relocatable weapon system, wherein the quantum computer (QC) comprises first quantum bits (QUB) and/or second quantum bits (CQUB), and wherein the quantum computer (QC) uses first means (e.g. WFG, LDRV, LD, DBS, OS, XT, YT, KV, mWA, MW/RF-AWFG, PM, PV, PVC, MGx, MGy, MGz, MFSx, MFSx, MFSz, MSx, MSy, MSz, GDx, GDy, GDz, μC) and/or second means (e.g. WFG, LDRV, LD, DBS, OS, XT, YT, KV, mWA, MW/RF-AWFG, PM, PV, PVC, MGx, MGy, MGz, MFSx, MFSx, MFSz, MSx, MSy, MSz, GDx, GDy, GDz, μC) for manipulating the quantum states of quantum bits of the quantum bits (QUB, CQUB) and wherein the quantum computer (QC) comprises third means (e.g. D, XT, YT, KV, OS, DBS, STM, CM1, PD, V, WFG, CIF, μC) for reading out one or more quantum states (QC) of one or more quantum bits of the quantum bits (QUB, CQUB), and wherein one or more quantum bits of the one or more first quantum bits (QUB) comprise paramagnetic centers, and wherein the quantum computer (QC) comprises a control device (μC) to control the first means and to control the second means and for acquiring measurement results of the second means, and characterized by this,
that the quantum computer (QC) comprises fourth means (RTS, PV, XT, YT, CM1, OS, STM, CIF, μC) which are set up for this purpose, predict changes in acceleration and/or rotational acceleration, in particular during a relocation of the relocatable quantum computer (QC), and/or to detect changes in acceleration and/or rotational acceleration, in particular during relocation of the relocatable quantum computer (QC), and/or
to compensate for changes in acceleration and/or rotational acceleration, in particular during relocation of the relocatable quantum computer (QC), and/or reduce the effect of such changes in acceleration and/or rotational acceleration, in particular during relocation of the relocatable quantum computer (QC),
whereby the third means in particular one or more acceleration sensor systems and/or acceleration sensors and/or one or more speed sensor system and/or one or more speed sensors and/or
one or more rotational acceleration sensor systems and/or rotational acceleration sensors and/or
one or more rotation sensor systems and/or rotation sensors (RTS) and/or one or more position displacement sensors and/or one or more position control systems and/or one or more positioning tables and/or positioning devices and/or one or more image acquisition devices and/or image processing devices and/or
other fluorescent defect centers in the substrate (D) with other fluorescence wavelengths, which have a fluorescence radiation with a fluorescence wavelength different from the fluorescence wavelength (λ_{fl}) of the quantum dots (NV1, NV2, NV3) of the quantum bits.

In a further aspect, a relocatable quantum computer (QC) is provided, in particular according to one of the preceding claims, in particular in a mobile device and in particular for use in a smartphone or a portable quantum computer system (QUSYS) or in a vehicle or in a relocatable weapon system, where the quantum computer (QC) comprises quantum bits (QUB, CQUB) and—wherein the quantum computer (QC) comprises first and second means for manipulating the quantum states of quantum bits of the quantum bits (QUB, CQUB), and wherein the quantum computer (QC) comprises third means for reading out one or more quantum states of one or more quantum bits of the quantum bits (QUB, CQUB), and wherein one or more quantum bits of the one or more quantum bits (QUB) comprise paramagnetic centers, and wherein the quantum computer (QC) comprises a control device (μC) to control the first means and to control the second means and to control the third means and
for acquiring measurement results of the third means, and characterized by this,
that the quantum computer (QC) comprises fourth means (PV, XT, YT, CM1, OS, STM, CIF, μC) which are set up for this purpose, predict changes in acceleration and/or rotational acceleration, in particular during a relocation of the relocatable quantum computer (QC), and/or to detect changes in acceleration and/or rotational acceleration, in particular during relocation of the relocatable quantum computer (QC), and/or
to compensate for changes in acceleration and/or rotational acceleration, in particular during relocation of the relocatable quantum computer (QC), and/or reduce the effect of such changes in acceleration and/or rotational acceleration, in particular during relocation of the relocatable quantum computer (QC),
whereby the fourth means in particular one or more acceleration sensor systems and/or acceleration sensors and/or one or more speed sensor system and/or one or more speed sensors and/or
one or more rotational acceleration sensor systems and/or rotational acceleration sensors and/or
one or more rotation sensor systems and/or rotation sensors (RTS) and/or one or more position displacement sensors and/or one or more position control systems and/or one or more positioning tables and/or positioning devices and/or one or more image acquisition devices and/or image processing devices and/or
other fluorescent defect centers in the substrate (D) with other fluorescence wavelengths, which may comprise fluorescence radiation with a fluorescence wavelength different from the fluorescence wavelength (λ_{fl}) of the quantum dots (NV1, NV2, NV3) of the quantum bits, and/or that the quantum computer (QC) comprises fifth means (PV, XT, YT, CM1, OS, STM, CIF, μC) which are set up for this purpose, predict an acceleration and/or a rotational acceleration, in particular during a relocation of the relocatable quantum computer (QC), and/or to detect an acceleration and/or a rotational acceleration, in particular during a relocation of the relocatable quantum computer (QC), and/or to compensate for an acceleration and/or a rotational acceleration, in particular during a relocation of the relocatable quantum computer (QC) and/or
to reduce the effect of an acceleration and/or a rotational acceleration, in particular during a relocation of the relocatable quantum computer (QC), wherein the fifth means are in particular one or more acceleration sensor systems and/or acceleration sensors and/or one or more speed sensor system and/or one or more speed sensors and/or a Cardanic suspension (KAH) or a functionally equivalent device, in particular comprising one or more gyroscopes (KR), and/or one or more rotational acceleration sensor systems and/or rotational acceleration sensors and/or one or more rotation sensor systems and/or rotation sensors (RTS) and/or
one or more position displacement sensors and/or one or more position control systems and/or
one or more positioning tables and/or positioning devices and/or one or more image acquisition devices and/or image processing devices and/or other fluorescent defect centers in the substrate (D) with other fluorescence wavelengths, which may comprise fluorescence radiation with a fluorescence wavelength different from the fluorescence wavelength (λ_{fl}) of the quantum dots (NV1, NV2, NV3) of the quantum bits, and/or in that the quantum computer (QC) comprises sixth means (QUV) which are set up to prevent and/or damp the transmission of mechanical shocks and/or vibrations between optical device parts (D, OS, DBS, STM, PD, CM1, LD) and/or further auxiliary device parts (KV, XT, YT, MGx, MGy, MGz, MSx, MSy, MSz, MWA, CM2, LM, HECLCS) of the optical subdevices of the quantum computer (QC), and/or in that the quantum computer (QC) comprises seventh means (QUV) which are set up to ensure the transmission of mechanical shocks and/or vibrations to optical device parts (D, OS, DBS, STM, PD, CM1, LD) of the quantum computer (QC) and/or to the further auxiliary device parts (KV, XT, YT, MGx, MGy, MGz, MSx, MSy, MSz, MWA, CM2, LM, HECLCS) of the optical subdevices of the quantum computer (QC), in particular via structure-borne sound, wherein the seventh means, inter alia, prevent and/or attenuate vibrations and/or shocks.a.
can be inserted in supply lines to optical device parts (D, OS, DBS, STM, PD, CM1, LD) of the quantum computer (QC) and/or to the other auxiliary device parts (KV, XT, YT, MGx, MGy, MGz, MSx, MSy, MSz, MWA, CM2, LM, HECLCS) and/or can be inserted in data lines (SDA) to optical device parts (D, OS, DBS, STM, PD, CM1, LD) of the quantum computer (QC) and/or to the other auxiliary device parts (KV, XT, YT, MGx, MGy, MGz, MSx, MSy, MSz, MWA, CM2, LM, HECLCS) and/or can comprise special mechanical, at least sectional, formations of supply lines to optical device parts (D, OS, DBS, STM, PD, CM1, LD) of the quantum computer (QC) and/or to the other auxiliary device parts (KV, XT, YT, MGx, MGy, MGz, MSx, MSy, MSz, MWA, CM2, LM, HECLCS) and/or can comprise special mechanical, at least sectional, formations of data lines (SDA) to optical device parts (D, OS, DBS, STM, PD, CM1, LD) of the quantum computer (QC) and/or to the other auxiliary device parts (KV, XT, YT, MGx, MGy, MGz, MSx, MSy, MSz, MWA, CM2, LM, HECLCS) and/or
in that the quantum computer (QC) comprises eighth means (QUV) which are set up to detect a non-statistical error of the quantum computer (QC) and/or to carry out or initiate countermeasures if a non-statistical error of the quantum computer (QC) occurs, and/or in that the quantum computer (QC) comprises ninth means (QUV) which are set up to detect a non-statistical error of the quantum computer (QC) and/or to signal such a non-statistical error to a higher-level system if a non-statistical error of the quantum computer (QC) occurs, and/or in that the quantum computer (QC) comprises tenth means (QUV) which are set up to detect a non-statistical quantum error of the quantum computer (QC) and/or to carry out or initiate countermeasures if a non-statistical error of the quantum computer (QC) occurs, and/or in that the quantum computer (QC) comprises eleventh means (QUV) which are set up to detect a non-statistical quantum error of the quantum computer (QC) and/or to signal such a non-statistical quantum error to a higher-level system if a non-statistical error of the quantum computer (QC) occurs, and/or in that the quantum computer (QC) comprises twelfth means (MSx, MSy, MSz, MFSx, MFSy, MFSz, PM, MGx, MGy, MGz, PV) which are set up to detect and compensate for changes in the magnetic field at the location of the quantum bits (QUB, CQUB) during and/or after a relocation of the quantum computer (QC), and/or that the quantum computer (QC) comprises thirteenth means (AS) for shielding external magnetic field changes.

In another aspect, a vehicle with a quantum computer (QC) as described above is provided.

In a further aspect, there is provided a gyroscope comprising a quantum computer (QC) according to one or more of the preceding claims.

For the operation of a quantum computer QC, suitable microcode programming of the control device μC of the quantum computer QC can be advantageous. In the following sections and in the previously published patent literature, various methods and method steps are described which can be used to manipulate various components and in particular electronic quantum bits QUB and their quantum dots NV and/or nuclear quantum bits CQUB and their nuclear quantum dots CI of the quantum computer QC in a predetermined manner. Each of these quantum operations and conventional operations can be symbolized by an operator code, the quantum OP code. For the purposes of the present document, a quantum op-code is a code that, when executed by the control device μC of the quantum computer QC, the quantum computer QC manipulates and/or reads out a quantum state of at least one of its electronic quantum bits QUB or one of its nuclear quantum bits CQUB.

For example, it is conceivable that the quantum computer QC has programmable logic. Such programmable logic can be an FPGA (abbreviation for Field Programmable Gate Array) or similar.

Optionally, the quantum computer QC comprises an FPGA. Optionally, the FPGA comprises one or more device parts of the control device μC. If necessary, a programmable logic can also be a device part of the control device μC. Optionally, the FPGA receives configuration data via an external data bus EXTDB, which influences the manipulation of the electronic quantum bits QUB and/or the nuclear quantum bits CQUB and/or the readout of the electronic quantum bits QUB and/or the nuclear quantum bits CQUB during the intended operation of the quantum computer QC. At the same time, some parts of the device may be extremely expensive. This may result in the technical requirement for the subsequent adaptability of existing quantum computers QC to new scientific and technical findings and to new customer requirements arising from new, as yet unknown market requirements.

Optional, the use of a proFPGA Xilinx Virtex UltraScale+ XCVU13P FPGA board can be advantageous for the realization of the digital parts of the quantum computer QC. The Xilinx Virtex UltraScale+ XCVU13P FPGA can be used to control the first first means (e.g. WFG, LDRV, LD, DBS, OS, XT, YT, KV, mWA, MW/RF-AWFG, PM, PV, PVC, MGx, MGy, MGz, MFSx, MFSx, MFSz, MSx, MSy, MSz, GDx, GDy, GDz, μC) of the quantum computer QC and for driving the second means (e.g. WFG, LDRV, LD, DBS, OS, XT, YT, KV, mWA, MW/RF-AWFG, PM, PV, PVC, MGx, MGy, MGz, MFSx, MFSx, MFSz, MSx, MSy, MSz, GDx, GDy, GDz, μC) of the quantum computer QC. Optionally, the FPGA also comprises the digital circuit parts of the first means (e.g. WFG, LDRV, LD, DBS, OS, XT, YT, KV, mWA, MW/RF-AWFG, PM, PV, PVC, MGx, MGy, MGz, MFSx, MFSx, MFSz, MSx, MSy, MSz, GDx, GDy, GDz, μC) and the second means (e.g. WFG, LDRV, LD, DBS, OS, XT, YT, KV, mWA, MW/RF-AWFG, PM, PV, PVC, MGx, MGy, MGz, MFSx, MFSz, MSx, MSy, MSz, GDx, GDy, GDz, μC).e.g. WFG, LDRV, LD, DBS, OS, XT, YT, KV, mWA, MW/RF-AWFG, PM, PV, PVC, MGx, MGy, MGz, MFSx, MFSx, MFSz, MSx, MSy, MSz, GDx, GDy, GDz, μC) in whole or in part.

Optionally, the FPGA also includes the digital circuit parts of the third means D, XT, YT, KV, OS, DBS, STM, CM1, PD, V, WFG, CIF, μC).

The present document proposes to provide at least one or more or all of the following exemplary micro-codes as quantum op-codes:

### Meaning of the Quantum OP Code

MFMW Determination of the common electron-electron microwave frequency (f_{MW}) for a single electronic quantum bit QUB and/or a single electronic quantum dot NV
MFMWEE Determination of the common electron1-electron2 microwave frequency (f_{MW}) for the coupling of two electronic quantum bits (QUB1, QUB2) and/or for the coupling of two electronic quantum dots (NV1, NV2).
MFMWCE Determination of the nuclear-electron microwave frequency (f_{MWCE}) for the coupling of an electronic quantum bit QUB and a nuclear quantum bit CQUB in one of a nuclear-electron quantum register comprising, for example, an electronic quantum dot NV and a nuclear quantum dot CI.
MFRWCC Determination of the nuclear-nuclear radio wave frequency (f_{RWCC}) of a nuclear-nuclear quantum register of two nuclear quantum bits (CQUB1 and CQUB2) typically comprising a first nuclear quantum dot CI1 and a second nuclear quantum dot CI2.
MFRWCC Determination of the electron-nuclear radio wave frequency (f_{RWEC}) for the coupling for the coupling of an electronic quantum bit QUB and a nuclear quantum bit CQUB in one of an electron-nuclear quantum register comprising, for example, an electronic quantum dot NV and a nuclear quantum dot CI.
RESQB Resetting one or more electronic quantum bits QUB and/or one or more quantum dots NV of these quantum bits QUB.
RESQBR Resetting one or more electronic quantum bits QUB and/or one or more quantum dots NV of these quantum bits QUB by relaxation.
RESQRCE Resetting one or more nuclear electron quantum registers comprising an electronic quantum bit QUB and a nuclear quantum bit CQUB in a nuclear electron quantum register comprising, for example, an electronic quantum dot NV and a nuclear quantum dot CI.
MQBP Manipulation of an electronic quantum bit QUB and/or a quantum dot NV of an electronic quantum bit QUB (CROT operation).
MCBP Manipulation of a nuclear quantum bit CQUB and/or a nuclear quantum dot CI of a nuclear quantum bit CQUB (CROT operation).
SMQB Selective manipulation of an electronic quantum bit QUB and/or a quantum dot NV of an electronic quantum bit QUB within a quantum register of several electronic quantum bits (QUB1, QUB1) and/or within a quantum register of several quantum dots (NV1, NV2) (CROT operation).
KQBQB Coupling of a first electronic quantum bit QUB1 with a second electronic quantum bit QUB2 and/or coupling of a first quantum dot NV1 of a first electronic quantum bit QUB1 with a second quantum dot NV2 of a second electronic quantum bit QUB2
KQBCB Coupling of first electronic quantum bit QUB1 with a nuclear quantum bit CQUB and/or coupling of a quantum dot NV of a first electronic quantum bit QUB1 with a nuclear quantum dot CI of a nuclear quantum bit CQUB.
CNQBCBA CNOT Linking of a first electronic quantum bit QUB with a nuclear quantum bit CQUB and/or CNOT Linking of a quantum dot NV with a nuclear quantum dot CI
CNQBCBB CNOT linkage of a first electronic quantum bit QUB with one with a nuclear quantum bit CQUB and/or CNOT linkage of a quantum dot NV with one with a nuclear quantum dot CI.
CNQBCBC CNOT linkage of an electronic quantum bit QUB with a nuclear quantum bit CQUB and/or CNOT linkage of a quantum dot NV with a nuclear quantum dot CI.
VQB Selective evaluation of an electronic quantum bit QUB1 within a quantum register (QUREG) with at least two electronic quantum bits (QUB1, QUB2) and/or selective evaluation of a quantum dot NV1 within a quantum register (QUREG) with at least two quantum dots (NV1, NV2).
SCNQB Selective CNOT operation for manipulating the quantum state of a quantum bit QUB1 within a quantum register of several electronic quantum bits (QUB1, QUB2) and/or selective CNOT operation for manipulating the quantum state of a quantum dot NV1 within a quantum register of several quantum dots (NV1, NV2).

It is conceivable to provide further operations through possible variants and/or combinations. Furthermore, it may be advantageous to allow some or all of the usual assembler instructions of conventional von Neumann computers and/or computers with Harvard architecture, such as jumps, branches, conditional jumps, program counter manipulations, move operations, addition operations, shift operations (left and right), inversion, bit manipulations, calling subroutines, stack operations, stack pointer operations, etc., to continue.

It can also be advantageous to hard-code these MNEMONICS and certain frequently used sequences of the MNEMONICs in the FPGA and to provide separate mnemonics for them.

The corresponding signal sequences are optionally stored as program parts of the quantum computer program and/or a quantum computer operating system in an optionally non-volatile program memory NVM of the control device μC, for example within the FPGA. Alternatively, the quantum computer QC can load the corresponding signal sequences and program parts of the quantum computer program and/or a quantum computer operating system into a memory (RAM, NVM) of the quantum computer QC via an external data bus EXTDB or from a storage medium at the start of operation of the quantum computer QC. Optionally, a quantum computer bios is stored in the non-volatile memory NVM of the control device μC of the quantum computer QC, which enables the control device μC to load a quantum computer operating system from a storage medium and/or via an external data bus EXTDB and ultimately to load a quantum computer program from a storage medium and/or via an external data bus EXTDB and to execute it when program parts of the quantum computer bios are executed.

The memory or memories (RAM, NVM) of the control device μC then optionally comprise, among other things, a table of the resonant frequencies of the electronic quantum bits QUB and the associated quantum dots NV and the nuclear quantum bits CQUB and the associated nuclear quantum dots CI and their couplings as well as the associated Rabi frequencies. This data can allow the control device μC within the FPGA to determine the first electronic quantum bits QUB and their quantum dots NV, the second nuclear quantum bits CQUB and their nuclear quantum dots CI, the pairs of two and possibly more first electronic quantum bits QUB and their nuclear quantum dots CI and their couplings as well as the associated Rabi frequencies. more first electronic quantum bits QUB and their quantum dots NV, the pairs of first electronic quantum bit QUB with associated quantum dot NV and second nuclear quantum bit CQUB with associated nuclear quantum dot CI and possibly the more complex structures can be selectively and specifically addressed and manipulated.

A program, a Q-assembler, optionally translates a control code presented in a human-readable text form into binary code sequences, which are executed by the control device C as needed. This allows the control device μC of the quantum computer QC to then process the quantum information of the first electronic quantum bits QUB and their quantum points NV, the second nuclear quantum bits CQUB and their nucleus quantum points CI, the pairs of two, and the associated quantum dots (NV1, NV2), the pairs of first electronic quantum bit QUB with associated quantum dot NV and second nuclear quantum bit CQUB with associated nuclear quantum dot CI and possibly the more complex structures selectively and specifically address and manipulate. With the help of this quantum assembler language, it may be possible to develop more complex programs for the quantum computer QC in order to operate the devices and provide a simple interface for software development. The control device μC of the quantum computer QC executes the binary microcode of the quantum computer program in its memory (NVM, RAM). Microcode in the sense of the proposed project is the connection between a predetermined binary code—the quantum assembler code-which the control device μC receives from an external monitoring computer ZSE via the external data bus EXTDB on one side, and the concrete sequence of signals and the corresponding signal forms for the first means (e.g. WFG, LDRV, LD, DBS, OS, XT, YT, KV, mWA, MW/RF-AWFG, PM, PV, PVC, MGx, MGy, MGz, MFSx, MFSx, MFSz, MSx, MSy, MSz, GDx, GDy, GDz, μC) and for the second means (e.g. WFG, LDRV, LD, DBS, OS, XT, YT, KV, mWA, MW/RF-AWFG, PM, PV, PVC, MGx, MGy, MGz, MFSx, MFSx, MFSz, MSx, MSy, MSz, GDx, GDy, GDz, μC) and for the third means (e.g. D, XT, YT, KV, OS, DBS, STM, CM1, PD, V, WFG, CIF, μC). In this sense, the control unit function of the control device μC of the quantum computer QC is comparable to the microcode programming of a conventional processor. The control device μC optionally has the quantum computer program at least partially stored in its memory (RAM, ROM) at the time of execution. The quantum computer program optionally comprises sequences of quantum assembler code in binary form, which is located in a memory (RAM, ROM) of the control device μC. The control device μC executes the binary quantum assembler code, which is optionally located in a memory (RAM, ROM) of the control device μC as a sequence of binary numbers, and optionally generates the signals on the vertical lines and horizontal lines with the aid of further means (CBA, HD1, HD2, HD3, VD1, VS1, HS1, HS2, HS3, LEDDR, LED, CBB) (see also FIG. 3) as a function of these optionally binary codes. This enables the development of quantum computer software on the hardware described here.

The following explanations concern the basic principles and optional features of an optional embodiment of a quantum computer system:

An external monitoring computer ZSE can address a large number of optional quantum computers (QC1 to QC16) with the same structure via a conventional external data bus EXTDB. The external conventional monitoring computer ZSE then forms a quantum computer system QUSYS with the multitude of quantum computers (QC1 to QC16). Optionally, the quantum computers (QC1 to QC16) of the quantum computer system QUSYS are structured as described below. The structure of the quantum computers (QC1 to QC16) of a quantum computer system QUSYS described here has the advantage that it is very compact and very inexpensive. The quantum computers (QC1 to QC16) of the quantum computer system QUSYS can be operated at room temperature, for example, when using diamond as the material of the substrates D or the epitaxial layers DEPI and NV centers as quantum dots NV of the first electronic quantum bits QUB. Optionally, the quantum computer system QUSYS uses a very large number of quantum computers (QC1 to QC16) for the quantum computer system QUSYS. Optionally, all or at least groups of quantum computers (QC1 to QC16) of the quantum computing system QUSYS have the same structure to ensure comparability of quantum computation results within such a group of quantum computers (QC1 to QC16) of the quantum computing system QUSYS. For example, they can be structured like the quantum computer QC of FIGS. 1 and 3. Optionally, groups of quantum computers of the quantum computers (QC1 to QC16) of the quantum computer system QUSYS or all quantum computers (QC1 to QC16) of the quantum computer system QUSYS perform the same operations within such a group of quantum computers (QC1 to QC16) of the quantum computer system QUSYS substantially at the same time in parallel. Since the realizations of the second nuclear quantum bits CQUB with their nuclear quantum dots CI and the electronic quantum bits QUB with their quantum dots NV may differ in detail among the quantum computers (QC1 to QC16), minor differences may exist. It is important that the quantum computers (QC1 to QC16) within a group of quantum computers (QC1 to QC16) of the QUSYS quantum computer system behave functionally equivalent to each other. Nevertheless, not all quantum computers of the quantum computers (QC1 to QC16) will come to the same results when performing quantum operations, since quantum computers QC only calculate certain results with a certain probability. The large number of quantum computers (QC1 to QC16) of the QUSYS quantum computer system (see also FIG. 4) can be utilized here. Since all quantum computers (QC1 to QC16) of the QUSYS quantum computer system optionally work in the same way at least some of the time in accordance with the proposal and optionally in parallel, the quantum computers (QC1 to QC16) will most frequently calculate the correct results and calculate incorrect values less frequently. The external monitoring computer, in FIG. 4 the central control unit ZSE, of the quantum computer system QUSYS queries the results of a longer sequence of quantum operations carried out in the same way by all quantum computers (QC1 to QC16) from all quantum computers concerned (QC1 to QC16) via the data line. The external monitoring computer, in FIG. 4 the central control unit ZSE, evaluates all results according to the frequency of calculation by the quantum computers (QC1 to QC16) of the quantum computer system QUSYS. Using a statistical procedure, the external monitoring computer of the QUSYS quantum computer system calculates the most probable result from the results of the quantum computers (QC1 to QC16) and selects this as a valid intermediate result. Then the external monitoring computer, in FIG. 4 the central control unit ZSE, of the quantum computer system QUSYS transmits this valid intermediate result to all quantum computers (QC1 to QC16) and optionally causes them first to reset their respective first electronic quantum bits QUB with their quantum dots NV and their respective second nuclear quantum bits CQUB with their nuclear quantum dots CI and then to set the Bloch vectors so that they correspond to the intermediate result. The quantum computers (QC1 to QC16) then carry out the next longer sequence of quantum operations until a second intermediate result is again available and then the next error correction loop is carried out by the external monitoring computer, in FIG. 4 the central control unit ZSE, of the quantum computer system QUSYS.

Such a quantum computer system QUSYS is thus optionally characterized in that it comprises a conventional external monitoring computer, in FIG. 4 the central control unit ZSE, of the quantum computer system QUSYS, which communicates with the quantum computers (QC1 to QC16) of the quantum computer system QUSYS via one or more optionally conventional data buses EXTDB. The EXTDB data buses can be conventional data transmission lines of any type. Optionally, the number of quantum computers (QC1 to QC16) in the quantum computer system QUSYS is greater than 5, better greater than 10, better greater than 20, better greater than 50, better greater than 100, better greater than 200, better greater than 500, better greater than 100, better greater than 200, better greater than 500, better greater than 1000, better greater than 2000, better greater than 5000, better greater than 10000, better greater than 20000, better greater than 50000, better greater than 100000, better greater than 200000, better greater than 50000, better greater than 1000000. In this case, the more quantum computers (QC1 to QC16) are part of the QUSYS quantum computer system, the better the resolution of the error correction. Optionally, each quantum computer (QC1 to QC16) optionally comprises a control device μC, which communicates with the external monitoring computer, in FIG. 4 the central control device ZSE, of the quantum computer system QUSYS via the one data bus EXTDB or the several, optionally conventional data buses EXTDB. Optionally, each quantum computer of the quantum computers (QC1 to QC16) comprises means suitable for manipulating and, if necessary, controlling the states of their first electronic quantum bits NV and/or their second nuclear quantum bits CI and/or the pairs of first electronic quantum bits NV and/or the pairs of first electronic quantum bits NV and second nuclear quantum bits CI. Furthermore, the quantum computers of these quantum computers (QC1 to QC16) each optionally have means (LD, LEDDRV) for generating pump radiation LB with a pump radiation wavelength λₚₘₚ. (see also section ZPL table) If necessary, this generation of the pump radiation LB can also take place centrally for one or more or all quantum computers (QC1 to QC16) of the quantum computer system QUSYS. In the latter case, the associated light source LD is then controlled by the external monitoring computer of the quantum computer system QUSYS, in contrast to FIG. 4. In FIG. 4, the external monitoring computer of the QUSYS quantum computer system corresponds to the central control unit ZSE.

Optionally, the quantum computer QC comprises said control device μC. The control device μC should be suitable and set up to receive commands and/or codes and/or code sequences via said data bus EXTDB, for example. The control device μC then optionally executes at least one of the following quantum operations by the quantum computer QC as a function of these received commands and/or received codes and/or received code sequences: MFMW, MFMWEE, MFMWCE, MFRWCC, FRWCC, RESQB, RESQBR, RESQRCE, MQBP, MCBP, SMQB, KQBQB, KQBCB, CNQBCBA, CNQBCBB, CNQBCBC, VQB, SCNQB. To this end, said control device μC generates and modulates the appropriate control signals on the m vertical lines (LV, LV1 to LVm) (with m as a positive integer), the n horizontal lines (LH, LH1 to LHn) (with n as a positive integer) and the associated shielding lines, depending on the command received, and to control the one light source LD or the multiple light sources LD. In addition, the control device μC detects any photocurrents Iₚₕ and controls an extraction voltage Vₑₓₜ for electronic readout.

This results in a suitable method for operating a quantum computer QC, as presented in this document.

In a first step, an initial file, hereinafter referred to as source code, is provided. Optionally, the source code consists of symbols that are arranged in an orderly sequence in the source code and can be read by a human. Predefined character strings are assigned to the basic operations that the μC control device can perform and which are referred to below as quantum assembler instructions. These quantum assembler instructions optionally include at least some, preferably all, of the already mentioned quantum operations of the quantum computer QC, i.e. in particular the quantum operations MFMW, MFMWEE, MFMWCE, MFRWCC, FRWCC, RESQB, RESQBR, RESQRCE, MQBP, MCBP, SMQB, KQBQB, KQBCB, CNQBCBA, CNQBCBB, CNQBCBC, VQB, SCNQB. Optionally, the quantum assembler commands also include assembler commands known from conventional computers.

Such quantum assembler instructions can, for example, be those of a 6502 processor and/or ARM processor, which can be easily implemented in the FPGA, for example as a μC control device:

| TYPE | MNEMONIC | COMMAND | MEANING |
|---|---|---|---|
| Load commands | LDA | Load Accumulator | Load accumulator |
| Load commands | LDX | Load X register | Load X register |
| Load commands | LDY | Load Y register | Load Y register |
| Storage commands | STA | STore Accumulator | Store Accumulator |
| Storage instructions | STX | STore X register | Store X register |
| Store commands | STY | STore Y register | Store Y register |
| Transfer commands | TAX | Transfer Accumulator to X | Copy Accumulator to X |
| Transfer commands | TAY | Transfer Accumulator to Y | Copy Accumulator to Y |
| Transfer commands | TXA | Transfer X to Accumulator | Copy X to Accumulator |
| Transfer commands | TYA | Transfer Y to Accumulator | Copy Y to Accumulator |
| Transfer commands | TSX | Transfer Stackpointer to X | Copy stack pointer to X |
| Transfer commands | TXS | Transfer X to Stackpointer | Copy X to Stackpointer |
| Logical operations | AND | And | Logical “And” |
| Logical operations | ORA | OR Accumulator | Logical “Or” |
| Logical operations | EOR | Exclusive OR | Logical “either/or” (XOR) |
| Arithmetic | ADC | ADd with Carry | Add with carry |
| operations | | | |
| Arithmetic | SBC | Subtract with Carry | Subtract with carry |
| operations | | | |
| Arithmetic | INC | INCrement | Increment memory cell |
| operations | | | |
| Arithmetic | DEC | DECrement | Decrement memory cell |
| operations | | | |
| Arithmetic | INX | INcrement X | Increment X register |
| operations | | | |
| Arithmetic | INY | INcrement Y | Increment Y register |
| operations | | | |
| Arithmetic | DEX | DEcrement X | Thinking increment X register |
| operations | | | |
| Arithmetic | DEY | DEcrement Y | Thinking increment Y register |
| operations | | | |
| Bitwise shift | ASL | Arithmetical Shift Left | Bitwise shift left |
| Bitwise shift | LSR | Logical Shift Right | Bitwise shift to the right |
| Bit-by-bit shift | ROL | ROtate Left | Bit-by-bit rotation to the left |
| Bit-by-bit shift | ROR | ROtate Right | Bit-by-bit rotation to the right |
| Comparison operations | CMP | CoMPare | comparisons with accumulator |
| Comparison operations | CPX | ComPare X | Comparisons with X |
| Comparison operations | CPY | ComPare Y | Comparisons with Y |
| Comparison operations | BIT | BIT test | BIT test with accumulator |
| Jump commands | JMP | JuMP | Unconditional jump |
| (unconditional) | | | |
| Jump commands | JSR | Jump to SubRoutine | Subroutine call (unconditional) |
| Jump commands | RTS | ReTurn from Subroutine | Return from subroutine |
| (mandatory) | | | |
| Jump commands | RTI | ReTurn from Interrupt | Return from interrupt |
| (unconditional) | | | |
| Jump commands | BCC | Branch on Carry Clear | Branches with deleted carry |
| (conditional) | | | flag |
| Jump commands | BCS | Branch on Carry Set | Branches with set carry flag |
| (conditional) | | | |
| Jump commands | BEQ | Branch on EQual | Branches with zero flag set |
| (conditional) | | | |
| Jump commands | BNE | Branch on Not Equal | Branches with deleted zero |
| (conditional) | | | flag |
| Branch commands | BPL | Branch on PLus | Branches with deleted negative |
| (conditional) | | | flag |
| Jump commands | BMI | Branch on MInus | Branches with negative flag |
| (conditional) | | | set |
| Jump commands | BVC | Branch on Overflow | Branches with deleted overflow |
| (conditional) | | Clear | flag |
| Jump commands | BVS | Branch on Overflow Set | Branches with set overflow |
| (conditional) | | | flag |
| Flag command | SEC | SEt Carry | Set carry flag |
| Flag command | CLC | CLear Carry | Delete carry flag |
| Flag command | SEI | SEt Interrupt | Set interrupt flag |
| Flag command | CLI | CLear Interrupt | Clear interrupt flag |
| Flag command | CLV | CLear oVerflow | Delete overflow flag |
| Flag command | SED | SEt Decimal | Set decimal flag |
| Flag command | CLD | CLear Decimal | Delete Decimal flag |
| Stack commands | PHA | PusH Accumulator | Place accumulator contents |
| | | | on stack |
| Stack commands | PLA | PuLl Accumulator | Get accumulator value from |
| | | | stack |
| Stack commands | PHP | PusH Processor status | Place status register on stack |
| Stack commands | PLP | PuLl Processor status | Get status register from stack |
| Special commands | NOP | No OPeration | No operation |
| Special commands | BRK | BReaK | Software interrupt |

However, this list is only an example of possible quantum assembler instructions. Each mnemonic is assigned a specific, unique value, called OP code in the following, which encodes the relevant operation for the C control device. Each quantum operation, in particular the quantum operations corresponding to the mnemonics MFMW, MFMWEE, MFMWCE, MFRWCC, FRWCC, RESQB, RESQBR, RESQRCE, MQBP, MCBP, SMQB, KQBQB, KQBCB, CNQBCBA, CNQBCBB, CNQBCBC, VQB, SCNQB, are also typically assigned such specific, unique numerical values, i.e. OP codes, here referred to as OP codes, in this case specifically quantum OP codes. If the control device μC finds such a predetermined numerical value when executing the program, the control device μC performs the relevant operation according to the OP code. If the value found encodes a quantum operation for manipulation by means of a quantum op-code encodes a quantum operation for manipulating and/or reading out the quantum state of a first electronic quantum bit QUB and/or the quantum state of a quantum dot NV of a quantum bit QUB and/or for manipulating and/or reading out the quantum state of a second nuclear quantum bit CQUB and/or the quantum state of a nuclear quantum dot CI of a second nuclear quantum bit CQUB, the control device μC performs the quantum operation assigned to this quantum OP code, whose mnemonic is assigned to the quantum OP code in question. The control device μC manipulates the quantum state of a first electronic quantum bit QUB and/or manipulates the quantum state of a quantum dot NV of a quantum bit QUB and/or manipulates the quantum state of a second nuclear quantum bit CQUB and/or manipulates the quantum state of a nuclear quantum dot CI of a second nuclear quantum bit CQUB and/or reads the quantum state of a first electronic quantum bit QUB and/or reads the quantum state of a quantum dot NV of a quantum bit QUB and/or reads the quantum state of a second nuclear quantum bit CQUB and/or reads the quantum state of a nuclear quantum dot CI of a second nuclear quantum bit CQUB.

In addition to the mnemonics of the possible operations and quantum operations, the source code also optionally includes data in the form of symbol strings. In a second step, a data processing system translates the source code into a second file, referred to below as a binary file. The binary file contains an ordered sequence of values. Some of these values optionally correspond to OP codes and quantum OP codes of the relevant mnemonics of the source code. The binary file may also contain data that was encoded as character strings in the source code. The source code may also include control commands for controlling the execution of this second step by the data processing system.

In a third step, the binary file is transferred to a memory (RAM, NVM) of the control device μC by means of a data connection, which optionally includes the external data bus EXTDB of the quantum computer QC, and/or a data carrier or another storage medium.

In a fourth step, a reset circuit or a monitoring device or the like causes the control device (μC to start executing the OP codes and quantum OP codes at a predetermined location in the memory. The OP codes and quantum OP codes can be assigned data on which the execution of the OP codes and/or quantum OP codes depends. In the case of quantum OP codes, such data assigned to a quantum OP code may be, for example, the above-mentioned parameters for quantum OP codes.

Optionally, each quantum op code thus symbolizes a manipulation and/or a readout of the quantum state of at least one first electronic quantum bit NV and/or the quantum state of a second nuclear quantum bit CI, which the control device μC performs during execution of the quantum op code with the aid of the first means (e.g. WFG, LDRV, LD, DBS, OS, XT, YT, KV, mWA, MW/RF-AWFG, PM, PV, PVC, MGx, MGy, MGz, MFSx, MFSx, MFSz, MSx, MSy, MSz, GDx, GDy, GDz, μC) and/or the second means (e.g. WFG, LDRV, LD, DBS, OS, XT, YT, KV, mWA, MW/RF-AWFG, PM, PV, PVC, MGx, MGy, MGz, MFSx, MFSx, MFSz, MSx, MSy, MSz, GDx, GDy, GDz, μC) and/or the third means (e.g. D, XT, YT, KV, OS, DBS, STM, CM1, PD, V, WFG, CIF, μC). In working out the invention, it was recognized that the accelerations and rotational accelerations and rotations exert an influence on the arrangement comprising the first electronic quantum bits QUB and their quantum dots NV and the second nuclear quantum bits CQUB and their nuclear quantum dots CI, which should be compensated in the case of a mobile quantum computer QC and on the other hand can also be used as measuring means of a sensor system. The essential finding of the document presented here is that it is advantageous to use two different quantum objects for two different types of quantum bits-here electronic quantum bits QUB with quantum dots NV and nuclear quantum bits CQUB with nuclear quantum dots CI. It is recognized that it is advantageous if the first type of quantum bits two different types of quantum bits is influenced by accelerations and/or rotational accelerations and/or rotations and if the second type of quantum bits is not influenced by accelerations and/or rotational accelerations and/or rotations.

In the present case, the first type of quantum bits is the type of electronic quantum bits QB with their quantum dots NV. In the present case, the second type of quantum bits is the type of nuclear quantum bits CQUB with their nuclear quantum dots CI.

In the present case, optionally, the first type of quantum bits is the type of electronic quantum bits QB with their quantum dots NV in the form of paramagnetic centers optionally in diamond and especially optionally in the form of NV centers in diamond. In the present case, the second type of quantum bits is optionally the type of nuclear quantum bits CQUB with their nuclear quantum dots CI in the form of isotopes with magnetic moment in a substrate D substantially optionally comprising isotopes without magnetic moment. In the present case, the second type of quantum bits is particularly optionally the type of nuclear quantum bits CQUB with their nuclear quantum dots CI in the form of ¹³C and/or ¹⁴N and/or ¹⁵N isotopes with magnetic moment in a substrate D comprising dimant. The diamond of the substrate D optionally comprises in the region of the quantum bits QUB and/or the nuclear quantum bits CQUB essentially optionally ¹²C isotopes without magnetic moment.

This makes it possible to detect these accelerations and/or rotational accelerations and/or rotations and compensate for them and is new compared to the state of the art.

In one embodiment of the proposal, the quantum computer QC has at least two first electronic quantum bits (QUB1, QUB2) with respective quantum dots (NV1, NV2), wherein the first first electronic quantum bit QUB1 with its first quantum dot NV1 can be coupled and/or entangled with the second first electronic quantum bit QUB2 with its second quantum dot NV2. This enables scaling of the first electronic quantum bits QUB1, QUB2 to form larger quantum registers QUREG.

In one embodiment of the proposal, the quantum computer QC has at least two first electronic quantum bits (QUB1, QUB2) with respective quantum dots (NV1, NV2), wherein the first electronic quantum bit QUB1 with its first quantum dot NV1 can be directly coupled and/or entangled with the second first electronic quantum bit QUB2 with its second quantum dot NV2 by means of dipole-dipole coupling. This enables scaling of the first electronic quantum bits QUB1, QUB2 to larger quantum registers QUREG and operation of the quantum computer QC at room temperature.

In one embodiment of the proposal, the quantum computer QC has at least a first electronic quantum bit QUB with a quantum dot NV and a second nuclear quantum bit CQUB with a nuclear quantum dot CI. Optionally, the first electronic quantum bit QUB or the quantum dot NV of the first electronic quantum bit QUB can be coupled and/or entangled with the second nuclear quantum bit CQUB and/or the nuclear quantum dot CI of the second nuclear quantum bit CQUB. This enables the nuclear spins to be used as second nuclear quantum bits CBUB with a significantly longer T2 time.

In one embodiment of the proposal, the quantum computer QC has at least two first electronic quantum bits (QUB1, QUB2) with respective quantum dots (NV1, NV2) at least two second nuclear quantum bits (CQUB1, CQUB2). Optionally, the first first electronic quantum bit QUB1 and/or its quantum dot NV1 can be coupled and/or entangled with the first second nuclear quantum bit CQUB1 and/or its nuclear quantum dot CI1. Optionally, the second first electronic quantum bit QUB2 and/or its quantum dot NV2 can be coupled and/or entangled with the second second nuclear quantum bit CQUB2 and/or its nuclear quantum dot CI2. Optionally, the first first electronic quantum bit QUB1 and/or its quantum dot NV1 is couplable and/or entanglable with the second first quantum bit QUB2 and/or its quantum dot NV. This makes the quantum computer QC scalable with respect to the number of the first electronic quantum bits QUB and the associated quantum dots NV and thus the number of the second nuclear quantum bits CQUB and the associated nuclear quantum dots CI. The quantum computer QC can then couple or entangle distant second nuclear quantum bits CQUB and their nuclear quantum dots CI with each other via the chains of first electronic quantum bits QUB and their quantum dots NV.

Optionally, the first electronic quantum bits QUB comprise paramagnetic centers and/or NV centers in diamond and/or SiV centers and/or TR1 centers and/or TR12 centers and/or LI centers and/or PbV centers and/or GeV centers in diamond as quantum dots NV. Here, NV centers in diamond as quantum dots NV of first electronic quantum bits QUB are particularly optional.

Optionally, one or more second nuclear quantum bits CQUB comprise nuclear spins of ¹³C isotopes and/or N isotopes and/or ¹⁴¹⁵N isotopes and/or other isotopes with nuclear spin as nuclear quantum dots CI of second nuclear quantum bits CQUB.

Optionally, the quantum computer QC according to the proposal is set up to determine the coupling frequencies and/or coupling phase positions of the electromagnetic radiation for manipulating pairs of coupleable in each case two first electronic quantum bits QUB1, QUB2 and their quantum dots NV1, NV2 with one another and to store them as coupling fundamental frequencies and/or coupling phase positions to be used. Optionally, the quantum computer QC uses electromagnetic radiation of the coupling fundamental frequency of the respective pair of coupleable respective first two electronic quantum bits QUB1, QUB2 and their quantum dots NV1, NV2 when manipulating these respective pairs of coupleable respective first two electronic quantum bits QUB1, QUB2 and their quantum dots NV1, NV2. Optionally, the electromagnetic radiation of the coupling fundamental frequency of the respective pair of couplable two first electronic quantum bits QUB1, QUB2 and their quantum dots NV1, NV2 has, in addition to the coupling fundamental frequency, the coupling fundamental phase position or a phase position which depends on the coupling fundamental phase position.

Optionally, the quantum computer QC according to the proposal is set up to determine the coupling frequencies and/or coupling phase positions of the electromagnetic radiation for manipulating couplable pairs each comprising a first electronic quantum bit QUB and its quantum dot NV and a second quantum bit CQUB and its nuclear quantum dot CI and to store them as coupling fundamental frequencies and/or coupling fundamental phases to be used. Optionally, the quantum computer QC uses electromagnetic radiation of the coupling fundamental frequency of the respective coupleable pairs of a first electronic quantum bit QUB and its quantum dot NV and a second quantum bit CQUB and its nuclear quantum dot CI when manipulating these respective coupleable pairs of a first electronic quantum bit QUB and its quantum dot NV and a second quantum bit CQUB and its nuclear quantum dot CI. Optionally, the electromagnetic radiation of the coupling fundamental frequency of the respective couplable pair of a first electronic quantum bit QUB and its quantum dot NV and a second quantum bit CQUB and its nuclear quantum dot CI has, in addition to the coupling fundamental frequency, the coupling fundamental phase position or a phase position which depends on the coupling fundamental phase position.

Optionally, the quantum computer QC according to the proposal is set up to determine the coupling frequencies and/or coupling phase positions of the electromagnetic radiation for manipulating pairs of coupleable respectively two second nuclear quantum bits (CQUB1, CQUB2) and/or their respective nuclear quantum dots (CI1, CI2) with each other and to store them as coupling fundamental frequencies and/or coupling fundamental phases to be used. Optionally, the quantum computer QC uses electromagnetic radiation of the coupling fundamental frequency of the respective pair of coupleable respectively two second nuclear quantum bits (CQUB1, CQUB2) and/or their respective nuclear quantum dots (CI1, CI2) when manipulating these respective pairs of coupleable respectively two second nuclear quantum bits (CQUB1, CQUB2) and/or their respective nuclear quantum dots (CI1, CI2). Optionally, the electromagnetic radiation of the coupling fundamental frequency of the respective pair of coupleable in each case two second nuclear quantum bits (CQUB1, CQUB2) and/or their respective nuclear quantum dots (CI1, CI2) has, in addition to the coupling fundamental frequency, the coupling fundamental phase position or a phase position which depends on the coupling fundamental phase position.

Optionally, the quantum computer QC comprises one or more rotation sensors RTS for detecting rotation values and/or rotational acceleration values for rotations about one axis or one or more rotation sensors RTS for detecting rotation values and/or rotational acceleration values for rotations about two axes or one or more rotation sensors RTS for detecting rotation values and/or rotational acceleration values for rotations about three axes. The rotation sensor RTS of the quantum computer QC optionally detects the current orientation of the quantum computer QC in the form of one or more orientation measurement values. The rotation sensor RTS of the quantum computer QC optionally detects the current rotation speed of the quantum computer QC in the form of one or more rotation values. The rotation sensor RTS of the quantum computer QC optionally detects the current rotational acceleration of the quantum computer QC in the form of one or more rotational acceleration values.

Optionally, the quantum computer QC has device parts which determine and/or allow the determination of alignment values and/or rotation values and/or rotational acceleration values and/or acceleration values for the quantum computer QC.

As an option, the QC quantum computer has device components that Alignment measurement values for rotations about one axis and/or two axes (AX1, AX2) and/or three axes and/or Rotation values for rotations about one axis and/or two axes (AX1, AX2) and/or three axes and/or Rotational acceleration values for rotations around one axis and/or around two axes (AX1, AX2) and/or three axes Rotational acceleration values and/or Acceleration values for one translational degree of freedom and/or two translational degrees of freedom and/or three translational degrees of freedom for the quantum computer QC and/or allow such a determination.

Optionally, the quantum computer QC therefore has alignment measurement values and/or rotation values and/or rotational acceleration values and/or acceleration values for the quantum computer QC and/or measurement values that allow these values to be determined during its quantum computer operation. Optionally, the quantum computer QC determines during its quantum computer operation:
from known alignment measurement values and/or
from known rotation values and/or
from known rotational acceleration values and/or
from known acceleration values and/or
from known speed values and/or
from known location coordinates and/or
from card information of an electronic card and/or
from route information about the future route of a vehicle of which the quantum computer QC is a part,
for the quantum computer QC
future alignment measurements and/or
future rotation values and/or
future rotational acceleration values and/or
future acceleration values and/or
future speed values and/or
future location coordinates.

Optionally, the quantum computer QC uses
the future alignment measured values and/or
the future rotation values and/or
the future rotational acceleration values and/or
the future acceleration values and/or
the future speed values and/or
the future location coordinates and/or
of coupling fundamental frequencies and/or
Coupling principles
future coupling base frequencies and/or future coupling base phases for a future point in time.

Optionally, the quantum computer QC uses these future coupling fundamental frequencies and/or future coupling fundamental phases at the future point in time as coupling fundamental frequencies and/or coupling fundamental phases.

Optionally, the quantum computer QC is set up to determine, as a function of the alignment measurement values and/or of the rotation values and/or of the rotation acceleration values and/or of the acceleration values, the coupling frequencies and coupling phase positions to be used between the pairs of coupleable two electronic quantum bits (QUB1 QUB2) and/or their quantum dots (NV1, NV2) among each other from the coupling fundamental frequencies and/or coupling fundamental phases to be used for these pairs of coupleable two electronic quantum bits (QUB1 QUB2) and/or their quantum dots (NV1, NV2). This enables the operation of a mobile quantum computer QC on the basis of paramagnetic centers as quantum dots NV of electronic quantum bits QUB and on the basis of nuclear quantum bits CQUB and their nuclear quantum bits CI.

Optionally, the quantum computer QC is set up to determine the coupling frequencies to be used between the coupleable pairs of a first electronic quantum bit QUB and/or its quantum dot NV and a second nuclear quantum bit CQUB and/or its nuclear quantum dot CI from the coupling fundamental frequencies and coupling fundamental phases to be used, as a function of the measured alignment values and/or of the rotation values and/or of the rotation acceleration values and/or of the acceleration values. This enables the operation of a mobile quantum computer QC on the basis of paramagnetic centers as quantum dots NV of electronic quantum bits QUB and on the basis of nuclear quantum bits CQUB and their nuclear quantum bits CI.

Optionally, the quantum computer QC is set up to determine the coupling frequencies to be used between the pairs of coupleable two second nuclear quantum bits CI in each case from the fundamental coupling frequencies to be used, as a function of the measured alignment values and/or of the rotation values and/or of the rotation acceleration values and/or of the acceleration values and/or velocity values and/or location coordinates of the quantum computer QC.

Optionally, the quantum computer QC is set up to manipulate the first electronic quantum bits QUB and/or their quantum dots NV and/or second nuclear quantum bits CQUB and/or their nuclear quantum bits CI by means of the first means (e.g. WFG, LDRV, LD, DBS, OS, XT, YT, KV, mWA, MW/RF-AWFG, PM, PV, PVC, MGx, MGy, MGz, MFSx, MFSx, MFSz, MSx, MSy, MSz, GDx, GDy, GDz, μC) and/or the second means (e.g. WFG, LDRV, LD, DBS, OS, XT, YT, KV, mWA, MW/RF-AWFG, PM, PV, PVC, MGx, MGy, MGz, MFSx, MFSx, MFSz, MSx, MSy, MSz, GDx, GDy, GDz, μC) the coupling frequencies thus determined to be used.

In a further embodiment, the quantum computer QC according to the proposal is optionally set up to determine the coupling frequencies and/or coupling phase positions between pairs of coupleable two respective first electronic quantum bits (QUB1, QUB2) and/or their quantum dots (NV1, NV2) at a first point in time and to store them as coupling fundamental frequencies and/or coupling fundamental phases. In this further embodiment, the quantum computer QC according to the proposal is optionally set up to determine the coupling frequencies and/or coupling phase positions between couplable pairs each comprising a first electronic quantum bit QUB and/or its quantum dot NV and a second nuclear quantum bit CQUB and/or its nuclear quantum dot CI at a first point in time and to store them as coupling fundamental frequencies and/or coupling fundamental phases. In this further embodiment, the quantum computer QC according to the proposal is optionally set up to determine the coupling frequencies and/or coupling fundamental phases between pairs of coupleable in each case two second nuclear quantum bits (CQUB1, CQUB2) and/or their nuclear quantum dots (CI1, CI2) with respect to one another at the first instant and to store them as coupling fundamental frequencies and/or coupling fundamental phases. In this further embodiment, the quantum computer QC according to the proposal is optionally set up to determine the coupling frequencies and/or coupling phase positions between pairs of coupleable in each case two first electronic quantum bits (QUB1, QUB2) and/or their quantum dots (NV1, NV2) with respect to one another at a second instant after the first instant and to use them as coupling frequencies and/or coupling phase positions or to store them. In this further embodiment, the quantum computer QC according to the proposal is optionally set up to determine the coupling frequencies and/or coupling phase positions between couplable pairs each comprising a first quantum bit QUB and its quantum dot NV and a second quantum bit CQUB and/or its nuclear quantum dot CI at a second instant after the first instant and to use them as coupling frequencies and/or coupling phase positions or to store them. In this further embodiment, the quantum computer QC according to the proposal is optionally set up to determine the coupling frequencies and/or coupling phase positions between pairs of coupleable in each case two second nuclear quantum bits (CQUB1, CQUB2) and/or their nuclear quantum dots (CI1, CI2) with respect to one another at a second instant after the first instant and to use them as coupling frequencies and/or coupling phase positions or to store them. In this further embodiment, the proposed quantum computer QC is optionally arranged to determine the current alignment of the quantum computer QC in the form of one or more alignment measurement values and/or in the form of one or more rotation values and/or in the form of one or more rotation acceleration values and/or in the form of one or more acceleration values from one or more coupling fundamental frequencies and/or coupling fundamental phase positions and one or more coupling frequencies and/or coupling phase positions. This enables the quantum computer QC to be used as a gyroscope.

In another embodiment, the quantum computer QC or parts of the quantum computer QC or an arrangement of first electronic quantum bits QUB and/or of their quantum dots NV and/or of second nuclear quantum bits CQUB and/or of their nuclear quantum dots CI and/or an arrangement of paramagnetic centers of the quantum computer QC are mounted rotatably about one axis or mounted rotatably about two axes (AX1, AX2) or mounted rotatably about three axes.

In a further embodiment of the quantum computer QC, the quantum computer QC has one or more energy couplings (EK1, EK2). An energy coupling of the energy couplings (EK1, EK2) is optionally set up to supply the quantum computer QC or parts of the quantum computer QC or the arrangement of first electronic quantum bits QUB and/or of their quantum dots NV and/or of second nuclear quantum bits CQUB and/or of their nuclear quantum dots CI and/or the arrangement of paramagnetic centers of the quantum computer QC with electrical or electromagnetic energy and/or radiant energy. For the purposes of this document, the radiant energy of the pump radiation LB is electromagnetic energy, in particular for supplying the quantum dots NV of the quantum dots NV with energy. In one of these embodiments of the quantum computer QC, the energy supply is optionally set up for this purpose, that a rotation of the quantum computer QC or of parts of the quantum computer QC or of the arrangement of first electronic quantum bits QUB and/or of quantum dots NV and/or of second nuclear quantum bits CQUB and/or of their nuclear quantum dots CI and/or of the arrangement of paramagnetic centers of the quantum computer QC about an axis (AX1, AX2) does not have to rotate the energy supply (LDV, TS, BENG, SRG, BENG2, SRG2, LD, LDRV). Optionally, the energy coupling (EK1, EK2) is set up to transport the energy from the energy supply (LDV, TS, BENG, SRG, BENG2, SRG2, LD, LDRV) to the quantum computer QC in such a way, that a rotation of the quantum computer QC or of parts of the quantum computer QC or of the arrangement of first electronic quantum bits QUB and/or of their quantum dots NV and/or of second nuclear quantum bits CQUB and/or of their nuclear quantum dots CI and/or of paramagnetic centers of the quantum computer QC with respect to the energy supply (LDV, TS, BENG, SRG, BENG2, SRG2, LD, LDRV) by any angle is possible.

In a further embodiment of the quantum computer QC, the energy coupling (EK1, EK2) comprises, for example, electrically conductive slip rings and sliding contacts for this energy transfer. In a further embodiment of the quantum computer QC, the energy coupling (EK1, EK2) is optionally set up to transfer the energy of the energy supply (LDV, TS, BENG, SRG, BENG2, SRG2, LD, LDRV) by means of inductive coupling to the quantum computer QC or to parts of the quantum computer QC or to the arrangement of first electronic quantum bits QUB and/or of their quantum dots NV and/or of second nuclear quantum bits CQUB and/or of their nuclear quantum dots CI and/or of paramagnetic centers of the quantum computer QC. In the further embodiment of the quantum computer QC, the energy coupling (EK1, EK2) is optionally set up to transfer the energy of the energy supply (LDV, TS, BENG, SRG, BENG2, SRG2, LD, LDRV) by means of electromagnetic waves and/or electromagnetic radiation to the quantum computer QC or to parts of the quantum computer QC or to the arrangement of first electronic quantum bits QUB and/or of their quantum dots NV and/or of second nuclear quantum bits CQUB and/or of their nuclear quantum dots CI and/or of paramagnetic centers of the quantum computer QC. In the sense of the document presented here, an irradiation of first electronic quantum bits QUB and/or their quantum dots NV and/or the arrangement of second nuclear quantum bits CQUB and/or their nuclear quantum dots CI and/or the arrangement of paramagnetic centers of the quantum computer QC with an irradiation of the quantum dots NV and/or the arrangement of second nuclear quantum bits CQUB and/or their nuclear quantum dots CI and/or the arrangement of paramagnetic centers of the quantum computer QC with a pump radiation LB an energy supply of the arrangement of first electronic quantum bits QUB and/or of their quantum dots NV and/or of second nuclear quantum bits CQUB and/or of their nuclear quantum dots CI and/or of paramagnetic centers of the quantum computer QC.

In a further embodiment of the quantum computer QC, the quantum computer QC is mounted rotatably about one axis or two axes (AX1, AX2) or three axes by means of a gimbal suspension KAH. Optionally, the quantum computer QC in this embodiment comprises one or more gyroscopes KR or is mechanically connected to these gyroscopes KR, so that the orientation of the quantum computer QC is not changed by rotations of the gimbal suspension KAH about this one axis or these two axes (AX1, AX2, AX3) or these three axes.

In a further embodiment of the quantum computer QC, one or more gyros of the gyros KR have a drive. The one gyroscope KR or the several gyroscopes KR and the drive of the one gyroscope KR or the drives of the gyroscopes KR in the sense of the document presented here are optionally a part of the quantum computer QC.

During the preparation of the document presented here, it was recognized that the use of a quantum computer QC as described above as a gyrometer is conceivable. The document presented here thus describes a gyrometer comprising a quantum computer QC. Such a gyrometer based on a quantum computer QC is characterized by a particular sensitivity. To determine the gyrometer measurement values of the gyrometer, the quantum computer QC of the gyrometer optionally determines one or more alignment measurement values and/or one or more rotation values and/or one or more rotational acceleration values and/or one or more acceleration values and/or one or more velocity values and/or one or more location coordinates of the quantum computer QC.

Optionally, the quantum computer QC is set up to determine the current alignment of the quantum computer QC in the form of one or more alignment measurement values and/or in the form of one or more nth-order temporal derivatives of alignment measurement values and/or in the form of one or more nth-order temporal integrals of alignment measurement values and/or in the form of filtered values of alignment measurement values by determining one or more fundamental coupling frequencies and/or fundamental coupling phase positions and by determining one or more coupling frequencies and/or coupling phase positions.

Optionally, the quantum computer QC is set up to determine the current rotational speed of the quantum computer QC in the form of one or more rotational values and/or in the form of one or more nth-order temporal derivatives of rotational values and/or in the form of one or more nth-order temporal integrals of rotational values and/or in the form of filtered values of rotational values by determining one or more fundamental coupling frequencies and/or fundamental coupling phase positions and by determining one or more coupling frequencies and/or coupling phase positions.

Optionally, the quantum computer QC is set up for this purpose, to determine the current rotational acceleration of the quantum computer QC in the form of one or more rotational acceleration values and/or in the form of one or more nth-order temporal derivatives of rotational acceleration values and/or in the form of one or more nth-order temporal integrals of rotational acceleration values and/or in the form of filtered values of rotational acceleration values by determining one or more fundamental coupling frequencies and/or fundamental coupling phase positions and by determining one or more coupling frequencies and/or coupling phase positions.

Optionally, the quantum computer QC is set up to determine the current acceleration of the quantum computer QC in the form of one or more acceleration values and/or in the form of one or more nth-order temporal derivatives of acceleration values and/or in the form of one or more nth-order temporal integrals of acceleration values and/or in the form of filtered values of acceleration values by determining one or more fundamental coupling frequencies and/or fundamental coupling phase positions and by determining one or more coupling frequencies and/or coupling phase positions.

Optionally, the quantum computer QC is set up to determine the current velocity of the quantum computer QC in the form of one or more velocity values and/or in the form of one or more nth-order temporal derivatives of velocity values and/or in the form of one or more nth-order temporal integrals of velocity values and/or in the form of filtered values of velocity values by determining one or more fundamental coupling frequencies and/or fundamental coupling phase positions and by determining one or more coupling frequencies and/or coupling phase positions.

Optionally, the quantum computer QC is set up to determine the current location coordinate of the quantum computer QC in the form of one or more location coordinate values and/or in the form of one or more nth-order temporal derivatives of location coordinate values and/or in the form of one or more nth-order temporal integrals of location coordinate values and/or in the form of filtered values of location coordinate values by determining one or more fundamental coupling frequencies and/or fundamental coupling phase positions and by determining one or more coupling frequencies and/or coupling phase positions.

Optionally, the quantum computer QC is set up to determine measured values of physical parameters, in particular such as orientation, angular velocity, angular acceleration, gravitational acceleration, acceleration, speed and/or location coordinate, by executing quantum op codes.

Gate Control of NV Centers and Nuclear Spins that are Coupled to them

For the purposes of the document disclosed herein, the NV center refers to the electron configuration of the NV center. The nuclear spin of the nitrogen atom of the NV center is named separately.

### Definition of the Term Gate

According to the disclosure, the term “gate” may optionally be understood as follows:

Gates in the sense of the document presented here are methods in the form of process step sequences which serve to manipulate readable states with the aim of being able to build complete Turing machines from temporally sequential or parallel sequences of these gates. A Turing machine in the sense of the document presented here is thus a sequence of such gates which a quantum computer executes and with which the quantum computer manipulates and/or reads out the state of quantum bits and/or nuclear quantum bits of the quantum computer.

Such a complete Turing machine based on such a quantum computer in the sense of the document presented here allows the solution of all computable tasks according to the Turing-Church conjecture. Classical computers are Turing complete. According to the Gottesman-Knill theorem, a quantum computer is Turing complete if the following unitary gates can be realized:
Clifford Gatter (Paul: X,Y,Z),
H Phase gate S (T) and
the 2 quantum bit gate CNOT.

A Clifford gate is a group of gates V (let V be an element of the set of Clifford gates) with the property U=WVW⁺ with U and W also as elements of the set of Clifford gates.

In quantum computing and quantum information theory, Clifford gates are the elements of the Clifford group, a set of mathematical transformations that normalize the n-qubit Pauli group, i.e. map tensor products of Pauli matrices to tensor products of Pauli matrices by conjugation. The term was introduced by Daniel Gottesman and is named after the mathematician William Kingdon Clifford.[1] Quantum circuits consisting only of Clifford gates can be efficiently simulated with a classical computer due to the Gottesman-Knill theorem.

The Clifford gates (Paul: X,Y,Z) are redundant. For example, X=HZH⁺.

A Clifford gate (Paul: X,Y,Z) can therefore be dispensed with. The state of the art also refers to these three gates 1 to 3 as universal gates. The quantum computer can reproduce these elementary gates by means of operations that induce spin rotations. However, the following should be noted here:

The X gate represents a mirror image with a positive mapping determinant. The quantum computer based on NV centers cannot implement an X gate. The X gate is one of the Pauli matrices that mirrors the spin by 180°. (hereinafter referred to as quantum bit flip) However, the quantum computer can realize an iX gate. I.e. with each gate operation, a phase shift of 90° is added (complex factor i) With an NV center, the quantum computer executes the X gate by generating a microwave signal with the resonance energy (resonance frequency) of a defined temporal length and amplitude (Rabi frequency=γ_{NV} B with γ_{NV} as the gyromagnetic moment of the NV center and B the magnetic component of the electromagnetic wave, which acts perpendicular to the direction of the electron spin of the electron configuration of the NV center) Such a π pulse then has the temporal length 1/(2γ_{NV} B) (this corresponds to 180°).

Rotations always have a negative determinant. The rotations therefore generate an additional general phase, but this has no significance because it cannot be measured. However, this phase must be taken into account during the calculation, as the phases can add up. The CROT gate is a unitary matrix that rotates the spin by an angle θu an axial surface in the four-dimensional space of the Bloch sphere. (referred to below as quantum bit rotation or simply CROT) Here too, a phase shift is added with each gate operation. With an NV center, the quantum computer executes the CROT gate by generating a microwave signal with the resonance energy (resonance frequency) of a defined temporal length and amplitude (γ_{NT} B with γ_{NV} as the gyromagnetic moment of the NV center and B the magnetic component of the electromagnetic wave, which acts perpendicular to the direction of the electron spin of the electron configuration of the NV center) Such as θ pulse then has the temporal length 1/(2γ_{NV} B) (θ/180°). If the phase of the microwave actuation (for nuclear spins of the radio frequency actuation) is shifted by 90°, the CROT actuation, if it previously caused a rotation around the X-axis, changes to an actuation that causes a rotation around the Y-axis. The microwave phase position of the microwave control therefore determines the axis of rotation of a CROT operation. In the case of nuclear spins, the radio wave phase position determines the axis of rotation of a CROT operation for the nuclear spin.

A rotation of 180° in the x-axis is therefore not an X but an iX gate! Precisely, a CROT is not a CNOT but a CiNOT. To define a CNOT, an additional Z(ζ/2) (Clifford gate (Paul,Z) with time length π/2) must be inserted before or after the execution of the CROT command and act on the conditional partner quantum bit. The conditional partner quantum bit of an NV center can be a nuclear spin in the vicinity of the NV center or another NV center in the vicinity of the NV center.

An exemplary system for explanation may include, for example, a first NV center and a second NV center and a third NV center, wherein the first NV center and the third NV center may in turn each couple to respective nuclear spins associated with exactly one of these two exemplary NV centers. The first NV center and the second NV center and the third NV center are arranged as a linear chain, wherein the first NV center can only couple with the third NV center via the second NV center as an ancilla bit and cannot couple directly. If the quantum state of the second NV center is now brought to the state m=0 by a quantum operation, this quantum operation decouples the first NV center from the third NV center. If the quantum state of the second NV center is brought into the state m=+1 or m=−1 by another quantum operation, the quantum operation can couple the first NV center with the third NV center.

A CROT operation around the Z-axis can be realized by a −π/2-rotation around the Y-axis and then an X-gate and then a +π/2-rotation around the Y-axis.

Initially, only the Z-axis is determined by the flux density of the magnetic field. With the first CROT operation, the quantum computer arbitrarily determines the X-axis for the NV center. Although this reference can be freely selected, it must be maintained as a reference (phase stability) during a quantum calculation.

In addition to executing these gates, the quantum computer must set its quantum bits and its nuclear quantum bits to a defined initial state at the start of a calculation and, after all operations have been carried out, the quantum computer must set its relevant quantum bits and/or its relevant nuclear quantum bits. If all three conditions are met, this quantum computer can perform any calculations and is then considered Turing-complete.

The goal of every universal quantum computer is therefore to achieve the universal gates, as well as the conditions for initializing and reading out the quantum bits and nuclear quantum bits with high quality.

### Basics:

### The Hamiltonian for NV Centers

The Hamiltonian for NV centers as quantum bits is:

$$H = D * {m}^{2} += {γ}_{NV} * m * B$$

Here are
D for zero-field splitting,
γ_{NV} for the gyromagnetic ratio of the NV center,
m for the quantum number,
B for an external magnetic field acting on the NV center in the NV axis.

If the external magnetic field acting on the NV center is not aligned in the direction of the NV axis, m is typically not a good quantum number due to interband mixing.

### The Hamiltonian for Atomic Nuclei as Nuclear Quantum Bits

The Hamiltonian for atomic nuclei as nuclear quantum bits includes a Zeeman component and possibly a quadrupole component (e.g. ¹⁴N). The Hamiltonian for atomic nuclei as nuclear quantum bits is:

$$H = γ * I * B + Q * {I}^{2} + {H}_{NV\_nucleus} ,$$

Here are
γ for the gyromagnetic ratio,
I for the magnetic quantum number,
B for the external magnetic field acting on the nuclear spin,
Q For the quadrupole component independent of B
H_{NV_nucleus} Determines the coupling strength between nucleus and NV by hyperfine WW. The hyperfine term can be split into a parallel part and a perpendicular part. Only the parallel term is important for the displacement.

For better differentiation, the document presented here designates the magnetic quantum number of atomic nuclei as I in the document presented here.

On the magnetic quantum number m of the negatively charged NV center

The magnetic quantum number m of the negatively charged NV center can assume the three values −1, 0, +1. For m=0, the NV center does not generate a magnetic field! The NV₀ state only has a single state.

γ_{NV}=The document presented here names 28.130 MHz/mT as the typical value of the gyromagnetic ratio. The document presented here names D=2.87 GHz as the typical value of the zero-field splitting.

### Magnetic Quantum Number I of the Nuclei:

The NV centers are embedded in a diamond crystal which essentially comprises carbon atoms in the form of essentially ¹²C isotopes without spin and without magnetic moment. A few atoms in the diamond lattice of the diamond crystal are optionally C isotopes. ¹³¹³C isotopes have the spin −½ or +½. The ¹³C isotopes typically have no quadrupole moment. Therefore, for m=0, with ¹³C atomic nuclei strongly coupled to the NV center and a low external magnetic field, the Zeeman component due to the external magnetic field is negligible compared to the hyperfine interaction. For the purposes of the paper presented here, a low external magnetic field is a magnetic field with a magnetic flux density at the location of the nuclear quantum bit in question, as at the location of the nuclear spin in question, less than 100 mT. Since the atomic nucleus of a quantum bit has only a dipole part, the atomic nucleus of the nuclear quantum bit typically shows no interaction with the NV center associated with it if the NV center is in a state in which it has the quantum number m=0.

The document presented here names γ_{13C}=10.7 kHz/mT as a typical value for the gyromagnetic ratio of an atomic nucleus of a ¹³C isotope, which the quantum computer uses as a nuclear quantum bit.

The document presented here names Q=0 as a typical value for the quadrupole component Q independent of B of a ¹³C isotope, which the quantum computer uses as a nuclear quantum bit.

The transition of the states, e.g. m=0 to m=1, is described by the Rabi frequency Ω. The following applies:

$$Ω = γ * {B}_{0} .$$

Here, B₀ is the magnetic component of the electromagnetic RF wave radiated into the respective quantum bit of the quantum computer with the resonance frequency resulting from the splitting of the states. This field is a vector field. The quantum computer must adapt the direction of the field to the orientation of the conductor track when generating the RF wave. The quantum computer typically uses RF (radio frequency) to control the respective nuclear spins of the atomic nuclei (¹³C isotopes). The quantum computer optionally uses MW (microwaves) to control the respective NV centers.

The strength of the hyperfine interaction depends on the lattice position of the nuclear spins relative to the nitrogen atom (N) and to the vacancy (V) within the diamond lattice. The document presented here specifies the following exemplary values for the radio frequency of the electromagnetic radiation for coupling the NV center with the nuclear spin of the associated coupled nucleus, which the quantum computer uses as a nuclear quantum bit, depending on the lattice position (see FIG. 18):

126 MHz (J-position directly next to the nitrogen), 13.8 MHz (A-position), 13.2 MHz (B-position), 6.5 MHz (D-position), 4.2 MHz (E-position, F-position), 2.6 MHz (G-position, H-position), 0.8 MHz (weakly coupled)

The document presented here explicitly points out that in later operation the quantum computer must add or subtract the Zeeman splitting depending on the orientation of the ¹³C isotopes relative to the NV center. The document presented here therefore proposes to determine the values for the Zeeman splitting in an initialization phase of the quantum computer and to store these values and/or the sums or difference values in a memory of the control device (μC) of the quantum computer (QC) and to keep them ready for the operation of the quantum computer (QC). In the course of developing the technical teaching presented here, it was determined that the Zeeman splitting in a magnetic field with a magnetic flux density of 50 mT at the location of the pair of NV center and nuclear spin is typically approx. 0.5 MHz.

In addition to the aforementioned ¹³C-carbon isotopes, whose nuclear spins the quantum computer can use as nuclear quantum bits by means of the NV center-based quantum bits, the quantum computer can also use the nuclear spins of the nitrogen atoms of the NV centers as nuclear quantum bits.

In addition to the dipole component, the ¹⁴N nitrogen isotope also has a quadrupole component and interacts with the electron spin of the electron configuration of the assigned NV center even in the m=0 state of this NV center.

The document presented here names γ_{14N}3.07 kHz/mT as a typical value for the gyromagnetic ratio of an atomic nucleus of an ¹⁴N-nitrogen isotope, which the quantum computer uses as a nuclear quantum bit.

The document presented here names
Q.=4945 kHz as a typical value for the quadrupole component Q independent of B of an ¹⁴N-nitrogen isotope, which the quantum computer uses as a nuclear quantum bit.

FIG. 19 shows the shift in energy splitting due to hyperfine WW hf Zeeman, nZ and quadrupole Q.
Q=Quadrupole proportion
hf=hyperfine interaction
nZ=nuclear Zeeman fission

The document presented here explicitly points out that for the state of the NV center with quantum number m=0, typically no hyperfine interaction takes place.

### Coupling

The document presented here distinguishes between atomic nuclei strongly coupled to the assigned NV center via their nuclear spin and atomic nuclei weakly coupled to the NV center via their nuclear spin.

Nuclei strongly coupled to the associated NV center are defined by a larger coupling strength (in MHz*h) compared to the line width of the resonance line of the NV center at the transition from m=0 to m=1 (in MHz*h). h is Planck's quantum of action.

The classification of the coupling strength therefore always refers to the minimum line width of the resonance line of the respective NV center. While the coupling strength between the nuclear spin of the atomic nucleus and the electron spin of the NV center depends on the position of the nuclear spin of the atomic nucleus relative to the NV center and on the distance of the nuclear spin of the atomic nucleus to the NV center in the crystal lattice of the diamond crystal and cannot be changed, the line width of the resonance line between two defined states can be increased depending on the amplitude, duration of the effect, shape, etc. The minimum achievable line width (lifetime of the state) is influenced by the crystal properties. The minimum achievable linewidth (lifetime of the state) is influenced by the crystal properties, the temperature of the crystal and the magnetic spins in the vicinity of the NV center and the associated nuclear spins of the nuclear quantum bits, as well as by generally externally and internally alternating magnetic fields.

Essentially, the hyperfine interaction of the NV center influences (hyperfine WW>linewidth) in a small or moderate magnetic field (<300-500 mT depending on the coupling strength) the coupling strength of strongly coupled nuclear spins of atomic nuclei. The gates executed by the quantum computer are therefore directly dependent on the spin state of the NV centers coupled to the nuclear ones. This area is also referred to as the freezing zone. Since nuclear spin-nuclear spin quantum bit flips, which can lead to decoherence, are almost completely suppressed by the NV centers with m=+1, m=−1 (energy shift between the spins). The nuclear spins of the atomic nuclei used as nuclear quantum bits are frozen for a state of the NV center assigned to them with m=0. For such a state of the NV center with m=0, a sufficiently strong external magnetic field can prevent these nuclear spin quantum bit flips.

The direct coupling between the nuclear spins of the atomic nuclei is low. The direct coupling between the nuclear spins of the atomic nuclei is small compared to the coupling between the NV center assigned to the respective atomic nucleus and the spin of this atomic nucleus. The direct coupling between the nuclear spins of the atomic nuclei therefore takes place on long time scales in the us to ms range. During the elaboration of the technical teaching of the document presented here, it was recognized that the influence of the direct coupling between the nuclear spins of the atomic nuclei can generally be neglected.

For nuclear spins of such weakly coupled atomic nuclei of the nuclear quantum bits that are weakly coupled to the respective NV center, the splitting due to the hyperfine interaction is negligible compared to the effect of the external magnetic field. The weakly coupled atomic nuclei therefore behave in exactly the opposite way to the strongly coupled atomic nuclei in this respect.

The document proposed here thus suggests a quantum computer comprising NV centers in diamond as quantum bits and comprises nuclear spins strongly bound to NV centers of atomic nuclei strongly coupled to these NV centers as nuclear quantum bits, which the paper presented hereafter refers to as strong nuclear quantum bits, and nuclear spins weakly bound to NV centers of atomic nuclei weakly coupled to these NV centers as nuclear quantum bits, which the paper presented hereafter refers to as weak nuclear quantum bits.

The resonance energy for the coupling of these weakly coupled nuclear spins of these atomic nuclei weakly coupled to the respective NV center is thus only weakly dependent on the respective spin state of the electron configuration of the NV center weakly coupled to this nuclear spin.

### Initialization

The following is an explanation of an optional process for initializing a quantum computer:

The NV centers are optionally initialized via a laser pulse as pump radiation with a defined temporal length and intensity. This temporal length depends on the coupling of the laser light of the laser and thus on the depth of the NV centers in the substrate measured from the surface of the diamond crystal. In addition, the focusing conditions influence the intensity of the laser's pump radiation at the location of the respective NV center. Since the NV center forms a dipole, the polarization angle is another determining factor. The NV center (formed by a nitrogen atom N- and a defect V) defines an NV center axis. In developing the technical teaching of this document, linearly polarized light was used as pump radiation for the NV centers. Both the linear polarization of the irradiated light should optionally be perpendicular to the NV center axis. A response with circularly polarized light is also possible if the pointing vector of the light is parallel to the axis of the NV center. In this case, two rotations can be performed simultaneously. The fluorescent radiation emitted by the NV center, if applicable, typically has a linear polarization with a polarization direction perpendicular to the NV center axis. Optionally, the microwave radiation for manipulating the electron spin of the electron configuration of the NV center is linearly polarized, whereby the polarization direction is also optionally perpendicular to the NV center axis. As before, manipulation can also be performed with circularly polarized electromagnetic waves (microwave) whose pointing vector is parallel to the NV center axis. In this case, the excitation from m=−1 to m=0 can be distinguished from the excitation from m=0 to m=+1. This can be achieved via a cross-bar structure above the relevant LV center with suitably phase-shifted modulated currents.

A pair of NV center and a nuclear spin can be manipulated with circularly polarized electromagnetic waves (radio waves) whose pointing vector is parallel to the NV center axis if the position and orientation of the nuclear spin relative to the NV center are suitable. In this case, the excitation from m=−1 to m=0 can be distinguished from the excitation from m=0 to m=+1. This can be achieved via a cross-bar structure above the relevant NV center with suitably phase-shifted modulated currents. Nuclei with spin I=½ or I=−½ can be manipulated with linearly polarized electromagnetic waves. In the case of circularly polarized electromagnetic waves, the nuclei with spin I=½ or I=−½ only react to the corresponding linearly polarized component.

Improved coupling and decoupling of the light can be achieved using u lenses or pillars, for example. Optionally, the quantum computer has optical functional elements between the surface of the diamond crystal and the light source for generating the pump radiation, for example between the surface of the diamond crystal and the laser for generating the laser pulse, such as lenses, mirrors, apertures, photonic crystals, optical functional elements of diffractive and/or digital optics, Bragg filters, filters, optical waveguides, wave couplers, circulators, directional couplers, matching layers, etc., which improve the coupling and/or decoupling.

The resonance line width of the state of the respective NV center is influenced by the irradiated power. In order to achieve an optimum line width, experience has shown that the power should not exceed 10 μWatt. A laser pulse duration of 3-10 μs has proven to be optimal for the initialization of the NV centers in the exemplary set-up used when developing the technical teacher in experimental tests.

The initialization of the nuclear spins of the respective atomic nuclei used as nuclear quantum bits of the quantum computer can be carried out by the quantum computer in very different ways. According to the technical teaching of the document presented here, the following exemplary methods currently appear to be the most promising:
a) SWOP of the quantum state of the NV center with the quantum state of the nuclear spin of a nuclear quantum bit under Hartmann-Hahn conditions (explanation follows),
b) CROT on the quantum state of the NV center of the quantum bit, CROT on the quantum state of the nuclear nucleus of the atomic nucleus of the nuclear quantum bit and laser pulses to re-initialize the quantum state of the electron configuration of the NV center (one-sided SWOP)
c) Quantum bit flips in ESLAC (excited-state level anti-crossing) and GSLAC (ground-state level anticrossing) (hyperpolarization) (explanation follows).

In the first method a), in the case of a SWOP of the quantum state of the NV center with the quantum state of the nuclear spin of a nuclear quantum bit under Hartmann-Hahn conditions, the quantum computer transfers the information of the quantum state of the NV center to the quantum state of the nuclear spin of the respective atomic nucleus under a Hartmann-Hahn (HH) condition. Here, the quantum computer sets the NV center through a Clifford gate (Paul: Y) as a (π/2) pulse and subsequent Clifford gate (Paul: X). This causes the orientation of the spin of the electron of the NV center to rotate with a Rabi frequency (spin lock). The Rabi frequency is set by adjusting the magnetic field so that the Rabi frequency is in resonance with the Lamor frequency of the nuclear spin of the atomic nucleus, so that a defined spin-spin SWAP (spin exchange) can take place. The transition of the spin-spin swap is again characterized by a time constant as a coupling constant. This makes a partial spin-spin swap controllable. (e.g. 50% spin exchange).

This method can be particularly effective for coupling between NV centers and nuclear spins weakly coupled to them.

Thus, the present document optionally proposes a quantum computer comprising NV centers as quantum bits and comprising strongly coupled nuclear spins strongly coupled to NV centers of quantum bits as strongly coupled nuclear quantum bits and comprising weakly coupled nuclear spins weakly coupled to NV centers of quantum bits as weakly coupled nuclear quantum bits, wherein the quantum computer is adapted to couple an NV center of a quantum bit to a weakly coupled nuclear spin as a weakly coupled nuclear quantum bit by using a Clifford gate (Paul: Y) as a (π/2) pulse and by adjusting the magnetic field and/or by adjusting the amplitude of the microwave radiation of the Y-Clifford gate to substantially match the Rabi frequency of the electron spin with the Lamor frequency of the nuclear spin, substantially meaning that this enables spin-spin exchange. The document presented here proposes to determine the necessary precision in the respective design of the respective quantum computer as part of a rework.

The quantum computer then re-initializes the NV center using a laser pulse from the pump radiation of the light source (laser). This method is suitable for nuclear spins of weakly coupled atomic nuclei that are weakly coupled to the NV center.

The second method b) is used to initialize nuclear spins of atomic nuclei of nuclear quantum bits that are strongly coupled to the NV center: The quantum computer performs a CNOT on the NV center depending on the quantum state of the strongly coupled nuclear spin of the strongly coupled nucleus of the nuclear quantum bit. If the quantum state of the strongly coupled nuclear spin of the strongly coupled atomic nucleus of the nuclear quantum bit is in the wrong quantum state, the transition takes place. If the quantum state of the strongly coupled nuclear spin of the strongly coupled atomic nucleus of the nuclear quantum bit is not in the wrong quantum state, the transition does not take place. If the quantum state of the strongly coupled nuclear spin of the strongly coupled atomic nucleus of the nuclear quantum bit is in the wrong quantum state, the CNOT can take place on the nuclear spin of the strongly coupled atomic nucleus of the nuclear quantum bit and the quantum computer rotates the strongly coupled nuclear spin of the strongly coupled atomic nucleus of the nuclear quantum bit by manipulation through the NV center of the quantum bit. The quantum computer then initializes the NV center by means of a laser pulse.

In the third method c), the quantum computer performs spin flips in the “exciting state anti-level crossing” (ESLAC). The quantum computer sets a magnetic flux density at which the quantum states with m=0 and m=−1 are energetically degenerate in the excited state of the NV center. However, the nuclear spins of the atomic nuclei of the nuclear quantum bits cancel this degeneracy and spin-spin flips can then take place between the nuclear spins of the atomic nuclei of the nuclear quantum bits of the quantum computer and the spin of the respective electron configuration of the respective NV center. These spin flips lead to a polarization of the nuclear spins of the atomic nuclei of the nuclear quantum bits that couple with this NV center. Depending on the magnetic field, this polarization can be positive (spin-up) or negative (spin-down). Unfortunately, this type of initialization is currently only possible with strongly coupled nuclei.

In order to achieve polarization, the quantum computer must optimally align the magnetic flux density of the magnetic field to the axis of the respective NV center (z-axis). Various methods are available for this purpose. The simplest is that the quantum computer maximizes the light intensity of the NV center by changing the orientation of the magnetic field flux density, whereby the quantum computer keeps the amount of flux density constant. Optionally, the quantum computer determines the orientation of the magnetic flux density by means of the resonance line of the NV transition, for example from the quantum state m=0 to m=1 of the electron configuration of the NV center. The quantum computer can achieve this with Ramsey sequences.

### Read Out

In the following, a process for reading out the quantum bits according to an optional embodiment is proposed:

The quantum computer reads through the quantum states of an NV center and the nuclear spins assigned to this NV center by means of the NV center. In doing so, the quantum computer distinguishes whether the NV center is in m=0 or m=+−1 quantum state.

If the NV center is in the m=−1 or m=+1 quantum state, the quantum computer can excite the NV center using a laser pulse from the light source as a pump radiation source with a pump radiation wavelength λₚₘₚ. However, the excited state of the NV center can now decay in two ways: In 70% of the cases and with a lifetime of approx. 10 ns, the excitation of the excited state of the NV center in the m−1 ground state takes place by emitting a photon. In this case, the laser as a light source immediately re-excites the quantum state of the NV center as a pump radiation source with a pump radiation wavelength λₚₘₚ. With a probability of 30%, the NV center then performs a forbidden interband transition from the triplet S=1 to the singlet S=0 state. This quantum state is metastable and, with a lifetime of approx. 100-300 ns, is stable for an order of magnitude longer than the direct decay to the ground state. After this time, the quantum state of the NV center decays back to the triplet state (m=0). This transition of the quantum state of the NV center takes place without radiation.

For the m=0 state, this transition to the singlet is suppressed, the NV center falls back to the ground state at m=0 by emitting a photon with a wavelength of 636-700 nm and is continuously re-excited by the laser.

As the metastable state is stable for approximately one order of magnitude longer than the radiative transition, a distinction can be made between m=0 and m=−1,+1 due to the different number of photons per laser pulse. The contrast that can be observed by the quantum computer results from the ratio of the two different lifetimes and corresponds to a factor of 10-30 for the first 300-500 ns. The quantum computer can determine approx. 0.8 photons per laser pulse—under ideal conditions—for the quantum state m=0 of the NV center. Under these conditions, the number of photons for m=−1 or m=+1 is <0.1 photons per laser pulse. The quantum computer therefore optionally carries out each measurement of a quantum state of an NV center approx. 1000-5000 times repeatedly in order to achieve the necessary number of results for a reliable statistical evaluation and for a reliable determination of a quantum state. The quantum computer optionally determines the optimum laser power when the laser pulses are emitted by the light source (pump radiation source) in an initialization phase by determining a saturation curve and extracting this optimum laser power.

There are various ways to increase the contrast. A first method is based on the possibility of using the nuclear spin of the ¹⁴N-nitrogen nucleus of the NV center (this is then no longer available as a qubit). In the ESLAC, a flip takes place between the nuclear spin of the ¹⁴N-nitrogen atomic nucleus of the NV center and the electron spin of the electron configuration of the NV center. This flip leads to a conversion of the quantum state of the electron configuration of the NV center from the quantum state with m=−1 to the quantum state with m=0 or from the quantum state with m=0 to the quantum state with m=+1. If the nuclear spin of the ¹⁴N nitrogen atom of the NV center is in the I=−1 state, 2 flips are therefore required to convert the nuclear spin of the ¹⁴N nitrogen atom of the NV center to the stable I=+1 state. If the ¹⁴N is integrated as an ancilla qubit, this integration increases the dark phase of the NV center by a factor of 3 and thus also increases the contrast between the quantum states of the electron configuration of the NV center with m=0 compared to m=−1 by a factor of 3 per laser pulse.

In the second step, the quantum computer reads out the quantum states of the nuclear spins of the atomic nuclei of the nuclear quantum bits via an upstream primitive CROT gate for the NV center depending on the respective nuclear states, see below.

The quantum computer optionally performs a quantum computer calculation several times for error correction. Here, the quantum computer should perform the CROT alternately in a stochastic order or at least in a newly defined order for each new quantum computer calculation in order to increase the fidelity. The quantum computer optionally checks all quantum states of strongly coupled spins of atomic nuclei of strongly coupled nuclear quantum bits by means of a corresponding CROT operation of the NV center. Optionally, the quantum computer controls several frequencies simultaneously. The corresponding signals can be calculated by Fourier transforming several signals from the time domain into the frequency domain, then summing them in the frequency domain to form a sum signal and transforming them back into the time domain and then generating them at the location of the NV center. The quantum computer therefore requires 2³=8 CROT gates to read out the nuclear quantum states of 3 nuclear spins of 3 atomic nuclei of three nuclear quantum bits in order to check combinations of quantum states. If the nuclei are in one of these 2³ combinations of quantum states of these three quantum bits, the NV transition of the NV center occurs and can be detected as such.

Gate for NV Nucleus Systems with Strongly Coupled Nuclei:

systems with nuclear spins of atomic nuclei of the nuclear quantum bits of the quantum computer strongly coupled to the electron configuration of an NV center, the gate operations of the coupled nuclear spins of the atomic nuclei of the nuclear quantum bits are always dependent on the quantum state of the electron spin of the electron configuration of the NV center and vice versa. In contrast, the operations of the strongly coupled nuclear spins of the atomic nuclei of the nuclear quantum bits are not necessarily dependent on the state of other strongly coupled nuclear spins of the atomic nuclei of the nuclear quantum bits.

The resulting primitive gates are therefore always conditional rotations:
a) CROT_{K} of the nuclei depending on the NV.
b) CROT_{NV} of the NV center depending on all quantum states of all strongly coupled nuclear spins of the atomic nuclei of strongly coupled nuclear quantum bits.

If the axis of the NV center (NV axis) defines the z-axis, the rotations can take place via the x-axis and y-axis. A rotation in y is characterized by a phase shift of 90° compared to x rotations. As described above, the phase position is defined by the first gates

(The position of the coordinate system is symmetrical about the z-axis and therefore arbitrary).

Rotation about the z-axis is achieved by a combination of 3 rotations CROT_zθ=CROT_{_Y}(−π/2) CROT_{_xθ} CROT_{_Y} (π/2) as already described above.

With the two primitive gates, the quantum computer can now generate all universal gates:

This is illustrated by the following examples:

Assumption: Magnetic field B in z-direction with B=51 mT (ESLAC). There should be two ¹³C atomic nuclei on the 3rd lattice site (13.8 MHz) and 5th lattice site (4.2 MHz) relative to the NV center. In addition, the electron configuration of the NV center can couple with a ¹⁴N-nitrogen nucleus of the NV center.

The quantum computer uses the spin state of the electron configuration of the NV center for m=0 and m=−1. The quantum computer uses the nuclear quantum states of the ¹⁴N nitrogen atom of the NV center with nuclear quantum states I=0 and I=+1 as nuclear quantum bits. The quantum computer uses the nuclear quantum states of the ¹³C isotope in the vicinity of the NV center with nuclear quantum states I=−½ and +½ as further nuclear quantum bits. The quantum computer performs the initialization of the spin state of the electron configuration of the NV center and the nuclear quantum states of the nuclear spins of the nuclear quantum bits by the laser pulse of the pump radiation source LD with pump radiation wavelength λₚₘₚ.

This results in the following gate operations by rotation around an angle θ in the Bloch sphere. θ is defined by the amplitude and length of the RF or MW field (and therefore the Rabi frequency). The conductor path and polarization direction as well as the magnetic field are set up optimally. In the ESLAC, the ¹⁴N-nitrogen atom is polarized to I=+1 as a nuclear quantum bit and the ¹³C-carbon isotopes are polarized to I=+½ as nuclear quantum bits.

Typical period durations of Rabi oscillation for 200 mV input and 40 dB gain are as follows:

| | | |
|---|---|---|
| NV | 300 | ns |
| ¹³C_{_{—}}₁ with 13.8 MHz | 13 | us |
| ¹³C_{_{—}}₂ with 4.2 MHz | 70 | us |
| ¹⁴N at 2.94 MHz | 40 | us |

The following primitive gates result from these values and the above-mentioned principles:
The following RF pulse frequencies result for the nuclear quantum bits for the assigned NV center in the m=−1 quantum state:
¹³C_{_1} CROT with 13.3 MHz (π=7 us)
¹³C_{_2} CROT with 4.7 MHz (π=35 us)
¹⁴N CROT with 2.94 MHz (π=20 us)
The following RF pulse frequencies result for the nuclear quantum bits for the assigned NV center in the m=0 quantum state:
¹⁴N: CROT with 5.1 MHz (π=20 us).
¹³C: Status cannot be changed.

For the NV center, 8 resonance energies corresponding to the combination for the spin states of the coupled nuclear spins of the nuclear quantum bits must be taken into account. The resulting frequencies for the MW pulse are necessary to drive the quantum state of the electron configuration of the NV center from m=0 to m=−1. The Rabi frequency is independent of the nuclear states and the pulse lengths are identical for all nuclear spin states of the coupled nuclear quantum bits. The states given here correspond to nuclear states for C, C¹³_{_1}¹³_{_2}¹⁴N.

The following table provides exemplary CROT frequencies (MHz) for various nuclear spin states as determined in developing the technical teachings of the present disclosure:

| | | |
|---|---|---|
| 000> | 1400.0 | MHz |
| 001> | 1397.06 | MHz |
| 010> | 1404.7 | MHz |
| 011> | 1401.76 | MHz |
| 100> | 1413.2 | MHz |
| 101> | 1410.26 | MHz |
| 110>. | 1417.9 | MHz |
| 111>. | 1414.96 | MHz |

Since the linewidth of the resonance of the electron spin of the electron configuration of the NV center is smaller than the frequency spacing of the resonances at approx. 0.5 MHz, all transitions can be carried out without crossover. However, if very large amplitudes, i.e. short pulses, are used, this leads to a strong broadening of the resonance line (by up to 6 MHz).

With these pulses, the transitions 000>001>010> and 011> can be changed simultaneously at a frequency of 1402 MHz. The resonance lines for 100>, 101>110 and 111> can also be driven with a pulse of frequency 1414 MHz of this width. Crosstalk can be reduced through optimum pulse control.

The universal gates can now be represented as a combination of the primitive gates:

### For the Quantum Bit of the NV Center (Single Gate):

iX (θ) (or iX resp.) is formed by the sum of all CROT( ) or by two strong-pulses with for example 1402 and 1414 MHz. The length defines the angle of rotation with the same amplitude.
   iY (θ) (or iY resp.) like X only the pulses are offset with a 90° phase.
   iZ (θ) given by Y (−π/2) X(θ) Y(π/2)
   H (Hadamard) is given by Y(π/2) Z(π)
   S (phase rotation by π/4) is given by Z(π/4)

### 2 Qubit Gate:

CiNOT(NV, nucleus) The partial sum of the respective rotations of the non-dependent qubits (4×CROT around the same axis with the appropriate frequency)
CCiNOT(NV, nucleus) The respective partial sum of the non-dependent qubits (2×CROT)
CCCiNOT(NV, nucleus): a CROT for 000>
CNOT(NV, nucleus): Z(π/2) CiNOT(NV, nucleus)

The following gates result for the nuclear qubits

### Single Gate:

iX: CROT for m=−1 of the NV center
If m is not known:
iX: CROT,X_NV, CROT, X_NV for m=−1 of the NV center
iY: X with a 90° phase shift of the radio wave for m=−1 of the NV center
iZ (θ) given by Y(−π/2) X(θ) Y(π/2) for m=−1 of the NV center
H (Hadamard) is given by Y(π/2) Z(π) for m=−1 of the NV center
S (phase rotation around π/4) is given by Z(π/4) for m=−1 of the NV center
Qubit:
CiNOT(nucleus, NV) is a primitive gate CROT (180°) for m=−1 of the NV center. The gate is not executed for m=0.

CiNOT(nucleus_1, nucleus_2) always takes place via the NV center. This is a Hadamard on the nuclear spin of nucleus_1, CROT on the NV center 2Pi, Hadamard on nucleus_1

CiNOT (nucleus_1, nucleus_2). CiNOT(nucleus_1, NV), CiNOT(NV,nucleus_2), CiNOT(nucleus1, NV) for m=−1

Or if the status of the NV is not known:

CiNOT(nucleus_1,nucleus_2). CiNOT(nucleus_1,NV), CiNOT(NV_nucleus_2) CiNOT(nucleus_1, NV), iX_NV, CiNOT(nucleus_1,NV), CiNOT(NV,nucleus_2) CiNOT(nucleus_1,NV), iX_NV

SWAP(NV,nucleus) CiNOT(nucleus,NV) CiNOT_Y(NV, nucleus)Z((π/2) CiNOT(nucleus,NV)

This defines all universal gates for a quantum computer according to an optional embodiment.

The quantum computer presented here can optionally realize a higher number of quantum bits with improved fidelity by different control of nuclear spins of atomic nuclei of nuclear quantum bits that are weakly and strongly coupled to the NV centers.

The features and embodiments mentioned above and explained in the following are not only to be regarded as disclosed in the combinations explicitly mentioned in each case, but are also covered by the disclosure in other technically meaningful combinations and embodiments. In particular, the individual features and embodiments can work together to produce and/or improve the relocatablility and/or mobility of the quantum computer system. Optionally, all disclosed features and/or embodiments can be realized in a quantum computer system.

### BRIEF DESCRIPTION OF THE DRAWINGS

Further details and advantages will now be explained in more detail with reference to the following examples and optional embodiments with reference to the figures.

It shows:

FIG. 1 is a schematic representation of a quantum computer system according to an optional embodiment.

FIG. 2 a schematic representation of a quantum computer according to an optional embodiment.

FIG. 3a schematic representation of a quantum computer system according to a further optional embodiment.

FIG. 4: a schematic representation of a quantum computer system according to a further optional embodiment with several quantum computers.

FIG. 5: A vehicle designed as an aircraft according to an optional embodiment.

FIG. 6a: A vehicle designed as an aircraft according to a further optional embodiment.

FIG. 6b: A mobile device designed as a container according to an optional embodiment.

FIG. 6c: A vehicle designed as a ship according to an optional embodiment.

FIG. 6d: A device designed as a factory according to an optional embodiment.

FIG. 7: A vehicle designed as a submarine according to an optional embodiment.

FIG. 8: A vehicle designed as a passenger car according to an optional embodiment.

FIG. 9: A method according to an optional embodiment.

FIG. 10: a schematic representation of a quantum computer system according to a further optional embodiment.

FIG. 11: a schematic representation of a quantum computer system according to a further optional embodiment.

FIG. 12: A method according to an optional embodiment.

FIG. 13: an exemplary structure of an amplifier V according to an optional embodiment.

FIG. 14: A garment according to an optional embodiment.

FIG. 15: A vehicle designed as a satellite according to an optional embodiment.

FIG. 16: A mobile device designed as a smartphone according to an optional embodiment.

FIG. 17: a schematic representation of a quantum computer system according to a further optional embodiment.

FIGS. 18A to 18G: schematic representations of quantum computing systems according to further optional embodiments.

FIG. 19A to 19G: Method according to optional embodiments.

FIG. 20: Structure diagram of a software stack according to an optional embodiment.

FIG. 21: A swarm of drones according to an optional embodiment.

FIG. 22: A quantum computer system with a Cardanic suspension.

### DETAILED DESCRIPTION

In the following figures, identical or similar elements in the various embodiments are designated with the same reference signs for the sake of simplicity.

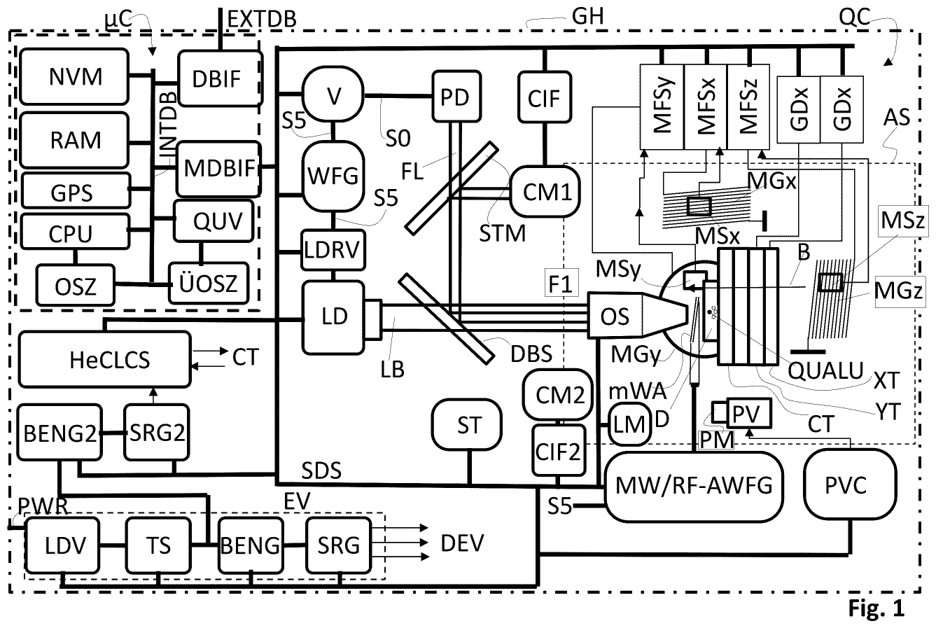

With reference to FIG. 1, a quantum computer system according to an optional embodiment is explained below. Some sub-devices of the quantum computer system are also explained in detail.

This explained embodiment of the quantum computer system can be based on a quantum computer system as described in DE 10 2020 101 784 B3. The individual components can relate to the quantum computer system or the quantum computer itself. In this context, quantum computer systems in which the individual features relate to the quantum computer per se and those in which the individual features relate to the quantum computer system separately from the quantum computer are to be regarded as equally disclosed. Thus, the disclosure relating to a quantum computer system is equally disclosed for a quantum computer and vice versa.

The optional embodiment shown describes a quantum computer with optical readout. Alternatively, or in addition, the paper presented here describes a quantum computer with electrical readout. The basis of the quantum computer presented here are quantum dots. Optionally, the quantum dots comprise paramagnetic centers in a substrate. Optionally, the substrate comprises diamond. Optionally, the paramagnetic centers comprise NV centers and/or SiV. centers and/or TR1 centers and/or TR12 centers. The quantum computer presented here optionally comprises an optical device. Firstly, the optical device optionally serves to irradiate quantum dots and thus the paramagnetic centers with pump radiation. Secondly, the optical device optionally serves to extract fluorescence radiation from the quantum dots. Optionally, the optical device thus serves to extract fluorescence radiation from paramagnetic centers. Optionally, the optical device thus serves to extract fluorescence radiation from NV centers. An optical functional element of the device is thus optionally a paramagnetic center in a crystal, in particular an NV center in a diamond crystal and/or an SiV center in a diamond crystal and/or a G center in a silicon crystal or a paramagnetic center in a solid solution of elements of the IV. main group of the periodic table. main group of the periodic table. In this context, the present document refers to the German patent DE 10 2020 101 784 B3, the technical teaching of which forms an integral part of this disclosure to the extent permitted by the law of the state in which a nationalization of an international application of the content of the present document is made. The entire contents of the disclosure of the German Patent DE 10 2020 101 784 B3 are hereby incorporated by reference.

Optionally, such a quantum computer comprises one or more micro-integrated circuits for generating the radio frequency signals, the microwave signals, the DC voltages and control currents and the control of the light source (LED), which serves as a pump radiation source for resetting the quantum dots of the quantum bits of the relocatable quantum computer.

All these components of the relocatable quantum computer, including the aforementioned micro-integrated circuits, are optionally accommodated on the circuit carrier, which can therefore be designed to be particularly compact.

The embodiment shown presents a relocatable quantum computer system or a relocatable quantum computer QC, optionally in a mobile device. The definition of the term “mobile device” in this document is described above. The core of the quantum computer QC forms a substrate D. The substrate D optionally has one or more quantum dots NV1, NV2, NV3. Their nature is explained in more detail below. In this context, however, the document presented here also expressly refers to the document DE 10 2020 007 977 B4, the content of which is fully part of the disclosure content of the document presented here, insofar as the legal system of the state in which the nationalization takes place permits this in the event of a later nationalization of a later international application.

Furthermore, the proposed relocatable quantum computer QC optionally comprises a light source LD and an associated light source driver LDRV. In order to be able to influence the quantum state of the quantum dots NV1, NV2, NV3, the proposed relocatable quantum computer QC optionally comprises one or more devices mWA, MW/RF-AWFG for generating an electromagnetic wave field at the respective location of the quantum dots NV1, NV2, NV3. Optionally, the relocatable quantum computer QC comprises a control device μC. The control device μC optionally controls the light source driver LDRV and thus the emission of pump radiation LB with the pump radiation wavelength λₚₘₚ. The control device μC optionally also controls the one or more devices mWA, MW/RF-AWFG for generating an electromagnetic wave field at the respective location of the quantum dots NV1, NV2, NV3. The control device μC optionally has one or more memories RAM, NVM. of the control device μC for program instructions and data. The proposed quantum computer QC optionally comprises a waveform generator WFG for controlling the light source driver LDRV by means of a transmission signal S5. The control device μC optionally also controls the waveform generator WFG. The proposed quantum computer QC optionally also comprises an optical system OS for irradiating the quantum dots NV1, NV2, NV3 in the substrate D with the pump radiation LB from the light source LD. Furthermore, the proposed relocatable quantum computer QC optionally comprises an optical and/or electronic quantum state readout device for reading out the current quantum states of the quantum dots NV1, NV2, NV3. In the case of an optical quantum state readout device, the quantum state readout device optionally comprises a photodetector PD and an amplifier V. In the case of an electrical quantum state readout device, the quantum state readout device optionally comprises contacts for contacting the substrate D and a voltage source for generating an extraction voltage between such contacts of the substrate D and an amplifier V for amplifying the thus extracted photocurrent of the quantum dots NV1, NV2, NV3. The amplifier V may comprise a transimpedance amplifier as an internal amplifier IVV. In this case, the quantum state readout device comprises a device for electronically reading out the states of the quantum dots NV1, NV2, NV3. The quantum dots NV1, NV2, NV3 are optionally located in the substrate D. Optionally, the substrate D is doped in the region of the quantum dots NV1, NV2, NV3. Optionally, this doping shifts the Fermi level in the region of the quantum dots NV1, NV2, NV3 in such a way that the quantum dots NV1, NV2, NV3 are electrically charged. Optionally, the substrate D is n-doped in the area of the quantum dots NV1, NV2, NV3. Optionally, this n-doping shifts the Fermi level in the region of the quantum dots NV1, NV2, NV3 in such a way that the quantum dots NV1, NV2, NV3 are negatively electrically charged. Typically, the waveform generator WFG generates a light source control signal S5 typically depending on the settings of the control device μC. The light source driver LDRV optionally supplies the light source LD with electrical energy as a function of the light source control signal S5 and, if necessary, typically as a function of the settings of the control device μC. The control device μC typically controls the waveform generator WFG. The light source LD irradiates the quantum dot or the multiple quantum dots NV1, NV2, NV3 with pump radiation LB of the pump radiation wavelength λₚₘₚ at least temporarily by means of the optical system OS. The one quantum dot or the multiple quantum dots NV1, NV2, NV3 emit fluorescence radiation FL with a fluorescence radiation wavelength λ_{fl} as a result of the irradiation with electromagnetic radiation of the pump radiation wavelength λₚₘₚ. In the case of optical readout of the quantum states of the quantum dots NV1, NV2, NV3, the photodetector PD detects at least part of the fluorescence radiation FL by means of the optical system OS. In this case, the photodetector PD converts at least part of the fluorescence radiation FL into a receiver output signal S0. A downstream amplifier V amplifies and, if necessary, filters the receiver output signal S0 into a received signal S1. In the case of electronic readout of the quantum states of the quantum dots NV1, NV2, NV3, the device for electronic readout of the states of the quantum dots NV1, NV2, NV3 generates the received signal S1. The control device μC controls the one or more devices mWA, MW/RF-AWFG for generating an electromagnetic wave field at the respective location of the quantum dots NV1, NV2, NV3. The control device μC can change the states of the quantum dots NV1, NV2, NV3 by controlling the one or more devices mWA, MW/RF-AWFG for generating an electromagnetic wave field at the respective location of the quantum dots NV1, NV2, NV3 and/or by controlling the emission of the light source LD. The control device μC can couple states of the quantum dots NV1, NV2, NV3 with each other by controlling the one or more devices mWA, MW/RF-AWFG for generating an electromagnetic wave field at the respective location of the quantum dots NV1, NV2, NV3 and/or by controlling the emission of the light source LD. For this purpose, the control device μC typically has means for generating a measured value signal S4 with one or more measured values from one or more received signals S1. The measured value signal S4 depends on the quantum states of the quantum dots NV1, NV2, NV3. The special feature (?) of the quantum computer QC is that, in contrast to the prior art, the relocatable quantum computer QC and/or the mobile device has a relocatable energy supply (LDV, TS, BENG, SRG) for supplying at least some of the subdevices of the quantum computer QC with energy. The relocatable power supply (LDV, TS, BENG, SRG) optionally has a mobile power supply (LDV, TS, BENG) and a power conditioning device SRG, in particular a voltage converter or a voltage regulator or a current regulator.

Optionally, a further embodiment of the relocatable quantum computer QC has not only quantum dots NV1, NV2, NV3, but also one or more nuclear quantum dots CI1₁, CI1₂, CI1₃, CI2₁, CI2₂, CI2₃, CI3₁, CI3₂, CI3₃. In this case, the proposed relocatable quantum computer QC optionally also comprises one or the plurality of devices mWA, MW/RF-AWFG for generating an electromagnetic wave field at the respective location of the nuclear quantum dots CI1₁, CI1₂, CI1₃, CI2₁, CI2₂, CI2₃, CI3₁, CI3₂, CI3₃. Typically, the one or more devices are mWA, MW/RF-AWFG for generating an electromagnetic wave field at the respective location of the nuclear quantum dots CI1₁, CI1₂, CI1₃, CI2₁, CI2₂, CI2₃, CI3₁, CI3₂, CI3₃ identical in whole or at least in part to the one or more devices mWA, MW/RF-AWFG for generating an electromagnetic wave field at the respective location of the quantum dots NV1, NV2, NV3, which thus then simultaneously also include one or more devices for generating an electromagnetic wave field at the respective location of the nuclear quantum dots CI1₁, CI1₂, CI1₃, CI2₁, CI2₂, CI2₃, CI3₁, CI3₂, CI3₃ are The quantum dots NV1, NV2, NV3 and the nuclear nuclear quantum dots CI1₁, CI1₂, CI1₃, CI2₁, CI2₂, CI2₃, CI3₁, CI3₂, CI3₃ are optionally located in the common substrate D. The control device μC controls the one or more devices mWA, MW/RF-AWFG for generating an electromagnetic wave field. The control device μC can then change quantum states of the quantum dots NV1, NV2, NV3 and/or quantum states of the nuclear quantum dots CI1₁, CI1₂, CI1₃, CI2₁, CI2₂, CI2₃, CI3₁, CI3₂, CI3₃ by controlling the one or more devices mWA, MW/RF-AWFG for generating an electromagnetic wave field and/or by controlling the emission of the light source LD. The control device μC can then couple quantum dots NV1, NV2, NV3 to other quantum dots NV1, NV2, NV3 by controlling the one or more devices mWA, MW/RF-AWFG to generate an electromagnetic wave field and/or by controlling the emission of the light source LD, NV3 The control device μC can then couple quantum dots NV1, NV2, NV3 with nuclear quantum dots CI1₁, CI1₂, CI1₃, CI2₁, CI2₂, CI2₃, CI3₁, CI3₂, CI3₃ by controlling the one or more devices mWA, MW/RF-AWFG for generating an electromagnetic wave field and/or by controlling the emission of the light source LD. The control device μC can then be controlled by controlling the one or more devices mWA, MW/RF-AWFG to generate an electromagnetic wave field and/or by controlling the emission of the light source LD nuclear quantum dots CI1₁, CI1₂, CI1₃, CI2₁, CI2₂, CI2₃, CI3₁, CI3₂, CI3₃ with other nuclear quantum dots CI1₁, CI1₂, CI1₃, CI2₁, CI2₂, CI2₃, CI3₁, CI3₂, CI3₃. The measured value signal S4 depends on quantum states of quantum dots NV1, NV2, NV3 and/or on states of nuclear quantum dots CI1₁, CI1₂, CI1₃, CI2₁, CI2₂, CI2₃, CI3₁, CI3₂, CI3₃.

In a further detail of the relocatable quantum computer QC, the mobile energy supply (LDV, TS, BENG) supplies the energy preparation device SRG with energy, whereby the energy preparation device SRG in turn supplies other device parts of the relocatable quantum computer QC with electrical energy.

In a more specific variant, the mobile energy supply (LDV, TS, BENG) comprises a charging device LDV and a disconnecting device TS and an energy reserve BENG. This makes it possible to improve the EMC sensitivity of the relocatable quantum computer QC (EMC=electromagnetic compatibility). For this purpose, the proposed relocatable quantum computer QC optionally has a first operating mode and a second operating mode. In the first operating mode of the relocatable quantum computer QC, firstly, the isolating device TS connects the charging device LDV to the energy reserve BENG, so that the charging device LDV charges the energy reserve BENG with electrical energy from an external energy supply PWR in this first operating mode. In the first operating mode, firstly, the disconnecting device TS connects the charging device LDV to the energy preparation device SRG, and secondly, the charging device LDV supplies the energy preparation device SRG with electrical energy from the external energy supply PWR. In the second operating mode, optionally, firstly, the disconnecting device TS disconnects the charging device LDV from the energy reserve BENG and, secondly, the disconnecting device TS disconnects the charging device LDV from the energy conditioning device SRG. In the second operating mode, the energy reserve BENG optionally supplies the energy preparation device SRG with electrical energy for the third time.

In a further optional embodiment, the relocatable quantum computer QC comprises a housing GH and a shield AS. Optionally, the light source LD and the light source driver LDRV and the substrate D and the devices mWA, MW/RF-AWFG for generating the electromagnetic wave field and the control device μC and the memory RAM, NVM of the control device μC and the optical system OS and possibly the amplifier V and the shield AS are located inside the housing GH. This protects these device parts and possibly the quantum dots NV1, NV2, NV3 and nuclear quantum dots CI1₁, CI1₂, CI1₃, CI2₁, CI2₂, CI2₃, CI3₁, CI3₂, CI3₃ in the substrate D from interfering EMC influences. Typically, the shielding AS can be part of the housing GH or the housing GH itself. Optionally, at least parts of the device parts of the power supply (LDV, TS, BENG, SRG) of the relocatable quantum computer QC or such parts of the power supply (LDV, TS, BENG, SRG) of the relocatable quantum computer QC, which enable an autonomous power supply for a certain time for an autonomous operation of the relocatable quantum computer QC, are located inside the common housing GH. Optionally, the parts have their own shielding AS.

An energy preparation device SRG and an energy reserve BENG of the energy supply (LDV, TS, BENG, SRG) of the quantum computer QC are optionally located within the shielding AS.

So that the relocatable quantum computer QC can also be operated as a mobile quantum computer QC during the deployment, the relocatable quantum computer QC optionally comprises means for its operation, wherein the relocatable quantum computer QC and all means for operating this relocatable quantum computer QC can be part of a mobile device. To make this possible, these means for operating the relocatable quantum computer QC according to the optional embodiment are also relocatable. For the same reason, these means for operating the relocatable quantum computer QC are optionally part of the relocatable quantum computer QC. Both the relocatable quantum computer QC and these means for operating the relocatable quantum computer QC are optionally part of the mobile device. It is typically irrelevant whether the operation of the relocatable quantum computer QC is coupled to means and/or commands from outside the relocatable quantum computer QC, despite the presence of all means for operating the relocatable quantum computer QC as part of the relocatable quantum computer QC.

As mentioned above, the relocatable quantum computer QC is optionally part of a mobile device, wherein the mobile device may in particular be a smartphone or a portable quantum computer system or a vehicle or a robot or an airplane or a missile or a satellite or a spacecraft or a space station or a floating body or a ship or an underwater vehicle or an underwater floating body or a relocatable weapon system or another mobile device.

In a further optional embodiment, the relocatable quantum computer QC optionally comprises a positioning device XT, YT. The positioning device XT, YT can optionally position the substrate D relative to the optical system OS in such a way that the optical system OS, in cooperation with the one or more devices mWA, MW/RF-AWFG for generating an electromagnetic wave field, can, firstly, in a first positioning, control a first set of quantum dots with a first number of quantum dots and, optionally, a second number of nuclear quantum dots, and, secondly, in a second positioning, control a second set of quantum dots with a second number of nuclear quantum dots. a second number of nuclear quantum dots, and secondly, in a second positioning, a second set of quantum dots with a third number of quantum dots and possibly a fourth number of nuclear quantum dots. The control device μC optionally controls the positioning device XT, YT for the substrate D in such a way that it assumes the first positioning or the second positioning or further positionings. In this way, the relocatable quantum computer QC can always reconfigure itself as a function of its operating temperature during operation and/or during breaks in operation so that it can always utilize a maximum number of quantum dots and nuclear quantum dots.

In a further optional embodiment, the relocatable quantum computer QC therefore has a temperature sensor ST, which determines a temperature measurement value for the temperature of the substrate D or for the temperature of a partial device of the relocatable quantum computer QC thermally connected thereto.

This results in an optional version of the relocatable quantum computer QC, wherein the relocatable quantum computer QC is set up and intended to be able to operate with a reduced first number of quantum dots even at room temperature of the substrate D or a measured temperature value corresponding to a value greater than 0° C. At the same time, however, the relocatable quantum computer QC is also set up and intended to be able to operate with an increased, third number of quantum dots at a measured temperature value corresponding to a value less than 0° C. In this way, the relocatable quantum computer QC can always reconfigure itself as a function of its operating temperature during operation and/or during breaks in operation so that it can always utilize a maximum number of quantum dots and nuclear quantum dots.

In an optional embodiment, the present document therefore discloses a relocatable quantum computer QC which is set up and intended to be able to operate with a reduced second number of nuclear quantum dots even at room temperature of the substrate D or at a measured temperature value corresponding to a value greater than 0° C. Optionally, the relocatable quantum computer QC is simultaneously set up and intended to be able to operate with an increased fourth number of nuclear quantum dots at a measured temperature value corresponding to a value less than 0° C. In this way, the relocatable quantum computer QC can always reconfigure itself as a function of its operating temperature during operation and/or during breaks in operation so that it can always utilize a maximum number of quantum dots and nuclear quantum dots.

In a further optional embodiment, the relocatable quantum computer QC comprises one or more relocatable cooling devices KV, which are relocatable together with the relocatable quantum computer (QC). One or more of the relocatable cooling devices KV are optionally suitable and/or provided for lowering the spin temperature of quantum dots NV1, NV2, NV3 and/or nuclear quantum dots CI1₁, CI1₂, CI1₃, CI2₁, CI2₂, CI2₃, CI3₁, CI3₂, CI3₃ and/or the temperature of the substrate D.

In a further optional embodiment, one or more such cooling devices KV reduce the temperature of quantum dots NV1, NV2, NV3 and/or the temperature of nuclear quantum dots CI1₁, CI1₂, CI1₃, CI2₁, CI2₂, CI2₃, CI3₁, CI3₂, CI3₃ and/or the temperature of the substrate D to such an extent that the relocatable quantum computer QC can operate with an increased third number of quantum dots NV1, NV2, NV3 compared to the reduced first number of quantum dots NV1, NV2, NV3. Optionally, one or more such cooling devices KV reduce the temperature of quantum dots NV1, NV2, NV3 and/or the temperature of nuclear quantum dots CI1₁, CI1₂, CI1₃, CI2₁, CI2₂, CI2₃, CI3₁, CI3₂, CI3₃ and/or the temperature of the substrate D to such an extent, that the quantum computer QC can operate with an increased fourth number of quantum dots CI1₁, CI1₂, CI1₃, CI2₁, CI2₂, CI2₃, CI3₁, CI3₂, CI3₃ relative to the reduced second number of nuclear quantum dots CI1₁, CI1₂, CI1₃, CI2₁, CI2₂, CI2₃, CI3₁, CI3₂, CI3₃.

In a further optional embodiment, one or more of the relocatable cooling devices KV of the quantum computer QC comprise one or more closed loop helium gas cooling systems HeCLCS, or one or more relocatable closed loop helium gas cooling systems HeCLCS comprise one or more relocatable cooling devices KV.

In a further optional embodiment, the relocatable quantum computer QC comprises a second relocatable power supply BENG2, which is different from the first relocatable power supply BENG. Optionally, the second relocatable power supply BENG2 supplies power to one or more of the relocatable cooling devices KV and/or one or more of the closed loop helium gas cooling systems HeCLCS.

In another optional embodiment, the relocatable quantum computer QC and/or the mobile device have a mobile data interface DBIF, in particular a mobile radio data interface and/or a wired data interface. Optionally, in a further optional embodiment, a higher-level computer system, for example a central control device ZSE, can control the control device μC by means of this data interface DBIF, that the control device μC of the relocatable quantum computer QC controls the relocatable quantum computer QC to perform at least one manipulation of a state of at least one quantum bit of the quantum bits NV1, NV2, NV3 and/or to perform at least one manipulation of a state of at least one nuclear nuclear quantum bit of the nuclear nuclear quantum bits CI1₁, CI1₂, CI1₃, CI2₁, CI2₂, CI2₃, CI3₁, CI3₂, CI3 3. The higher-level central control unit ZSE optionally controls the control device μC via the mobile data interface DBIF.

Optionally, the first relocatable energy reserve BENG and/or or the second relocatable energy reserve BENG2 comprise one or more batteries and/or one or more accumulators or one or more capacitors and/or one or more interconnections of several of these energy storage devices. Optionally, the relocatable quantum computer QC and/or the mobile device comprise one or more charging devices LDV. Typically, one or more charging devices LDV are intended and/or provided to at least temporarily store energy in at least some or all of the rechargeable energy storage devices BENG, BENG2.

In one variant, in the relocatable quantum computer QC, the first relocatable energy reserve BENG and/or the second relocatable energy reserve BENG2 may comprise one or more energy storage devices that generate energy from at least one or more fluids by means of chemical and/or electrochemical processes. In this case, the first relocatable energy reserve BENG and/or the second relocatable energy reserve BENG2 and/or the quantum computer QC optionally have one or more storage tanks for these fluids. One or more of these storage tanks supply one or more energy stores of the quantum computer QC with one or more of these fluids, which are typically used to generate energy. Optionally, one or more of the energy storage tanks comprise one or more galvanic cells and/or one or more fuel cells and/or one or more combustion engines and/or turbines and the like, each coupled to one or more electrical generators, and/or one or more thermal energy conversion engines, each coupled to one or more electrical generators. One or more of the mobile energy supplies of the quantum computer QC optionally comprise one or more energy conditioning devices SRG, in particular one or more voltage converters and/or one or more voltage regulators and/or one or more current regulators. One or more of the energy storage devices optionally supply the energy conditioning devices SRG with energy. One or more of the energy conditioning devices SRG optionally in turn supply one or more device parts of the quantum computer QC with electrical energy that is suitable, conditioned and stabilized for the respective device part.

In a further optional variant of the relocatable quantum computer QC, the first relocatable energy reserve BENG and/or the second relocatable energy reserve BENG2 comprise one or more energy storage devices that generate energy by means of mechanical processes. Optionally, one or more of these energy storage devices then comprise one or more generators and/or one or more alternators and/or one or more electric motors that can be operated as generators. Typically, one or more mobile energy supplies of the quantum computer QC comprise one or more energy conditioning devices SRG, in particular one or more voltage converters or one or more voltage regulators or one or more current regulators. One or more of the energy storage devices supply one or more of the energy conditioning devices SRG with energy. One or more of the energy conditioning devices SRG then optionally supply one or more other device parts of the relocatable quantum computer QC with electrical energy.

In a further optional variant of the relocatable quantum computer QC, the first relocatable energy reserve BENG and/or the second relocatable energy reserve BENG2 optionally comprise one or more energy storage devices that generate electrical energy by means of the conversion of electromagnetic radiation, in particular light. For this purpose, one or more of the energy storage devices optionally comprise one or more solar cells and/or one or more functionally equivalent devices, such as PN junctions. In that case, optionally one or more of the mobile energy supplies of the quantum computer QC comprise one or more energy conditioning devices SRG, in particular one or more voltage converters and/or one or more voltage regulators and/or one or more current regulators. One or more of the energy storage devices of the energy reserve BENG, BENG2 of the quantum computer QC then typically at least temporarily supply one or more of the energy conditioning devices SRG with energy. One or more energy preparation devices SRG then supply one or more other device parts of the quantum computer QC with electrical energy.

In a further optional variant of the relocatable quantum computer QC, the first relocatable energy reserve BENG and/or the second relocatable energy reserve BENG2 comprise one or more energy storage devices that generate energy by means of nuclear processes. One or more of the mobile energy supplies of the quantum computer QC comprise one or more energy conditioning devices SRG, in particular one or more voltage converters and/or one or more voltage regulators and/or one or more current regulators. One or more of the energy storage devices of the energy reserve BENG, BENG2 of the quantum computer QC optionally supply one or more of the energy conditioning devices SRG with energy at least temporarily. One or more of these energy preparation devices SRG then in turn supply one or more device parts of the relocatable quantum computer QC with electrical energy.

In a further optional embodiment, one or more of the energy storage devices comprise one or more thermonuclear batteries or radionuclide batteries or one or more devices functionally equivalent to such a thermonuclear battery.

In a further optional variant, the substrate D comprises diamond. In that case, optionally one or more of the quantum dots NV1, NV2, NV3 in the substrate D are formed as defect centers and/or paramagnetic centers in diamond. Optionally, one or more of the defect centers in diamond are then NV centers or ST1 centers or SiV centers or TR1 centers and/or TR12 centers.

Optionally, the relocatable quantum computer QC comprises one or more nuclear quantum dots CI1₁, CI1₂, CI1₃, CI2₁, CI2₂, CI2₃, CI3₁, CI3₂, CI3₃ based on isotopes with a magnetic moment u. Optionally, the nuclear quantum dots CI1₁, CI1₂, CI1₃, CI2₁, CI2₂, CI2₃, CI3₁, CI3₂, CI3₃ are coupled with quantum dots NV1, NV2, NV3.

Optionally, the substrate D is essentially isotopically pure at least in the region of the nuclear quantum dots CI1₁, CI1₂, CI1₃, CI2₁, CI2₂, CI2₃, CI3₁, CI3₂, CI3₃ and the quantum dots NV1, NV2, NV3. This has the advantage that the magnetic moments of the nuclear quantum dots CI1₁, CI1₂, CI1₃, CI2₁, CI2₂, CI2₃, CI3₁, CI3₂, CI3₃ and the quantum dots NV1, NV2, NV3 do not couple with such parasitic magnetic moments caused by impurities of the substrate D. The isotopes of the substrate D are isotopically pure. For this purpose, the isotopes of the substrate D optionally have essentially no nuclear magnetic moment apart from atoms that form the nuclear quantum dots CI1₁, CI1₂, CI1₃, CI2₁, CI2₂, CI2₃, CI3₁, CI3₂, CI3₃.

In a further optional embodiment, the relocatable quantum computer QC has one or more fans and/or one or more heat exchangers for heat exchange with the environment and/or one or more heat exchangers for heat exchange with the ambient air and/or one or more radiant coolers for heat exchange with the ambient air or the environment by means of electromagnetic thermal radiation.

In a further optional variant of the relocatable quantum computer QC, one or more of the fans and/or one or more of the heat exchangers exchange energy in the form of heat with one or more of the relocatable cooling devices KV.

In a further optional modification, the relocatable quantum computer QC has an internal shielding AS. The internal shielding AS optionally shields the substrate D with the quantum dots NV1, NV2, NV3 and, if applicable, the nuclear quantum dots CI1, CI1, CI1, CI2. the nuclear quantum dots CI1₁, CI1₂, CI1₃, CI2₁, CI2₂, CI2₃, CI3₁, CI3₂, CI3₃ against electromagnetic fields of the control device μC and/or the memory RAM, NVM and/or the power supply SRG, TS, LDV, BENG, BENG2 and/or the light source driver LDRV and/or the light source LD. In a further modification, the relocatable quantum computer QC has an internal shielding AS. The internal shielding AS optionally shields the substrate D with the quantum dots NV1, NV2, NV3 and, if applicable the nuclear quantum dots CI1₁, CI1₂, CI1₃, CI2₁, CI2₂, CI2₃, CI3₁, CI3₂, CI3₃ against magnetic fields of the control device μC and/or the memory RAM, NVM and/or the power supply SRG, TS, LDV, BENG, BENG2 and/or the light source driver LDRV and/or the light source LD.

In order to be able to relocate the relocatable quantum computer QC, the relocatable quantum computer QC is optionally equipped in this case with one or more wheels or a chassis or device parts that are functionally equivalent to these, which can also be driven and/or braked, at least temporarily.

In another optional embodiment, the relocatable quantum computer QC at least temporarily comprises one or more propulsion devices. According to a proposal, one or more of the propulsion devices is a wheel or a propeller or a propeller or a turbine or a rocket engine or a propulsion wheel or an MHD (magnetohydrodynamic) engine.

In embodiments of the relocatable quantum computer QC, which are to be operated in a fluid and moved for deployments, it is expedient if, in certain applications, such a relocatable quantum computer QC has aerodynamically and/or hydrodynamically shaped functional elements for reducing and/or controlling aerodynamic effects and/or hydrodynamic effects and/or for generating dynamic lift, in particular wings and/or flaps.

In some optional embodiments of the relocatable quantum computer QC, it is useful to design electronic device parts of the quantum computer QC, at least partially in radiation-hard electronics. Such optional radiation-hard device parts of the quantum computer QC are for example:
the μC control device and/or
the memory RAM, NVM of the control device μC and/or
the computer core CPU and/or
the DBIF data interface and/or
the internal data interface MDBIF and/or
the light source driver LDRV and/or
the waveform generator WFG and/or
the amplifier V and/or
the PD photodetector and/or
the first camera interface CIF and/or
the second camera interface CIF2 and/or
the first camera CM1 and/or
the second camera CM2 and/or
the temperature sensor ST and/or
the microwave and/or radio wave frequency generator MW/RF-AWFG for generating largely freely definable waveforms and/or
the magnetic field sensors MSx, MSy, MSz and/or
the magnetic field controllers MFSx, MFSy, MFSz and/or
the first energy processing device SRG and/or
the second energy processing device SRG2 and/or
the BENG energy reserve and/or
the second energy reserve BENG2 and/or
the separator TS and/or
the LDV loading device.

In this context, “radiation-hard” in the sense of the document presented here means that these functional elements of the quantum computer QC are intended and/or suitable for use in space and/or in areas of increased ionizing radiation, such as nuclear reactors or the environment of thermonuclear batteries.

In many optional use cases, it is advantageous if the relocatable quantum computer QC has a control device μC that executes a neural network model at least some of the time. The neural network model, which the control device μC typically executes, processes input values and/or the values of input signals. The neural network model, which the control device μC typically executes, outputs output signals and/or output values of output signals. The control device μC then optionally influences states of quantum dots NV1, NV2, NV3 and/or states of nuclear quantum dots CI1₁, CI1₂, CI1₃, CI2₁, CI2₂, CI2₃, CI3₁, CI3₂, CI3₃ as a function of output signals and/or output values of the neural network model that the control device μC typically executes. Conversely, the control device μC optionally influences input signals and/or input values of the neural network model, which the control device μC typically executes, depending on states of quantum dots NV1, NV2, NV3 and/or states of nuclear quantum dots CI1₁, CI1₂, CI1₃, CI2₁, CI2₂, CI2₃, CI3₁, CI3₂, CI3₃.

Thus, the presently disclosed document discloses, inter alia, a smartphone and/or a portable quantum computing system and/or a mobile quantum computing system and/or vehicle and/or robot and/or aircraft and/or missile and/or satellite and/or a spacecraft and/or space station and/or floating body and/or ship and/or underwater vehicle and/or surface floating body and/or underwater floating body and/or relocatable weapon system and/or warhead and/or surface or underwater vehicle and/or projectile and/or other mobile device and/or movable device. For the sake of simplicity, the present document refers to all these objects hereinafter as “vehicle”. Thus, the present document proposes a vehicle in this very broad sense comprising a relocatable quantum computer QC as previously described. The present document further proposes, conversely, a relocatable quantum computer as previously described, which is a vehicle in the broad sense previously described.

In a further, optional variant, the quantum computer QC is intended to decrypt and/or encrypt the data communication, in particular of the control device μC, via a data interface DBIF. Optionally, this is the data interface DBIF of the control device μC.

Optionally, such a vehicle comprises sensors and/or measuring means in the broadest sense, which supply measured values about the environment of the vehicle and/or states of the vehicle and/or states of the vehicle occupants or users of the vehicle and/or states of the payload of the vehicle to the control device μC. Under certain circumstances, the control device μC may also receive measured values about the vehicle's environment via the data interface DBIF. The quantum computer QC and possibly the control device μC can optionally determine a position assessment for the overall state of the vehicle and/or the environment of the vehicle as a function of such measured values. In this context, the overall state of the vehicle as defined herein may comprise the state of the environment of the vehicle and/or the state of the vehicle occupants and/or the state of a payload of the vehicle.

In a further optional embodiment, the present document proposes that at least one or more sensors SENS of the vehicle is one of the following sensors SENS providing measured values or comprises at least one of the following sensors SENS providing measured values as a subsystem:
a radar sensor and/or
a microphone and/or
an ultrasonic microphone and/or
an infrasonic microphone and/or
an ultrasonic transducer and/or
an infrared sensor and/or
a gas sensor and/or
an acceleration sensor and/or
a speed sensor and/or
a radiation detector and/or
an imaging system and/or
a camera and/or
an infrared camera and/or
a multispectral camera and/or
a LIDAR system and/or
an ultrasonic measuring system and/or
a Doppler radar system and/or
a quantum radar system and/or
a quantum sensor and/or
a position sensor and/or
a navigation system and/or
a GPS sensor (or a functionally equivalent device) and/or
a position sensor and/or
a particle counter and/or
a detection system for biological substances, in particular for biological warfare agents, and/or
a gravimeter and/or
a compass and/or
a gyroscope and/or
a MEMS sensor and/or
a pressure sensor and/or
an inclination angle sensor and/or
a temperature sensor and/or
a humidity sensor and/or
a wind speed sensor and/or
a wavefront sensor and/or
a microfluidic measuring system and/or
a distance measuring system and/or
a length measuring system and/or
a biological sensor for detecting biological markers and/or viruses and/or microbes or the like and/or
a sensor system for detecting biological measurements of vehicle occupants and/or for
detecting biological measurements of living cargo, in particular animals and/or biological materials, and/or
a seat occupancy measuring system and/or
a voltage sensor and/or a current sensor and/or a power sensor.

As an optional further development, the paper presented here proposes a vehicle in the broad sense described above, in which the quantum computer QC controls the vehicle and/or device parts of the vehicle as a function of these measured values and/or influences a control of the vehicle or a device part of the vehicle.

The paper presented here also proposes an optional variant in which the vehicle has an interior and in which the quantum computer QC influences parameters of the interior of the vehicle and/or a device part in the interior of the vehicle as a function of the measured values.

In particular, the technical teaching presented herein discloses that the vehicle may optionally be a weapon system and/or that the vehicle may comprise a weapon system coupled to the quantum computer QC.

For military applications, the vehicle may comprise a fire control system. The fire control system may in turn comprise one or more quantum computers QC and/or be coupled to one or more quantum computers QC. Optionally, the control of the weapon system by the fire control system depends at least temporarily on the quantum computer QC and its signaling. The control of the weapon system by the fire control system optionally takes place in cooperation between the fire control system and the quantum computer QC.

Optionally, the vehicle comprises an evaluation device that classifies the intended control of the weapon system with regard to the expected effects before the control is executed and determines a control command class. The evaluation device optionally prevents execution of the control or postpones this execution until a release by a human user if the control command determined in cooperation with the quantum computer QC falls into a predetermined control class.

For example, the vehicle can identify one or more targets with the help of the relocatable quantum computer QC.

The vehicle can then use the relocatable quantum computer QC, for example, to classify the one or more targets, in particular with the aid of a neural network program that can be executed by a control computer μC of the relocatable quantum computer QC, for example.

In the case of a military vehicle or weapon system, the vehicle or weapon system can use the QC quantum computer to determine a temporal order or prioritization of engagement of multiple targets.

In the case of a military vehicle or weapon system, the vehicle or weapon system may use the quantum computer QC to determine a time to engage a target. In the case of a military vehicle or weapon system, the vehicle or weapon system may use the quantum computer QC to determine a type of weapon and/or munition to engage a target. In one possible embodiment, the present document proposes a vehicle that uses the quantum computer QC to determine a route for the vehicle. In the case of a military vehicle or weapon system, the vehicle or weapon system may use the quantum computer QC to determine a route for a weapon or warhead or projectile or munition or other vehicle.

The present document also proposes, inter alia, a vehicle according to an optional embodiment, wherein the control device μC executes a neural network model at least intermittently and wherein the neural network model processes input values and/or input signals and outputs output signals and/or output values. As already described above, optionally the control device μC typically influences states of the quantum dots NV1, NV2, NV3 and/or states of the nuclear quantum dots CI1₁, CI1₂, CI1₃, CI2₁, CI2₂, CI2₃, CI3₁, CI3₂, CI3₃ as a function of output signals and/or output values of the neural network model. Typically, in this embodiment, the control device μC influences input signals and/or input values of the neural network model depending on the states of the quantum dots NV1, NV2, NV3 and/or states of the nuclear quantum dots CI1₁, CI1₂, CI1₃, CI2₁, CI2₂, CI2₃, CI3₁, CI3₂, CI3₃.

### Substrate

As described above, the relocatable quantum computer QC according to the explained optional embodiment comprises a substrate D with one or more quantum dots NV1, NV2, NV3. Optionally, the substrate D comprises diamond as substrate material. The diamond is optionally isotopically pure or has at least one isotopically pure sub-region which optionally has the quantum dots NV1, NV2, NV3. Optionally, the quantum dots NV1, NV2, NV3 are paramagnetic centers. In the case where the substrate material of the material of substrate D comprises diamond, the paramagnetic centers are optionally ST1 centers and/or optionally TR1 centers and/or optionally NV centers. This means that disturbances emanating from such isotopic impurities do not interfere with the functionality of the quantum bits, or at most to a sufficiently small extent. In relation to diamond, this means that the diamond optionally consists essentially of ¹²C isotopes as base isotopes. Such ¹²C isotopes have no magnetic moment that can interact with the quantum dots NV1, NV2, NV3. Optionally, the nuclear quantum dots CI1₁, CI1₂, CI1₃, CI2₁, CI2₂, CI2₃, CI3₁, CI3₂, CI3₃ are also located in the isotopically pure region of the substrate D. When isotopic purity is mentioned here, the isotopes that serve as nuclear quantum dots CI1₁, CI1₂, CI1₃, CI2₁, CI2₂, CI2₃, CI3₁, CI3₂, CI3₃ are not considered in the assessment of isotopic purity. At this point, this document expressly refers to DE 10 2020 125 189 A1, whose technical teaching for the following international methods is part of the disclosure of this document by reference, insofar as legally permissible in the respective countries of application. For the purposes of this disclosure and DE 10 2020 125 189 A1, a material is isotopically pure if the concentration of isotopes other than the base isotopes that dominate the material is so low that the technical purpose is achieved to a sufficient extent for the production and sale of products with an economically sufficient production yield. DE 10 2020 125 189 A1 lists the relevant isotope ratios of the relevant elements on which the technical teaching disclosed here is based. Since isotopically pure diamonds are extremely expensive, it is useful if the substrate D comprises a diamond material and, for example, the diamond material comprises an epitaxially at least locally grown isotopically pure layer consisting essentially of ¹²C isotopes. This layer can, for example, be deposited by CVD and other deposition methods on the original surface of a silicon wafer used as substrate D or a diamond surface. In the following, the term substrate D from now on includes the part of the combination of substrate D and epitaxial grown layer DEPI in which the quantum dots NV1, NV2, NV3 are fabricated. Typically, this is the epitaxial layer DEPI. The term “essentially” means that the total proportion K_{1G}′ of the C isotopes with magnetic moment that are part of the substrate D, based on 100% of the C atoms that are part of the substrate D, is reduced to a proportion K_{1G}′ of the C isotopes with magnetic moment that are part of the substrate D, based on 100% of the C isotopes that are part of the substrate D, compared to the natural total proportion K_{1G} given in the tables of DE 10 2020 125 189 A1. Optionally, this proportion K_{1G}′ is less than 50%, better than 20%, better than 10%, better than 5%, better than 2%, better than 1%, better than 0.5%, better than 0.2%, better than 0.1% of the total natural fraction K_{1G′} for C isotopes with magnetic moment on the C isotopes of the substrate D in the area of influence of the quantum dots NV1, NV2, NV3 and/or the nuclear quantum dots CI1₁, CI1₂, CI1₃, CI2₁, CI2₂, CI2₃, CI3₁, CI3₂, CI3₃. When determining the proportion K_{1G}′, those C atoms of the nuclear quantum dots CI1₁, CI1₂, CI1₃, CI2₁, CI2₂, CI2₃, CI3₁, CI3₂, CI3₃ are not taken into account, as their magnetic moments are intentional and therefore not parasitic.

The use of NV centers and/or ST1 centers and/or TR1 centers and/or TR12 centers or L1 centers as quantum dots NV1, NV2, NV3 of the quantum bits of the quantum computer optionally enables the operation of the quantum computer QC at room temperature and thus the deployability of the quantum computer QC in the first place. The electron spin configuration of such a paramagnetic center optionally serves as a quantum dot of the quantum dots NV1, NV2, NV3. Optionally, in addition to such quantum dots NV1, NV2, NV3 as quantum bits, the relocatable quantum computer QC also comprises nuclear nuclear quantum dots CI1₁, CI1₂, CI1₃, CI2₁, CI2₂, CI2₃, CI3₁, CI3₂, CI3₃ as nuclear nuclear quantum bits. Typically, the magnetic moments of isotopes having such nonzero magnetic moments due to a nuclear spin serve as nuclear nuclear quantum dots CI1₁, CI1₂, CI1₃, CI2₁, CI2₂, CI2₃, CI3₁, CI3₂, CI3₃. Optionally, such nuclear magnetic moments of the respective isotopes of the nuclear quantum dots CI1₁, CI1₂, CI1₃, CI2₁, CI2₂, CI2₃, CI3₁, CI3₂, CI3₃ couple with the electron configuration of the paramagnetic centers of the quantum dots NV1, NV2, NV3. This enables a control device μC of the quantum computer QC to manipulate the nuclear nuclear quantum dots CI1₁, CI1₂, CI1₃, CI2₁, CI2₂, CI2₃, CI3₁, CI3₂, CI3₃ by manipulating the states of the quantum dots NV1, NV2, NV3. The control device μC can also detect the nuclear quantum states of the nuclear nuclear quantum dots CI1₁, CI1₂, CI1₃, CI2₁, CI2₂, CI2₃, CI3₁, CI3₂, CI3₃ by means of an electrical or optical readout of the quantum states of the quantum dots NV1, NV2, NV3. The control device μC can also couple distant nuclear quantum dots CI1₁, CI1₂, CI1₃, CI2₁, CI2₂, CI2₃, CI3₁, CI3₂, CI3₃ to each other by means of chains of coupled quantum dots NV1, NV2, NV3. The nuclear nuclear quantum dots CI1₁, CI1₂, CI1₃, CI2₁, CI2₂, CI2₃, CI3₁, CI3₂, CI3₃ thus form nuclear nuclear quantum bits. These nuclear nuclear quantum dots CI1₁, CI1₂, CI1₃, CI2₁, CI2₂, CI2₃, CI3₁, CI3₂, CI3₃ are optionally the nuclear spins of isotopes with a magnetic nuclear moment. At this point, the document presented here expressly refers again to the document DE 10 2020 125 189 A1, whose technical teaching for the following international methods, insofar as legally permissible in the respective countries of application, is part of the disclosure of this document by referencing. The nuclear nuclear quantum dots CI1₁, CI1₂, CI1₃, CI2₁, CI2₂, CI2₃, CI3₁, CI3₂, CI3₃ of the nuclear nuclear quantum bits are characterized by very long T2 times. Optionally, the proposed relocatable quantum computer QC uses its quantum dots NV1, NV2, NV3 to control and entangle the states of the nuclear nuclear quantum dots CI1₁, CI1₂, CI1₃, CI2₁, CI2₂, CI2₃, CI3₁, CI3₂, CI3₃ and for reading out the nuclear quantum states of the nuclear quantum dots CI1₁, CI1₂, CI1₃, CI2₁, CI2₂, CI2₃, CI3₁, CI3₂, CI3₃. The quantum states of the quantum dots NV1, NV2, NV3 can be read out optically and/or electrically. With regard to the electrical readout, this document expressly refers to the document DE 10 2020 125 189 A1, the technical teaching of which for the following international methods is part of the disclosure of the document presented here, insofar as legally permissible in the countries of application concerned. A further advantage of the relocatable quantum computer QC proposed here is the relatively simple operability and the better selectivity of the control of the quantum dots NV1, NV2, NV3 of the quantum bits and the good scalability compared to other quantum computers.

As described above, a quantum computer QC optionally comprises a substrate D with one or more quantum dots NV1, NV2, NV3. Optionally, the substrate D also optionally has one or more nuclear nuclear quantum dots CI1₁, CI1₂, CI1₃, CI2₁, CI2₂, CI2₃, CI3₁, CI3₂, CI3₃. Optionally, the quantum dots NV1, NV2, NV3 are one or more paramagnetic centers that form one or more quantum bits. Optionally, the nuclear nuclear quantum dots CI1₁, CI1₂, CI1₃, CI2₁, CI2₂, CI2₃, CI3₁, CI3₂, CI3₃ are one or more isotopes with magnetic moment, which form one or more nuclear quantum bits. The document presented here again expressly refers to DE 10 2020 125 189 A1. Optionally, the nuclear quantum dots CI1₁, CI1₂, CI1₃, CI2₁, CI2₂, CI2₃, CI3₁, CI3₂, CI3₃ are therefore the magnetic moments of individual isotopes in the vicinity of the quantum dots NV1, NV2, NV3. Here, “proximity” means that a coupling of the magnetic moments of the relevant isotopes, which form the nuclear nuclear quantum dots CI1₁, CI1₂, CI1₃, CI2₁, CI2₂, CI2₃, CI3₁, CI3₂, CI3₃, with the nearby quantum dot of the nearby quantum bit is possible with the device presented here.

The quantum dots NV1, NV2, NV3 optionally have a magnetic moment of an electron configuration of the respective quantum dot. The quantum dots NV1, NV2, NV3 optionally couple with each other by means of this magnetic moment in the sense of the technical teaching of the paper presented here. Optionally, one or more quantum dots NV1, NV2, NV3 are paramagnetic centers in the substrate D. Optionally, the Fermi level of the substrate D in the region of a paramagnetic center used as a quantum dot is set such that the paramagnetic center is electrically charged. Optionally, the electrical charge is negative. In the case of an NV center as a paramagnetic center, the NV center is optionally negatively charged. In the case of an NV center as a paramagnetic center, the NV center is thus optionally an NV⁻ center. Optionally, the NV centers in the substrate D therefore comprise NV⁻ centers. Optionally, doping the substrate D in the region of the paramagnetic center ensures that the paramagnetic center is electrically charged in the intended manner. Optionally, isotopes without magnetic moment as dopant atoms dope the material of the substrate D in the region of the relevant quantum dot of the quantum dots NV1, NV2, NV3. Optionally, these dopant atoms without magnetic moment shift the Fermi level in the region of this particular quantum dot. Optionally, these dopant atoms without magnetic moment thus shift the Fermi level in the region of the relevant paramagnetic center. Optionally, the substrate D essentially comprises isotopes without a magnetic nuclear moment apart from the isotopes that serve as nuclear quantum dots CI1₁, CI1₂, CI1₃, CI2₁, CI2₂, CI2₃, CI3₁, CI3₂, CI3₃ of the nuclear quantum bits. Since the atoms of the III. Main group of the periodic table and the V. Main group of the periodic table generally do not have stable isotopes without magnetic moment, mixtures and/or compounds of isotopes without magnetic moment, for example isotopes of the IV. main group z. B. ¹²C, ¹⁴C, ²⁸Si, ³⁰Si, ⁷⁰Ge, ⁷²Ge, ⁷⁴Ge, ⁷⁶Ge, ¹¹²Sn, ¹¹⁴Sn, ¹¹⁶Sn, ¹¹⁸Sn, ¹²⁰Sn, ¹²²Sn, ¹²⁴Sn and/or of the VI. main group ¹⁶O, ¹⁸O, ³²S, ³⁴S, ³⁶S, ⁷⁴Se, ⁷⁶Se, ⁷⁸Se, ⁸⁰Se, ⁸²Se, ¹²⁰Te, ¹²²Te, ¹²⁴Te, ¹²⁶Te, ¹²⁸Te, ¹³⁰Te, and/or of the II. main group ²⁴ Mg, ²⁶ Mg, ⁴⁰Ca, ⁴²Ca, ⁴⁴Ca, ⁴⁶Ca, ⁴⁸Ca, ⁸⁴Sr, ⁸⁶Sr, ⁸⁸ Sr, ¹³⁰Ba, ¹³²Ba, ¹³⁴Ba, ¹³⁶Ba, ¹³⁸Ba, and/or o the II. main group ⁴⁶Ti, ⁴⁸Ti, ⁵⁰Ti, ⁹⁰Zr, ⁹⁰Zr, ⁹²Zr, ⁹⁴Zr, ⁹⁶Zr, ¹⁷⁴Hf, ¹⁷⁶Hf, ¹⁷⁸Hf, and/or of the IV. minor group ⁵⁰Cr, ⁵²Cr, ⁵³Cr, ⁹²Mo, ⁹⁴Mo, ⁹⁶Mo, ⁹⁸Mo, ¹⁰⁰Mo, ¹⁸⁰ W, ¹⁸² W, ¹⁸⁴W, ¹⁸⁶W, and/or of the VI. minor group ⁵⁴Fe, ⁵⁶Fe, ⁵⁸Fe, ⁹% Ru, ⁹⁸Ru, ¹⁰⁰Ru, ¹⁰²Ru, ¹⁰⁴Ru, ¹⁸⁴Os, ¹⁸⁶Os, ¹⁸⁸Os, ¹⁹⁰Os, ¹⁹²Os and/or of the VIII. minor group ⁵⁸Ni, ⁶⁰Ni, ⁶²Ni, ⁶⁴Ni, ¹⁰²Pd, ¹⁰²Pd, ¹⁰⁴Pd, ¹⁰⁶Pd, ¹⁰⁸Pd, ¹¹⁰Pd, ¹⁹⁰ Pt, ¹⁹² Pt, ¹⁹⁴ Pt, ¹⁹⁶ Pt, ¹⁹⁸ Pt and/or of the X. minor group ⁶⁴Zn, ⁶⁶Zn, ⁶⁸Zn, ⁷⁰Zn, ¹⁰⁶Cd, ¹⁰⁸Cd, ¹¹⁰Cd, ¹¹²Cd, ¹¹⁴Cd, ¹¹⁶Cd, ¹⁹⁶Hg, ¹⁹⁸Hg, ²⁰⁰Hg, ²⁰²Hg, ²⁰⁴Hg and/or of the Lanthanides: ¹³⁶Ce, ¹³⁸Ce, ¹⁴⁰Ce, ¹⁴²Ce, ¹⁴²Nd, ¹⁴⁴Nd, ¹⁴⁶Nd, ¹⁴⁸Nd, ¹⁵⁰Nd, ¹⁴⁴Sm, ¹⁴⁶Sm, ¹⁴⁸Sm, ¹⁵⁰Sm, ¹⁵²Sm, ¹⁵⁴Sm, ¹⁵²Gd, ¹⁵⁴Gd, ¹⁵⁶Gd, ¹⁵⁸Gd, ¹⁶⁰Gd, ¹⁵⁶Dy, ¹⁵⁸Dy, ¹⁶⁰Dy, ¹⁶²Dy, ¹⁶⁴Dy, ¹⁶²Er, ¹⁶²Er, ¹⁶⁴Er, ¹⁶⁶Er, ¹⁶⁸Er, ¹⁷⁰Er, ¹⁶⁸Yb, ¹⁷⁰Yb, ¹⁷²Yb, ¹⁷⁴Yb, ¹⁷⁶Yb, and/or of the Actinides ²³²Th, ²³⁴Pa, ²³⁴U, ²³⁸U, ²⁴⁴Pu. These isotopes can also be used as doping atoms for doping the substrate (D). If the substrate D comprises diamond and if the quantum dots NV1, NV2, NV3 comprise paramagnetic centers, ³²S, ³⁴S, ³⁶S, ¹⁶O and ¹⁸O can optionally be considered as doping isotopes for shifting the Fermi level. For the formation of NV centers in diamond as substrate D, a beneficial effect can also be observed for doping with phosphorus, which is less optimal, however, since the phosphorus isotopes typically have a magnetic moment that interacts with the electron configuration of the paramagnetic centers. However, this interaction is typically undesirable.

### Light Source LD

The relocatable quantum computer QC according to the optional embodiment shown in FIG. 1 comprises a light source LD. The light source LD is optionally a laser that can irradiate quantum dots NV1, NV2, NV3 of the relocatable quantum computer with pump radiation LB of a pump radiation wavelength λₚₘₚ. Optionally, the light source LD irradiates the relevant quantum dots NV1, NV2, NV3 with pump radiation LB, which is pulse-modulated in its temporal intensity profile, i.e. optionally pulsed.

Optionally, the light source LD can emit light pulses of the pump radiation LB at light pulse start times tₛₚ that can be preset by the control device μC in relation to a reference time t₀ₚ with a light pulse duration t_{dp}. Optionally, a control device μC of the relocatable quantum computer controls the light source LD with the aid of a light source driver LDRV via a control data bus SDB. The light source driver LDRV supplies the light source LD with energy. This energy supply to the light source LD typically depends on control commands that the light source driver LDRV receives from the control device μC via the control data bus SDB. The radiant power of the pump radiation LB emitted by the light source LD typically depends on control commands that the light source driver LDRV receives from the control device μC via the control data bus SDB, as well as on one or more transmit signals S5. Optionally, the light source LD is a semiconductor laser. Optionally, the light source LD is a laser diode. However, the use of an LED (light-emitting diode) as the light source LD is also conceivable. In the exemplary use of NV centers as paramagnetic centers NV1, NV2, NV3 in diamond as quantum dots, the light of the light source LD used as pump radiation LB optionally has a wavelength in a wavelength range from 400 nm to 700 nm wavelength and/or better 450 nm to 650 nm and/or better 500 nm to 550 nm and/or better 515 nm to 540 nm. In the course of developing the technical content of this document, a wavelength of 532 nm of the electromagnetic radiation of the light source LD used as pump radiation LB gave good results. Optionally, the light source LD comprises a laser, which is optionally a semiconductor laser. In the case of NV centers as paramagnetic centers in diamond as substrate D, an OSRAM laser diode of the type PLT5 520B with a wavelength of 520 nm has proven to be an exemplary light source LD for irradiating the NV centers in diamond with pump radiation LB. The proposed relocatable quantum computer QC optionally comprises the said light source driver LDRV which controls the emission of the pump radiation LB by the light source LD.

Optionally, a waveform generator WFG controls the light source driver LDRV and thus the light source LD by means of a transmission signal S5. The waveform generator WFG optionally generates the transmission signal S5 synchronized in time with the radio frequency and microwave signals that the microwave and/or radio wave frequency generator MW/RF-AWFG generates to generate largely freely predeterminable waveforms (arbitrary waveform generator) and radiates into the substrate D by means of a microwave and/or radio wave antenna mWA. The microwave and/or radio wave antenna mWA thus irradiates the quantum dots NV1, NV2, NV3 and the nuclear quantum dots CI1₁, CI1₂, CI1₃, CI2₁, CI2₂, CI2₃, CI3₁, CI3₂, CI3₃ in a fixed temporal phase relationship to the light pulses of the irradiation of the quantum dots NV1, NV2, NV3 and the nuclear quantum dots CI1₁, CI1₂, CI1₃, CI2₁, CI2₂, CI2₃, CI3₁, CI3₂, CI3₃ with pump radiation LB by the light source LD. Typically, the microwave and/or radio wave frequency generator MW/RF-AWFG synchronizes to the transmit signal S5 of the waveform generator WFG, optionally to the transmit signal S5). This ensures that the phase position between the radio and microwave signals of the microwave and/or radio wave frequency generator MW/RF-AWFG on the one hand, and the light pulses of the light source LD on the other hand, are in a predeterminable phase relationship to each other. Optionally, the computer core CPU of the control device μC of the relocatable quantum computer QC sets the operating parameters of the waveform generator WFG and the microwave and/or radio wave frequency generator MW/RF-AWFG according to the desired quantum operation in such a way, so that they can manipulate the quantum states of the quantum dots NV1, NV2, NV3 and the core quantum states of the nuclear quantum dots CI1₁, CI1₂, CI1₃, CI2₁, CI2₂, CI2₃, CI3₁, CI3₂, CI3₃ as intended.

The LD light source optionally includes a photodetector. Optionally, the system comprising light source LD and light source driver LDRV comprises a controller. The photodetector PD of the light source LD can be a photodiode, for example, which typically monitors the intensity of the pump radiation LB emitted by the light source LD. Optionally, the controller is part of the light source driver LDRV. The light source driver LDRV optionally drives the light source LD as a function of the transmission signal S5. Optionally, the controller is a P-controller or better an I-controller or better a PI-controller or better a PID-controller or a controller with a frequency-optimized frequency response of the gain of the open control loop or the loop gain. The controller optionally compares the value of the measurement signal of the photodetector of the light source LD with the transmission signal S5 of the waveform generator WFG. Depending on the comparison result of the value of the transmission signal S5 together with the value of the measurement signal of the photodetector of the light source LD, the controller of the light source LD then adjusts the intensity of the pump radiation LB. The controller of the light source LD optionally adjusts the intensity of the pump radiation LB by changing the driver power of the light source driver LDRV. As a result, in the ideal case, the intensity of the pump radiation LB essentially corresponds to the value of the transmission signal S5 in the steady state, except for control deviations. Ideally, the controller of the light source driver LDRV has an analog-to-digital converter and a data interface to the internal control data bus SDB of the relocatable quantum computer QC. In this case, the controller and/or a control computer of the light source driver LDRV and/or a control computer of the light source LD can make the intensity values of the pump radiation LB recorded by the controller of the light source driver LDRV of the light source LD and/or the control computer of the light source LD and/or the controller of the light source driver LDRV available to the control device μC of the relocatable quantum computer QC, for example via the control data bus SDB of the relocatable quantum computer QC. In this case, the controller and/or said control computer of the light source LD and/or the control computer of the light source LD can also make the other operating parameters of the light source LD, for example by means of an analog-to-digital converter and/or sensors within the light source LD and/or the light source driver LDRV, such as respective operating voltages, respective temperatures or the like, available to the control device μC of the relocatable quantum computer QC, for example via the control data bus SDB of the relocatable quantum computer QC. Optionally, an amplifier of the light source LD and/or an amplifier of the light source driver LDRV amplify the signal of the photodetector of the light source LD before, for example, the analog-to-digital converter of the controller of the light source driver LDRV converts it into a digital measurement signal for the controller of the light source driver LDRV of the light source LD. The control device μC can configure the light source LD and/or the light source driver LDRV and its components via the control data bus SDB, for example. Such configuration targets can be, for example, the controller of the light source driver LDRV of the light source LD and its control parameters and/or the gain and/or the frequency response of the amplifier of the light source LD and/or the gain and/or the frequency response of the amplifier of the light source driver LDRV and its parameters. The light source driver LDRV and the light source LD can form a unit. The light source driver LDRV and the light source LD may have one or more common control computers and/or one or more common analog-to-digital converters. For setting analog control parameters, the light source LD and/or the light source driver LDRV may have one or more digital-to-analog converters that provide analog control levels within the light source LD and/or the light source driver LDRV. The control device μC of the quantum computer QC optionally controls these digital-to-analog converters via the control data bus SDB. The control computer of the light source LD and/or the control computer of the light source driver LDRV, if present, can also control the digital-to-analog converters.

### Optical System

The optical system OS of the quantum computer QC according to the optional embodiment shown in FIG. 1 optionally comprises a confocal microscope. The light source LD emits the pump radiation LB. In the example shown in FIG. 1, the pump radiation LB passes through the dichroic mirror DBS. The optical system OS focuses the pump radiation LB onto quantum dots NV1, NV2, NV3 and/or nuclear nuclear quantum dots CI1₁, CI1₂, CI1₃, CI2₁, CI2₂, CI2₃, CI3₁, CI3₂, CI3₃ at the focal point of the optical system OS. The OS optical system optionally uses its confocal microscope. The irradiation of the quantum dots NV1, NV2, NV3 typically causes the quantum dots NV1, NV2, NV3 to emit fluorescence radiation FL. The optical system OS typically detects at least a part of the fluorescent radiation FL of the quantum dots NV1, NV2, NV3. The optical system OS feeds this detected fluorescence radiation FL to the photodetector PD via the dichroic mirror DBS. Optionally, the dichroic mirror DBS or another device separates the pump radiation LB and the fluorescence radiation FL from each other in such a way that essentially only fluorescence radiation FL reaches the photodetector PD. Instead of a dichroic mirror DBS, the quantum computer QC proposed here can therefore also comprise a combination of a semi-transparent mirror and an optical filter. In this case, the optical filter is then optionally arranged relative to the semi-transparent mirror on the side of the photodetector PD. Optionally, the optical filter then allows radiation with the fluorescence wavelength λ_{fl} of the fluorescence radiation FL to pass through essentially unattenuated. Optionally, the optical filter then essentially does not allow radiation with the pump radiation wavelength λₚₘₚ of the pump radiation LB to pass. In the example of FIG. 1, the proposed quantum computer QC has a further semi-transmissive or partially reflective mirror STM. In the example of FIG. 1, the further semi-transmissive or partially reflective mirror STM separates a part of the fluorescence radiation FL. The further semi-transmissive or partially reflective mirror STM feeds this split fluorescence radiation FL to an exemplary first camera CM1. The first camera CM1 captures an image of the quantum dots NV1, NV2, NV3 emitting fluorescence radiation FL. In the example of FIG. 1, the control device μC can access the first camera CM1 and the captured image of the first camera CM1 via an exemplary first camera interface CIF and the control data bus SDB. For example, a user can access the image of the first camera CM1 via the external data bus EXTDB or another interface of the control device μC via the control computer μC, and control parts of the quantum computer QC depending on the captured image of the first camera CM1. The computer core CPU of the control device μC can also, for example, query the captured image of the first camera CM1 via the control data bus SDB and then evaluate it, or store it in a memory RAM, NVM, or process it in some other way. For example, the computer core CPU of the control device μC can execute an image processing program. For example, the computer core CPU of the control device μC or another suitable subdevice of the quantum computer QC can determine a mechanical offset of the quantum dots NV1, NV2, NV3 relative to the optical system OS, for example by evaluating the image captured by the first camera CM1, and determine an offset vector. Optionally, the computer core CPU of the control device μC or the other suitable subdevice of the quantum computer QC corrects this offset of the quantum dots NV1, NV2, NV3 with respect to the optical system OS that it has detected. For example, the computer core CPU of the control device μC or the other suitable subdevice of the quantum computer QC can eliminate the detected offset vector by means of a translatory positioning device in the X direction XT and/or a translatory positioning device in the Y direction YT. For this purpose, the translatory positioning device optionally displaces the substrate D with the quantum ALU comprising quantum dots NV1, NV2, NV3 and/or nuclear nuclear quantum dots CI1₁, CI1₂, CI1₃, CI2₁, CI2₂, CI2₃, CI3₁, CI3₂, CI3₃ in the X direction in such a way that the X component of the detected offset vector optionally becomes substantially 0. For example, the control device μC can optionally control the translatory positioning device XT in the X direction via the control data bus SDB by means of an X control device GDX and query operating parameters of the positioning device XT in the X direction. The X control device GDX for the translatory positioning device XT in the X direction is optionally connected to the control data bus SDB for this purpose. Optionally, the computer core CPU of the control device μC or the other suitable subdevice of the quantum computer QC performs a control algorithm that corresponds to a PI or PI controller or another suitable controller. Furthermore, the translational positioning device optionally displaces the substrate D with the quantum ALU comprising quantum dots NV1, NV2, NV3 and/or nuclear nuclear quantum dots CI1₁, CI1₂, CI1₃, CI2₁, CI2₂, CI2₃, CI3₁, CI3₂, CI3₃ in the Y-direction YT in such a way that the Y-component of the determined offset vector optionally becomes substantially 0. For example, the control device μC can optionally control the translatory positioning device YT in the Y direction via the control data bus SDB by means of a Y control device GDY for the translatory positioning device YT in the Y direction and query operating parameters of the positioning device YT in the Y direction. The Y control device GDY for the translatory positioning device YT in the Y direction is optionally connected to the control data bus SDB for this purpose. Optionally, the computer core CPU of the control device μC or the other suitable subdevice of the quantum computer QC performs a control algorithm which corresponds to a PI or PI controller or another suitable controller. Optionally, the quantum computer QC also has a refocusing device. For example, the optical system OS may comprise a dividing device that allows the optical system OS to be shifted in the Z direction relative to the substrate D. Optionally, the computer core CPU of the control device μC can control this partial device for displacing the optical system OS in the Z direction via the control data bus STB. Optionally, the computer core CPU of the control device μC can use the control data bus STB to access operating parameters of this partial device for displacing the optical system OS in the Z direction and optionally automatically focus the confocal microscope of the optical system OS. Optionally, the computer core CPU of the control device μC adjusts the distance between the optical system OS and substrate D via the control data bus STB as a function of the captured image of the first camera CM1 using this partial device for displacing the optical system OS in the Z direction in such a way that the focus of the captured images of the first camera lies on the fluorescent quantum dots NV1, NV2, NV3 and also remains there in the event of mechanical interference. If the control device μC, by manipulating the quantum state of quantum dots NV1, NV2, NV3, reduces or suppresses the fluorescence radiation FL of such quantum dots NV1, NV2, NV3 too far, the control device μC optionally does not take the fluorescence radiation FL of these quantum dots NV1, NV2, NV3 further into account for the duration of this state of these quantum dots NV1, NV2, NV3 in the position control of the substrate D with respect to the optical system OS or in the focus control of the optical system OS. If the control device μC enables or increases the fluorescence radiation FL of such quantum dots NV1, NV2, NV3 to a sufficient extent by manipulating the quantum state of quantum dots NV1, NV2, NV3, the control device μC optionally takes the fluorescence radiation FL of these quantum dots NV1, NV2, NV3 into account again for the duration of this state of these quantum dots NV1, NV2, NV3 in the position control of the substrate D with respect to the optical system OS or in the focus control of the optical system OS. The proposed quantum computer QC thus optionally comprises one or more control loops for stabilizing the spatial position of the quantum dots NV1, NV2, NV3 and/or nuclear nuclear quantum dots CI1₁, CI1₂, CI1₃, CI2₁, CI2₂, CI2₃, CI3₁, CI3₂, CI3₃ relative to the focal point of the optical system OS and, optionally, one or more control loops for stabilizing the spatial position of the quantum dots NV1, NV2, NV3 and/or nuclear nuclear quantum dots CI3₁, CI3₂, CI3₃ relative to the focal point of the optical system OS. optionally one or more control loops for stabilizing the focus of the optical system OS on the quantum dots NV1, NV2, NV3 and/or the nuclear nuclear quantum dots CI1₁, CI1₂, CI1₃, CI2₁, CI2₂, CI2₃, CI3₁, CI3₂, CI3₃ of the substrate D.

Optionally, the control device μC adjusts the light source LD and/or the light source driver LDRV depending on the captured image of the first camera CM1. The light source driver LDRV is optionally connected to the control data bus SDB for this purpose. The computer core CPU can then control the light source driver LDRV via this control data bus STB and optionally query its operating parameters. It is conceivable that the proposed quantum computer QC within the light source LD and/or within the light source driver LDRV comprises an optical monitoring device, for example a monitor photodiode, with a monitor diode evaluation device associated with this monitor photodiode, which monitors the intensity of the emission of the pump radiation LB of the light source LD and records its parameters. The computer core CPU of the control device μC can then optionally read out these recorded parameters via the control data bus SDB. The control device μC and/or the said optical monitoring device of the light source LD and/or the light source driver LDRV and/or another sub-device of the relocatable quantum computer QC can then readjust the intensity of the emission of the pump radiation LB of the light source LD, for example depending on the value of the transmission signal S5 or another parameter specified by you.

According to the optional embodiment shown in FIG. 1, the photodetector PD detects the fluorescence radiation FL of the quantum dots NV1, NV2, NV3. The photodetector PD converts the detected fluorescence radiation FL into a receiver output signal S0. An amplifier V optionally amplifies and/or filters the receiver output signal S0. Optionally, the amplifier V amplifies and/or filters the receiver output signal S0 as a function of the transmitter signal S5. Optionally, the amplifier V comprises one or more analog-to-digital converters. Optionally, the computer core CPU of the control device can query values of these analog-to-digital converters via the control data bus SDB. Optionally, an analog-to-digital converter ADCV of the amplifier in cooperation with an internal amplifier IVV of the amplifier V converts the receiver output signal S0 into measured values of samples of the receiver output signal S0. Optionally, the amplifier V is connected to the control data bus SDB for this purpose. Optionally, the computer core CPU of the control device STV can set and/or query operating parameters of the amplifier V via the control data bus SDB. These operating parameters can, for example, be the gain and/or filter parameters of a filtering process performed by the amplifier V.

### Microwave Control MW/RF-AWFG, mWA

The relocatable quantum computer QC according to the optional embodiment shown in FIG. 1 optionally comprises one or more devices MW/RF-AWFG, mWA for generating an electromagnetic wave field at the respective location of the quantum dots NV1, NV2, NV3 and/or at the respective location of the nuclear nuclear quantum dots CI1₁, CI1₂, CI1₃, CI2₁, CI2₂, CI2₃, CI3₁, CI3₂, CI3₃. For example, such a device can be MW/RF-AWFG, mWA for generating an electromagnetic wave field at the respective location of the quantum dots NV1, NV2, NV3 and/or at the respective location of the nuclear nuclear quantum dots CI1₁, CI1₂, CI1₃, CI2₁, CI2₂, CI2₃, CI3₁, CI3₂, CI3₃ comprise one or more microwave/radio frequency generators with optionally freely selectable waveform MW/RF-AWFG and one or more antennas mWA connected to these via one or more waveguides. These antennas mWA then generate the said electromagnetic wave field at the respective location of the quantum dots NV1, NV2, NV3 and/or at the respective location of the nuclear nuclear quantum dots CI1₁, CI1₂, CI1₃, CI2₁, CI2₂, CI2₃, CI3₁, CI3₂, CI3₃. A simple wire can already serve as an antenna mWA if the quantum dots NV1, NV2, NV3 are arranged at a sufficiently small distance from the wire. The said electromagnetic wave field at the respective location of the quantum dots NV1, NV2, NV3 and/or at the respective location of the nuclear nuclear quantum dots CI1₁, CI1₂, CI1₃, CI2₁, CI2₂, CI2₃, CI3₁, CI3₂, CI3₃ depends on the output signals of the one or more microwave/radio frequency generators with optionally freely selectable waveform MW/RF-AWFG in each case. Optionally, the control device μC controls the one or more devices MW/RF-AWFG, mWA via the control data bus SDB to generate an electromagnetic wave field at the respective location of the quantum dots NV1, NV2, NV3 and/or at the respective location of the nuclear nuclear quantum dots CI1₁, CI1₂, CI1₃, CI2₁, CI2₂, CI2₃, CI3₁, CI3₂, CI3₃. Optionally, the transmit signal S5 synchronizes the generation of the electromagnetic wave field at the respective location of the quantum dots NV1, NV2, NV3 and/or at the respective location of the nuclear nuclear quantum dots CI1₁, CI1₂, CI1₃, CI2₁, CI2₂, CI2₃, CI3₁, CI3₂, CI3₃ by the one or more devices MW/RF-AWFG, mWA to generate an electromagnetic wave field at the respective location of the quantum dots NV1, NV2, NV3 and/or at the respective location of the nuclear nuclear quantum dots CI1₁, CI1₂, CI1₃, CI2₁, CI2₂, CI2₃, CI3₁, CI3₂, CI3₃. For example, the transmit signal S5 may include the generation of the electromagnetic wave field at the respective location of the quantum dots NV1, NV2, NV3 and/or at the respective location of the nuclear nuclear quantum dots CI1₁, CI1₂, CI1₃, CI2₁, CI2₂, CI2₃, CI3₁, CI3₂, CI3₃ by the one or more devices MW/RF-AWFG, mWA for generating an electromagnetic wave field at the respective location of the quantum dots NV1, NV2, NV3 and/or at the respective location of the nuclear nuclear quantum dots CI1₁, CI1₂, CI1₃, CI2₁, CI2₂, CI2₃, CI3₁, CI3₂, CI3₃ synchronize with the light source driver LDRV and thus with the emission of the pump radiation LB of the light source LD.

### Control Device μC

Optionally, the relocatable quantum computer QC according to the optional embodiment shown in FIG. 1 comprises the aforementioned control device μC with the computer core CPU. Optionally, the control device μC is a conventional digital computer in Von Neumann or Harvard architecture. The control device μC optionally comprises a computer core CPU and optionally one or more data and program memories RAM NVM. For example, it can be an ARM controller. For example, the computer core CPU can be an ARM Cortex-A78AE for safety-critical applications. The ARM Cortex-A78AE is characterized by the fact that it includes supporting device parts and functions to meet the ISO 26262 ASIL B and ASIL D safety requirements. The paper presented here therefore proposes to provide in certain cases a computer core CPU that has supporting device parts and functions to fulfill the ISO 26262 ASIL B and ASIL D safety requirements or functionally equivalent standards such as IEC 61508 and/or IEC 62061:2021, EN 61511, EN 50129, EN 62304, US RTCA DO-178B, US RTCA DO-254, EUROCAE ED-12B. The data and program memory RAM NVM or the multiple data and program memory RAM NVM can be designed in whole or in part as non-volatile memory NVM and/or in whole or in part as volatile memory RAM. The data and program memory of the control device μC can be read-only in whole or in part, and writable/readable in whole or in part. The data and program memory RAM NVM can, for example, comprise a RAM, an SRAM, a DRAM, a ROM, an EEPROM, a PROM, a flash memory and/or functionally equivalent memories. The control device μC can comprise a bootstrap device for loading the start program into the data and program memory. The data and program memory RAM NVM of the control device μC can comprise a BIOS. The data and program memory RAM NVM of the control device μC can comprise a data memory and/or a program memory. The computer core CPU of the control device μC can comprise a data interface DBIF for communication with other computer systems, in particular a higher-level central control unit ZSE, and with user interfaces. This data interface DBIF can be wired and/or wireless. The paper presented here refers to the relevant literature on data networks.

### Control Tasks of the μC Control Device

Optionally, the control device μC of the relocatable quantum computer QC according to the optional embodiment shown in FIG. 1 also controls the intensity and modulation of the pump radiation LB, and intensity modulation of the light source LD by means of its computer core μC. For this purpose, for example, the computer core CPU of the control device μC can control the temporal progression of the intensity of the pump radiation LB emitted by the light source LD. Optionally, the temporal intensity curve of the pump radiation LB of the light source LD is pulse-modulated. The computer core CPU of the control device μC controls the light source LED by means of the waveform generator WFG via the light source driver LDRV. The computer core CPU of the control device μC optionally controls the intensity Iₚ and/or the temporal position tₛₚ of the pulses and/or the temporal duration t_{dp} of the pulses of the pulsed pump radiation LB of the light source LD. The computer core CPU of the control device μC of the relocatable quantum computer QC can thus influence the states of the quantum dots NV1, NV2, NV3 of the proposed relocatable quantum computer QC via this intensity Iₚ of the pulses of the pump radiation LB and via the temporal position tₛₚ of the pulses of the pump radiation LB and via the temporal duration t_{dp} of the pulses of the pump radiation LB. Therefore, via this intensity Iₚ of the pulses of the pump radiation LB and via the temporal position tₛₚ of the pulses of the pump radiation LB and via the temporal duration t_{dp} of the pulses of the pump radiation LB, the computer core CPU of the control device μC of the relocatable quantum computer QC can thus couple the states of quantum dots NV1, NV2, NV3 of the quantum dots with one another. In doing so, the device synchronizes these pulses of the pump radiation LB, for example by means of the computer core CPU of the control device μC and/or by means of suitable synchronizations and/or by means of synchronization signals with, if necessary microwave and/or radio signals generated by the microwave and/or radio wave frequency generator MW/RF-AWFG to control the quantum dots NV1, NV2, NV3 and/or nuclear quantum dots CI1₁, CI1₂, CI1₃, CI2₁, CI2₂, CI2₃, CI3₁, CI3₂, CI3₃. One such synchronization signal can be the transmission signal S5. These microwave and/or radio signals generated by the microwave and/or radio wave frequency generator MW/RF-AWFG also influence the quantum dots NV1, NV2, NV3 depending on the state of the quantum dots NV1, NV2, NV3. Via such influences on the states of the quantum dots NV1, NV2, NV3 of the proposed relocatable quantum computer QC, the computer core CPU of the control device μC can typically also influence the states of the nuclear nuclear quantum dots CI1₁, CI1₂, CI1₃, CI2₁, CI2₂, CI2₃, CI3₁, CI3₂, CI3₃ and, if necessary, the states of nuclear nuclear quantum dots CI2₁, CI2₂, CI2₃, CI3₁, CI3₂, CI3₃. couple the states of nuclear nuclear quantum dots CI1₁, CI1₂, CI1₃, CI2₁, CI2₂, CI2₃, CI3₁, CI3₂, CI3₃ with states of quantum dots NV1, NV2, NV3. Via such influences on the states of the quantum dots NV1, NV2, NV3 of the proposed relocatable quantum computer QC, the computer core CPU of the control device μC can typically also influence the states of the nuclear nuclear quantum dots CI1₁, CI1₂, CI1₃, CI2₁, CI2₂, CI2₃, CI3₁, CI3₂, CI3₃ and, if necessary, influence the states of the nuclear nuclear quantum dots NV1, NV2, NV3. the states of the nuclear nuclear quantum dots CI1₁, CI1₂, CI1₃, CI2₁, CI2₂, CI2₃, CI3₁, CI3₂, CI3₃ among each other.

Said computer core CPU of the control device μC optionally controls the one or more devices MW/RF-AWFG, mWA for generating an electromagnetic wave field at the respective location of the quantum dots NV1, NV2, NV3 and at the respective location of the nuclear quantum dots CI1₁, CI1₂, CI1₃, CI2₁, CI2₂, CI2₃, CI3₁, CI3₂, CI3₃. These one or more devices MW/RF-AWFG, mWA for generating an electromagnetic wave field at the respective location of the quantum dots NV1, NV2, NV3 and at the respective location of the nuclear quantum dots CI1₁, CI1₂, CI1₃, CI2₁, CI2₂, CI2₃, CI3₁, CI3₂, CI3₃ optionally generate one or more possibly overlapping electromagnetic fields. overlapping electromagnetic fields at the respective location of the quantum dots NV1, NV2, NV3 and at the respective location of the nuclear nuclear quantum dots CI1₁, CI1₂, CI1₃, CI2₁, CI2₂, CI2₃, CI3₁, CI3₂, CI3₃. These electromagnetic fields are optionally designed such that they have a suitable frequency, in particular a microwave and/or radio wave frequency, f_{HF}, which is typically modulated with a temporal envelope curve in pulse form. Optionally, the generation of the pulses of these pulsed electromagnetic fields with microwave and/or radio wave frequency f_{HF} is synchronized in time with the generation of the pulses of the pump radiation LB of the light source LED, for example via the transmission signal S5. Such a pulse of these pulsed electromagnetic fields with microwave and/or radio wave frequency f_{HF} optionally begins at a pulse start time t_{spHF} relative to the reference time t_{0HF} and optionally has a pulse duration t_{dHF}. The said computer core CPU of the control device μC optionally controls the one or more devices MW/RF-AWFG for generating the said electromagnetic wave field at the respective location of the quantum dots NV1, NV2, NV3 and at the respective location of the nuclear nuclear quantum dots CI1₁, CI1₂, CI1₃, CI2₁, CI2₂, CI2₃, CI3₁, CI3₂, CI3₃. Optionally, said computer core CPU of the control device μC adjusts the frequency of the electromagnetic field f_{HF}, which the one or more devices MW/RF-AWFG generate to produce an electromagnetic wave field at the respective location of the quantum dots NV1, NV2, NV3 and at the respective location of the nuclear quantum dots CI1₁, CI1₂, CI1₃, CI2₁, CI2₂, CI2₃, CI3₁, CI3₂, CI3₃. Optionally, the said computer core CPU of the control device μC may also provide a pulse start time t_{spHF} relative to the reference time tour and, if applicable, a pulse duration t of a timed pulse. a pulse duration t_{dHF} of a temporal envelope curve of the radiation of an electromagnetic field by the one or more devices MW/RF-AWFG for generating an electromagnetic wave field at the respective location of the quantum dots NV1, NV2, NV3 and at the respective location of the nuclear quantum dots CI1₁, CI1₂, CI1₃, CI2₁, CI2₂, CI2₃, CI3₁, CI3₂, CI3₃ in pulse form. In addition, said computer core CPU of the control device μC optionally also sets the amplitude I_{pHF} of this pulse generated by these devices MW/RF-AWFG, mWA.

In addition, the computer core CPU of the control device μC may control further functions of the relocatable quantum computer QC and its sub-devices and processes. The quantum dots NV1, NV2, NV3 and the pairs of two quantum dots and the pairs of one quantum dot and one nuclear nuclear quantum dot each typically have different resonance frequencies f_{HF}. This is caused firstly by the different spatial distances between the quantum dots within the various pairs of two quantum dots, and secondly by the different spatial distances within the various pairs of one quantum dot and a nuclear nuclear quantum dot assigned to this quantum dot. Optionally, the computer core CPU of the control device μC measures these resonance frequencies f_{HF} in a test run or trial run at the start of operation and/or while still in the manufacturing facility. For this purpose, the computer core CPU of the control device μC uses the means described above. At this point, the document presented here expressly refers once again to DE 10 2020 125 189 A1. The resonant frequency values determined in this way are optionally stored by the computer core CPU of the control device μC in a memory NVM of the control device μC as stored resonant frequencies. Optionally, this memory is a non-volatile memory NVM. This has the advantage that this determination of the resonant frequencies by a scanning process with a typically step-by-step tuning of the frequency f_{HF} is then required less frequently and is not necessary every time the quantum computer QC is restarted. During operation, the computer core CPU of the control device μC uses these resonant frequencies stored in the memory NVM of the control device μC to set the frequency f_{HF} of the electromagnetic field to be generated in such a way that one or more devices MW/RF-AWFG, mWA for generating an electromagnetic field can specifically influence the state of a very specific quantum dot and/or specifically influence the state of a very specific pair of quantum dots and/or a very specific pair of a quantum dot and a nuclear quantum dot and/or specifically influence the states of a very specific group of quantum dots. At this point, the document presented here expressly refers again to DE 10 2020 125 189 A1.

The computer core CPU of the control device μC can optionally control the light source driver LDRV via the internal data interface MDBIF and the control data bus SDB and read out operating parameters of the light source driver LDRV, such as internal temperatures, internal supply voltages, etc.

The computer core CPU of the control device μC can optionally control the light source LD via the internal data interface MDBIF and the control data bus SDB and read out operating parameters of the light source LD, such as temperature, light radiation intensity, etc.

The computer core CPU of the control device μC can optionally control the waveform generator WFG via the internal data interface MDBIF and the control data bus SDB, and read out operating parameters of the waveform generator WFG.

The computer core CPU of the control device μC can optionally control the amplifier V via the internal data interface MDBIF and the control data bus SDB and read out operating parameters of the amplifier V, such as gains and/or filter parameters.

The computer core CPU of the control device μC can optionally acquire and read out the measured values of the receiver output signal S0 of the photodetector PD, which are amplified and filtered by the analog-to-digital converter ADCV of the amplifier V, via the internal data interface MDBIF and the control data bus SDB. If possible, the computer core CPU of the control device μC can optionally configure the photodetector PD via the internal data interface MDBIF and, if necessary, read out further operating parameters, such as a bias voltage or a temperature, or set the bias voltage.

The computer core CPU of the control device μC can optionally configure and read out the first camera CM1 via the internal data interface MDBIF and the control data bus SDB and a first camera interface CIF. Optionally, the first camera CM1 captures an image of the substrate D. Optionally, the first camera CM1 captures an image of the distribution of the fluorescence radiation FL of the substrate D and optionally transmits this image to the computer core CPU of the control device μC. Optionally, the first camera CM1 thus captures an image of the distribution of the fluorescence radiation FL of the quantum dots NV1, NV2, NV3 of the substrate D and optionally transmits this image to the computer core CPU of the control device μC. The computer core CPU of the control device μC can thus control the first camera CM1 and read out operating parameters and data of the camera CM1.

The computer core CPU of the control device μC can optionally control the X control device GDX for the translatory positioning device XT in the X direction via the internal data interface MDBIF and the control data bus SDB and read out and, if necessary, adjust the operating parameters of the X control device GDX.

The computer core CPU of the control device μC can optionally control the Y-control device GDY for the translatory positioning device YT in the Y-direction via the internal data interface MDBIF and the control data bus SDB and read out and, if necessary, adjust the operating parameters of the Y-control device GDY.

The computer core CPU of the control device μC can optionally control the translatory positioning device XT in the X direction via the internal data interface MDBIF and the control data bus SDB and via the X control device GDX and read out and, if necessary, adjust operating parameters of the translatory positioning device XT in the X direction.

The computer core CPU of the control device μC can optionally control the translatory positioning device YT in the Y direction via the internal data interface MDBIF and the control data bus SDB and via the Y control device GDY and read out and, if necessary, adjust operating parameters of the translatory positioning device YT in the Y direction.

Optionally, the computer core CPU of the control device μC detects the position of the substrate D relative to the optical system OS. The computer core CPU of the control device μC can, for example and optionally, detect this position of the substrate D relative to the optical system OS via the internal data interface MDBIF and the control data bus SDB and via the first camera interface CIF and the first camera CIM1 and optionally correct changes to this position of the substrate D relative to the optical system OS by means of the Y control device GDY and the translatory positioning device YT in the Y direction and by means of the X control device GDX and the translatory positioning device XT in the X direction in such a way that these corrections reverse these changes to this position of the substrate D relative to the optical system OS, such that these corrections cancel these changes in this position of the substrate D relative to the optical system OS.

The computer core CPU of the control device μC can optionally read out a temperature sensor ST via the internal data interface MDBIF and the control data bus SDB and configure it if necessary.

The computer core CPU of the control device μC can optionally reconfigure or differently operate one or more device parts of the relocatable quantum computer QC via the internal data interface MDBIF and the control data bus SDB depending on the temperature detected by the temperature sensor ST. In particular, the computer core CPU of the control device μC can put one or more fans of the quantum computer QC, or functionally equivalent cooling devices such as water or oil coolers with corresponding coolant circuits, into operation, or change their operating parameters so that the temperature detected by the temperature sensor TS remains within a predetermined temperature range. The proposed quantum computer QC can have one or more temperature sensors TS and one or more coolant circuits and/or one or more fans. All suitable fluids can be used as coolants. Air, water and oil are optional examples of coolants. Cooling is typically used to dissipate waste heat from device components of the quantum computer QC. Typically, a target temperature in the range of 0° C. to 50° C. is optional. A military temperature range of −40° C. to 125° C. seems reasonable for military applications. Instead of a cooling device, the quantum computer QC can also have a heater for air conditioning purposes, whereby the computer core CPU of the control device μC optionally controls this heater via the internal data interface MDBIF and the control data bus SDB as a function of the temperature detected by the temperature sensor ST so that the interior of the quantum computer QC exceeds a minimum temperature. The heating can be electrical, chemical or thermonuclear, for example.

Optionally, the computer core CPU of the control device μC detects the position of the substrate D relative to the optical system OS, and the position of a permanent magnet PM relative to the substrate D. The computer core CPU of the control device μC can, for example and optionally, detect this position of the substrate D relative to the optical system OS and the position of a permanent magnet PM relative to the substrate D, for example in the side view, via the internal data interface MDBIF and the control data bus SDB and via the second camera interface CIF2 and the second camera CIM2.

The computer core CPU of the control device μC can optionally configure and read out the second camera CM2 via the internal data interface MDBIF and the control data bus SDB and the second camera interface CIF2. Optionally, the second camera CM2 captures an image of the substrate D relative to the optical system OS and the position of a permanent magnet PM relative to the substrate D, for example in the side view. Optionally, a light LM with a light source illuminates the area to be captured by the second camera CM2 for this purpose. Optionally, the second camera CM2 captures this image and optionally transmits this image to the computer core CPU of the control device μC. The computer core CPU of the control device μC can thus control the second camera CM2 and read out operating parameters and data of the second camera CM2. This second camera CM2 makes it possible to remotely observe and check the positioning process and the positioning of the substrate D relative to the optical system OS by means of the translatory positioning device XT in the X direction and the translatory positioning device YT in the Y direction and, if necessary, to observe and check the positioning process and the positioning of the substrate D relative to a permanent magnet PM by means of the positioning device PV of this permanent magnet PM without having to check the housing of the quantum computer QC. Optionally, the second camera CM2 transmits the image of the observed image area via the second camera interface CIF2, the control data bus SDB, the internal data interface MDBIF, the internal data bus INTDB of the control device μC, the computer core CPU of the control device μC, the external data interface DBIF of the control device μC and the external data bus EXTDB to a higher-level control unit ZSE or another computer which has a suitable human-machine interface. This human-machine interface can have a screen and a keyboard or the like, so that an operator of the quantum computer QC can make entries here for controlling device parts of the quantum computer QC or the quantum computer QC as a whole. This or another human-machine interface can be used to display calculation results of the quantum computer QC, and/or status messages of the quantum computer QC, in particular of the computer core CPU of the control device μC, and/or operating parameters and/or status messages of device parts of the quantum computer QC. In particular, the human-machine interface can display images and/or video sequences of the first camera CM1 and/or the second camera CM2. These images and/or video sequences may have been previously processed for display by the computer core CPU of the control device μC of the quantum computer QC or a computer that is connected to the relocatable quantum computer QC via the external data bus EXTDB. The computer may be a central control unit ZSE. For example, these images and/or video sequences may be false color images, image sections, distorted images and/or videos or the like.

The first camera CM1 and/or the second camera CM2 do not necessarily have to be RGB cameras. Rather, they can also be sensitive to radiation that is not visible to humans. The first camera CM1 and/or the second camera CM2 can also be multispectral cameras, for example in order to be able to optimally observe the fluorescence radiation FL of the quantum dots NV1, NV2, NV3. The first camera CM1 optionally comprises imaging optics and an imaging photodetector circuit, for example a CCD sensor IC, and camera evaluation electronics coupled to the first camera interface CIF. The second camera CM2 optionally comprises second imaging optics and a second imaging photodetector circuit, for example a second CCD sensor IC, and second camera evaluation electronics coupled to the second camera interface CIF2.

The computer core CPU of the control device μC can optionally control a control device PVC for a positioning device PV of the permanent magnet PM via the internal data interface MDBIF and the control data bus SDB and read out and, if necessary, modify operating parameters of the control device PVC for a positioning device PV of the permanent magnet PM.

For example, the computer core CPU of the control device μC can optionally detect changes in the position of the substrate D relative to the optical system OS and the position of a permanent magnet PM relative to the substrate D via the internal data interface MDBIF and the control data bus SDB, for example in the side view, and compensate for such changes in the position of the permanent magnet PM relative to the substrate D by means of a positioning device PV of the permanent magnet PM. The computer core CPU of the control device μC optionally uses the control device PVC for a positioning device PV of the permanent magnet PM for this purpose. The computer core CPU of the control device μC can thereby optionally control the positioning device PV of the permanent magnet PM via the internal data interface MDBIF and the control data bus SDB by means of the control device PVC and read out and, if necessary, modify operating parameters of the positioning device PV. In particular, the computer core CPU of the control device μC can optionally control and change the position of the permanent magnet PM by means of the positioning device PV via the internal data interface MDBIF and the control data bus SDB. Optionally, the computer core CPU of the control device μC can detect changes in the position of the permanent magnet PM relative to the substrate D by means of the second camera CM2 and compensate for them again by means of the positioning device PV.

The quantum computer QC according to the optional embodiment shown in FIG. 1 thus comprises first means (CM1, CM2) for detecting changes in the arrangement of device parts (OS, D, PM) relative to one another, and second means (XT, YT, PV) for reversing the detected changes. The first means can also comprise functionally equivalent sensors, in particular position sensors. The second means may also include other functionally equivalent actuators.

The computer core CPU of the control device μC can, for example, optionally control a microwave and/or radio wave frequency generator MW/RF-AWFG via the internal data interface MDBIF and the control data bus SDB to generate largely freely predeterminable waveforms (arbitrary waveform generator) and read out and, if necessary, adjust its operating parameters. In particular, the computer core CPU of the control device μC can optionally program or set the generated waveforms of the microwave and/or radio wave frequency generator MW/RF-AWFG or read out the set waveform via the internal data interface MDBIF and the control data bus SDB.

The computer core CPU of the control device μC can, for example, optionally set and configure the microwave and/or radio wave antenna mWA via the internal data interface MDBIF and the control data bus SDB and/or read out such a configuration of the microwave and/or radio wave antenna mWA. The microwave and/or radio wave frequency generator MW/RF-AWFG typically controls the microwave and/or radio wave antenna mWA with the waveforms of the microwave and/or radio wave frequency generator MW/RF-AWFG generated by the microwave and/or radio wave frequency generator MW/RF-AWFG. The microwave and/or radio wave antenna m WA irradiates the substrate D with the quantum dots NV1, NV2, NV3 with the electromagnetic radiation corresponding to the waveforms of the microwave and/or radio wave frequency generator MW/RF-AWFG generated by the microwave and/or radio wave frequency generator MW/RF-AWFG.

As a result, the electromagnetic radiation manipulates the quantum state of the quantum dots NV1, NV2, NV3 and the nuclear quantum dots CI1₁, CI1₂, CI1₃, CI2₁, CI2₂, CI2₃, CI3₁, CI3₂, CI3₃ according to the waveforms generated by the microwave and/or radio wave frequency generator MW/RF-AWFG, NV2, NV3 and the nuclear quantum dots CI1₁, CI1₂, CI1₃, CI2₁, CI2₂, CI2₃, CI3₁, CI3₂, CI3₃ in substrate D. This enables the computer core CPU of the control device μC to manipulate the quantum state of the quantum dots NV1, NV2, NV3 and the nuclear quantum dots CI1₁, CI1₂, CI1₃, CI2₁, CI2₂, CI2₃, CI3₁, CI3₂, CI3₃ in the substrate D, for example via the internal data interface MDBIF and the control data bus SDB. The computer core CPU of the control device μC can typically also manipulate the quantum state of the quantum dots NV1, NV2, NV3 and the core via the internal data interface MDBIF and the control data bus SDB by means of the waveform generator WFG and the light source driver LDRV and the light source LD, NV2, NV3 and the nuclear quantum dots CI1₁, CI1₂, CI1₃, CI2₁, CI2₂, CI2₃, CI3₁, CI3₂, CI3₃ in the substrate D.

The computer core CPU of the control device μC can, for example, optionally control a cooling device KV of the substrate D and any auxiliary devices of the cooling device KV of the substrate D not shown in FIG. 1 via the internal data interface MDBIF and the control data bus SDB and record and read out their status information. The auxiliary device of the cooling device KV of the substrate D can be, for example, a so-called closed loop helium gas cooling system HeCLCS, which uses helium as a coolant. The computer core CPU of the control device μC can, for example, optionally control the closed loop helium gas cooling system HeCLCS via the internal data interface MDBIF and the control data bus SDB. For example, this coolant can flow through a cooling surface as a cooling device KV, whereby the substrate D is attached in a thermally conductive manner to the surface of the cooling surface serving as the cooling device KV, and whereby the substrate is cooled by the closed loop helium gas cooling system HeCLCS as a result. Optionally, the translatory positioning device XT in the X-direction and the translatory positioning device YT in the Y-direction position the composite of the cooling device KV and the substrate D.

The computer core CPU of the control device μC can optionally control a charging device LDV via the internal data interface MDBIF and the control data bus SDB and read out operating parameters and data of the charging device LDV. One such operating parameter can be, for example, the voltage value of the mains voltage of the electrical supply network that supplies the LDV charging device with electrical energy.

The computer core CPU of the control device μC can, for example, optionally control a disconnecting device TS via the internal data interface MDBIF and the control data bus SDB and read out operating parameters and data of the disconnecting device TS. For example, the computer core CPU of the control device μC can disconnect the outputs of the charging device LDV from the first energy reserve BENG and/or the second energy reserve BENG2 so that, firstly, this no longer charges the first energy reserve BENG and/or the second energy reserve BENG2 with electrical energy and, secondly, the other device parts of the quantum computer are not disturbed or only disturbed to a much lesser extent. For example, the computer core CPU of the control device μC can connect the outputs of the charging device LDV to the first energy reserve BENG and/or to the second energy reserve BENG2, so that the latter charges the first energy reserve BENG and/or the second energy reserve BENG2 with electrical energy.

The computer core CPU of the control device μC can optionally control the first energy reserve BENG and/or read out operating parameters and data of the first energy reserve BENG via the internal data interface MDBIF and the control data bus SDB, for example. For example, the first energy reserve BENG can comprise several submodules that are monitored by the computer core CPU of the control device μC. For example, the computer core CPU of the control device C can detect the temperature of these submodules and/or the pressure in these submodules and/or the charge state of these submodules. For this purpose, the first energy reserve BENG optionally comprises suitable sensors, the values of which can be recorded by the computer core CPU of the control device μC. In the event of a fault, the computer core CPU of the control device μC can detect this fault from the detected parameters of these submodules and switch faulty submodules out of the system and bridge the resulting gap. For this purpose, the first energy reserve BENG optionally comprises suitable switches and/or changeover switches whose switching state can be influenced by the computer core CPU of the control device μC. Optionally, the computer core CPU of the control device μC can thereby influence the energy supply of a first energy conditioning device SRG.

The computer core CPU of the control device μC can optionally control the first energy preparation device SRG via the internal data interface MDBIF and the control data bus SDB and/or record and read out operating parameters and data of the first energy preparation device SRG. Typically, this enables the computer core CPU of the control device μC to monitor and control the energy supply of the other device parts of the quantum computer QC.

If DMA accesses of the other device parts of the quantum computer QC are permitted, these can optionally access devices outside the quantum computer QC via the internal data interface MDBIF and the control data bus SDB by means of a DMA access to the control device μC and/or the memory RAM, NVM of the control device μC and/or the computer core CPU and/or the control device μC and the data interface DBIF and the external data bus EXTDB.

The possibly existing internal control computers of device parts of the quantum computer QC can optionally communicate with devices outside the quantum computer QC via the control device μC and the data interface DBIF and the external data bus EXTDB and exchange data with these external devices. Such external devices may be, for example, control units of a motor vehicle or the like. In particular, data exchange with the Internet or a comparable data network with a large number of computer systems is conceivable. These computer systems can include, for example, a relocatable central control unit ZSE of a relocatable quantum computer system QUSYS, of which the relocatable quantum computer QC can be a part.

The computer core CPU of the control device μC can optionally write data to and read data from the volatile memory RAM of the control device μC. Typically, the data content of the volatile memory RAM comprises program data and/or operating data and/or program instructions.

The computer core CPU of the control device μC can optionally read the data of the non-volatile memory NVM of the control device μC. Optionally, the non-volatile memory NVM of the control device μC comprises a writable non-volatile memory such as a flash memory. Typically, the data content of the non-volatile memory NVM comprises program data and/or operating data and/or program instructions. Optionally, the data content of a non-volatile and writable memory NVM comprises the parameters of the resonant frequencies for controlling the nuclear quantum bits CI1₁, CI1₂, CI1₃, CI2₁, CI2₂, CI2₃, CI3₁, CI3₂, CI3₃.

The computer core CPU of the control device μC can optionally read and/or write data to the memory RAM, NVM of the control device μC.

The computer core CPU of the control device μC can optionally access a higher-level computer system, for example a central control unit ZSE, and/or the control devices of other quantum computers QC1 to QC16 via the data interface DBIF and the external data bus EXTDB.

The computer core CPU of the control device μC can optionally access the control data bus SDB via the internal data interface MDBIF and other device parts of the relocatable quantum computer QC via this control data bus SDB.

The computer core CPU of the control device μC can optionally control the light source driver LDRV via the internal data interface MDBIF and the control data bus SDB and/or read out operating parameters and data of the light source driver LDRV. The control data can include, for example, the light intensity and other adjustable operating parameters. The data that the computer core CPU of the control device μC can read from the light source driver LDRV via the internal data interface MDBIF and the control data bus SDB can include, for example, current levels, internal values, electrical voltages, operating temperatures, identification data such as the serial number, etc., and values derived from these. Typically, the computer core CPU of the control device μC can thereby monitor and control the light source driver LDRV of the quantum computer QC.

The computer core CPU of the control device μC can optionally control the waveform generator WFG via the internal data interface MDBIF and the control data bus SDB and/or read out operating parameters and data of the waveform generator WFG. The control data may, for example, comprise the data of the waveform of the transmission signal S5 of the waveform generator WFG to be generated and/or the speed/frequency of the generation of the waveform of the generated transmission signal S5 of the waveform generator WFG thus predetermined and other adjustable operating parameters of the waveform generator WFG. The data that the computer core CPU of the control device μC can read from the waveform generator WFG via the internal data interface MDBIF and the control data bus SDB can include, for example, current levels, internal values, electrical voltages, operating temperatures, identification data such as the serial number, etc., and values derived therefrom. Typically, the computer core CPU of the control device μC can use this to monitor and control the waveform generator WFG of the quantum computer QC.

The computer core CPU of the control device μC can optionally control the amplifier V and/or read out operating parameters and data of the amplifier V via the internal data interface MDBIF and the control data bus SDB. The control data can, for example, include the gain and/or filter parameters of amplifier V and other adjustable operating parameters of amplifier V. The data that the computer core CPU of the control device μC can read from the amplifier V via the internal data interface MDBIF and the control data bus SDB can include, for example, internal current levels, internal values, electrical voltages, operating temperatures, identification data such as the serial number, etc., and values derived therefrom. Typically, this enables the CPU of the control device μC to monitor and control the amplifier V of the quantum computer QC.

The computer core CPU of the control device μC can optionally control the photodetector PD via the internal data interface MDBIF and the control data bus SDB, and/or read out operating parameters and data of the photodetector PD. The control data can, for example, be the gain and/or filter parameters of a possibly existing drive circuit integrated in the photodetector PD, which drives the actual photon-sensitive element of the photodetector PD and records the values relevant for the detection of photons and converts them into a readable signal. The data that the computer core CPU of the control device μC can read from the photodetector PD via the internal data interface MDBIF and the control data bus SDB can include, for example, internal current levels, internal values, electrical voltages, operating temperatures, identification data such as the serial number, etc., and values derived from these. Typically, the computer core CPU of the control device μC can monitor and control the photodetector PD of the quantum computer QC. In the simplest case, however, it can also be a completely passive photodetector PD without any intelligence, which merely transmits an analog output signal to the amplifier V.

The computer core CPU of the control device μC can, for example, optionally control the first camera CM1 and/or read out operating parameters and data of the first camera CM1 via the internal data interface MDBIF and the control data bus SDB and a first camera interface CIF. The control data can include, for example, operating parameters of the first camera CM1 such as brightness, contrast, color settings, apertures, focus, etc., and other adjustable operating parameters of the first camera CM1. The data that the computer core CPU of the control device μC can read from the first camera CM1 via the internal data interface MDBIF and the control data bus SDB can include, for example, the image data, internal current levels, internal values, electrical voltages, operating temperatures, identification data such as the serial number, etc., and values derived therefrom. Typically, this enables the computer core CPU of the control device μC to monitor and control the first camera CM1 of the quantum computer QC.

The computer core CPU of the control device μC can, for example, optionally control the first camera interface CIF via the internal data interface MDBIF and the control data bus SDB and/or read out operating parameters and data of the first camera interface CIF. The control data can, for example, include operating parameters of the first camera interface CIF, such as memory depth, DMA access parameters and other adjustable operating parameters of the first camera interface CIF. The data that the computer core CPU of the control device μC can read from the first camera interface CIF via the internal data interface MDBIF and the control data bus SDB can include, for example, the image data of the first camera CM1, internal current levels, internal values, electrical voltages, operating temperatures, identification data such as the serial number, etc., and values derived therefrom. Typically, this enables the computer core CPU of the control device μC to monitor and control the first camera interface CIF of the quantum computer QC.

The computer core CPU of the control device μC can, for example, optionally control the second camera CM2 via the internal data interface MDBIF and the control data bus SDB and a second camera interface CIF2 and/or read out operating parameters and data of the second camera CM2. The control data can include, for example, operating parameters of the second camera CM2 such as brightness, contrast, color settings, apertures, focus, etc. of the second camera CM2 and other adjustable operating parameters of the second camera CM2. The data that the computer core CPU of the control device μC can read from the second camera CM2 via the internal data interface MDBIF and the control data bus SDB can include, for example, the image data, internal current levels, internal values, electrical voltages, operating temperatures, identification data such as the serial number, etc., and values derived therefrom. Typically, the computer core CPU of the control device μC can thereby monitor and control the second camera CM2 of the quantum computer QC.

The computer core CPU of the control device μC can optionally control the second camera interface CIF2 via the internal data interface MDBIF and the control data bus SDB and/or read out operating parameters and data of the second camera interface CIF2. The control data can, for example, include operating parameters of the second camera interface CIF2 such as memory depth, DMA access parameters and other adjustable operating parameters of the second camera interface CIF2. The data that the computer core CPU of the control device μC can read from the second camera interface CIF2 via the internal data interface MDBIF and the control data bus SDB can include, for example, the image data of the second camera CM2, internal current levels, internal values, electrical voltages, operating temperatures, identification data such as the serial number, etc., and values derived from these. Typically, the computer core CPU of the control device μC can thereby monitor and control the second camera interface CIF2 of the quantum computer QC.

The computer core CPU of the control device μC can optionally control a light with a light source LM via the internal data interface MDBIF and the control data bus SDB to illuminate the field of view of the second camera CM2 and/or read out operating parameters and data of the light with the light source LM. The control data may, for example, comprise operating parameters of the light with the light source LM such as brightness, orientation and other adjustable operating parameters of the light with the light source LM. The data that the computer core CPU of the control device μC can read from the luminaire with the light source LM via the internal data interface MDBIF and the control data bus SDB can include internal current levels, internal values, electrical voltages, operating temperatures, identification data such as the serial number, etc., and values derived from these. Typically, the computer core CPU of the control device μC can use this to monitor and control the luminaire with the light source LM of the quantum computer QC.

The computer core CPU of the control device μC can, for example, optionally control one or more temperature sensors ST via the internal data interface MDBIF and the control data bus SDB and/or read out operating parameters and data of the one or more temperature sensors ST. The control data can, for example, include operating parameters of the one or more temperature sensors ST and other adjustable operating parameters of the one or more temperature sensors ST. The data that the computer core CPU of the control device μC can read from the one or more temperature sensors ST via the internal data interface MDBIF and the control data bus SDB can include temperature data, internal current levels, internal values, electrical voltages, operating temperatures, identification data such as the serial number, etc., and values derived therefrom. Typically, this enables the computer core CPU of the control device μC to monitor and control the one or more temperature sensors ST of the quantum computer QC and the quantum computer QC itself.

The one temperature sensor ST or the multiple temperature sensors ST can comprise, for example, NTC resistors, PTC resistors, PN junctions, thermocouples (e.g. platinum/rhodium thermocouples) or similar and/or evaluation electronics as temperature-sensitive sensor elements.

In particular, if the quantum computer QC is to be used in hot or very cold environments, the quantum computer QC can optionally have one or more heating devices and/or cooling devices for the quantum computer QC as a whole. If the quantum computer QC is to be used in hot or very cold environments, the computer core CPU of the control device μC can then optionally control these one or more heating devices for the quantum computer QC and/or these one or more cooling devices for the quantum computer QC as a whole, for example via the internal data interface MDBIF and the control data bus SDB, and/or read out operating parameters and data of these one or more heating devices and/or cooling devices for the quantum computer QC. The control data may include, for example, operating parameters of the one or more quantum computer QC heating devices and/or one or more quantum computer QC cooling devices and other adjustable operating parameters of the one or more quantum computer QC heating devices and/or quantum computer QC cooling devices. The data that the computer core CPU of the control device μC can read from the one or more quantum computer QC heating devices and/or cooling devices via the internal data interface MDBIF and the control data bus SDB may include temperature data, internal current levels, internal values, electrical voltages, operating temperatures, identification data such as the serial number, etc., and values derived therefrom. Typically, this allows the computer core CPU of the control device μC to monitor and control the one or more heating devices and/or cooling devices for the quantum computer QC.

The computer core CPU of the control device μC can optionally control the microwave and/or radio wave frequency generator MW/RF-AWFG via the internal data interface MDBIF and the control data bus SDB to generate largely freely definable waveforms and/or read out operating parameters and data of the microwave and/or radio wave frequency generator MW/RF-AWFG. The control data can, for example, comprise operating parameters of the microwave and/or radio wave frequency generator MW/RF-AWFG such as waveform, wave frequency, amplitude and time delay with respect to a synchronization signal, such as the transmission signal S5, and other adjustable operating parameters of the microwave and/or radio wave frequency generator MW/RF-AWFG. The data that the computer core CPU of the control device μC can read from the microwave and/or radio frequency generator MW/RF-AWFG via the internal data interface MDBIF and the control data bus SDB can include internal current levels, internal values, electrical voltages, operating temperatures, identification data such as the serial number, etc., and values derived therefrom, etc., Typically, the computer core CPU of the control device μC can thereby monitor and control the microwave and/or radio wave frequency generator MW/RF-AWFG of the quantum computer QC.

The computer core CPU of the control device C can, for example, optionally control the magnetic field sensors MSx, MSy, MSz via the internal data interface MDBIF and the control data bus SDB and via the magnetic field controllers MFSx, MFSy, MFSz and/or read out operating parameters and data of the magnetic field sensors MSx, MSy, MSz. The control data can include, for example, operating parameters of the magnetic field sensors MSx, MSy, MSz such as sensitivity, current and other adjustable operating parameters of the microwave and/or radio wave frequency generator MW/RF-AWFG. The data that the computer core CPU of the control device μC can read out from the magnetic field sensors MSx, MSy, MSz via the internal data interface MDBIF and the control data bus SDB can include the magnetic field measurement values, internal current levels, internal values, electrical voltages, operating temperatures, identification data such as the serial number etc., and values derived from these. Typically, the computer core CPU of the control device μC can thereby monitor and control the magnetic field sensors MSx, MSy, MSz of the quantum computer QC.

The computer core CPU of the control device μC can, for example, optionally control the first magnetic field controller MFSx via the internal data interface MDBIF and the control data bus SDB and/or read out operating parameters and data of the first magnetic field controller MFSx. The control data can, for example, comprise operating parameters of the first magnetic field controller MFSx such as the strength of the magnetic flux density Bx to be set in the direction of the first direction, the current to be set to the first magnetic field generating means MGx and other adjustable operating parameters of the first magnetic field controller MFSx. The data that the computer core CPU of the control device μC can read from the first magnetic field controller MFSx via the internal data interface MDBIF and the control data bus SDB can include the magnetic field measurement values, internal current levels, internal values, electrical voltages, operating temperatures, identification data such as the serial number, etc., and values derived therefrom. Typically, the computer core CPU of the control device μC can thereby monitor and control the first magnetic field controller MFSx of the quantum computer QC.

The computer core CPU of the control device μC can, for example, optionally control the second magnetic field controller MFSy via the internal data interface MDBIF and the control data bus SDB and/or read out operating parameters and data of the second magnetic field controller MFSy. The control data can, for example, include operating parameters of the second magnetic field control MFSy such as the strength of the magnetic flux density B_{y} to be set in the direction of the second direction, the current to be set to the second magnetic field generating means MGy and other adjustable operating parameters of the second magnetic field control MFSy. The data that the computer core CPU of the control device μC can read from the second magnetic field controller MFSy via the internal data interface MDBIF and the control data bus SDB can include the magnetic field measurement values, internal current levels, internal values, electrical voltages, operating temperatures, identification data such as the serial number, etc., and values derived therefrom. Typically, the computer core CPU of the control device μC can thereby monitor and control the second magnetic field controller MFSy of the quantum computer QC.

The computer core CPU of the control device μC can, for example, optionally control the third magnetic field controller MFSz via the internal data interface MDBIF and the control data bus SDB and/or read out operating parameters and data of the third magnetic field controller MFSz. The control data can, for example, include operating parameters of the third magnetic field control MFSz such as the strength of the magnetic flux density Bz to be set in the direction of the third direction, the current to be set to the third magnetic field generating means MGy and other adjustable operating parameters of the third magnetic field control MFSz. The data that the computer core CPU of the control device μC can read from the third magnetic field controller MFSz via the internal data interface MDBIF and the control data bus SDB can include the magnetic field measurement values, internal current levels, internal values, electrical voltages, operating temperatures, identification data such as the serial number, etc., and values derived therefrom. Typically, the computer core CPU of the control device μC can thereby monitor and control the third magnetic field controller MFSz of the quantum computer QC.

The computer core CPU of the control device μC can, for example, optionally control the first power conditioning device SRG via the internal data interface MDBIF and the control data bus SDB and/or read out operating parameters and data of the first power conditioning device SRG. The control data may, for example, include operating parameters of the first energy conditioning device SRG such as the voltage values and maximum current levels to be supplied to other parts of the device and other adjustable operating parameters. The data that the computer core CPU of the control device μC can read from the first power conditioning device SRG via the internal data interface MDBIF and the control data bus SDB can include internal current levels, internal values, electrical voltages, operating temperatures, identification data such as the serial number, etc., and values derived therefrom. Typically, the computer core CPU of the control device μC can thereby monitor and control the first power conditioning device SRG of the quantum computer QC.

The computer core CPU of the control device μC can optionally control the second energy conditioning device SRG2 via the internal data interface MDBIF and the control data bus SDB and/or read out operating parameters and data of the second energy conditioning device SRG2. The control data can, for example, include operating parameters of the second energy conditioning device SRG2 such as the voltage values and maximum current levels to be supplied to other parts of the device and other adjustable operating parameters of the second energy conditioning device SRG2. The data that the computer core CPU of the control device μC can read from the second energy conditioning device SRG2 via the internal data interface MDBIF and the control data bus SDB can include internal current levels, internal values, electrical voltages, operating temperatures, identification data such as the serial number, etc., and values derived therefrom. Typically, the computer core CPU of the control device μC can thereby monitor and control the second power conditioning device SRG2 of the quantum computer QC.

The computer core CPU of the control device μC can optionally control the energy reserve BENG via the internal data interface MDBIF and the control data bus SDB and/or read out operating parameters and data of the energy reserve BENG. If the energy reserve BENG has its own control and monitoring device, the computer core CPU of the control device μC can, for example, optionally send control data to this control and monitoring device of the energy reserve BENG via the internal data interface MDBIF and the control data bus SDB. The control data can, for example, include operating parameters of the energy reserve BENG, such as maximum temperatures, etc. The control and monitoring device of the energy reserve BENG optionally has means for monitoring important, in particular safety-relevant operating parameters of the energy reserve BENG. These means can include temperature sensors, voltage and current sensors, or pressure sensors for measuring the internal pressure of battery cells. The data that the computer core CPU of the control device μC can read from the energy reserve BENG via the internal data interface MDBIF and the control data bus SDB can include, for example, internal current levels, internal values, electrical voltages, operating temperatures, identification data such as the serial number, etc., and values derived from these. Typically, this enables the CPU of the control device μC to monitor and control the energy reserve BENG of the quantum computer QC.

The computer core CPU of the control device μC can, for example, optionally control the energy reserve BENG and/or read out operating parameters and data of the second energy reserve BENG2 via the internal data interface MDBIF and the control data bus SDB. If the second energy reserve BENG2 has its own control and monitoring device, the computer core CPU of the control device μC can, for example, optionally send control data to this control and monitoring device of the second energy reserve BENG2 via the internal data interface MDBIF and the control data bus SDB. The control data can, for example, include operating parameters of the second energy reserve BENG2, such as maximum temperatures, etc. The control and monitoring device of the second energy reserve BENG2 optionally has means for monitoring important, in particular safety-relevant operating parameters of the second energy reserve BENG2. These means can include temperature sensors, voltage and current sensors or pressure sensors for measuring the internal pressure of battery cells. The data that the computer core CPU of the control device μC can read from the second energy reserve BENG2 via the internal data interface MDBIF and the control data bus SDB can include, for example, internal current levels, internal values, electrical voltages, operating temperatures, identification data such as the serial number, etc., and values derived from these. Typically, the computer core CPU of the control device μC can thereby monitor and control the second energy reserve BENG2 of the quantum computer QC.

The computer core CPU of the control device μC can, for example, optionally control the isolating device TS via the internal data interface MDBIF and the control data bus SDB and/or read out operating parameters and data of the isolating device TS. If the isolating device TS has its own control and monitoring device, the computer core CPU of the control device μC can, for example, optionally send control data to this control and monitoring device of the isolating device TS via the internal data interface MDBIF and the control data bus SDB. The control data can, for example, include operating parameters of the disconnector TS such as closing status (connected/disconnected), maximum temperatures, etc. The control and monitoring device of the disconnecting device TS optionally has means for monitoring important, in particular safety-relevant operating parameters of the disconnecting device TS. These means can include temperature sensors, voltage sensors and current sensors. The data that the computer core CPU of the control device μC can read from the isolating device TS via the internal data interface MDBIF and the control data bus SDB can include, for example, internal current levels, internal values, electrical voltages, operating temperatures, identification data such as the serial number, etc., and values derived from these. Typically, the computer core CPU of the control device μC can thereby monitor and control the isolating device TS of the quantum computer QC.

The computer core CPU of the control device μC can, for example, optionally control the charging device LDV via the internal data interface MDBIF and the control data bus SDB and/or read out operating parameters and data of the charging device LDV. If the charging device LDV has its own control and monitoring device, the computer core CPU of the control device μC can, for example, optionally send control data to this control and monitoring device of the charging device LDV via the internal data interface MDBIF and the control data bus SDB. The control data can, for example, include operating parameters of the charging device LDV such as mains voltage of the power supply PWR of the charging device LDV, output voltages of the charging device LDV to be set, maximum temperatures, etc. The control and monitoring device of the disconnecting device TS optionally has means for monitoring important, in particular safety-relevant operating parameters of the charging device LDV. These means can include temperature sensors, voltage sensors and current sensors. The data that the computer core CPU of the control device μC can read from the charging device LDV via the internal data interface MDBIF and the control data bus SDB can include, for example, the actual mains voltage of the power supply PWR of the charging device LDV, actually set output voltages of the charging device LDV, internal current levels, internal values, electrical voltages, operating temperatures, identification data such as the serial number, etc., and values derived therefrom. Typically, the computer core CPU of the control device μC can thereby monitor and control the charging device LDV of the quantum computer QC.

The relocatable quantum computer QC according to the optional embodiment shown in FIG. 1 optionally has a quantum computer monitoring device QUV which monitors the quantum computer QC while the quantum computer QC executes a quantum computer program with a quantum computer program sequence which is optionally stored in its memory RAM, NVM. The paper presented here refers to the as yet unpublished German patent application DE 10 2021 110 964.7 and any subsequent applications thereof resulting from priority claims. This quantum computer monitoring device QUV monitors the correct quantum computer program execution of the quantum computer program of the quantum computer QC. Optionally, the quantum computer monitoring device QUV monitors at least the value and/or value progression of at least one, preferably several and optimally all of the following operating parameters:
one or more values of operating voltages of device parts of the quantum computer QC,
one or more values of current consumption of device parts of the quantum computer QC,
the processor clock of the computer core CPU of the control device μC of the quantum computer QC and/or its frequency,
the processor clocks of other device parts of the quantum computer QC and/or their frequency,
the light output of the light source LD of the quantum computer QC, in particular the intensity of the pump radiation LB of the light source LD,
the signal generation of the waveform generator WFG of the quantum computer QC,
the functionality of the DBIF data interface,
the functionality of the internal data interface MDBIF,
the functionality of the LDRV light source driver,
the functionality of the amplifier V,
the functionality of the PD photodetector,
the temperature by means of a temperature sensor ST,
the functionality of the microwave and/or radio wave frequency generator MW/RF-AWFG for generating waveforms that can be freely preset as far as possible,
the functionality of the magnetic field sensors MSx, MSy, MSz,
the functionality of the magnetic field controls MFSx, MFSy, MFSz,
the functionality of the first SRG energy treatment device,
the functionality of the second energy preparation device SRG2,
the functionality of the BENG energy reserve,
the functionality of the second energy reserve BENG2,
the functionality of the disconnecting device TS,
the functionality of the LDV loading device,
   The detection capability of electromagnetic radiation of a photodetector,
   The correct generation of electromagnetic fields as intended, in particular microwave fields and/or radio wave fields, by a device of the quantum computer QC for manipulating one or more quantum bits QUB,
   the complex and/or real and/or imaginary conductance of a line and the microwave and/or radio wave antenna MWA which is part of the device of the quantum computer QC for manipulating one or more quantum dots NV1, NV2, NV3.

### Quantum Computer Monitoring Device QUV

Optionally, the T2 times of the quantum dots NV1, NV2, NV3 and the nuclear quantum dots CI1₁, CI1₂, CI1₃, CI2₁, CI2₂, CI2₃, CI3₁, CI3₂, CI3₃ are limited. Therefore, time pauses may occur between two quantum computer calculations, during which a quantum computer monitoring device QUV of the quantum computer QC can check the functionality of the remaining areas of the quantum computer QC.

Optionally, the quantum computer QC thus performs its quantum computer calculations within first time periods that are typically shorter than the T2 times of the quantum dots NV1, NV2, NV3 and the nuclear quantum dots CI1₁, CI1₂, CI1₃, CI2₁, CI2₂, CI2₃, CI3₁, CI3₂, CI3₃. The quantum computer monitoring device QUV optionally performs tests of the remaining device parts of the quantum computer QC within second time periods. The first time periods are optionally different from the second time periods. A quantum computer calculation as defined herein optionally comprises at least one quantum operation, such as an initialization of one or more quantum dots NV1, NV2, NV3 and the nuclear quantum dots CI1₁, CI1₂, CI1₃, CI2₁, CI2₂, CI2₃, CI3₁, CI3₂, CI3₃ and/or, for example, the execution of a quantum gate such as a CNOT operation or a CCNOT operation or a Hadamard gate or ax pulse or an X-gate, etc.

The paper presented here refers in this context to the book by Steven Prawer (editor), Igor Aharonovich (editor), “Quantum Information Processing with Diamond: Principles and Applications”, Woodhead Publishing Series in Electronic and Optical Materials, Volume 63, Woodhead Publishing, May 8, 2014, ISBN-10:0857096567, ISBN-13:978-0857096562.

Since the result of a quantum computation of the quantum computer QC provides correct results only with a certain statistics, the quantum computer monitoring device QUV collects a plurality of the results of a plurality of similar requests of the quantum computer monitoring device QUV transmitted in response from the remaining quantum computer QC to the computer core CPU of the quantum computer QC to perform quantum computations and optionally statistically evaluates them. If the determined statistics of the results transmitted by the computer core CPU of several similar requests of the quantum computer monitoring device QUV for performing quantum calculations to the computer core CPU of the quantum computer QC deviate from an expected statistic by more than x*σ, the quantum computer monitoring device QUV typically concludes that the quantum computer QC is faulty. Here σ stands for the standard deviation of the statistical distribution of the value of the expected response. Optionally, x is between 1 and 4. Depending on the type of error in the execution of a quantum computer program, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures.

In the simplest case, exemplary countermeasures can include, for example, resetting and reinitializing the quantum computer QC and/or device parts of the quantum computer QC and/or starting a more extensive self-test program.

An optional countermeasure can also be, for example, a translational displacement of the substrate D relative to the optical system OS, so that other quantum dots NV1, NV2, NV3 with other nuclear quantum dots CI1₁, CI1₂, CI1₃, CI2₁, CI2₂, CI2₃, CI3₁, CI3₂, CI3₃ replace the previously used quantum dots NV1, NV2, NV3 and nuclear quantum dots CI1₁, CI1₂, CI1₃, CI2₁, CI2₂, CI2₃, CI3₁, CI3₂, CI3₃. In this case, re-initialization of the quantum computer QC is unavoidable. In particular, the computer core CPU uses the methods of DE 10 2020 007 977 B4 to determine the resonance frequencies for controlling and manipulating and entangling the other quantum dots NV1, NV2, NV3 with other nuclear quantum dots CI1₁, CI1₂, CI1₃, CI2₁, CI2₂, CI2₃, CI3₁, CI3₂, CI3₃ and optionally stores these in its non-volatile memory NVM and less optionally in its volatile memory RAM. For the translational displacement of the substrate D relative to the optical system OS, the computer core CPU optionally uses the translational positioning device XT of the substrate D in the X direction and the translational positioning device of the substrate D in the Y direction.

In addition, the quantum computer monitoring device QUV of the quantum computer QC can optionally cause the computer core CPU by means of a request message via the internal data bus INTDB to perform a predetermined quantum computer calculation after a quantum computer calculation has been performed in the first time period and to transmit the result of the quantum computer calculation back to the quantum computer monitoring device QUV. If the relocatable quantum computer QC does not respond to the quantum computer monitoring device QUV of the relocatable quantum computer QC within a predetermined time window, an error may be present. If the computer core CPU does not respond to the computer core CPU of the control device μC of the relocatable quantum computer QC with values that lie within expected value ranges within a predetermined time window after the request has been made by the quantum computer monitoring device QUV of the quantum computer QC, the quantum computer monitoring device QUV of the quantum computer QC evaluates the execution as faulty. For this purpose, the quantum computer monitoring device QUV of the relocatable quantum computer QC optionally keeps statistical records. If the statistical distribution of the contents of the responses of the computer core CPU of the control device μC of the relocatable quantum computer QC does not correspond to an expected statistical distribution, the quantum computer monitoring device QUV of the relocatable quantum computer QC optionally also concludes that an error has occurred. Depending on the type of error, the quantum computer monitoring device QUV of the relocatable quantum computer QC initiates a countermeasure or changes the data basis of a statistical evaluation. If, for example, the frequency of a certain error exceeds a permissible value, the quantum computer monitoring device QUV of the relocatable quantum computer QC initiates countermeasures. These can be the countermeasures already described in this document or other countermeasures.

Such a test optionally also tests the intended correct generation of electromagnetic fields, in particular microwave fields and/or radio wave fields, by a device of the relocatable quantum computer QC for manipulating one or more quantum dots NV1, NV2, NV3. Such a test also tests, in part, the complex and/or real and/or imaginary conductance of a line and the microwave and/or radio wave antenna MWA which is part of the device of the quantum computer QC for manipulating one or more quantum dots NV1, NV2, NV3.

Optionally, the quantum computer monitoring device QUV of the quantum computer QC can cause the computer core CPU by means of a query message via the internal data bus INTDB to query one or more values of operating voltages of device parts of the quantum computer QC, of other device parts in the second time periods after the execution of a quantum computer calculation in the first time periods and to pass them on to the quantum computer monitoring device QUV of the quantum computer QC within a predetermined time window. If the computer core CPU does not respond to the computer core CPU of the control device μC of the quantum computer QC with values that lie within expected value ranges within a predetermined time window after the request has been made by the quantum computer monitoring device QUV of the quantum computer QC, the quantum computer monitoring device QUV of the quantum computer QC evaluates the execution as faulty. Depending on the type of error, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures. These can be the countermeasures already described in this document or other countermeasures.

Optionally, the quantum computer monitoring device QUV of the quantum computer QC can cause the computer core CPU by means of a query message via the internal data bus INTDB to query one or more values of current consumption of device parts of the quantum computer QC, of other device parts of the quantum computer QC in the second time periods after the execution of a quantum computer calculation in the first time periods and to pass them on to the quantum computer monitoring device QUV of the quantum computer QC within a predetermined time window. If the computer core CPU does not respond to the computer core CPU of the control device μC of the quantum computer QC with values that lie within expected value ranges within a predetermined time window after the request has been made by the quantum computer monitoring device QUV of the quantum computer QC, the quantum computer monitoring device QUV of the quantum computer QC evaluates the execution as faulty. Depending on the type of error, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures. These can be the countermeasures already described in this document or other countermeasures.

The clock generator OSZ of the computer core CPU of the control device μC of the quantum computer QC optionally supplies the computer core CPU of the control device μC of the quantum computer QC with a clock for operating the computer core CPU of the control device μC of the quantum computer QC. The clock generator OSZ of the computer core CPU of the control device μC of the quantum computer QC can also optionally supply further digital circuits and device parts of the quantum computer QC with a clock for operating these digital circuits and device parts of the quantum computer QC.

Optionally, the quantum computer monitoring device QUV of the quantum computer QC can cause the computer core CPU to check the processor clock by means of the computer core CPU of the control device μC of the quantum computer QC and/or its frequency, in particular during or after the execution of a quantum computer calculation in the first time periods and/or the second time period. If an error occurs, such as an incorrect processor clock frequency or a processor clock jitter, the quantum computer monitoring device QUV of the quantum computer QC evaluates the processor clock as faulty. Thus, the quantum computer monitoring device QUV of the quantum computer QC optionally monitors the clock generator OSZ of the computer core CPU of the control device μC of the quantum computer QC.

Depending on the type of error, the quantum computer monitoring device QUV of the quantum computer QC initiates a countermeasure or changes the data basis of a statistical evaluation. If, for example, the frequency of a certain error exceeds a permissible maximum frequency value, the quantum computer monitoring device QUV of the quantum computer QC initiates countermeasures. These can be the countermeasures already described in this document or other countermeasures.

Optionally, the quantum computer monitoring device QUV of the quantum computer QC has its own monitoring clock generation ÜOSZ. Optionally, the monitoring clock generation ÜOSZ typically supplies the quantum computer monitoring device QUV of the quantum computer QC with a clock for operating the quantum computer monitoring device QUV of the quantum computer QC.

For example, the computer core CPU of the quantum computer QC can check the processor clock of the quantum computer monitoring device QUV of the quantum computer QC and/or its frequency and/or the monitoring clock generation ÜOSZ, in particular after a quantum computer calculation has been performed in the second time periods. If an error occurs, such as an incorrect processor clock frequency or a processor clock jitter, the computer core CPU of the quantum computer QC evaluates the processor clock of the quantum computer monitoring device QUV of the quantum computer QC as faulty. Thus, the computer core CPU of the quantum computer QC optionally monitors the monitoring clock generation ÜOSZ of the quantum computer monitoring device QUV of the quantum computer QC.

Depending on the type of error, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures. These can be the countermeasures already described in this document or other countermeasures.

Optionally, the quantum computer monitoring device QUV has a separate energy supply with optionally a further energy reserve and its own energy preparation device. Optionally, the charging device LDV or another further charging device feeds this further separate energy preparation device and/or the charging of this further energy reserve. These optional device parts, the further energy reserve, the further energy preparation device and the further charging device and, if applicable, a further isolating device of the quantum computer monitoring device QUV of the quantum computer QC and their connecting lines are no longer shown in FIG. 1 for a better overview.

Optionally, the quantum computer monitoring device QUV of the quantum computer QC can cause the computer core CPU to check processor clocks of other device parts of the quantum computer QC and/or their frequency, in particular during or after the execution of a quantum computer calculation in the first time periods and/or the second time period. If an error occurs, such as an incorrect processor clock frequency or a processor clock jitter, the quantum computer monitoring device QUV of the quantum computer QC evaluates the processor clock in question as faulty. Thus, the quantum computer monitoring device QUV of the quantum computer QC optionally also monitors the clocks of other device parts of the quantum computer QC. These clock generators of other device parts of the quantum computer QC are also not shown in FIG. 1 for a better overview. Depending on the type of error, the quantum computer monitoring device QUV of the quantum computer QC initiates a countermeasure or changes the data basis of a statistical evaluation. If, for example, the frequency of a certain error of the other processor clocks of other device parts of the quantum computer QC exceeds a permissible value, the quantum computer monitoring device QUV of the quantum computer QC initiates countermeasures. These may be the countermeasures already described in this document or other countermeasures.

Optionally, the quantum computer monitoring device QUV of the quantum computer QC can cause the computer core CPU to check the light output of the light source LD of the quantum computer QC, in particular after a quantum computer calculation has been performed in the second time periods. For example, the quantum computer monitoring device QUV of the quantum computer QC can cause the computer core CPU by means of a query message via the internal data bus INTDB to query one or more values of monitor diodes of the light source LD of the quantum computer QC in the second time periods after the execution of a quantum computer calculation in the first time periods and to pass them on to the quantum computer monitoring device QUV of the quantum computer QC within a predetermined time window. If the computer core CPU does not respond to the computer core CPU of the control device μC of the quantum computer QC with values that lie within expected value ranges within a predetermined time window after the request has been made by the quantum computer monitoring device QUV of the quantum computer QC, the quantum computer monitoring device QUV of the quantum computer QC evaluates the execution as faulty. Depending on the type of error, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures. These can be the countermeasures already described in this document or other countermeasures.

Optionally, the quantum computer monitoring device QUV of the quantum computer QC can cause the computer core CPU to check the activation of the light source LD of the quantum computer QC by the light source driver LDRV and the functionality of the light source driver LDRV, in particular after a quantum computer calculation has been performed in the second time periods. For example, the quantum computer monitoring device QUV of the quantum computer QC can initiate the computer core CPU by means of a request message via the internal data bus INTDB, to detect one or more values of the operating parameters of the light source driver LDRV and/or one or more values of the drive signals of the light source driver LDRV for the light source LD of the quantum computer QC in the second time periods after a quantum computer calculation has been performed in the first time periods by means of an analog-to-digital converter or the like and to pass them on to the quantum computer monitoring device QUV of the quantum computer QC within a predetermined time window. If the computer core CPU does not respond to the computer core CPU of the control device μC of the quantum computer QC with values that lie within expected value ranges within a predetermined time window after the request has been made by the quantum computer monitoring device QUV of the quantum computer QC, the quantum computer monitoring device QUV of the quantum computer QC evaluates the execution as faulty. Depending on the type of error, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures. These can be the countermeasures already described in this document or other countermeasures.

Optionally, the quantum computer monitoring device QUV of the quantum computer QC can cause the computer core CPU to check the generation of the transmission signal S5 by the waveform generator WFG of the quantum computer QC, in particular after a quantum computer calculation has been performed in the second time periods. For this purpose, the quantum computer QC and/or the waveform generator WFG may comprise a measuring device, for example a digital storage oscilloscope or a similar signal acquisition device, which acquires the time course of the transmitted signal S5. For example, it may be an analog-to-digital converter that acquires this signal curve of the transmission signal S5. For example, the quantum computer monitoring device QUV of the quantum computer QC can cause the computer core CPU by means of a request message via the internal data bus INTDB to cause the waveform generator WFG of the quantum computer QC to generate a transmit signal S5 in the second time periods after performing a quantum computer calculation in the first time periods, and to detect the time course of the transmit signal S5 by means of said signal detection device. Optionally, the computer core CPU evaluates the thus acquired temporal course of the transmission signal S5 and transmits the result of this evaluation to the quantum computer monitoring device QUV in response to the request of the quantum computer monitoring device QUV. It is also conceivable that the computer core CPU of the quantum computer QC transmits the detected signal waveform of the transmitted signal S5 to the quantum computer monitoring device QUV in response to the request of the quantum computer monitoring device QUV and then the quantum computer monitoring device QUV evaluates the detected signal waveform of the transmitted signal S5. The response of the computer core CPU should be sent to the quantum computer monitoring device QUV of the quantum computer QC within a predetermined time window. If the computer core CPU does not respond to the computer core CPU of the control device μC of the quantum computer QC with values that lie within expected value ranges within a predetermined time window after the request has been made by the quantum computer monitoring device QUV of the quantum computer QC, the quantum computer monitoring device QUV of the quantum computer QC evaluates the execution as faulty. Depending on the type of error, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures. These can be the countermeasures already described in this document or other countermeasures.

Optionally, the quantum computer monitoring device QUV of the quantum computer QC can cause the computer core CPU to check the generation of the output signal by means of the microwave and/or radio wave frequency generator MW/RF-AWFG of the quantum computer QC, in particular after the execution of a quantum computer calculation in the second time periods. For this purpose, the quantum computer QC and/or the microwave and/or radio wave frequency generator MW/RF-AWFG of the quantum computer QC may comprise a measuring device, for example a digital storage oscilloscope or a similar signal acquisition device, which acquires the time course of the output signal of the microwave and/or radio wave frequency generator MW/RF-AWFG of the quantum computer QC. For example, it may be an analog-to-digital converter that detects this waveform of the output signal of the microwave and/or radio wave frequency generator MW/RF-AWFG of the quantum computer QC. For example, the quantum computer monitoring device QUV of the quantum computer QC can cause the computer core CPU by means of a request message via the internal data bus INTDB to cause the microwave and/or radio wave frequency generator MW/RF-AWFG of the quantum computer QC to generate an output signal with a specific waveform for test purposes in the second time periods after a quantum computer calculation has been performed in the first time periods, and to detect, by means of said signal detection device, the time history of the output signal of the microwave and/or radio wave frequency generator MW/RF-AWFG of the quantum computer QC. Also, the quantum computer monitoring device QUV of the quantum computer QC can cause the computer core CPU by means of the request message via the internal data bus INTDB, after performing a quantum computer calculation in the first time periods, to cause the microwave and/or radio wave frequency generator MW/RF-AWFG of the quantum computer QC in the second time periods to generate an output signal with a specific waveform for test purposes and to detect the power reflected by the microwave and/or radio wave antenna MWA by magnitude and/or phase by means of said signal detection device and thus to infer and detect the impedance of the microwave and/or radio wave antenna MWA and its feed line. Optionally, the computer core CPU evaluates the time characteristic of the output signal of the microwave and/or radio wave frequency generator MW/RF-AWFG of the quantum computer QC and/or the measured values acquired in this way and transmits the result of this evaluation to the quantum computer monitoring device QUV in response to the request of the quantum computer monitoring device QUV. It is also conceivable that the computer core CPU of the quantum computer QC transmits the detected signal waveform of the output signal of the microwave and/or radio wave frequency generator MW/RF-AWFG of the quantum computer QC to the quantum computer monitoring device QUV in response to the request of the quantum computer monitoring device QUV and then the quantum computer monitoring device QUV evaluates the detected signal waveform of the output signal of the microwave and/or radio wave frequency generator MW/RF-AWFG of the quantum computer QC. The response of the computer core CPU is to be sent to the quantum computer monitoring device QUV of the quantum computer QC within a predetermined time window. If the computer core CPU does not respond to the computer core CPU of the control device μC of the quantum computer QC with values that lie within expected value ranges within a predetermined time window after the request has been made by the quantum computer monitoring device QUV of the quantum computer QC, the quantum computer monitoring device QUV of the quantum computer QC evaluates the execution as faulty. Depending on the type of error, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures. These can be the countermeasures already described in this document or other countermeasures.

Optionally, the quantum computer monitoring device QUV of the quantum computer QC can cause the computer core CPU to check the functionality of the data interface DBIF, in particular after a quantum computer calculation has been performed in the second time periods. For example, the quantum computer monitoring device QUV of the quantum computer QC can cause the computer core CPU by means of a request message via the internal data bus INTDB to communicate via the data interface DBIF and the external data bus EXTDB with a higher-level computer system for test purposes in the second time periods after a quantum computer calculation has been performed in the first time periods. The higher-level computer system can be a central control unit ZSE, for example. Optionally, the higher-level computer system responds with an evaluable response within a predefined period of time. Optionally, the computer core CPU evaluates the message received from the external computer system via the data interface DBIF and the external data bus EXTDB and transmits the result of this evaluation to the quantum computer monitoring device QUV in response to the request from the quantum computer monitoring device QUV. It is also conceivable that the computer core CPU of the quantum computer QC transmits the message received via the data interface DBIF and the external data bus EXTDB from the external computer system to the quantum computer monitoring device QUV in response to the request of the quantum computer monitoring device QUV and then the quantum computer monitoring device QUV evaluates the message received via the data interface DBIF and the external data bus EXTDB from the external computer system. The response of the computer core CPU and the higher-level computer system, for example the central control unit ZSE, should optionally be sent to the quantum computer monitoring device QUV of the quantum computer QC within a predefined time window. If the computer core CPU does not respond to the computer core CPU of the control device μC of the quantum computer QC with values that lie within expected value ranges within a predetermined time window after the request has been made by the quantum computer monitoring device QUV of the quantum computer QC, the quantum computer monitoring device QUV of the quantum computer QC evaluates the execution as faulty. Depending on the type of error, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures. These can be the countermeasures already described in this document or other countermeasures.

Optionally, the quantum computer monitoring device QUV of the quantum computer QC can cause the computer core CPU to check the functionality of the internal data interface MDBIF in the second time periods, in particular after a quantum computer calculation has been performed. For example, the quantum computer monitoring device QUV of the quantum computer QC can cause the computer core CPU to communicate via the internal data interface MDBIF and the control data bus SDB with an internal computer core of another device part of the quantum computer QC in the second time periods by means of a request message via the internal data bus INTDB after a quantum computer calculation has been performed in the first time periods. Optionally, the internal computer core of the other device part of the quantum computer QC responds with an evaluable response within a predetermined time period. Optionally, the computer core CPU evaluates the message received via the internal data interface MDBIF and the internal data bus INTDB and the control data bus SDB from the internal computer core of the other device part of the quantum computer QC and transmits the result of this evaluation to the quantum computer monitoring device QUV in response to the request of the quantum computer monitoring device QUV. It is also conceivable that the computer core CPU of the quantum computer QC transmits the message received via the internal data interface MDBIF and the internal data bus INTDB and the control data bus SDB from the internal computer core of the other device part of the quantum computer QC to the quantum computer monitoring device QUV in response to the request of the quantum computer monitoring device QUV. of the quantum computer monitoring device QUV, and then the quantum computer monitoring device QUV evaluates the message received via the internal data interface MDBIF and the internal data bus INTDB and the control data bus SDB from the internal computer core of the other device part of the quantum computer QC. The response of the computer core CPU and the internal computer core of the other device part of the quantum computer QC should optionally be sent to the quantum computer monitoring device QUV of the quantum computer QC within a predetermined time window. If the computer core CPU does not respond to the computer core CPU of the control device μC of the quantum computer QC with values that lie within expected value ranges within a predetermined time window after the request has been made by the quantum computer monitoring device QUV of the quantum computer QC, the quantum computer monitoring device QUV of the quantum computer QC evaluates the execution as faulty. Depending on the type of error, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures. These can be the countermeasures already described in this document or other countermeasures.

Optionally, the quantum computer monitoring device QUV of the quantum computer QC can cause the computer core CPU to check the operability of the amplifier V and the operability of the photodetector PD, in particular after a quantum computer calculation has been performed in the second time periods. For example, the quantum computer monitoring device QUV of the quantum computer QC can cause the computer core CPU by means of a request message via the internal data bus INTDB to cause the light source LD of the quantum computer QC to emit a defined light emission or a test radiation source of the quantum computer QC to emit a test light emission in the second time periods after a quantum computer calculation has been performed in the first time periods, which irradiates the photodetector PD, and/or causes the photodetector PD to generate a test signal for the amplifier V in the second time periods and interrogates the detected values in the amplifier V and/or detects operating parameters of the amplifier V and the photodetector PD and forwards them to the quantum computer monitoring device QUV of the quantum computer QC within a predetermined time window. If the computer core CPU does not respond to the computer core CPU of the control device μC of the quantum computer QC with values that lie within expected value ranges within a predetermined time window after the request has been made by the quantum computer monitoring device QUV of the quantum computer QC, the quantum computer monitoring device QUV of the quantum computer QC evaluates the execution as faulty. Depending on the type of error, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures. These can be the countermeasures already described in this document or other countermeasures.

The computer core CPU of the control device μC of the quantum computer QC can typically control the optionally provided test radiation source of the quantum computer QC via the internal data bus interface MDBIF and the internal data bus INTDB and the control data bus SDB. Typically, the control device μC of the quantum computer QC can irradiate the photodetector PD of the quantum computer QC with an optical test signal, for example by means of an optical test radiation source, in order to ensure the functionality of the quantum computer QC. For a better overview, this test radiation source of the relocatable quantum computer QC for irradiating the photodetector PD with test radiation is not shown in FIG. 1.

Optionally, the quantum computer monitoring device QUV of the quantum computer QC may cause the computer core CPU to check temperatures within the quantum computer QC by means of one or more temperature sensors ST, in particular after performing a quantum computer calculation in the second time periods. For example, the quantum computer monitoring device QUV of the quantum computer QC can cause the computer core CPU by means of a request message via the internal data bus INTDB to detect one or more temperatures within the quantum computer QC by means of one or more temperature sensors ST of the quantum computer QC after a quantum computer calculation has been performed in the first time periods and to pass on the detected temperature measurement values to the quantum computer monitoring device QUV of the quantum computer QC within a predetermined time window. If the computer core CPU does not respond to the computer core CPU of the control device μC of the quantum computer QC with values that lie within expected value ranges within a predetermined time window after the request has been made by the quantum computer monitoring device QUV of the quantum computer QC, the quantum computer monitoring device QUV of the quantum computer QC evaluates the execution as faulty. Depending on the type of error, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures. These can be the countermeasures already described in this document or other countermeasures.

Optionally, the quantum computer monitoring device QUV of the quantum computer QC can cause the computer core CPU to check the functionality of the magnetic field sensors MSx, MSy, MSz and/or the functionality of the magnetic field controllers MFSx, MFSy, MFSz and/or the functionality of the magnetic field generating means MGx, MGy, MGz, in particular after a quantum computer calculation has been performed in the second time periods. For example, the quantum computer monitoring device QUV of the quantum computer QC can cause the computer core CPU by means of a request message via the internal data bus INTDB, after the execution of a quantum computer calculation in the first time periods by means of the magnetic field controls MFSx, MFSy, MFSz and the magnetic field generating means MGx, MGy, MGz of the quantum computer QC to set different magnetic flux densities and to detect them by means of the magnetic field sensors MSx, MSy, MSz, and to pass on the detected measured values to the quantum computer monitoring device QUV of the quantum computer QC within a predetermined time window. If the computer core CPU does not respond to the computer core CPU of the control device μC of the quantum computer QC with values that lie within expected value ranges within a predetermined time window after the request has been made by the quantum computer monitoring device QUV of the quantum computer QC, the quantum computer monitoring device QUV of the quantum computer QC evaluates the execution as faulty. Depending on the type of error, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures. These can be the countermeasures already described in this document or other countermeasures.

Optionally, the quantum computer monitoring device QUV of the quantum computer QC can cause the computer core CPU to check the operability of the first energy conditioning device SRG and/or the operability of the second energy conditioning device SRG2 and/or the operability of the further energy conditioning devices, in particular after a quantum computer calculation has been performed in the second time periods. For example, the quantum computer monitoring device QUV of the quantum computer QC can cause the computer core CPU by means of a request message via the internal data bus INTDB to set and/or modify certain supply voltages of device parts of the quantum computer QC after a quantum computer calculation has been performed in the first time periods by means of the first energy conditioning device SRG and/or the second energy conditioning device SRG2 and/or the further energy conditioning devices, and, for example, to detect their voltage values and/or current values by means of measuring devices and to transmit the detected measured values to the quantum computer monitoring device QUV of the quantum computer QC within a predetermined time window. If the computer core CPU does not respond to the computer core CPU of the control device μC of the quantum computer QC with values that lie within expected value ranges within a predetermined time window after the request has been made by the quantum computer monitoring device QUV of the quantum computer QC, the quantum computer monitoring device QUV of the quantum computer QC evaluates the execution as faulty. Depending on the type of error, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures. These can be the countermeasures already described in this document or other countermeasures.

Optionally, the quantum computer monitoring device QUV of the quantum computer QC can cause the computer core CPU to check the functionality of the energy reserve BENG and/or the functionality of the second energy reserve BENG2 and/or the functionality of possibly further energy reserves and/or possibly further device parts or already designated device parts of the quantum computer QC, in particular after a quantum computer calculation has been carried out in the second time periods.

For example, the quantum computer monitoring device QUV of the quantum computer QC can instruct the processor nucleus CPU via a request message sent over the internal data bus INTDB to check the charge status of the energy reserve BENG and/or the functionality of the second energy reserve BENG2 and/or the functionality of further energy reserves and/or further device devices parts, as the case may be, after performing a quantum computer calculation in the first time periods using charging devices, such as the previously mentioned charging device LDV, and in doing so to record the values of the respective current consumption and the voltage curve by means of suitable measuring means of the quantum computer QC and thus, for example, to draw conclusions about the impedance of these energy reserves. In this case, the quantum computer monitoring device QUV of the quantum computer QC causes the computer core CPU to pass on the recorded measured values to the quantum computer monitoring device QUV of the quantum computer QC via the internal data bus INTDB by means of said request message within a predetermined time window. If the computer core CPU does not respond to the computer core CPU of the control device μC of the quantum computer QC with values that lie within expected value ranges within a predetermined time window after the request has been made by the quantum computer monitoring device QUV of the quantum computer QC, the quantum computer monitoring device QUV of the quantum computer QC evaluates the execution as faulty. Depending on the type of error, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures. These can be the countermeasures already described in this document or other countermeasures.

Optionally, the quantum computer monitoring device QUV of the quantum computer QC can cause the computer core CPU to check the operability of the disconnecting device TS of the quantum computer QC and the operability of the loading device LDV of the quantum computer QC, in particular after a quantum computer calculation has been performed in the second time periods. For example, the quantum computer monitoring device QUV of the quantum computer QC can cause the computer core CPU by means of a request message via the internal data bus INTDB to open the isolating device TS after the execution of a quantum computer calculation in the first time periods and to change the charge state of the energy reserve BENG and/or the functionality of the second energy reserve BENG2 and/or the functionality of possibly further energy reserves and/or possibly further device parts by means of the charging devices, such as the charging device LDV already mentioned. and to record the values of the respective current consumption and the voltage curve by means of suitable measuring means of the quantum computer QC and to close the isolating device TS and to check the state of charge of the energy reserve BENG and/or the functionality of the second energy reserve BENG2 and/or the functionality of any other energy reserves and/or the functionality of any other energy reserves and/or the functionality of any other energy reserves by means of the charging devices, such as the charging device LDV already mentioned. of further energy reserves and/or further device parts, as the case may be, and to record second values of the respective current consumption and the voltage curve by means of suitable measuring means of the quantum computer QC. In this case, the quantum computer monitoring device QUV of the quantum computer QC causes the computer core CPU to pass on the recorded measured values and second measured value to the quantum computer monitoring device QUV of the quantum computer QC by means of said request message via the internal data bus INTDB within a predetermined time window. If the computer core CPU does not respond to the computer core CPU of the control device μC of the quantum computer QC with the second values that lie within expected value ranges within a predetermined time window after the request has been made by the quantum computer monitoring device QUV of the quantum computer QC, the quantum computer monitoring device QUV of the quantum computer QC evaluates the execution as faulty. Depending on the type of error, the quantum computer monitoring device QUV of the quantum computer QC initiates a countermeasure or changes the data basis of a statistical evaluation. If, for example, the frequency of a certain error exceeds a permissible value, the quantum computer monitoring device QUV of the quantum computer QC initiates countermeasures. These can be the countermeasures already described in this document or other countermeasures.

### Quantum Computer System QSYS

If the proposed relocatable quantum computer QC is integrated into a quantum computer system QUSYS with a second, optionally mobile quantum computer QC2, it can be advantageous if signaling, in particular of a quantum computer calculation result, can take place to the second quantum computer QC2 and/or vice versa via at least one signal connection, for example an external data bus EXTDB from the quantum computer QC.

Optionally, the relocatable quantum computer system QUSYS comprises at least two quantum computers, a first relocatable quantum computer QC1 and a second relocatable quantum computer QC2, with several measuring devices for detecting operating variables of the quantum computer system QUSYS or a device or a system. Typically, the states of the device or system may depend on the quantum computer system QUSYS, wherein the first relocatable quantum computer QC1 optionally performs at least in part the same quantum computer computation that the second relocatable quantum computer QC2 performs. The quantum computer calculation optionally comprises a monitoring measure for checking the functionality of the respective relocatable quantum computer QC1, QC2. Optionally, the first relocatable quantum computer QC1 performs the quantum computation of the first relocatable quantum computer QC1 independently of the quantum computation of the second relocatable quantum computer QC2. This makes it possible to compare the results of the quantum computer calculations by the computer cores CPU of the control devices μC of the relocatable quantum computers QC1, QC2 and/or the quantum computer monitoring devices QUV of the relocatable quantum computers QC1, QC1.

### Monitoring Procedure

The paper presented herein further proposes a method according to an optional embodiment for monitoring the execution of a quantum computer program executable on at least one control device μC of a relocatable quantum computer QC by means of a quantum computer monitoring device QUV of the quantum computer QC. The relocatable quantum computer QC optionally comprises quantum dots NV1, NV2, NV3 and optionally nuclear quantum dots CI1₁, CI1₂, CI1₃, CI2₁, CI2₂, CI2₃, CI3₁, CI3₂, CI3₃ and the control device μC with the computer core CPU and first means for manipulating quantum dots NV1, NV2, NV3 and optionally for manipulating nuclear quantum dots NV1, NV2, NV3. for manipulating nuclear quantum dots CI1₁, CI1₂, CI1₃, CI2₁, CI2₂, CI2₃, CI3₁, CI3₂, CI3₃ of the quantum computer QC and second means for reading out the state of quantum dots NV1, NV2, NV3 and, if applicable, nuclear quantum dots CI1 of the quantum computer QC. nuclear quantum dots CI1₁, CI1₂, CI1₃, CI2₁, CI2₂, CI2₃, CI3₁, CI3₂, CI3₃ of the quantum computer QC. The computer core CPU of the control device μC optionally controls the first means for manipulating quantum dots NV1, NV2, NV3 and, if applicable, nuclear quantum dots CI1. nuclear quantum dots CI1₁, CI1₂, CI1₃, CI2₁, CI2₂, CI2₃, CI3₁, CI3₂, CI3₃ of the quantum computer QC and the second means for reading out the state of quantum dots NV1, NV2, NV3 and, if applicable, nuclear quantum dots CI1 of the quantum computer QC. nuclear quantum dots CI1₁, CI1₂, CI1₃, CI2₁, CI2₂, CI2₃, CI3₁, CI3₂, CI3₃ of the quantum computer QC. In this case, the quantum computer monitoring device QUV optionally triggers a manipulation of a subset of the quantum dots and/or, if applicable, the nuclear quantum dots of the quantum dots NV1, NV2, NV3 and, if applicable, the nuclear quantum dots CI1. The quantum computer monitoring device QUV optionally triggers an exception condition (exception), in particular an interrupt of the quantum computer program sequence, if this manipulation was not intended, in the event of manipulation of a subset of quantum dots and/or, if applicable, of the nuclear quantum dots CI1₁, CI1₂, CI1₃, CI2₁, CI2₂, CI2₃, CI3₁, CI3₂, CI3₃ of the quantum computer QC during the quantum computer program runtime. This can occur during a program jump due to interference such as cosmic radiation, which is intercepted by this.

For the relocatable quantum computer QC according to the explained optional embodiment, the paper presented here proposes a non-volatile memory NVM, in particular a read-only memory or a flash memory or a non-volatile memory, for a relocatable quantum computer QC, in particular as part of a control unit of a vehicle. Optionally, a quantum computer program is stored in the non-volatile memory NVM, which can run on at least one computer core μC of the quantum computer QC and is suitable for executing the method described above.

The paper presented here proposes the following to further ensure the functionality of the relocatable quantum computer QC with at least one computer core CPU of a control device μC and with a quantum computer monitoring device QUV:

A quantum computer program is to be executable on the at least one computer core CPU of the control device μC. During the quantum computer program runtime, the quantum computer monitoring device QUV monitors the execution of the quantum computer program during execution by the other device parts of the quantum computer QC. When the computer core CPU accesses a specific address range within a memory RAM, NVM of the control device μC of the quantum computer QC or other predetermined device parts of the quantum computer QC, the quantum computer monitoring device QUV generates an exception condition (exception), in particular an interrupt of the quantum computer program flow, whereupon the computer core CPU of the control device μC of the quantum computer QC typically interrupts the execution of the quantum computer program in an optionally predetermined manner.

The computer core CPU of the control device μC or a central control unit ZSE or another computer system, which may for example be connected to the computer core CPU of the control device μC of the quantum computer QC via the external data bus EXTDB, may for example configure the quantum computer monitoring device QUV. Optionally, the quantum computer QC and/or the computer core μC has means for running an exception routine after an exception condition is triggered during the quantum computer program runtime. The exception routine can itself be a quantum computer program.

### Further Monitoring Procedure

The present paper proposes a method according to an optional embodiment for operating a relocatable quantum computer system QUSYS comprising a relocatable quantum computer QC and a quantum computer monitoring device QUV, comprising the following exemplary steps:

Monitoring the correct quantum computer program execution of the quantum computer program of the relocatable quantum computer QC, in particular by the quantum computer monitoring device QUV or another computer system;

Performing predetermined quantum computer calculations with at least one quantum operation for calculating predetermined quantum computer calculation results in predetermined time periods at predetermined points in time, in particular by the quantum computer QC, and
driving a quantum computer monitoring device QUV after these predetermined times, and performing a reset or re-initialization of the quantum computer QC to a predefined quantum computer program restart state or the like when this driving is not performed in a predetermined manner.

### Data Buses

The quantum computer QC according to the optional embodiment shown in FIG. 1 optionally comprises a data interface DBIF with which the proposed quantum computer QC can communicate with higher-level computer systems and/or other quantum computers QC2 and exchange data. In particular, the proposed quantum computer QC can communicate and exchange data with a central control unit ZSE via the data interface DBIF. The data interface can be wired and/or wireless.

Via the internal data interface MDBIF and the control data bus SDB, the computer core CPU of the control device μC and/or the quantum computer monitoring device QUV can optionally communicate with the device parts of the quantum computer QC by means of the relocatable quantum computer QC and exchange data and signals.

### Magnetic System

Optionally, the relocatable quantum computer QC according to the embodiment shown in FIG. 1 comprises a system for compensating external magnetic fields and the earth's magnetic field. For this purpose, the proposed mobile relocatable quantum computer QC optionally has sensor systems for three-dimensional detection of the three-dimensional vector of the magnetic flux density B. Optionally, the sensor system for three-dimensional detection of the three-dimensional vector of the magnetic flux density B detects this three-dimensional vector of the magnetic flux density B in the vicinity of the substrate D. For example, the sensor system for three-dimensional detection of the three-dimensional vector of the magnetic flux density B can comprise three magnetic field sensors MSx, MSy, MSz for the three spatial directions X, Y, and Z. It is conceivable to use a single sensor system if the orientation of the magnetic field allows it. For example, the quantum computer QC can include a magnetic field sensor MSx for the magnetic flux density Bₓ in the direction of the X-axis. For example, the quantum computer QC may comprise a magnetic field sensor MSy for the magnetic flux density B_{y} in the direction of the Y-axis. For example, the quantum computer QC may comprise a magnetic field sensor MSz for the magnetic flux density B2 in the direction of the Z-axis.

Optionally, the proposed mobile quantum computer QC comprises magnetic field generating devices PM, MGx, MGy, MGz. The magnetic field generating devices may comprise permanent magnets PM and/or coils MGx, MGy, MGz, in particular Helmholtz coils and Helmholtz coil pairs, as magnetic field generating means. The permanent magnets PM permanently generate a magnetic flux density. The coils MGx, MGy, MGz generate a magnetic flux density corresponding to their electrical current. Optionally, the permanent magnets PM and the magnetic field generating means MGx, MGy, MGz are part of a magnetic circuit. Optionally, but not necessarily, the magnetic circuit comprises a yoke. Optionally, the permanent magnet PM is located in an air gap. Optionally, a positioning device PV can reposition the permanent magnet PM relative to the substrate D and/or in the air gap and thus change the magnetic flux density B acting on the substrate D with the quantum dots.

Optionally, the control device μC of the quantum computer QC comprises a navigation device GPS, which communicates the current position to the computer core CPU of the control device μC. Optionally, the control device μC can use geomagnetic maps of the earth's magnetic field to determine the resulting earth's magnetic field strength and its magnetic flux density component. If the quantum computer QC is moved translationally or rotated, the computer core CPU of the quantum computer QC can, for example, receive predicted values for future translational coordinates and/or future rotations via the external data bus EXTDB or predict them from received or determined velocity values and rotation velocity values. Therefore, the computing core CPU of the quantum computer QC can then predict changes in the future velocity acting on the quantum dots NV1, NV2, NV3 and the nuclear quantum dots CI1₁, CI1₂, CI1₃, CI2₁, CI2₂, CI2₃, CI3₁, CI3₂, CI3₃ and compensate them by changing the magnetic field generated in the quantum computer QC by means of the magnetic field generating devices PM, MGx, MGy, MGz.

The method according to an optional embodiment for preventing disturbances in the operation of the relocatable quantum computer QC due to changes in external magnetic fields as a result of movement of the relocatable quantum computer QC optionally proceeds as follows:

In a first step a), the control device μC optionally determines the currently acting external magnetic field, for example by means of magnetic field sensors MSx, MSy, MSz. In a second step, the control device μC detects the current coordinates and/or the current speed and/or acceleration, for example by means of a navigation system NAV and/or a position determination device GPS. Based on this data and possibly additional data, such as an electronic map of the earth's magnetic field, for example, the control device μC of the relocatable quantum computer QC calculates the expected new external magnetic field and optionally adjusts the current supply to the magnetic field generating means MGx, MGy, MGz so that this change in the external magnetic field is essentially not affected by the movement of the relocatable quantum computer QC and essentially does not influence the calculation results of quantum computer programs of the relocatable quantum computer QC.

To simplify the illustration, it is assumed here that the GPS navigation device determines not only the translational coordinates, for example the position on the earth's surface, but also the angular orientation of the relocatable quantum computer QC and the angular velocity of the change in these angles. Only by taking into account the translational changes and the rotational changes in the position and orientation of the relocatable quantum computer QC can the computer system CPU of the relocatable quantum computer QC suitably predict the necessary adaptation of the magnetic field generation and suitably control the magnetic field generating devices PM, MGx, MGy, MGz.

For this purpose, the computer core CPU of the control device μC can, for example, cause the first magnetic field control MFSx to adjust the current supply to the first magnetic field generating means MGx, which optionally generates a magnetic flux density Bₓ, with electric current.

For this purpose, the computer core CPU of the control device μC can optionally also cause the second magnetic field control MFSy to adjust the energization of the second magnetic field generating means MGy, which optionally generates a magnetic flux density B_{y}, with electric current. For this purpose, the computer core CPU of the control device μC can optionally also cause the third magnetic field control MFSz to adjust the current supply of the third magnetic field generating means MGz, which optionally generates a magnetic flux density B_{z}, with electric current.

For this purpose, the computer core CPU of the control device μC can, for example, also cause the positioning device PV of the permanent magnet PM to spatially adjust the positioning of the permanent magnet PM, which optionally generates a permanent, inhomogeneous magnetic flux density B, and thus to adjust the magnetic flux density at the location of the quantum dots NV1, NV2, NV3 and the nuclear quantum dots CI1₁, CI1₂, CI1₃, CI2₁, CI2₂, CI2₃, CI3₁, CI3₂, CI3₃.

The computer core CPU of the control device μC optionally detects the actual magnetic field by means of said magnetic field sensors MSx, MSy, MSz and adjusts the magnetic flux density by means of the actuators described immediately above in the form of the magnetic field generating devices PM, MGx, MGy, MGz in order to compensate for deviations between the detected vector of magnetic flux density and the desired vector of magnetic flux density.

Optionally, the quantum computer QC comprises an acceleration sensor system which can detect translational and/or rotational accelerations and supplies the corresponding values to the computer core CPU of the control device μC of the quantum computer QC, so that the latter can, if necessary, take countermeasures in the form of counter-accelerations of a position control system not shown in the figures. If necessary, the computer core CPU of the control device μC of the quantum computer QC can use the positioning device PV of the permanent magnet PM and/or the translatory positioning device XT in the X direction and/or the translatory positioning device YT in the Y direction for some such countermeasures. the computer core CPU of the control device μC of the relocatable quantum computer QC may also modify the focus of the optical system OS depending on such coordinate predictions and/or velocity predictions and/or acceleration predictions for translational movements and rotational movements in order to maintain the focus. For example, the computer core CPU of the control device μC of the relocatable quantum computer QC can predict deformations and mechanical vibrations within the relocatable quantum computer QC on the basis of such coordinate predictions and/or velocity predictions and/or acceleration predictions for translational movements and rotational movements and, if necessary, detect and compensate for such by means of suitable sensors such as cameras and position and distance sensors within the quantum computer QC.

### Energy Supply

The relocatable quantum computer QC according to the optional embodiment shown in FIG. 1 optionally receives its energy via an energy supply EV. A charging device LDV of the energy supply EV receives the energy externally from an energy source PWR. A good overview of possible electrical energy sources can be found in the book: Vasily Y. Ushakov (Author), “Electrical Power Engineering: Current State, Problems and Perspectives (Green Energy and Technology)”, Paperback—Aug. 18, 2018, Springer; 1st ed. 2018 Edition (Aug. 18, 2018), ISBN-10:3319872850, ISBN-13:978-3319872858.

This energy source can be one of the following energy sources, for example:

### Electric Generator

The energy source can be an electrical generator that converts mechanical energy into electrical energy. The mechanical energy can, for example, be energy transmitted via a shaft or the energy of a moving fluid. For example, it can be an electrical machine, such as a synchronous or asynchronous or DC motor, a linear motor, a reluctance motor or a BLDC motor or the like, which converts the mechanical energy of a linear and/or rotational movement into electrical energy by means of induction in the lines of a stator and/or rotor. It can also be a magnetohydrodynamic generator, or MHD generator for short, which converts the movement of an electrically conductive fluid into electrical energy. The fluid can be a plasma or an electrically conductive liquid, such as a salt solution or a molten metal. The actual energy source can be, for example, a nuclear reactor, an internal combustion engine, a heating device, a jet engine, a rocket engine, a ship propulsion system, a Stirling engine, a turbine, a water turbine, a gas turbine, a wind turbine, a tidal power plant, a wave power plant and the like. Magnetohydrodynamic generators are known, for example, from DE 20 2021 101 169 U1, WO 2021 159 117 A1, EP 3 863 165 A1, U.S. Pat. No. 2,021,147 061 A1, CN 108 831 576 B, U.S. Pat. No. 2,019,368 464 A1, WO 2019 143 396 A2, EP 3 646 452 B1, CN 20 634 1126 U, EP 3 279 603 B1, EP 3 400 642 B1, EP 3 345 290 B1, EP 3 093 966 B1, WO 2016 100 008 A2, DE 10 2014 225 346 A1, RU 2014 143 858 A, EP 3 007 350 B1, U.S. Pat. No. 2,016,377 029 A1, RU 2 566 620 C2, EP 3 075 064 A1, EP 2 874 292 B1, EP 2 986 852 B1, CN 10 385 5907 B, RU 126 229 U1, WO 2014 031 037 A2. Due to the large number of documents, the document presented here does not provide a complete list. The paper presented here refers to the book Hugo K. Messerle (author), “Magnetohydrodynamic Electrical Power Generation (UNESCO Energy Engineering Series)”, John Wiley & Sons Ltd (Aug. 1, 1995), ISBN-10:0471942529, ISBN-13:978-0471942528.

### Electrochemical Cell

The energy source can be an electrochemical cell. This can, for example, be an electrochemical cell in the broadest sense, which provides electrical energy by means of chemical reactions. These electrochemical cells include accumulators, batteries and fuel cells.

### Nuclear Energy Sources

In the case of nuclear energy sources, the document presented here distinguishes between those that first convert nuclear energy into mechanical energy, for example by means of steam cycles and turbines, and then convert it into electrical energy by means of the generators mentioned above, and those that convert nuclear energy directly into electrical energy. The paper presented here mentions betavoltaic cells and thermonuclear generators as examples. These have the advantage that they can be designed to be mobile. They are therefore particularly well suited to the technical theory presented here. The radionuclide batteries considered here optionally use the isotopes ⁶⁰Co, ⁹⁰Sr, ¹⁰⁶Ru, ¹⁴⁴Cs, ¹⁴⁷Pm, ²¹⁰Pm, ²¹⁰Po, ²³⁸Pu, ²⁴²Cm, ²⁴¹Am, ²⁴³Am. Optionally, the relocatable quantum computer QC is protected from the radiation of such a nuclear energy source by a radiation shield, for example made of lead. Radionuclide batteries also include beta-voltaic cells, which, for example, convert beta radiation from beta emitters directly into electrical energy.

Such radionuclide batteries are described, for example, in DE 1 240 967 B, DE 1 564 070 B1, DE 2 124 465 B2, DE 7 219 216 U, DE 19 782 844 538 B1, DE 69 411 078 T2, U.S. Pat. Nos. 5,443,657 A, 5,859,484 A, DE 19 602 875 A1, DE 19 738 066 A1, DE 19 957 669 A1, DE 19 957 669 A1, U.S. Pat. No. 8,552,616 B2, WO 2009 103 974 A1 and U.S. Pat. No. 2,018,226 165 A1.

The energy source can also be a renewable energy source, such as a solar cell, a hydroelectric power plant with a water turbine and a generator, or a wind power plant with a wind turbine and a generator.

The energy source can also be conventional coal, oil and gas-fired power plants that burn carbonaceous and/or hydrocarbon fuels to generate thermal energy, and then convert the thermal energy into mechanical energy, and then convert the mechanical energy into electrical energy.

The energy sources can be so-called energy harvesting devices. These are devices that use energy differences that are already present in the environment or otherwise, for example, to generate energy from the kinetic energy of a person or another moving object or from thermal differences, for example in heating systems, or the like.

Finally, the energy source can simply be the electricity grid, in which case the primary energy source can remain undefined.

Optionally, the charging device LDV processes the energy of the power supply PWR of the charging device LDV to such an extent that the charging device LDV can charge an energy reserve BENG, BENG2 with the energy of the power supply PWR. For example, this may be a voltage converter and/or a buck converter or a boost converter or a buck-boost converter, depending on the type of energy supply PWR. Optionally, the charging device LDV monitors the charging process of the respective energy reserve BENG, BENG2 when it charges it.

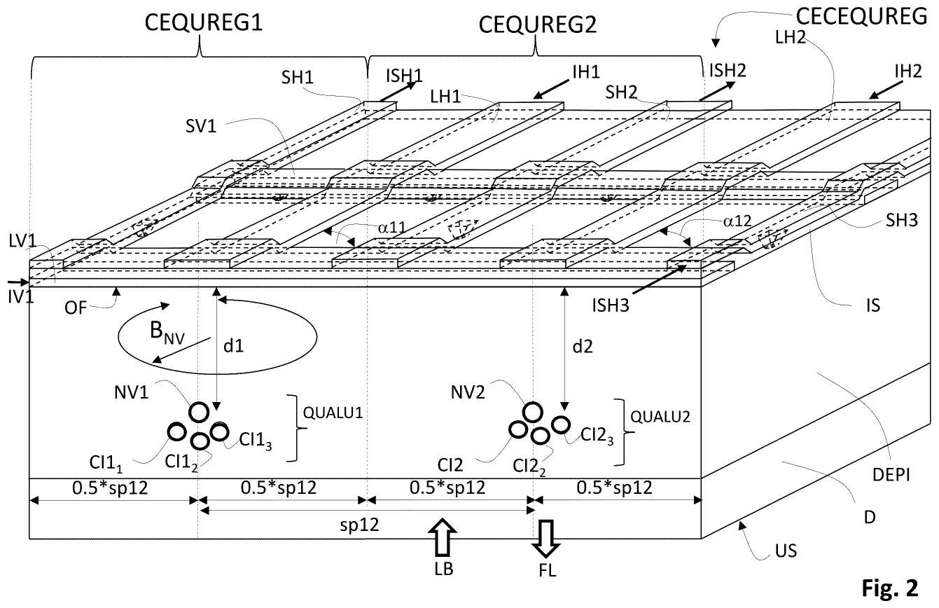

If the quantum computer QC is not executing a quantum computer program and/or is not performing any quantum operations, the charging device LDV can also supply device parts of the relocatable quantum computer QC via respective energy preparation devices SRG, SRG2. Optionally, the charging device LDV then also charges one or more of the energy reserves BENG, BENG2 of the relocatable quantum computer QC. In the example of FIG. 1, the proposed relocatable quantum computer QC has, by way of example, two energy reserves BENG, BENG2 and two energy conditioning devices SRG, SRG2. The present document indicates that the number of energy reserves, energy preparation devices and charging devices and disconnecting devices may be larger than in the example of FIG. 2.

The LDV charging device is an optional barrier for transients in the PWR power supply. However, the LDV charging device cannot usually completely suppress these transient disturbances of the PWR power supply. The charging device LDV also produces transient interference itself, for example if the charging device LDV is a switching power supply. It has therefore proved useful to use one or more low-noise energy reserves BENG, BENG2 for the supply of particularly interference-prone device components such as the photodetector PD, the amplifier V, the light source driver LDRV, the light source LD and, if necessary, for magnetic field-generating device components. for magnetic field generating device components MFSx, MFSy, MFSz, MGx, MGy, MGz and device components with a particularly time-sensitive signal scheme such as the waveform generator WFG and the microwave and/or radio wave frequency generator MW/RF-AWFG for generating arbitrary waveforms. Optionally, these device parts further stabilize their internal supply voltages within these device parts in order to suppress the noise and the disturbances of the power supply to a maximum. Optionally, the quantum computer QC comprises one or more energy conditioning devices SRG, SRG2 for supplying the device parts from the one energy reserve or the plurality of energy reserves BENG, BENG2. The energy conditioning devices optionally adapt the voltage level supplied by the charging device LDV or the energy reserves BENG, BENG2 to the required voltage level of the respectively supplied device part of the quantum computer QC optionally with a voltage hold-up. In a second control stage, which is optionally a linear regulator, these linear regulators, for example, can then use the voltage reserve to precisely adjust the actual supply voltage of the relevant device parts of the quantum computer QC with low noise.

Optionally, one or more isolating devices TS isolate the one charging device or the plurality of charging devices LDV from the one energy conditioning device or the plurality of energy conditioning devices SRG, SRG2 and/or from the one low-noise energy reserve or the plurality of low-noise energy reserves BENG, BENG2 when the quantum computer executes a quantum computer program and/or performs a quantum operation, the plurality of low-noise energy reserves BENG, BENG2, if the quantum computer executes a quantum computer program and/or a quantum operation A quantum operation in the sense of the paper presented here is a manipulation of a quantum dot NV1, NV2, NV3 and/or a nuclear quantum dot CI1₁, CI1₂, CI1₃, CI2₁, CI2₂, CI2₃, CI3₁, CI3₂, CI3₃. A quantum computer program in the sense of the paper presented here is a program that comprises at least one quantum operation. Optionally, one or more binary data in the memory NVN, RAM of the control device μC of the relocatable quantum computer QC encode such a quantum operation. For example, it may be a predetermined data word. A quantum operation as defined herein manipulates at least the quantum state of at least one quantum dot of the quantum dots NV1, NV2, NV3 of the relocatable quantum computer QC and/or manipulates at least the quantum state of at least one nuclear quantum dot of the nuclear quantum dots CI1₁, CI1₂, CI1₃, CI2₁, CI2₂, CI2₃, CI3₁, CI3₂, CI3₃ of the relocatable quantum computer QC. The data word symbolizing such a quantum operation is also referred to as a quantum op-code in the technical teaching of the present document. A quantum computer program comprises at least one quantum op code. In the above case, when the relocatable quantum computer QC executes a quantum computer program and/or performs a quantum operation, the one power reserve or the plurality of power reserves BENG, BENG2 optionally supply the one power conditioning device or the plurality of power conditioning devices SRG, SRG2 with electric power which is particularly low in noise.

Optionally, one or more disconnecting devices TS connect the one charging device or the plurality of charging devices LDV to the one energy conditioning device or the plurality of energy conditioning devices SRG, SRG2 and/or the one low-noise energy reserve or the plurality of low-noise energy reserves BENG, BENG2 when the relocatable quantum computer QC is not executing a quantum computer program and/or is not performing a quantum operation. In that case, the charging device LDV optionally charges the one energy reserve or the multiple energy reserves BENG, BENG2 and, if necessary, supplies the one energy conditioning device or multiple energy conditioning devices SRG, SRG2 with electrical energy, which is now typically less noisy.

### Magnetic Field Shielding

In order to reduce the influence of external magnetic fields, the quantum computer QC according to the optional embodiment shown in FIG. 1 can be provided with a shield AS for these external magnetic fields. This shielding can optionally be a passive shielding AS, for example in the form of μ-metal mats, and/or an active shielding AS in the form of a magnetic field-generating system that generates a magnetic counter-field to an external magnetic interference field and thereby reduces and/or even compensates for its effect. Optionally, the proposed quantum computer therefore comprises one or more sensors MSx, MSy, MSz for detecting the strength of the magnetic flux density B and/or the magnetic field strength H. Optionally, the control device μC uses the values of the magnetic flux density B and/or the magnetic field strength H detected by the one or more sensors MSx, MSy, MSz to control magnetic field generating means MGx, MGy, MGz. The magnetic field generating means MGx, MGy, MGz optionally generate a compensating magnetic flux density B of an opposing magnetic field that compensates for the magnetic flux density B of the magnetic interference field.

Optionally, a first sensor MSx detects the strength of the magnetic flux density B and/or the magnetic field strength H in a first direction, for example an X-axis. A first magnetic field controller MFSx optionally supplies a first magnetic field generating means MGx with electrical energy. The first magnetic field generating means MGx optionally generates a magnetic flux density Bₓ, which optionally essentially has a direction that optionally corresponds to the first direction, for example the direction of the X-axis. The first magnetic field controller MFSx optionally energizes the first magnetic field generating means MGx with a first electric current Ix. Optionally, the control device μC controls the first magnetic field generating means MGx via the first magnetic field control MFSx. Optionally, the first magnetic field controller MFSx controls the generation of the magnetic flux density Bₓ by the first magnetic field generating means MGx in such a way that the magnetic flux density B detected by the first sensor MSx or the magnetic field strength H detected by the first sensor MSx corresponds to a first value. Optionally, this first value is zero. For this purpose, the first magnetic field controller MFSx evaluates the value of the magnetic flux density B detected by the first sensor MSx or the value of the magnetic field strength H detected by the first sensor MSx.

Optionally, a second sensor MSy detects the strength of the magnetic flux density B and/or the magnetic field strength H in a second direction, for example a Y-axis. Optionally, the direction of the Y-axis is perpendicular to the direction of the X-axis. A second magnetic field control MFSy optionally supplies a second magnetic field generating means MGy with electrical energy. The second magnetic field generating means MGy optionally generates a magnetic flux density B_{y}, which optionally essentially has a direction that optionally corresponds to the second direction, for example the direction of the Y-axis. The second magnetic field control MFSy optionally energizes the second magnetic field generating means MGy with a second electric current Iy.

Optionally, the control device μC controls the second magnetic field generating means MGy via the second magnetic field controller MFSy. Optionally, the second magnetic field controller MFSy controls the generation of the magnetic flux density B_{y} by the second magnetic field generating means MGy in such a way that the magnetic flux density B or the magnetic field strength H detected by the second sensor MSy corresponds to a second value. Optionally, this second value is zero. For this purpose, the second magnetic field control MFSy evaluates the value of the magnetic flux density B detected by the second sensor MSy or the value of the magnetic field strength H detected by the second sensor MSy.

Optionally, a third sensor MSz detects the strength of the magnetic flux density B and/or the magnetic field strength H in a third direction, for example a Z-axis. Optionally, the direction of the Z-axis is perpendicular to the direction of the X-axis and perpendicular to the direction of the Y-axis. A third magnetic field control MFSz optionally supplies a third magnetic field generating means MGz with electrical energy. The third magnetic field generating means MGz optionally generates a magnetic flux density B_{z}, which optionally essentially has a direction that optionally corresponds to the third direction, for example the direction of the Z-axis. The third magnetic field control MFSz optionally energizes the third magnetic field generating means MGz with a third electric current Iz. Optionally, the control device μC controls the third magnetic field generating means MGz via the third magnetic field control MFSz. Optionally, the third magnetic field control MFSz controls the generation of the magnetic flux density B_{z} by the third magnetic field generating means MGz in such a way that the magnetic flux density B or the magnetic field strength H detected by the third sensor MSz corresponds to a third value. Optionally, this third value is zero. For this purpose, the third magnetic field control MFSz evaluates the value of the magnetic flux density B detected by the third sensor MSz or the value of the magnetic field strength H detected by the third sensor MSz.

The proposed relocatable quantum computer QC typically has an optical system OS that allows the light source LED to irradiate the quantum dots NV1, NV2, NV3 with pump radiation LB. Optionally, the OS optical system is a confocal microscope. Optionally, however, the optical system OS also enables the optical readout of the state of quantum dots NV1, NV2, NV3 of the relocatable quantum computer QC. For this purpose, the relocatable quantum computer QC of the relocatable quantum computer system QUSYS optionally has, for example, a dichroic mirror DBS, which allows the fluorescence radiation FL emitted by the quantum dots NV1, NV2, NV3 to pass through and directs the pump radiation LB of the light source LD onto the quantum dots NV1, NV2, NV3 and deflects the pump radiation LB away from the photodetector PD for detecting the fluorescence radiation FL. Instead of a dichroic mirror DBS, the relocatable quantum computer QC of the quantum computer system QUSYS can also have a dichroic mirror DBS, for example, which reflects the fluorescence emitted by the quantum dots NV1, NV2, NV3 and allows the pump radiation LB of the light source LD to pass via the optical system OS to the quantum dots NV1, NV2, NV3, so that the pump radiation LB of the light source LD irradiates these quantum dots NV1, NV2, NV3 with pump radiation LB of the pump radiation wavelength λₚₘₚ. In this case, the optical system OS optionally detects the fluorescent radiation FL of the quantum dots NV1, NV2, NV3 and the dichroic mirror DBS reflects this fluorescent radiation FL onto the photodetector PD for detecting the fluorescent radiation FL. The proposed relocatable quantum computer QC thus comprises, if it uses an optical readout of the states of the quantum dots NV1, NV2, NV3, a photodetector PD for detecting the fluorescence radiation FL of the quantum dots NV1, NV2, NV3. The photodetector PD typically generates a received signal S0 as a function of the fluorescence radiation FL. A downstream amplifier V in the signal path typically amplifies and filters the received signal S0 to an amplified received signal S1. The amplifier V thus typically serves to amplify and/or filter the output signal of the photodetector PD, which is typically the received signal S0. Optionally, the amplified received signal S1 is a digitized signal consisting of one or more sampled values. Optionally, the control device μC detects the value of the amplified received signal S1, for example by means of an analog-to-digital converter ADCV. The proposed relocatable quantum computer QC comprises, if it uses an electronic readout of the states of the quantum dots NV1, NV2, NV3, a corresponding device for electronically reading out the states of the quantum dots NV1, NV2, NV3. At this point, the document presented here again expressly refers to DE 10 2020 125 189 A1. Optionally, these device parts are accommodated in an optionally common housing GH, which optionally forms part of the relocatable quantum computer QC within the meaning of the document presented here. As already described above, the quantum dots NV1, NV2, NV3 and the nuclear quantum dots CI1₁, CI1₂, CI1₃, CI2₁, CI2₂, CI2₃, CI3₁, CI3₂, CI3₃ are optionally located within said substrate D. Optionally, the substrate D is doped with dopants. Optionally, the substrate D essentially optionally comprises atoms without a magnetic moment at least in the effective range of the quantum dots NV1, NV2, NV3. In the case of diamond as the material of the substrate D, the diamond optionally essentially comprises ¹²C isotopes. Optionally, in the case of the use of NV centers in diamond as quantum dots NV1, NV2, NV3, oxygen atoms ¹⁶O, ¹⁸O and/or phosphorus and/or sulfur atoms ³²S, ³⁴S, ³⁶S without a magnetic moment in the substrate D form the doping in the region of the quantum dots NV1, NV2, NV3. This doping in the region of the quantum dots NV1, NV2, NV3 has two functions. Firstly, these dopant atoms change the Fermi level E_{F} in the region of the quantum dots NV1, NV2, NV3. In the case of using NV centers as quantum dots NV1, NV2, NV3, this doping with the said dopant atoms shifts the Fermi level E_{F} in the region of these quantum dots NV1, NV2, NV3. In the case of an n-doping, this n-doping shifts the Fermi level E_{F} in the area of these quantum dots NV1, NV2, NV3 in such a way that the Fermi level is raised and therefore the energetically lower lying NV centers are optionally negatively charged. The NV centers then represent NV centers. Since NV-centers have a magnetic moment of this electron configuration due to the negative charge electron, NV centers are therefore particularly suitable for use as quantum dots NV1, NV2, NV3. Secondly, this doping, which is optionally an n-doping, means that the vacancies in the diamond are electrically charged during implantation to form the NV centers and therefore do not agglomerate due to the electrical repulsion of the negatively charged single vacancies. As a result, the concentration of single vacancies remains high, which increases the probability of NV centers forming when nitrogen is implanted in diamond. The best results are achieved by doping a diamond substrate D with sulfur prior to nitrogen implantation. Doping with a sulfur isotope without a nuclear magnetic momentum is optional. Such isotopes are the isotopes ³²S, ³⁴S, ³⁶S. An alternative is doping with the oxygen isotopes ¹⁶O, ¹⁸O, which, however, is less suitable. It is known that n-doping with phosphorus should also be successful. However, phosphorus has a nuclear magnetic momentum. In principle, therefore, N-doping with atoms that do not have a magnetic nuclear moment makes sense. Shifting the Fermi level E_{F} by other means, for example by means of optionally very thin electrodes pre-charged to a suitable potential relative to the substrate D, also led to such effects in the run-up to the preparation of this paper. Optionally, the substrate D of the relocatable quantum computer thus exhibits a local shift of the Fermi level E_{F} at least temporarily, so that this is then energetically shifted in such a way that the yield of quantum dots NV1, NV2, NV3 in the form of NV centers is increased during the implantation of the nitrogen atoms. Similarly, the Fermi level E_{F} of other substrate materials and/or in relation to other paramagnetic centers (e.g. the ST1 center) can be influenced during the formation of these paramagnetic centers. Optionally, the light source LD and the light source driver LDRV and the substrate D and the devices for generating the electromagnetic wave field MW/RF-AWFG, mWA, MGx, MGy, MGz and the control device μC and the memories RAM, NVM of the control device μC and the optical system OS and possibly the amplifier V and the shielding AS are located inside the housing GH, whereby they are optionally shielded against electromagnetic interference radiation penetrating from outside. For this purpose, the material of the housing GH optionally comprises an electrically conductive material. Optionally, the housing GH forms a Faraday cage. Optionally, the material of the housing GH also comprises a material for shielding against magnetostatic and/or quasistatic magnetic fields. For this purpose, the material of the housing GH optionally comprises so-called μ-metal, which is a particularly soft magnetic material.

The optional μ-metal (Mu-metal or permalloy) proposed herein for use in quantum computers QC and quantum technological devices may belong to a group of soft magnetic nickel-iron alloys with 72 to 80% nickel, as well as proportions of copper, molybdenum, cobalt or chromium with high magnetic permeability, which is used in the proposed relocatable quantum computer QC or the proposed quantum technological device for shielding AS low-frequency external magnetic fields.

Such μ-metal optionally has a high permeability (μᵣ=50,000 to 140,000 or more), which causes the magnetic flux of the external low-frequency magnetic fields to concentrate in the material of the housing GH of the relocatable quantum computer QC. This effect leads to considerable shielding attenuation when shielding AS from low-frequency or static magnetic interference fields. Thus, the quantum dots NV1, NV2, NV3 and nuclear quantum dots CI1₁, CI1₂, CI1₃, CI2₁, CI2₂, CI2₃, CI3₁, CI3₂, CI3₃ are shielded against such external magnetic fields even if the relocatable quantum computer QC changes its spatial orientation and/or location in the course of a relocation, wherein such a change in the orientation of the relocatable quantum computer QC and/or the change in location of such a relocatable quantum computer QC is typically accompanied by a change in the orientation and or the strength of the magnetic fields acting on the relocatable quantum computer QC relative to the relocatable quantum computer QC. This is particularly advantageous if the relocatable quantum computer QC does not have active shielding against external magnetic fields, e.g. to save weight, which would detect the interfering magnetic field by means of a magnetic field sensor MSX, MSy, MSz and generate an opposing magnetic field for compensation by means of suitable means MFSx, MFSy, MFSz, MGX, MGy, MGz.

The shield AS of the quantum computer QC may be a part of the housing GH of the relocatable quantum computer QC or the housing GH of the relocatable quantum computer QC itself. As already described, the control device μC controls the light source LD with the aid of said light source driver LDRV. In doing so, the control device μC optionally generates a light source control signal, which may for example be the transmission signal S5, by suitable means. The light source driver LDRV then typically supplies the light source LD with electrical energy as a function of the light source control signal from the control device μC. The light source LD thus optionally generates the pump radiation LB as a function of the light source control signal of the control device μC. Optionally, the light source LD thus optionally generates the pumping radiation LB as a function of the transmission signal S5. In the case of FIG. 1, the control device μC optionally transmits the light source control signal via the control data bus SDB and the waveform generator WFG as transmit signal S5. In the following, the reader can therefore assume for simplification and better understanding that in FIG. 1 the light source control signal is equal to the transmission signal S5. The light source LD then irradiates the quantum dot or the multiple quantum dots NV1, NV2, NV3 with pump radiation LB of a pump radiation wavelength λₚₘₚ by means of the optical system OS. The pump radiation wavelength λₚₘₚ is optionally between 400 nm and 700 nm wavelength and/or preferably between 450 nm and 650 nm and/or preferably between 500 nm and 550 nm and/or preferably between 515 nm and 540 nm and/or optimally at a wavelength of 532 nm. In the case of NV centers in diamond, an OSRAM laser diode of the type PLT5 520B with a wavelength of 520 nm has proven to be an exemplary source of the pump radiation LB for the irradiation of NV centers in diamond as the material of the substrate D. The quantum dots NV1, NV2, NV3 then emit fluorescence radiation FL with a fluorescence wavelength λ_{fl} depending on their state and the pump radiation LB. In the case of NV centers as paramagnetic centers of quantum dots, the fluorescence wavelength is typically in the range of 638 nm. The intensity In of the fluorescence radiation FL typically depends on the intensity Iₚₘₚ of the pump radiation LB and thus also on the light source control signal. The one quantum dot or the several quantum dots NV1, NV2, NV3 thus emit fluorescence radiation FL with a fluorescence radiation wavelength on when irradiated with electromagnetic radiation of the pump radiation wavelength λₚₘₚ. In the case of an optical readout of the state of the quantum dots NV1, NV2, NV3 or the quantum dot, the photodetector PD detects the fluorescence radiation FL by means of the optical system OS and converts the fluorescence radiation FL into a receiver output signal S0. The receiver output signal S0 typically depends on the fluorescent radiation FL that hits the photodetector PD. Optionally, the receiver output signal S0 depends on the intensity In of the fluorescent radiation FL that hits the photodetector PD. In the case of optical readout of the state of the quantum dot(s) NV1, NV2, NV3, the amplifier V amplifies and/or filters the receiver output signal S0 and optionally makes the signal available to the computer core CPU of the control device μC as an amplified receive signal S1. Optionally, the amplifier V stores the values of the amplified samples of the amplified received signal S1, which have been digitized by means of an analog-to-digital converter of the amplifier V, in a memory of the amplifier V. The computer core CPU of the control device μC of the relocatable quantum computer QC can then query these samples of the amplified received signal S1 from the memory of the amplifier V via the control data bus SDB, for example, and process them further. In the case of electronic readout of the quantum dots NV1, V2, NV3, devices HS1 to HS3 and VS1 for electronic readout of the states of the quantum dots NV1, NV2, NV3 with a control unit B CBB, not shown in FIG. 1, generate a second receive signal. As already described, the control device μC of the relocatable quantum computer QC controls the one or more devices for generating an electromagnetic wave field at the respective location of the quantum dots NV1, NV2, NV3 and at the respective location of the nuclear quantum dots CI1₁, CI1₂, CI1₃, CI2₁, CI2₂, CI2₃, CI3₁, CI3₂, CI3₃. By controlling the one or more devices LH1, LH2, LH3, LV1) for generating an electromagnetic wave field at the respective location of the quantum dots NV1, NV2, NV3 and at the respective location of the nuclear quantum dots CI1₁, CI1₂, CI1₃, CI2₁, CI2₂, CI2₃, CI3₁, CI3₂, CI3₃ and/or by controlling the emission of the light source LD, the control device μC of the relocatable quantum computer QC can thus change the states of the quantum dots NV1, NV2, NV3 and/or nuclear quantum dots CI1₁, CI1₂, CI1₃, CI2₁, CI2₂, CI2₃, CI3₁, CI3₂, CI3₃ and/or couple them to one another. Optionally, the control device μC of the relocatable quantum computer QC has means for generating a measured value signal with one or more measured values from one or more received signals, in particular from the first received signal and or the second received signal. Since these received signals depend on the states of the quantum dots NV1, NV2, NV3 and/or nuclear quantum dots CI1₁, CI1₂, CI1₃, CI2₁, CI2₂, CI2₃, CI3₁, CI3₂, CI3₃ the measured value signal typically also depends on the states of the quantum dots NV1, NV2, NV3 and/or nuclear quantum dots CI1₁, CI1₂, CI1₃, CI2₁, CI2₂, CI2₃, CI3₁, CI3₂, CI3₃.

To achieve deployability, the optional use of a room-temperature relocatable quantum computer QC based on paramagnetic centers as quantum dots NV1, NV2, NV3 using nuclear magnetic moments as nuclear quantum dots CI1₁, CI1₂, CI1₃, CI2₁, CI2₂, CI2₃, CI3₁, CI3₂, CI3₃ with optical pump radiation LB and optical state readout or electronic state readout of the quantum dot states of the quantum dots NV1, NV2, NV3 and a suitable relocatable, preferably passive shielding AS.

The present proposal now suggests that the relocatable quantum computer QC and/or the mobile device optionally comprises a relocatable power supply EV for supplying power to the relocatable quantum computer QC. This can facilitate or favor the deployability. Optionally, the power supply EV is located inside the housing GH. The housing GH can comprise a partial housing with a magnetically shielded area in which the partial devices of the relocatable quantum computer QC that are sensitive to magnetic fields are located. Outside this partial housing, but still inside the housing GH, there are optionally the parts of the relocatable quantum computer QC which, firstly, are not sensitive or are less sensitive to external magnetic and electromagnetic interference fields and/or themselves generate electromagnetic and/or magnetic interference fields. The power supply EV is therefore optionally placed outside the partial housing, but inside the housing GH of the relocatable quantum computer QC. The quantum computers QC1 to QC16 of a quantum computer system QUSYS can also have a common housing GH.

Typically, the relocatable quantum computer QC according to the optional embodiment shown in FIG. 1 is part of the relocatable quantum computer system QUSYS together with all necessary means for its operation, e.g. the smartphone or the portable quantum computer system QUSYS or the vehicle or the relocatable weapon system.

These means for operating the relocatable quantum computer QC can thus optionally also be relocatable. The proposed relocatable quantum computer system QUSYS comprises as relocatable means for its operation in particular one or more relocatable power supplies EV and/or one or more relocatable quantum computers QC. For the purposes of this document, these means for operating the relocatable quantum computer QC are also part of the smartphone or the garment or the portable quantum computer system QUSYS or the vehicle or the relocatable weapon system. It is irrelevant for the interpretation of the claims whether the operation of the relocatable quantum computer QC is coupled to means and/or commands external to the quantum computer QC, despite the presence of all means for operating the relocatable quantum computer QC as part of the relocatable quantum computer QC. Importantly, the relocatable quantum computer QC is potentially operable without these means and/or commands external to the quantum computer QC. For example, a relocatable quantum computer system QUSYS that is waiting for an external start command due to the programming of the central control device ZSE and/or the programming of a control device μC of a quantum computer QC of the quantum computer system QUSYS shall still be encompassed by the claims.

The mobile relocatable energy supply EV optionally comprises one or more relocatable charging devices LDV with one or more energy supplies PWR of the charging devices LDV, one or more relocatable disconnecting devices TS, one or more relocatable energy reserves BENG and one or more relocatable energy conditioning devices SRG. The mobile energy supply EV optionally comprises an energy conditioning device SRG, in particular a voltage converter or a voltage regulator or a current regulator, which prevents changes in the energy content of the energy reserve BENG of the energy supply EV, for example the charge state of an accumulator as energy reserve BENG of the energy supply EV, from having an effect on the relocatable quantum computer QC and/or the quantum computer system QUSYS. In this case, the mobile energy supply EV supplies the energy preparation device SRG with energy and the energy preparation device SRG supplies, for example, the relocatable quantum computer QC and possibly other parts of the quantum computer system QUSYS with electrical energy. In this case, the energy supply EV therefore only supplies the quantum computer QC, for example, with electrical energy indirectly via the energy preparation device SRG.

Optionally, the relocatable quantum computer QC is set up and intended to be able to operate with a reduced first number of quantum dots NV1, NV2, NV3 even at room temperature. Room temperature as the operating temperature of the quantum dots NV1, NV2, NV3 leads to a broadening of the resonances in the resonance spectrum, so that they overlap. Optionally, the proposed relocatable quantum computer QC therefore has a relocatable cooling device KV, which can be deployed together with the relocatable quantum computer QC. The relevant relocatable cooling device KV is optionally suitable and/or provided for lowering the temperature of the quantum dots NV1, NV2, NV3 and/or nuclear quantum dots CI1₁, CI1₂, CI1₃, CI2₁, CI2₂, CI2₃, CI3₁, CI3₂, CI3₃. Lowering the operating temperature of the quantum dots NV1, NV2, NV3 leads to a narrowing of the resonances in the resonance spectrum, so that they overlap to a lesser extent or do not overlap. Such cooling by means of a cooling device KV optionally lowers the temperature of the quantum dots NV1, NV2, NV3 and/or nuclear quantum dots CI1₁, CI1₂, CI1₃, CI2₁, CI2₂, CI2₃, CI3₁, CI3₂, CI3₃ to such an extent that the quantum computer QC can work with a second number of quantum dots NV1, NV2, NV3 that is higher than the first number of quantum dots NV1, NV2, NV3.

Optionally, the relocatable quantum computer QC comprises a Closed Loop Helium Gas Cooling System HeCLCS, also known as a Closed Cycle Cryocooler, as a relocatable cooling device KV. We refer here, for example, to https://en.wikipedia.org/wiki/Cryocooler.

A further optional embodiment of the proposal relates to a relocatable quantum computer having a second relocatable power supply. The relocatable second power supply may be wholly or partially identical to the first relocatable power supply (Bat). Optionally, this second relocatable energy supply BENG supplies the relocatable cooling device KV with energy. This has the advantage that the first power supply is not disturbed by transient disturbances of the electric motors of the relocatable cooling device KV.

A further optional embodiment of the proposal concerns a relocatable quantum computer QC for use in a mobile device. Optional is a use in a smartphone or a portable quantum computer system QUSYS or in a vehicle motor vehicle or in a weapon system. That is, the present disclosure proposes a relocatable weapon system having a relocatable quantum computer QC that is part of the relocatable weapon system. Optionally, the relocatable quantum computer QC is used as part of the fire control system of the weapon system or the navigation system GPS, NAV of the weapon system. Optionally, the weapon system uses the relocatable quantum computer QC to solve NP-complete problems, such as but not limited to target identification, target classification, mapping of targets to known enemy objects such as aircraft and/or missile types, vehicle types, ship types, missile types, floating object types, underwater vehicle types, underwater object types, spacecraft types, satellite types, etc., as well as to solve NP-complete problems. Further, the selection of target engagement sequence and/or the selection of weapon means and/or the selection of munitions to engage the targets may be among the problems that the weapon system solves using the relocatable quantum computer QC. Furthermore, the relocatable weapon system can determine and/or modify and/or monitor the route of the respective projectile or warhead or weapon carrier to the target with the aid of the relocatable quantum computer QC.

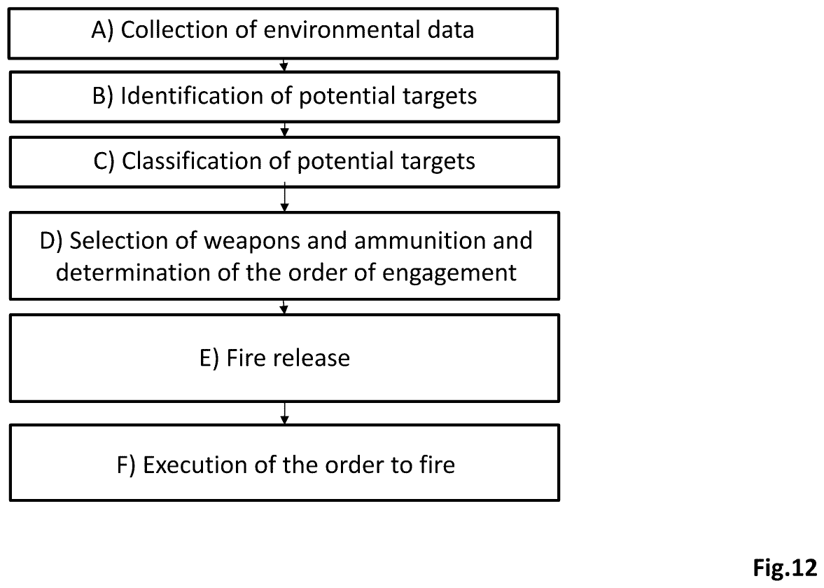

Such a method begins with the acquisition of environment data by the quantum computer system QUSYS in a step A). The environment data is typically recorded by means of suitable sensors, which may be part of the quantum computer system QUSYS or which are connected to this quantum computer system QUSYS via data links and transmit environment data to the quantum computer system QUSYS. In a step B), the quantum computer system QUSYS identifies objects in the environment of the quantum computer system QUSYS, whereby this environment can also be remote from the quantum computer system QUSYS. In a step C), the quantum computer system QUSYS classifies the identified objects in the environment of the quantum computer system QUSYS. Typically, in step C), the quantum computer system QUSYS classifies the objects according to dangerousness and/or vulnerability and/or strategic effect in order to maximize a weapon effect. Optionally, this classification is carried out in step C) by means of a neural network model, which the quantum computer system QUSYS optionally executes. Optionally, for this step C), the quantum computer system QUSYS uses one or more quantum operations to manipulate the quantum state of one or more quantum dots NV1, NV2, NV3 of one or more quantum computers QC1 to QC16 of the quantum computer system QUSYS to perform the classification of the objects. In a step D, the quantum computer system QUSYS determines the weapons and/or the ammunition and/or the configuration and/or the sequence of the attacked objects and/or the attacked objects and/or the non-attacked objects. Optionally, this determination is made in step D) by means of a neural network model, which the quantum computer system QUSYS optionally executes. Optionally, in step D), the quantum computer system QUSYS uses one or more quantum operations to manipulate the quantum state of one or more quantum dots NV1, NV2, NV3 of one or more quantum computers QC1 to QC16 of the quantum computer system QUSYS in order to carry out these determinations. In a step E), the quantum computer system QUSYS optionally proposes one or more of these determined attack scenarios to an operator, for example one or more pilots and/or one or more fire control officers or the like. If they give the order to fire, the quantum computer system QUSYS can, for example, implement the approved attack scenario in a step F). This is shown in FIG. 12.

Optionally, the relocatable quantum computer QC has a shield AS. Optionally, the shielding AS shields the quantum dots NV1, NV2, NV3, for example the NV centers, against electromagnetic fields and/or electromagnetic waves.

The relocatable quantum computer QC optionally comprises an optical system OS, which directs the electromagnetic radiation of the light source LD to the quantum dots NV1, NV2, NV3, for example the paramagnetic centers or the NV centers. The optical system OS optionally comprises a confocal microscope.

Optionally, the optical system OS comprises a first camera CM1 which detects the fluorescence radiation FL of the paramagnetic centers NV1, NV2, NV3 and/or of clusters of such paramagnetic centers, for example NV centers and/or clusters of NV centers. Other fluorescent defect centers with other fluorescence wavelengths are conceivable. Such other fluorescent defect centers with other fluorescence wavelengths can thus have a fluorescence radiation with a fluorescence wavelength that is different from the fluorescence wavelength λ_{fl} of the quantum dots NV1, NV2, NV3 and can therefore be optically separated from the pump radiation LB and the fluorescence radiation FL of the quantum dots NV1, NV2, NV3, for example by means of a dichroic mirror instead of the semi-transparent mirror STM or by means of an optical filter. Optionally, the substrate D is mounted on a positioning stage. The positioning table optionally comprises a translatory positioning device XT in the X direction and a translatory positioning device YT in the Y direction, which optionally controls the control device μC of the quantum computer QC via the control data bus SDB. Optionally, the first camera CM1 detects the position of the substrate D relative to the optical system OS and thus the position of the quantum dots NV1, NV2, NV3 in the substrate D. The first camera CM1 thus detects the position of the paramagnetic centers, for example the NV centers, relative to the optical system OS. If the substrate D is displaced relative to the optical system OS, for example due to mechanical vibrations or other disturbances, an image processing system of the relocatable quantum computer QC detects this mechanical displacement, for example by evaluating the position of fluorescent paramagnetic defect centers. The image processing system optionally records the fluorescence patterns of the defect centers by means of the first camera CM1 and compares their position on the image with target positions. The image processing system optionally determines a displacement vector and repositions the substrate D relative to the optical system OS using the positioning table XT, YT as a function of the determined displacement vector. The image processing device optionally performs this repositioning in such a way that the position of the quantum dot, for example the paramagnetic center or a cluster of paramagnetic centers, relative to the optical system OS is optionally essentially unchanged after completion of the repositioning. Optionally, the image processing system is part of the relocatable quantum computer QC. Typically, the control device μC of the quantum computer operates as the image processing system. However, the image processing system can also be a separate sub-device of the relocatable quantum computer QC. In this case, the control device μC optionally controls the separate image processing system via the control data bus SDB. The image processing system can then be part of the first camera interface CIF, for example. Instead of an image processing system, other position displacement sensors can also detect the displacements of the substrate D relative to the optical system and/or position displacements of the substrate D relative to the optical system. The proposed quantum computer QC then adjusts the position of the substrate D relative to the optical system OS based on the positional displacement data of such positional displacement sensors. For example, such position displacement sensors can transmit the detected position displacement data to the control device μC of the quantum computer QC via the control data bus SDB, so that the control device μC of the quantum computer QC, for example, repositions the positioning table in the X direction by means of the translatory positioning device XT and in the Y direction by means of the translatory positioning device YT and the substrate D relative to the optical system OS in dependence on this detected position displacement data via the control data bus SDB as if essentially no displacement had taken place. This ensures that the relocatable quantum computer QC also functions in the event of vibrations, accelerations and the like.

Optionally, the relocatable quantum computer QC comprises a photodetector PD and an amplifier V. The photodetector PD detects the fluorescence radiation FL of the quantum dots NV1, NV2, NV3 when the light source LD irradiates them with its electromagnetic radiation, which serves as pump radiation LB. The relocatable quantum computer QC optionally uses this to read out the quantum state of the quantum dots NV1, NV2, NV3. Optionally, the quantum dots NV1, NV2, NV3 are paramagnetic centers. Optionally, the paramagnetic centers are NV centers in diamond. The amplifier V amplifies and/or filters the receiver output signal S0 of the photodetector PD to an amplified receiver output signal S1. The amplified receiver output signal can, for example, also be an ordered set of data in a memory of the amplifier V, whereby the computer core CPU of the control device μC can optionally read out this memory of the amplifier V at least partially via the control data bus SDB.

Furthermore, according to the optional embodiment shown in FIG. 1, the relocatable quantum computer QC can also perform an electronic readout of quantum dots NV1, NV2, NV3 in parallel or as an alternative to this optical readout of the state of quantum dots NV1, NV2, NV3. For this purpose, the relocatable quantum computer QC may have, as an alternative or in parallel to the photodetector PD and the amplifier V, a device for electronically reading out the states of the quantum dots NV1, NV2, NV3. Optionally, the device for electronically reading out the states of the quantum dots NV1, NV2, NV3 comprises electrically conductive lines for applying electric fields in the effective range of the quantum dots NV1, NV2, NV3 and contacts for extracting charge carriers in the region of the quantum dots NV1, NV2, NV3. Furthermore, the device optionally comprises, for electronically reading out the states of the quantum dots NV1, NV2, NV3, devices for providing the control signals for controlling said electrically conductive lines for applying electric fields in the effective range of the quantum dots NV1, NV2, NV3. Furthermore, the device optionally comprises devices for electronically reading out the states of the quantum dots NV1, NV2, NV3 for amplifying the electrical currents of charge carriers extracted via the contacts for extracting charge carriers in the region of the quantum dots NV1, NV2, NV3. Optionally, the proposed quantum computer QC comprises one or more digital-to-analog converters which participate in the generation of the control signals for driving said electrically conductive lines LH1, LH2, LH3, LV1 for applying electric fields in the region of action of the quantum dots NV1, NV2, NV3. Optionally, the first horizontal driver stage HD1 has an analog-to-digital converter for driving the first quantum dot NV1 to be driven, which the computer core CPU of the control device μC can optionally control via the control data bus STB. Optionally, the second horizontal driver stage HD2 has an analog-to-digital converter for controlling the second quantum dot NV2 to be controlled, which the computer core CPU of the control device μC can optionally control via the control data bus STB. Optionally, the third horizontal driver stage HD3 has an analog-to-digital converter for controlling the third quantum dot NV3 to be controlled, which the computer core CPU of the control device μC can optionally control via the control data bus STB. Optionally, the control device μC controls one or more of these digital-to-analog converters via an internal control data bus SDB of the relocatable quantum computer QC.

### FIG. 2

FIG. 2 shows two exemplary quantum bits QUB1, QUB2 of a quantum computer system according to an optional embodiment. In the following, the paper presented here first describes the first quantum bit QUB1. The second quantum bit QUB2 results analogously. The substrate D has an underside US to which a backside contact BSC is attached. Optionally, the substrate D is made of diamond. Optionally, the quantum dots NV1, NV2, NV3 and the nuclear quantum dots CI1₁, CI1₂, CI1₃, CI2₁, CI2₂, CI2₃, CI3₁, CI3₂, CI3₃ are irradiated with pump radiation LB from the underside US of the substrate D. Optionally, the isotopes of the substrate D have essentially no nuclear magnetic momentum u. Optionally, an epitaxial layer DEPI is deposited on the substrate D to improve the electronic properties. Optionally, the substrate D and/or the epitaxial layer DEPI essentially comprise only isotopes without a nuclear magnetic momentum μ. Optionally, the substrate D and/or the epitaxial layer DEPI comprises substantially only one isotope type of an isotope without a nuclear magnetic moment μ. The package of substrate D and epitaxial layer DEPI has a surface OF. A vertical line LV1 is applied to the surface OF as part of an exemplary crossbar structure, through which a vertical electric current IV1 modulated with a vertical modulation flows. The surface OF and the vertical line LV1 are covered by an insulation IS. Optionally, a further insulation is located between the vertical line LV1 and the surface OF in order to electrically insulate the vertical line LV1. A first horizontal line LH1 is applied to the insulation IS, through which a first horizontal electric current IH1 modulated with a first horizontal modulation flows. The first vertical line LV1 and the first horizontal line LH1 are optionally electrically insulated from each other. Optionally, the angle α₁₁ between the first horizontal line LH1 and the first vertical line LV1 is a right angle of 90°. The first horizontal line LH1 and the first vertical line LV1 optionally cross above the paramagnetic center of the first quantum dot NV1. Optionally, the first quantum dot NV1 is an NV center in diamond. Optionally, the first quantum dot NV1 is located directly below the crossing point of the first horizontal line LH1 with the first vertical line LV1 at a first distance d1 below the surface OF in the epitaxial layer DEPI. The first distance d1 is optionally between 10 μm and 20 μm, optionally between 5 μm and 40 μm, and optionally between 2.5 μm and 80 μm. In the case of diamond as the material of the epitaxial layer DEPI, the first quantum dot NV1 can, for example, be an NV center. The use of SiV and/or TR1 centers and/or TR12 centers and other paramagnetic centers in diamond is also conceivable. If the horizontal modulation of the first horizontal current IH1 is shifted by +/−π/2, this results in a rotating magnetic field B_{NV} at the location of the first quantum dot NV1, for example, which influences the first quantum dot NV1. This can be used by the control device μC of the quantum computer QC to manipulate the first quantum dot NV1. Here, the control device μC optionally selects the frequency so that the first quantum dot NV1 comes into resonance with the rotating magnetic field B_{NV}. The duration of the pulse then determines the angle of rotation of the quantum information of the first quantum dot NV1. The direction of polarization determines the direction.

FIG. 2 illustrates an example of six nuclear quantum dots, namely, firstly, a first nuclear quantum dot CI1₁, which is assigned to the first quantum dot NV1, and secondly, a second nuclear quantum dot CI1₂, which is assigned to the first quantum dot NV1, and thirdly, a third nuclear quantum dot CI1₃, which is assigned to the first quantum dot NV1, and fourthly, a first nuclear quantum dot CI2₁, which is assigned to the second quantum dot NV2, and for the fifth, a second nuclear quantum dot CI2₂, which is assigned to the second quantum dot NV2, and for the sixth a third nuclear quantum dot CI2₃, which is assigned to the second quantum dot NV2.

Each of the nuclear quantum dots forms a nuclear quantum bit with the lines LV1, LH1, LH2. In the respective nuclear quantum bit, the quantum dot NV1, NV2 is replaced by the nuclear quantum dot CI1₁, CI1₂, CI1₃ in QUB1 and CI2₁, CI2₂, CI2₃ in QUB2.

Isotopes with a magnetic nuclear spin optionally form the nuclear quantum dots CI1₁, CI1₂, CI1₃, CI2₁, CI2₂, CI2₃ in the substrate D. In the case of diamond as the material of the epitaxial layer DEPI or the substrate D, a nuclear quantum dot can be, for example, a ¹³C isotope or an atomic nucleus of a nitrogen atom of an NV center.

FIG. 2 shows an example of a quantum register according to an optional embodiment with a first quantum bit QUB1 and a second quantum bit QUB2. The quantum bits QUB1, QUB2 of the quantum register have a common substrate D and a common epitaxial layer DEPI. The first vertical line of the first quantum bit QUB1 is the first vertical line LV1 of the second quantum bit QUB2. The first vertical line LV1 and the first horizontal line LH1 optionally cross above the first quantum dot NV1, which optionally lies at a first distance d1 below the surface OF, at an optionally right angle α₁₁ of 90°. The first vertical line LV1 and the second horizontal line LH2 optionally cross above the second quantum dot NV2, which optionally lies at a second distance d2 below the surface, at an optional right angle α₁₂ of 90°. Optionally, the first distance d1 and the second distance d2 are similar to each other. In the case of NV centers in diamond as quantum dots NV1, NV2, these distances d1, d2 are optionally 10 nm to 20 nm. A first vertical current IV1 modulated with a horizontal modulation can flow through the first vertical line LV1. A first horizontal current IH1 modulated with a first horizontal modulation can flow through the first horizontal line LH1. A second horizontal current IH2 modulated with a second horizontal modulation can flow through the second horizontal line LH2. The first quantum dot NV1 has a distance sp12 from the second quantum dot NV2.

FIG. 2 also shows an exemplary nucleus-electron-nucleus-electron quantum register CECEQUREG according to an optional embodiment.

The nucleus-electron-nucleus-electron quantum register CECEQUREG comprises an electron-electron quantum register in which the first quantum dot NV1 of the first quantum bit QUB1 can couple with the second quantum dot NV2 of the second quantum bit QUB2.

The nucleus electron-nucleus electron quantum register CECEQUREG comprises a first nuclear electron quantum register in which the first quantum dot NV1 of the first quantum bit QUB1 can couple with the first nuclear quantum dot CI1₁ of the first nuclear quantum bit.

The nucleus electron-nucleus electron quantum register CECEQUREG comprises a second nuclear electron quantum register in which the first quantum dot NV1 of the first quantum bit QUB1 can couple with the second nuclear quantum dot CI1₂ of the second nuclear quantum bit.

The nucleus electron-nucleus electron quantum register comprises a third nuclear electron quantum register in which the first quantum dot NV1 of the first quantum bit QUB1 can couple with the third nuclear quantum dot CI1₃ of the second nuclear quantum bit.

The nucleus electron-nucleus electron quantum register comprises a fourth nuclear electron quantum register in which the second quantum dot NV2 of the second quantum bit QUB2 can couple with the first nuclear quantum dot CI2₁ of the fourth nuclear quantum bit.

The nucleus electron-nucleus electron quantum register comprises a fifth nuclear electron quantum register in which the second quantum dot NV2 of the second quantum bit QUB2 can couple with the second nuclear quantum dot CI2₂ of the fifth nuclear quantum bit.

The nucleus electron-nucleus electron quantum register comprises a sixth nuclear electron quantum register in which the second quantum dot NV2 of the second quantum bit QUB2 can couple with the third nuclear quantum dot CI2₃ of the sixth nuclear quantum bit.

This is a simple form of a quantum bus according to an optional embodiment with a first quantum ALU QUALU1 (NV1, CI1₁, CI1₂, CI1₃) and a second quantum ALU QUALU2 (NV2, CI2₁, CI2₂, CI2₃). The control device μC can entangle the nuclear quantum dots CI1₁, CI1₂, CI1₃ of the first quantum ALU NV1, CI1₁, CI1₂, CI1₃ and the nuclear quantum dots of the second quantum ALU QUALU2 with the aid of the first quantum dot NV1 and the second quantum dot NV2. The first quantum dot NV1 and the second quantum dot NV2 are optionally used to transport the dependency, and the nuclear quantum dots CI1₁, CI1₂, CI1₃, CI2₁, CI2₂, CI2₃ are used for calculations and storage. The fact that the coupling range of the quantum dots NV1, NV2 is greater than the range of the nuclear quantum dots CI1₁ is utilized here, CI1₂, CI1₃, CI2₁, CI2₂, CI2₃ and that the T2 time of the nuclear quantum dots CI1₁, CI1₂, CI1₃, CI2₁, CI2₂, CI2₃ is longer than that of the quantum dots NV1, NV2.

Typically, the distance between the nuclear quantum dots CI1₁, CI1₂, CI1₃ of the first quantum ALU QUALU1 and the second quantum dot NV2 is greater than the electron-nuclear coupling range, so that the state of the nuclear quantum dots CI1₁, CI1₂, CI1₃ of the first quantum ALU QUALU1 cannot influence the state of the second quantum dot NV2 and the state of the second quantum dot NV2 cannot influence the state of the nuclear quantum dots CI1₁, CI1₂, CI1₃ of the first quantum ALU QUALU1.

Typically, the distance between the nuclear quantum dots CI2₁, CI2₂, CI2₃ of the second quantum ALU QUALU2 and the first quantum dot NV1 is greater than the electron-nuclear coupling range, so that the state of the nuclear quantum dots CI2₁, CI2₂, CI2₃ of the second quantum ALU QUALU2 cannot influence the state of the first quantum dot NV1 and the state of the first quantum dot NV1 cannot directly influence the state of the nuclear quantum dots CI2₁, CI2₂, CI2₃ of the second quantum ALU QUALU2.

FIG. 2 further shows an exemplary quantum register according to an optional embodiment with a second horizontal shielding line SH2 and with a first horizontal shielding line SH1 and with a third horizontal shielding line SH3. The additional shield lines enable the injection of further currents to improve the selection of the quantum dots during the execution of the operations by energizing the vertical and horizontal lines. The two additional lines enable even better adjustment.

FIG. 2 further shows an exemplary two-bit electron-electron quantum register according to an optional embodiment with a common first vertical line LV1, several shield lines and two quantum dots NV1, NV2. In FIG. 2, a first vertical shielding line SV1 is drawn parallel to the first vertical line LV1 to illustrate an optional readout process. As this is a cross-sectional view, the corresponding second vertical shielding line SV2, which also runs parallel to the first vertical line LV1 on the other side, is not shown. In this example, the shielding lines are connected to the substrate D by contacts. If an extraction field is now applied between two parallel shielding lines by applying an extraction voltage between these shielding lines SV1, SV2, a measurable current flow occurs when the light source LD irradiates the quantum dots NV1, NV2 with pump radiation LB and these are in the correct quantum state. Further information (suggestion for conciseness:) on a 2-bit electron-electron register can be found, for example, in the following publication:

Petr Siyushev, Milos Nesladek, Emilie Bourgeois, Michal Gulka, Jaroslav Hruby, Takashi Yamamoto, Michael Trupke, Tokuyuki Teraji, Junichi Isoya, Fedor Jelezko, “Photoelectrical imaging and coherent spin-state readout of single nitrogen-vacancy centers in diamond”, Science 363, 728-731 (2019) 15 Feb. 2019. The entire contents of this publication is incorporated herein by reference.

The two quantum dots NV1, NV2 of FIG. 2 are each part of several nuclear electron quantum registers. In the example of FIG. 2, each quantum dot NV1, NV2 is part of a respective quantum ALU QUALU1, QUALU2. The first quantum dot NV1 of the first quantum ALU QUALU1 in the example of FIG. 2 can interact with a first nuclear quantum dot CI1₁ of the first quantum ALU QUALU1 when the microwave and/or radio wave frequency generator MW/RF-AWFG energizes the first horizontal line LH1 and the first vertical line LV1 with a first horizontal current IH1 and a first vertical current IV1, which the microwave and/or radio wave frequency generator MW/RF-AWFG modulates with a first electron-nuclear-radio wave resonance frequency _{fRWEC1_1} for the first quantum ALU QUALU1 or a first nuclear-electron-microwave resonance frequency _{fMWCE1_1} for the first quantum ALU QUALU1. The quantum computer QC optionally measures this first electron-nuclear radio wave resonance frequency _{fRWEC1_1} for the first quantum ALU QUALU1 and this first nuclear-electron microwave resonance frequency (_{fMWCE1_1}) for the first quantum ALU QUALU1 once in an initialization step by means of an OMDR measurement. The computer core CPU of the quantum computer QC stores the measured values in a memory NVM, RAM of the computer core CPU of the control device μC, which the latter retrieves when the computer core CPU is to control the corresponding first nuclear electron quantum register CEQUREG1. The computer core CPU of the control device μC then sets the frequencies accordingly.

In the example of FIG. 2, the first quantum dot NV1 of the first quantum ALU QUALU1 can interact with a second nuclear quantum dot CI1₂ of the first quantum ALU QUALU1 if the microwave and/or radio wave frequency generator MW/RF-AWFG energizes the first horizontal line LH1 and the first vertical line LV1 with a first horizontal current IH1 and a first vertical current IV1, which the microwave and/or radio wave frequency generator MW/RF-AWFG modulates with a second electron-nuclear-radio wave resonance frequency f_{RWEC2_1} for the first quantum ALU QUALU1 or a second nuclear-electron-microwave resonance frequency f_{MWCE2_1} for the first quantum ALU QUALU1. The quantum computer QC measures this second electron-nucleus radio wave resonance frequency f_{RWEC2_1} for the first quantum ALU QUALU1 and this second nucleus electron microwave resonance frequency f_{MWCE2_1} for the first quantum ALU QUALU1 optionally once in an initialization step by means of an OMDR measurement. The computer core CPU of the quantum computer QC stores the measured values in a memory NVM, RAM of the computer core CPU of the control device C, which the latter retrieves when the computer core CPU is to control the corresponding first nuclear electron quantum register CEQUREG1. The computer core CPU of the control device μC then sets the frequencies accordingly.

In the example of FIG. 2, the first quantum dot NV1 of the first quantum ALU QUALU1 can interact with a third nuclear quantum dot CI1₃ of the first quantum ALU QUALU1 if the microwave and/or radio wave frequency generator MW/RF-AWFG energizes the first horizontal line LH1 and the first vertical line LV1 with a first horizontal current IH1 and a first vertical current IV1, which the microwave and/or radio wave frequency generator MW/RF-AWFG modulates with a third electron-nuclear radio wave resonance frequency f_{RWEC3_1} for the first quantum ALU QUALU1 or a third nuclear-electron microwave resonance frequency f_{MWCE3_1} for the first quantum ALU QUALU1. The quantum computer QC measures this third electron-nucleus radio wave resonance frequency f_{RWEC3_1} for the first quantum ALU QUALU1 and this third nucleus electron microwave resonance frequency f_{MWCE3_1} for the first quantum ALU QUALU1 optionally once in an initialization step by means of an OMDR measurement. The computer core CPU of the quantum computer QC stores the measured values in a memory NVM, RAM of the computer core CPU of the control device C, which the latter retrieves when the computer core CPU is to control the corresponding first nuclear electron quantum register CEQUREG1. The computer core CPU of the control device μC then sets the frequencies accordingly.

In the example of FIG. 2, the second quantum dot NV2 of the second quantum ALU QUALU2 can interact with a first nuclear quantum dot CI2₁ of the second quantum ALU QUALU2 if the microwave and/or radio wave frequency generator MW/RF-AWFG energizes the second horizontal line LH2 and the first vertical line LV1 with a second horizontal current IH2 and a first vertical current IV1, which the microwave and/or radio wave frequency generator MW/RF-AWFG modulates with a fourth electron-nuclear radio wave resonance frequency f_{RWEC1_2} for the second quantum ALU QUALU2 or a fourth nuclear-electron microwave resonance frequency f_{MWCE1_2} for the second quantum ALU QUALU2. The quantum computer QC measures this fourth electron-nuclear radio wave resonance frequency f_{RWEC1_2} for the second quantum ALU QUALU2 and this fourth nuclear electron microwave resonance frequency (f_{MWCE1_2}) for the second quantum ALU QUALU2 optionally once in an initialization step by means of an OMDR measurement. The computer core CPU of the quantum computer QC stores the measured values in a memory NVM, RAM of the computer core CPU of the control device μC, which the latter retrieves when the computer core CPU is to control the corresponding first nuclear electron quantum register CEQUREG1. The computer core CPU of the control device μC then sets the frequencies accordingly.

In the example of FIG. 2, the second quantum dot NV2 of the second quantum ALU QUALU2 can interact with a second nuclear quantum dot CI2₂ of the second quantum ALU QUALU2 if the microwave and/or radio wave frequency generator MW/RF-AWFG energizes the second horizontal line LH2 and the first vertical line LV1 with a second horizontal current IH2 and a first vertical current IV1, which the microwave and/or radio wave frequency generator MW/RF-AWFG modulates with a fifth electron-nuclear-radio wave resonance frequency f_{RWEC2_2} for the second quantum ALU QUALU2 or a fifth nuclear-electron-microwave resonance frequency f_{MWCE2_2} for the second quantum ALU QUALU2. The quantum computer QC measures this fifth electron-nucleus radio wave resonance frequency f_{RWEC2_2} for the second quantum ALU QUALU2 and this fifth nucleus electron microwave resonance frequency f_{MWCE2_2} for the second quantum ALU QUALU2 optionally once in an initialization step by means of an OMDR measurement. The computer core CPU of the quantum computer QC stores the measured values in a memory NVM, RAM of the computer core CPU of the control device μC, which the latter retrieves when the computer core CPU is to control the corresponding first nuclear electron quantum register CEQUREG1. The computer core CPU of the control device μC then sets the frequencies accordingly.

In the example of FIG. 2, the second quantum dot NV2 of the second quantum ALU QUALU2 can interact with a third nuclear quantum dot CI2₃ of the second quantum ALU QUALU2 if the microwave and/or radio wave frequency generator MW/RF-AWFG energizes the second horizontal line LH2 and the first vertical line LV1 with a second horizontal current IH2 and a first vertical current IV1, which the microwave and/or radio wave frequency generator MW/RF-AWFG modulates with a sixth electron-nuclear radio wave resonance frequency f_{RWEC2_2} for the second quantum ALU QUALU2 or a sixth nuclear-electron microwave resonance frequency f_{MWCE3_2} for the second quantum ALU QUALU2. The quantum computer QC measures this sixth electron-nucleus radio wave resonance frequency f_{RWEC3_2} for the second quantum ALU QUALU2 and this sixth nucleus electron microwave resonance frequency (f_{MWCE3_2}) for the second quantum ALU QUALU2 optionally once in an initialization step by means of an OMDR measurement. The computer core CPU of the quantum computer QC stores the measured values in a memory NVM, RAM of the computer core CPU of the control device μC, which the latter retrieves when the computer core CPU is to control the corresponding first nuclear electron quantum register CEQUREG1. The computer core CPU of the control device μC then sets the frequencies accordingly.

Since the coupling range of the quantum dots NV1, NV2 is greater, they can be coupled together. In the example of FIG. 2, the second quantum dot NV2 of the second quantum ALU QUALU2 can interact with the first quantum dot NV1 of the first quantum ALU QUALU1 if the microwave and/or radio wave frequency generator MW/RF-AWFG energizes the first horizontal line LH1 and the second horizontal line LH2 and the first vertical line LV1 with a first horizontal current IH1 and a second horizontal current IH2 and a first vertical current IV1, which the microwave and/or radio wave frequency generator MW/RF-AWFG modulates with an electron1-electron2 microwave resonance frequency f_{MWEE12} for coupling the first quantum dot NV1 of the first quantum ALU QUALU1 with the second quantum dot NV2 of the second quantum ALU QUALU2. The computer core CPU of the quantum computer QC optionally measures this electron1-electron2 microwave resonance frequency f_{MWEE12} for the coupling of the first quantum dot NV1 of the first quantum ALU QUALU1 once in the said initialization step by means of a further OMDR measurement. The computer core CPU of the quantum computer QC stores the measured values in a memory RAM, NVM of the computer core CPU of the control device μC, which this computer core CPU retrieves when the corresponding electron-electron quantum register comprising the first quantum dot NV1 and the second quantum dot NV2 is to be activated. The computer core CPU of the control device μC then sets the frequencies accordingly.

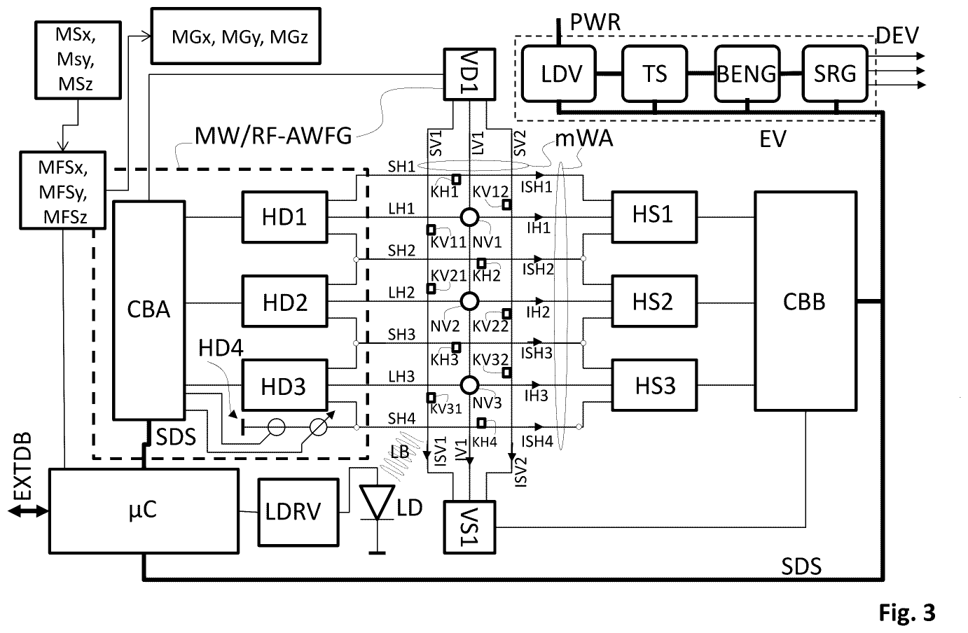

### FIG. 3

FIG. 3 shows the block diagram of a quantum computer QC according to an optional embodiment with an exemplary, schematically indicated three-bit quantum register, which could also be replaced, for example, by a three-bit nuclear electron nuclear electron quantum register (CECEQUREG) with three quantum ALUs. An extension to an n-bit quantum register is easily possible for the skilled person.

The core of the exemplary control device of FIG. 3 is a control device μC, which optionally comprises a computer core CPU. Optionally, the overall device has a magnetic field control optionally in the form of a first magnetic field control MFSx and a second magnetic field control MFSy and a third magnetic field control MFSz, which optionally receives its operating parameters from the said control device μC and optionally returns operating status data to this control device μC. The magnetic field control MFSx, MFSy, MFSz is optionally a multi-dimensional controller whose task is to compensate an external magnetic field by active counter-control. The magnetic field controller MFSx, MFSy, MFSz optionally uses one or more magnetic field sensors MSx, MSy, MSz for this purpose, which optionally measure the magnetic flux in the quantum computer QC in the vicinity of the quantum dots NV1, NV2, NV3 and the nuclear quantum dots CI1₁, CI1₂, CI1₃, CI2₁, CI2₂, CI2₃, CI3₁, CI3₂, CI3₃ not shown in the figure for a better overview. Optionally, the magnetic field sensors MSx, MSy, MSz are quantum sensors. Reference is made here by way of example to the applications DE 10 2018 127 394.0, DE 10 2019 130 114.9, DE 10 2019 120 076.8 and DE 10 2019 121 137.9. With the aid of the magnetic field control device, for example in the form of the first magnetic field generating means MGx and the second magnetic field generating means MGy and the third magnetic field generating means MGz and, the magnetic field control MFSx, MFSy, MFSz adjusts the magnetic flux density B in the vicinity of the quantum dots NV1, NV2, NV3 and the nuclear quantum dots CI1₁, CI1₂, CI1₃, CI2₁, CI2₂, CI2₃, CI3₁, CI3₂, CI3₃ not shown in the figure for a better overview. The paper presented here proposes to optionally use quantum sensors as magnetic field sensors MSx, MSy, MSz, as these have the higher accuracy to sufficiently stabilize the magnetic field.

The control device μC optionally controls the horizontal and vertical driver stages HD1, HD2, HD3 via a control unit A CBA, which optionally energize the horizontal lines LH1, LH2, LH3 and vertical lines LV1 with the respective horizontal and vertical currents and generate the correct frequencies and temporal burst durations and burst positions in relation to a temporal starting point t₀.

The control unit A CBA sets the frequency and the pulse duration of the first horizontal shielding current ISH1 for the first horizontal shielding line SH1 in the first horizontal driver stage HD1 in accordance with the specifications of the control device μC.

The control unit A CBA sets the frequency and the pulse duration of the second horizontal shielding current ISH2 for the second horizontal shielding line SH2 in the first horizontal driver stage HD1 and in the second horizontal driver stage HD2 in accordance with the specifications of the control device μC.

The control unit A CBA sets the frequency and the pulse duration of the third horizontal shielding current ISH3 for the third horizontal shielding line SH3 in the second horizontal driver stage HD2 and in the third horizontal driver stage HD3 in accordance with the specifications of the control device μC.

The control unit A CBA sets the frequency and the pulse duration of the fourth horizontal shielding current ISH4 for the fourth horizontal shielding line SH4 in the third horizontal driver stage HD3 and in the fourth horizontal driver stage HD4, which is only indicated for lack of space, according to the specifications of the control device μC.

The control unit A CBA sets the frequency and the pulse duration of the first horizontal current IH1 for the first horizontal line LH1 in the first horizontal driver stage HD1 according to the specifications of the control device μC.

The control unit A CBA sets the frequency and the pulse duration of the second horizontal current IH2 for the second horizontal line LH2 in the second horizontal driver stage HD2 according to the specifications of the control device μC.

The control unit A CBA sets the frequency and the pulse duration of the third horizontal current IH3 for the third horizontal line LH3 in the third horizontal driver stage HD3 according to the specifications of the control device μC.

The control unit A CBA sets the frequency and the pulse duration of the first vertical shielding current ISV1 for the first vertical shielding line SV1 in the first vertical driver stage HV1 according to the specifications of the control device μC.

The control unit A CBA sets the frequency and the pulse duration of the first vertical current IV1 for the first vertical line LV1 in the first vertical driver stage VD1 according to the specifications of the control device μC.

Synchronized by the control unit A CBA, these driver stages VD1, HD1, HD2, HD3, HD4 feed their current into the lines SV1, LV1, SV2, SH1, LH1, SH2, LH2, SH3, LH3, SH4 in a fixed phase ratio in relation to a common synchronization time.

The following device elements of the quantum computer QC according to the optional embodiment shown are necessary for electronic readout of the quantum states of the quantum dots NV1, NV2, NV3 or the nuclear quantum dots CI1₁, CI1₂, CI1₃, CI2₁, CI2₂, CI2₃, CI3₁, CI3₂, CI3₃.

A control unit B CBB is connected to the control device μC via the control data bus SDB. The control device configures the one control unit B CBB via the control data bus SDB and sets operating parameters and reads out data and operating states via the control data bus SDB. Optionally, the control unit B CBB records the respective photocurrent that the receiver stages HS1, HS2, HS3, VS1 record and makes the measurement data available to the control device μC via the control data bus SDB.

Prior to this, the control device μC configures a first horizontal receiver stage HS1 via the control data bus SDB and typically via the control unit B CBB in such a way that it withdraws the currents fed in by the first horizontal driver stage HD1 on the other side of the lines.

Prior to this, the control device μC optionally configures a second horizontal receiver stage HS2 via the control data bus SDB and typically via the control unit B CBB in such a way that it draws the currents fed in by the second horizontal driver stage HD2 on the other side of the lines.

Prior to this, the control device μC configures a third horizontal receiver stage HS3 via the control data bus SDB and typically via the control unit B CBB in such a way that it withdraws the currents fed in by the third horizontal driver stage HD3 on the other side of the lines.

Prior to this, the control device μC configures a first vertical receiver stage VS1 via the control data bus SDB and typically via the control unit B CBB in such a way that it withdraws the currents fed in by the first vertical driver stage VD1 on the other side of the lines.

Furthermore, the exemplary system of FIG. 3 has a light source LD for pump radiation LB as defined in this document. By means of a light source driver LDRV, the control device μC can irradiate the quantum dots NV1, NV2, NV3 with the pump radiation LB via the optical system OS. When irradiated with this pump radiation LB, the paramagnetic centers of the quantum dots NV1, NV2, NV3 generate photoelectrons which can be extracted by the first horizontal receiver stage HS1 and/or the second horizontal receiver stage HS2 and/or the third horizontal receiver stage HS3 and/or the first vertical receiver stage VS1 by applying an extraction field, for example to the connected shielding lines SH1, SH2, SH3, SH4, SV1, SV2.

In the example shown in FIG. 3, the microwave and/or radio wave frequency generator MW/RF-AWFG for generating largely freely definable waveforms (arbitrary waveform generator) comprises the control unit A CBA, the first horizontal driver stage HD1, the second horizontal driver stage HD2, the third horizontal driver stage HD2 and the first vertical driver stage VD1.

In addition, the microwave and/or radio wave frequency generator MW/RF-AWFG for generating largely freely predeterminable waveforms (arbitrary waveform generator) can also be understood to comprise, in the example of FIG. 3, the control unit B CBB, the first horizontal receiver stage HS1, the second horizontal receiver stage HS2, the third horizontal receiver stage HS2 and the first vertical receiver stage VS1.

The lines SV1, LV1, SV2, SH1, LH1, SH2, LH2, SH3, LH3, SH4 form the exemplary microwave and/or radio wave antenna mWA in the example shown in FIG. 3.

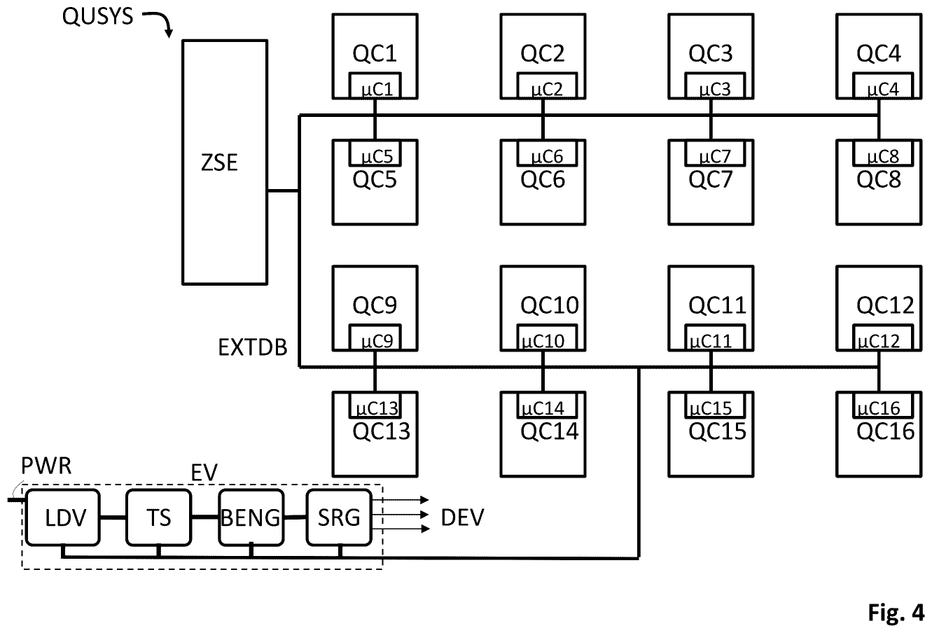

### FIG. 4

FIG. 4 shows an exemplary quantum computer system QUSYS according to an optional embodiment with an exemplary central control unit ZSE. In this example, the exemplary central control unit ZSE is connected to a plurality of quantum computers QC1 to QC16 via an optionally bidirectional data bus, the external data bus EXTDB. Optionally, such a quantum computer system QUSYS comprises more than one quantum computer QC1 to QC16. In the example of FIG. 4, each of the quantum computers QC1 to QC16 comprises a control device μC1 to μC16. Optionally, the quantum computer system QUSYS comprises a charging device LDV, which charges an energy reserve BENG with the energy from an energy supply PWR of the charging device LDV and/or supplies an energy conditioning device SRG with electrical energy. The energy conditioning device SRG supplies one or more device parts of the quantum computer system QUSYS with electrical energy from the energy reserve BENG and/or with electrical energy from the charging device LDV. Optionally, the energy preparation device SRG supplies one or more device parts of the quantum computer system QUSYS with electrical energy from the energy reserve BENG, when a device part of the quantum computer system QUSYS performs a quantum operation for manipulating a quantum dot NV1, NV2, NV3 and/or for manipulating a nuclear quantum dot CI1₁, CI1₂, CI1₃, CI2₁, CI2₂, CI2₃, CI3₁, CI3₂, CI3₃. In the example in FIG. 4, 16 quantum computers QC1 to QC16 are connected to the central control unit ZSE via the external data bus EXTDB. The external data bus EXTDB can be any suitable data transmission system. For example, it can be wired, wireless, fiberoptic, optical, acoustic or radio-based. In the case of a wired system, the external data bus EXTDB can be a single-wire data bus, such as a LIN bus, or a two-wire data bus, such as a CAN data bus, either in its entirety or in sections. The external data bus EXTDB can, for example, be a more complex data bus with several conductors and/or several logical levels, etc., either in whole or in part. The external data bus EXTDB can, for example, be an Ethernet data bus in whole or in part. The external data bus EXTDB can consist entirely of one type of data bus or be composed of various data transmission lines of different types. The external data bus EXTDB can be arranged in a star shape, as in the example in FIG. 4. The external data bus EXTDB can also be designed in whole or in part, for example as in a daisy chain (https://de.wikipedia.org/wiki/Daisy_Chain), as a concatenation of the bus nodes in the form of the quantum computers QC1 to QC16, in which case each of the control devices of the relevant quantum computers of this part of the quantum computer system QUSYS can optionally have more than one data interface in order to be able to connect more than one external data bus EXTDB to the relevant quantum computer, for example for such a concatenation. It is conceivable that one or more quantum computers of the quantum computers QC1 to QC16 then act as bus masters and thus as central control devices ZSE for subordinate sub-networks of the quantum computer system QUSYS.

Optionally, the central control device ZSE of the quantum computer system QUSYS is the control device μC of a quantum computer QC. Optionally, the central control device ZSE of the quantum computer system QUSYS is a quantum computer QC with a control device μC, whereby in the case of FIG. 4, the “normal” computer properties of the control device μC, which control the quantum computer system QUSYS as the central control device ZSE, are taken into account. From the perspective of the quantum computers QC1 to QC16, the central control device ZSE optionally corresponds to an external monitoring computer of the quantum computer system QUSYS.

The data transmission network of the QSYS quantum computer system can correspond in whole or in part to a linear chain of bus nodes in the form of the quantum computers QC1 to QC16 along part of the external data bus EXTDB or along the external data bus EXTDB, which can also be closed to form a ring (keyword token ring).

The data transmission network of the QSYS quantum computer system can resemble a star structure of bus nodes in the form of quantum computers QC1 to QC16, which are connected to one or more data lines and/or data transmission media, either in whole or in part. A star structure exists, for example, in the case of radio transmission of data. One, several or all quantum computers of the quantum computers QC1 to QC16 can also be connected to the central control unit ZSE via a point-to-point connection. In this case, the central control unit ZSE must have a separate data interface for each point-to-point connection.

The data transmission network of the QSYS quantum computer system can be designed as a tree structure, whereby individual quantum computers can have more than one data bus interface, for example, and can serve as bus masters, i.e. central control devices ZSE for sub-networks of the data transmission network consisting of data buses and quantum computers.

The quantum computer system QUSYS can optionally be hierarchically structured, whereby the control devices μC of individual quantum computers can be central control devices ZSE of sub-quantum computer systems. The sub-quantum computer systems are themselves optionally quantum computer systems QUSYS. The central control device ZSE of the sub-quantum computer system is optionally itself a quantum computer, which is optionally itself part of a superordinate quantum computer system QUSYS.

This hierarchization allows different calculations to be processed in parallel in different sub-quantum computer systems, with the number of quantum computers used being selected differently depending on the task.

The QUSYS quantum computer system therefore optionally comprises several interconnected computer units. The computer units are typically computer cores CPU of the control devices μC of the quantum computers QC1 to QC16. Such a computer unit can use an artificial intelligence program that can be coupled with the quantum computers and/or the quantum registers and/or the quantum bits. Both the input to the artificial intelligence program may depend on the state of the quantum dots of these components of the quantum computer system, and the control of the quantum bits and quantum dots of these components of the quantum computer system may depend on the results of the artificial intelligence program. The artificial intelligence program can be executed both in the central control device ZSE and in the control devices μC1 to μC16 of the quantum computers QC1 to QC16. In this case, only parts of the artificial intelligence program can be executed in the central control device ZSE, while other parts of the artificial intelligence program are executed in the control devices μC of quantum computers within the quantum computer system. Optionally, only parts of the artificial intelligence program can be executed in one of the control devices μC1 to μC16 of the quantum computers QC1 to QC16, while other parts of the artificial intelligence program are executed in other control devices μC1 to μC16 of other quantum computers QC1 to QC16 within the quantum computer system QUSYS. This processing of an artificial intelligence program can therefore be distributed across the quantum computer system QUSYS or concentrated in a control device of the control devices μC1 to μC16 of the quantum computers QC1 to QC16. The artificial intelligence program interacts with quantum dots NV1, NV2, NV3 of the quantum computers QC1 to QC16. The control device can therefore optionally be a system of control devices μC1 to μC16. A control device can thus comprise, for example, the central control device ZSE of a quantum computer system QSYS with one or more quantum dots NV1, NV2, NV3 and/or one or more control devices μC of one or more quantum computers QC1 to QC16, each with one or more quantum dots NV1, NV2, NV3. More complex topologies with further intermediate computer nodes and data bus branches are conceivable. The control device, which as described can also be a group of control devices, executes an artificial intelligence program. Such an artificial intelligence program can, for example, be a neural network model with neural network nodes.

For example, one or more control devices of the control devices μC1 to μC16 of the quantum computers QC1 to QC16 and/or the central control unit ZSE may perform a machine learning method. The paper presented here refers to examples of this, the contents of each of which are incorporated herein by reference:
Akinori Tanaka, Akio Tomiya, Koji Hashimoto, “Deep Learning and Physics (Mathematical Physics Studies)” Feb. 21, 2021, Publisher: Springer; 1st ed. 2021 Edition, ISBN-10:9813361077, ISBN-13:978-9813361072, and
Ovidiu Calin, “Deep Learning Architectures: A Mathematical Approach (Springer Series in the Data Sciences)”, Springer; 1st ed. 2020 Edition (Feb. 14, 2021), ISBN-10:3030367231, ISBN-13:978-3030367237.

The methods explained in these writings are part of the disclosure of the presently presented writing, insofar as they are performed by a quantum computer QC according to the presently presented writing. One of the most common techniques in artificial intelligence that a quantum computer QC according to an optional embodiment and/or a quantum computer system QUSYS according to an optional embodiment can perform is machine learning. Machine learning is a self-adaptive algorithm that a quantum computer QC according to an optional embodiment and/or a quantum computer system QUSYS according to an optional embodiment can perform. The so-called deep learning, which a quantum computer QC according to an optional embodiment and/or a quantum computer system QUSYS according to an optional embodiment can perform, is typically a subset of machine learning. In machine learning, a quantum computer QC according to an optional embodiment and/or a quantum computer system QUSYS according to an optional embodiment utilize a series of hierarchical layers or a hierarchy of concepts to perform the process of machine learning. Optionally, the quantum computer QC according to an optional embodiment or the quantum computer system QUSYS according to an optional embodiment uses a model of artificial neural networks that are virtually organized and constructed like the human brain. The virtual neurons of the neural network model executed by the quantum computer QC according to an optional embodiment or the quantum computer system QUSYS according to an optional embodiment are optionally virtually interconnected like a network. The first virtual layer of the neural network, the visible input layer, processes a raw data input, such as the individual pixels of an image. The data input contains variables that are accessible to observation, hence the “visible layer”. This first virtual layer of the neural network model forwards its output to the next virtual layer of the network model in the execution of the neural network model by the quantum computer QC according to an optional embodiment or by the quantum computer system QUSYS according to an optional embodiment. This second virtual layer processes the information of the previous virtual layer and also passes on the result when the neural network model is executed by the quantum computer QC or by the quantum computer system QUSYS. The next, third virtual layer of the neural network model receives the information from the second virtual layer when the neural network model is executed by the quantum computer QC or by the quantum computer system QUSYS. The third virtual layer of the neural network model processes this information further during the execution of the neural network model by the quantum computer QC or by the quantum computer system QUSYS. These layers are referred to as hidden layers. The features they contain become increasingly abstract. Their values are not specified in the original data. Instead, the neural network model should optionally determine which concepts are useful for explaining the relationships in the observed data when the neural network model is executed by the quantum computer QC or by the quantum computer system QUSYS. This continues across all virtual levels of the artificial neural network model. The result is output in the visible, last virtual layer when the neural network model is executed by the quantum computer QC or by the quantum computer system QUSYS. This divides the desired complicated data processing into a series of nested simple assignments, each of which describes a different layer of the neural network model.

The neural network model typically uses one or more input values and/or one or more input signals. The neural network model typically provides one or more output values and/or one or more output signals. It is now proposed here to supplement the artificial intelligence program with a program that performs one or more of the above-mentioned quantum operations on one or more quantum computers of the quantum computers QC1 to QC16. This coupling can optionally take place in one direction in that the control of one or more quantum dots QC1 to QC16, in particular by means of horizontal lines LH1, LH2, LH3 and/or vertical lines LV1, depends on one or more output values and/or one or more output signals of the neural network model. In the other direction, states of one or more quantum dots are read out at a point in time and used as input in the artificial intelligence program, in this example the neural network model. The value of one or more input values and/or one or more input signals of the artificial intelligence program, in this case the neural network model, then depends on the state of one or more of the quantum dots NV1, NV2, NV3 and/or one or more nuclear quantum dots CI1₁, CI1₂, CI1₃, CI2₁, CI2₂, CI2₃, CI3₁, CI3₂, CI3₃.

### FIG. 5

FIG. 5 shows an aircraft FZ according to an optional embodiment with several relocatable quantum computers QC1, QC2. In the example of FIG. 5, the exemplary aircraft FZ has a first quantum computer QC1 and a second quantum computer QC2 and a central control unit ZSE, which are connected to the exemplary two quantum computers QC1, QC2 via an external data bus EXTDB. The external data bus EXTDB is optionally part of the proposed aircraft FZ. The relocatable quantum computers QC1, QC2 optionally perform the solution of NP-hard problems in the proposed aircraft FZ.

Further information on NP-hard problems can be found, for example, at
https://de.wikipedia.org/wiki/NP_(Complexity%C3%A4tsclass) and
https://en.wikipedia.org/wiki/NP-hardness.

Such problems may concern, for example, the arrangement of certain loads in the cargo hold or optimization problems, such as the optimal travel route. It is also conceivable that the relocatable quantum computers QC1, QC2 perform or support artificial intelligence tasks in the aircraft FZ. Optionally, the relocatable quantum computers QC1, QC2 are connected via the external data bus EXTDB to the central control unit ZSE, which is typically another control unit of the aircraft FZ. For example, the central control unit ZSE can be a computer system in the cockpit of the aircraft FZ or in a server room of the aircraft FZ. The proposed aircraft FZ thus optionally comprises a quantum computer system QUSYS with at least one quantum computer QC1, QC2.

The quantum computers QC1, QC2 can optionally support the pilots and the other computer systems of the aircraft FZ. For example, the quantum computers QC1, QC2 of the aircraft FZ can support the attitude control system FLR and/or the navigation system and/or the autopilot NAV, or take over their function in whole or in part. Of course, the functions of a quantum computer QC are not limited to these functions of an aircraft FZ.

Other optional embodiments may include, for example:

### Airborne Weather Radar

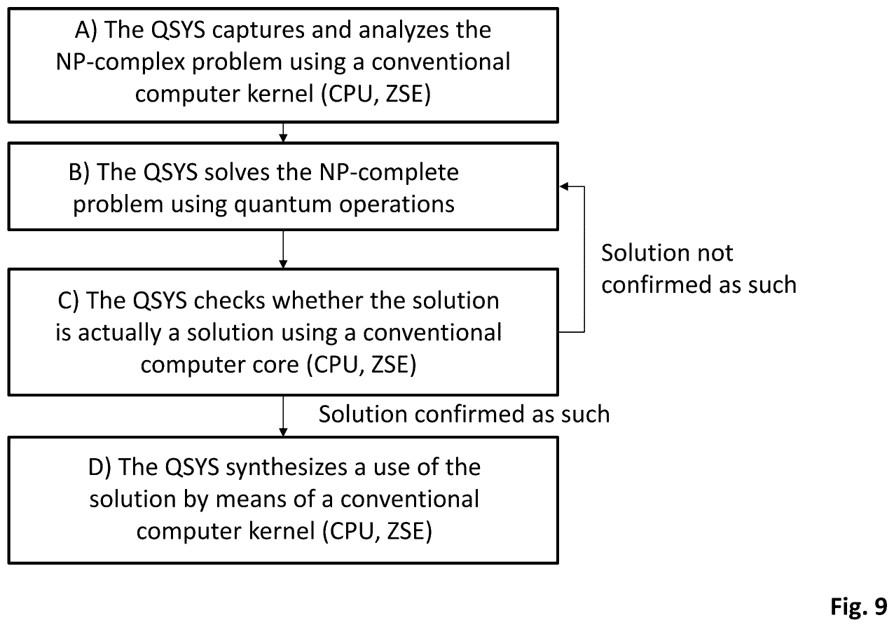

The application and the process of evaluating the airborne weather radar is described below. The weather radar can be installed in the nose behind a radome, a closed protective cover (radar nose), of the aircraft FZ. It can determine the weather in the vicinity of the aircraft. The weather radar can transmit data to one or more quantum computers QC1, QC2 via the external data bus EXTDB. The quantum computers QC1, QC2 can then evaluate the data from the weather radar. Optionally, the quantum computers QC1, QC2 receive further data, for example via radio interfaces of the aircraft FZ from other locations, such as weather services, airline control centers, aircraft manufacturers, etc. Typical NP-complete problems that can be solved particularly well with quantum computers QC in this context are optionally the evaluation of weather data and the optimization of the flight route with regard to risk, flight time, costs, etc. The quantum computers QC1, QC2 can perform these calculations of NP-complete problems and warn the pilots of dangerous weather phenomena at an early stage and make suggestions for optimization. If necessary, conventional computer systems of the aircraft can verify the results of the quantum computer programs, which were executed on the quantum computers QC1, QC2, in a conventional way, since then no optimization search is necessary, and the correctness of the quantum computer calculation is confirmed to the pilots. The paper presented here refers to FIG. 9 as an example.

### ECAM (Electronic Centralized Aircraft Monitoring) or

### EICAS (Engine Indication and Crew Alerting System)

Another possible application is, for example, support for ECAM (Electronic Centralized Aircraft Monitoring) by the QC1 and QC2 quantum computers of the aircraft's QUSYS quantum computer system. This electronic system optionally displays the most important engine parameters in the aircraft and checks all aircraft systems, such as for fuel and hydraulics. It reports errors and optionally provides information on how to rectify the problem. This electronic system optionally displays the most important engine parameters in the aircraft FZ and checks all aircraft systems, for example with regard to fuel and hydraulics. It optionally reports suspected or detected faults and provides information on how to rectify the problem. For this purpose, the quantum computers QC1 and QC2 can perform quantum computer calculations in order to recognize the probabilities of critical combinations of aircraft and environmental parameters and to determine measures, sequences of measures and flight routes etc. in such a way that the probability of critical situations is minimized with maximum effectiveness.

### TCAS (Traffic Alert and Collision Avoidance System)

The TCAS is an on-board early warning system of an aircraft FZ according to an optional embodiment for avoiding aircraft collisions in the air. If two aircraft are on a collision course, it recommends a suitable evasive maneuver to the two pilots in order to avert an imminent collision. The quantum computers QC1, QC2 can optionally suggest avoidance maneuvers, taking into account the weather conditions, etc. The quantum computers QC1, QC2 can optionally suggest evasive maneuvers that firstly have a minimum probability of collision and secondly are also optimal with regard to the weather conditions.

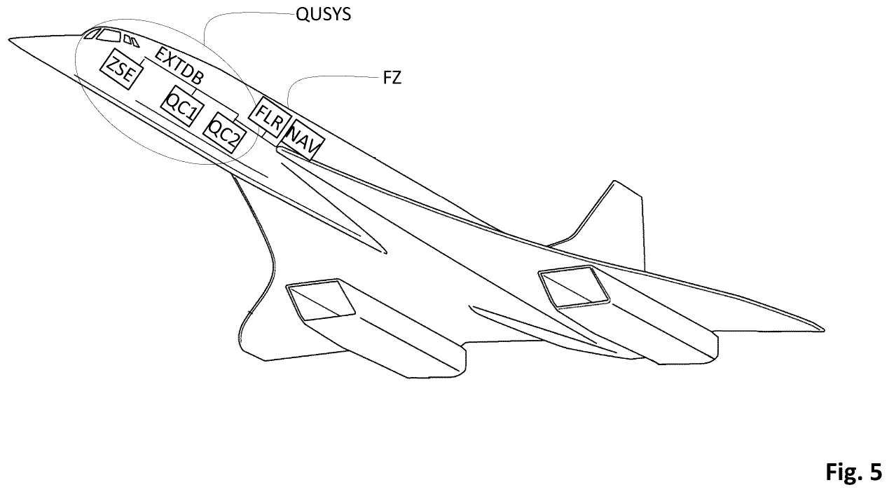

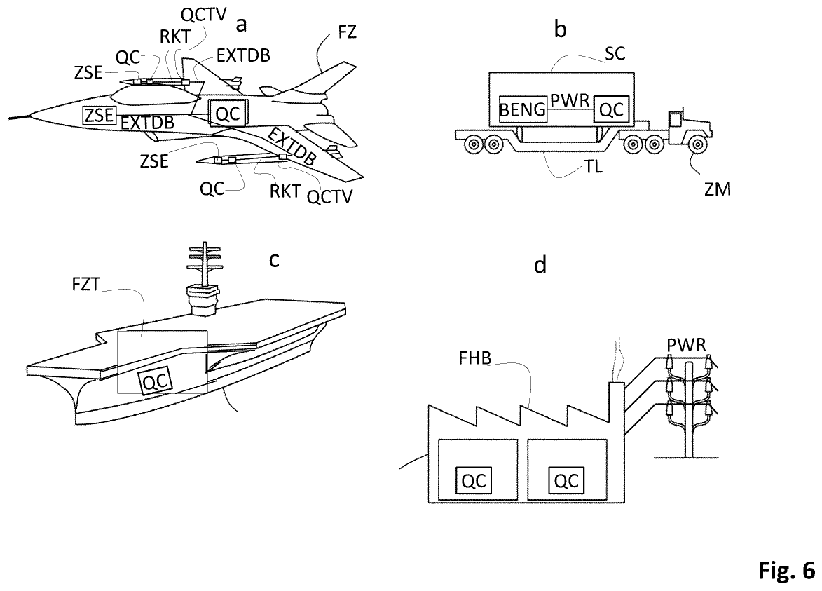

### FIG. 6/FIG. 6a

FIG. 6a shows another example of use of the proposed relocatable quantum computer QC in an aircraft FZ according to an optional embodiment. The example in FIG. 6a is a military aircraft FZ. A military aircraft may be, for example, an interceptor or a long-range bomber or a general combat aircraft or a helicopter or the like. It can also be a drone or the like.

In the example of FIG. 6a, the combat aircraft comprises a quantum computer QC according to an optional embodiment. The quantum computer QC can, for example, in cooperation with a central control unit ZSE of the aircraft FZ, process the NP-complete problem of risk assessment of objects in the vicinity of the aircraft and/or along the route to the target, the target selection and/or target designation and/or the order of target engagement, the selection of ammunition and weapons and/or the fastest and at the same time lowest-risk route to the target. In the example shown in FIG. 6, the quantum computer QC is connected to the central control unit ZSE via an external data bus EXTDB within the aircraft FZ. The quantum computer QC optionally corresponds to a quantum computer QC according to the embodiment shown in FIG. 1 or the preceding description.

In the example shown in FIG. 6a, the exemplary fighter aircraft FZ is armed with a first missile RKT and a second missile RKT. Instead of being armed with missiles RKT and/or in addition to being armed with missiles, it is also conceivable to arm the aircraft with other weapons such as automatic cannons, jammers, reconnaissance devices, etc., In this respect, the missiles are only examples of additional equipment that can be transported as payload by the FZ combat aircraft. In this respect, the FZ aircraft is only an example of a vehicle in the broadest sense.

In the example of FIG. 6a, the vehicle in the form of the aircraft FZ has a quantum computer system QUSYS similar to that of FIG. 4 with one or more central control devices ZSE, which are connected to one or more quantum computers QC via one or more external data buses EXTDB.

In the example of FIG. 6a, the payload in the exemplary form of two rockets RKT each has its own quantum computer systems QUSYS similar to FIG. 4 with one or more central control devices ZSE of the respective payload, which are connected via one or more external data buses EXTDB of the respective payload to one or more quantum computers QC of the respective payload. In the example of FIG. 6a, each of the two exemplary rockets RKT has its own respective quantum computer system QUSYS of the respective rocket RKT similar to FIG. 4 with one or more respective central control devices ZSE of the respective rocket RKT, which are connected to one or more quantum computers QC of the respective rocket RKT via one or more external data buses EXTDB of the respective rocket RKT.

In the state shown, the fighter aircraft FZ thus has several quantum computer systems QUSYS. A first quantum computer system QUSYS comprises at least one central control unit ZSE of the combat aircraft FZ and at least one external data bus EXTDB of the combat aircraft FZ and at least one quantum computer QC of the combat aircraft FZ. An exemplary second quantum computer system QUSYS comprises at least one central control unit ZSE of the first exemplary missile RKT and at least one external data bus EXTDB of the first exemplary missile RKT and at least one quantum computer QC of the first exemplary missile RKT. An exemplary third quantum computer system QUSYS comprises at least one central control unit ZSE of the second exemplary rocket RKT and at least one external data bus EXTDB of the second exemplary rocket RKT and at least one quantum computer QC of the second exemplary rocket RKT.

The paper presented here proposes that optionally an external data bus EXTDB connects the first quantum computer system to the second and third quantum computer systems as long as the payloads, i.e. for example the rockets, are connected to the aircraft FZ.

After the rockets RKT have been fired, i.e. when the aircraft FZ separates from its payload in the form of the rockets RKT, a quantum computer system separation device QCTV separates the quantum computer system QUSYS of the separated payload, in this case the fired rocket RKT, from the quantum computer system QUSYS of the aircraft FZ. The vehicle in this example is an aircraft FZ. However, a vehicle as defined herein may also be a motor vehicle, a two-wheeler, a three-wheeler or a truck, a commercial vehicle, a robot, a transport vehicle, a drone, a robot drone, a flying body, a floating body, a diving body, a ship, a submarine, a sea mine, a land mine, a missile, a projectile, a satellite, a space station, a trailer, a barge, a container, in particular a sea container or the like. The quantum computer system separation device QCTV optionally separates an external data bus EXTDB, which for example connects a first quantum computer system QUSYS to a second quantum computer system QUSYS, if necessary, so that the quantum computer system QUSYS, which previously comprised the first and the second quantum computer system QUSYS, breaks up into two separate quantum computer systems QUSYS as a result of the separation by means of the quantum computer system separation device QCTV. However, the quantum computer system separator QCTV can also, conversely, connect a previously separate first quantum computer system QUSYS to a previously separate second quantum computer system QUSYS, for example via one or more external data buses EXTDB, and couple them if necessary, so that a new, enlarged quantum computer system QUSYS is created, which subsequently merges the first and second quantum computer systems QUSYS into one quantum computer system QUSYS by connecting these two quantum computer systems via a quantum computer system separating device. In such a new quantum computer system QUSYS consisting of at least two previously separate quantum computer systems QUSYS, the central control unit ZSE of the quantum computer system QUSYS of the vehicle, in this case the combat aircraft FZ, is optionally prioritized higher than the central control unit ZSE of the quantum computer system QUSYS of the payload, in this case the missile RKT. This fusion is particularly advantageous during the loading process in which the payload is connected to the vehicle.

After separation of the payload from the vehicle, the quantum computer system QUSYS of the payload can optionally act autonomously. In the example of FIG. 6a, this means that after the separation of the missiles RKT as exemplary payload from the combat aircraft FZ as exemplary vehicle, the quantum computer system QUSYS of the missile RKT can optionally act autonomously. However, it is conceivable that the quantum computer system QUSYS of the payload, here in the form of a missile RKT, remains connected to the quantum computer system QUSYS of the vehicle, here in the form of the combat aircraft FZ, after separation from the vehicle, here in the form of the combat aircraft FZ, via a wireless or wired or via an optical fiber or a functionally equivalent data transmission link. It is also conceivable that, for example, each of the quantum computers QC1 to QC16 of FIG. 4 is the quantum computer QC of an individual vehicle, which are connected to a central control unit ZSE in a command vehicle and/or to each other via a radio link as an external data bus EXTDB. For example, an exemplary quantum computer system QUSYS may be a swarm of drones in which each of the drones comprises one or more quantum computers QC that communicate with each other wirelessly, for example via radio links or laser beam connections as an external data bus EXTDB. In the exemplary case of a swarm of drones, the quantum computer system QUSYS of the quantum computers QC1 to QC16 of the exemplary drones can therefore optionally not comprise a central control device ZSE. Optionally, all drones are designed in approximately the same way and then optionally organize themselves using swarm technologies.

In the example shown in FIG. 6a, each missile RKT comprises an exemplary quantum computer QC. The quantum computer QC can, for example, in cooperation with a central control unit ZSE of the respective missile RKT, process the NP-complex problem of risk assessment of objects in the vicinity of the respective missile RKT and along the route of the respective missile RKT to the target, the target selection and target designation and the order of target engagement of the ammunition and weapon selection and the fastest and at the same time lowest-risk route to the target. The RKT missile can also be a drone or a cruise missile that can engage multiple targets. In the example shown in FIG. 6a, the quantum computer QC of the relevant missile RKT is connected to the central control unit ZSE of the relevant missile RKT via an external data bus EXTDB within the relevant missile RKT. The quantum computer QC of the relevant rocket RKT optionally corresponds to a quantum computer QC of FIG. 1 or the preceding description.

### FIG. 6b

FIG. 6b shows an exemplary relocatable quantum computer QC according to an optional embodiment in a sea container SC on a low-loader TL with a tractor unit ZM. Both the sea container SC and the low-loader TL as well as the tractor unit ZM can comprise one or more quantum computers QC and/or one or more quantum computer systems QUSYS. One or more quantum computers QC and/or one or more quantum computer systems QUSYS may be placed inside the sea container SC. All of these quantum computers QC and/or quantum computer systems QUSYS may be interconnected during transportation and/or before and/or after to form one or more quantum computer systems QUSYS, as explained in the example of FIG. 6a, in particular temporarily. In the example of FIG. 6c, an additional energy reserve BENG supplies the quantum computer system QUSYS with the quantum computer QC within the exemplary sea container SC with electrical energy.

### FIG. 6c

FIG. 6c shows an exemplary aircraft carrier FZT. The exemplary aircraft carrier FZT comprises one or more quantum computers QC and/or one or more quantum computer systems QUSYS. The exemplary aircraft carrier FZT is an example of a warship comprising one or more quantum computers QC and/or one or more quantum computing systems QUSYS. The exemplary aircraft carrier FZT is an example of a ship comprising one or more quantum computers QC and/or one or more quantum computer systems QUSYS. The exemplary aircraft carrier FZT is an example of a floating body comprising one or more quantum computers QC and/or one or more quantum computer systems QUSYS. The exemplary aircraft carrier FZT is an example of a vehicle comprising one or more quantum computers QC and/or one or more quantum computer systems QUSYS. Optionally, the quantum computers QC and/or quantum computer systems QUSYS are relocatable quantum computers QC as defined herein. For example, quantum computer systems QUSYS and/or quantum computers QC of aircraft FZ of the aircraft carrier FZT may be connected to one or more quantum computers QC and/or quantum computer systems QUSYS of the aircraft carrier FZT during transportation by the aircraft carrier FZT and/or in the aircraft carrier FZT, for example via one or more quantum computer system separation devices QCTV and one or more external data buses EXTDB to form larger quantum computer systems QUSYS.

In the example of FIG. 6c, the aircraft carrier FZT exemplarily comprises one or more quantum computers QC and/or one or more quantum computer systems QUSYS. One or more of these quantum computers QC and/or one or more quantum computer systems QUSYS can, for example, in cooperation with a central control unit ZSE of the aircraft carrier FZT, process the NP-complete problem of risk assessment of objects in the environment of the aircraft carrier FZT and along the route to a target, the target selection and target designation and the order of target engagement of the aircraft, ammunition and weapon selection and the fastest and at the same time lowest-risk route to the target. The quantum computer(s) QC and/or the quantum computer system(s) QUSYS of the aircraft carrier FZT are optionally connected to each other and to those of other devices on the aircraft carrier FZT via an external data bus EXTDB and possibly suitable quantum computer system separation devices QCTV within the aircraft carrier FZT. A quantum computer QC of the aircraft carrier FZT optionally corresponds to a quantum computer QC of FIG. 1 or the preceding description.

### FIG. 6d

FIG. 6d shows a factory building FHB as an example of a stationary device in which several quantum computers QC have been installed here as an example. In the example of FIG. 6d, the normal power grid PWR supplies the relocatable quantum computer systems QUSYS with their quantum computers QC within the exemplary stationary devices FBH with electrical energy. For example, the stationary device FHB may comprise one or more quantum computer systems QUSYS with one or more quantum computers QC. The quantum computer(s) QC and/or the quantum computer system(s) QUSYS of the stationary device FHB are optionally connected to each other and to those of other devices of the stationary device FHB via an external data bus EXTDB and possibly suitable quantum computer system separation devices QCTV within the stationary device FHB. A quantum computer QC of the stationary device FHB optionally corresponds to a quantum computer QC of FIG. 1 or the preceding description.

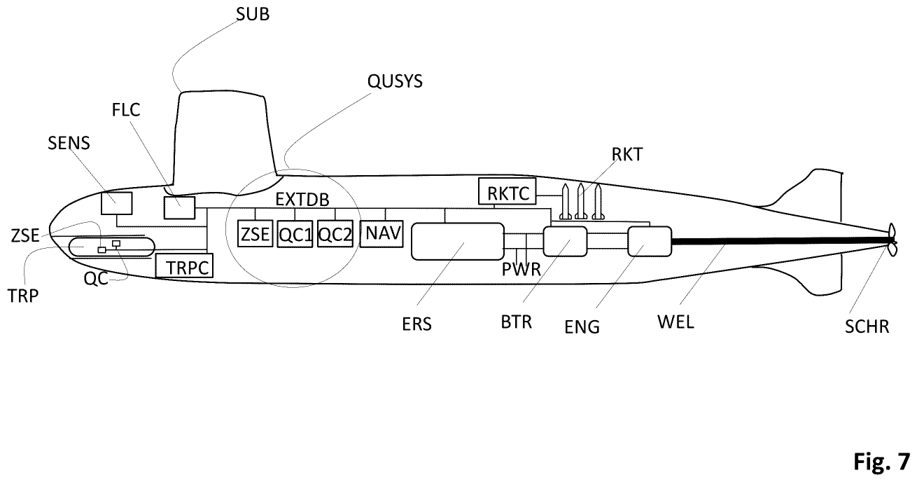

### FIG. 7

FIG. 7 shows another example of a vehicle with a quantum computer system QUSYS according to an optional embodiment with, in this example, two quantum computers QC. This is an exemplary submarine (submarine) SUB. The exemplary submarine SUB has an energy system ERS as the energy source of the submarine SUB. The energy system ERS also represents the energy supply PWR of the charging device LDV of the quantum computer system QUSYS of the submarine SUB. The submarine SUB typically has a very large energy reserve BTR. In the example of FIG. 7, a drive ENG drives the submarine SUB via one or more exemplary propellers SCHR.

In the example shown in FIG. 7, the submarine SUB is armed with a plurality of missiles RKT. These may also be cruise missiles or other devices that are located on the submarine SUB as devices that can be separated from the submarine SUB. In this respect, the missiles RKT here are only examples of devices that are separable from a vehicle and are located on or in the vehicle, here a submarine SUB, for example as a payload, as is the case here. For example, one or more of the rockets RKT of the submarine SUB may comprise one or more quantum computer systems QUSYS and/or one or more quantum computers QC. Optionally, the one or more quantum computer systems QUSYS and/or one or more quantum computers QC are connected to the one and/or more quantum computer systems QUSYS and/or the one or more quantum computers QC1, QC2 of the submarine SUB by means of a quantum computer system separation device QCTV and an external data bus EXTDB. The paper presented here already described the separation and connection of quantum computer systems QUSYS in the description of FIG. 6a. Here, the submarine SUB assumes the role of the aircraft FZ of FIG. 6a. The relationships disclosed there also apply here insofar as applicable and are claimed insofar as applicable and reasonable. A missile launch control RKTC is an example of a fire control system of a vehicle. Here, the vehicle is the submarine SUB. In the example of FIG. 7, the missile launch control RKTC and the submarine SUB may each comprise one or more quantum computer systems QUSYS and/or one or more quantum computers QC. Since the missile launch control RKTC is part of the submarine, the one or more quantum computer systems QUSYS and/or the one or more quantum computers QC of the missile launch control RKTC are also part of the submarine SUB. Optionally, an external data bus EXTDB connects the one or more quantum computer systems QUSYS and/or the one or more quantum computers QC of the missile launch control RKTC to the one or more quantum computer systems QUSYS and/or the one or more quantum computers QC of the submarine SUB.

In the example of FIG. 7, the submarine SUB has a plurality of torpedoes TRP as armament. These may be cruise missiles or other devices that are located on the submarine SUB as devices that can be separated from the submarine SUB and are separated, for example, via the torpedo tubes as an example of a mechanical separation device, for example by firing. In this respect, the torpedoes TRP are here only examples of devices which are separable from a vehicle and are located, for example, as here, as a payload on or in the vehicle, here a submarine SUB. For example, one or more of the torpedoes TRP of the submarine SUB may comprise one or more quantum computer systems QUSYS and/or one or more quantum computers QC. Optionally, the one or more quantum computer systems QUSYS and/or one or more quantum computers QC are connected to the one and/or more quantum computer systems QUSYS and/or the one or more quantum computers QC1, QC2 of the submarine SUB by means of a quantum computer system separation device QCTV and an external data bus EXTDB. The paper presented here already describes the separation and connection of quantum computer systems QUSYS in the description of FIG. 6a. Here, the submarine SUB assumes the role of the aircraft FZ of FIG. 6a. The relationships disclosed there also apply here insofar as applicable and are claimed insofar as applicable and reasonable. A torpedo launch control system TRPC is an example of a fire control system of a vehicle. Here, the vehicle is the submarine SUB. In the example of FIG. 7, the torpedo launch control system TRPC and the submarine SUB may each comprise one or more quantum computer systems QUSYS and/or one or more quantum computers QC. Since the torpedo launch control TRPC is part of the submarine SUB, the one or more quantum computer systems QUSYS and/or the one or more quantum computers QC of the torpedo launch control RKTC are also part of the submarine SUB. Optionally, an external data bus EXTDB connects the one or more quantum computer systems QUSYS and/or the one or more quantum computers QC of the torpedo launch control TRPC to the one or more quantum computer systems QUSYS and/or the one or more quantum computers QC of the submarine SUB.

In addition, the submarine SUB in the example of FIG. 7 optionally has a plurality of sensors SENS which, for example, an external data bus EXTDB connects to one or more quantum computer systems QUSYS and/or quantum computers QC on board the submarine SUB. These may be, for example, sound sensors and/or ultrasonic sensors, conductivity sensors, antennas, sensors for electromagnetic and/or ionizing radiation, particle detectors, pressure sensors, speed sensors, position sensors, attitude sensors, acceleration sensors, magnetometers, LIDAR sensors, RADAR sensors, quantum sensors and the like. The SENS sensors can also be sensor systems, sensor arrays and other measuring systems. The sensors SENS can record measured values inside and outside the vehicle, in this case a submarine SUB.

### FIG. 7

In the example of FIG. 7, for example, one or more quantum computers QC and/or one or more quantum computer systems QUSYS on board the vehicle, here a submarine SUB, for example in cooperation with a central control unit ZSE of the vehicle, can solve the NP-complete problem of risk assessment of objects in the vicinity of the vehicle, here exemplarily the submarine SUB, and/or along the course to the target of the vehicle, the target selection and target determination and the sequence of target engagement, the ammunition and weapon selection and the fastest and at the same time lowest-risk route of the vehicle to the target. In the example shown in FIG. 7, the quantum computers QC1, QC2 of the submarine SUB and the other parts of the device are connected to the central control unit ZSE of the submarine SUB via an external data bus EXTDB within the submarine SUB. The quantum computers QC1, QC2 and the other device parts optionally correspond to a quantum computer QC of FIG. 1 or the preceding description.

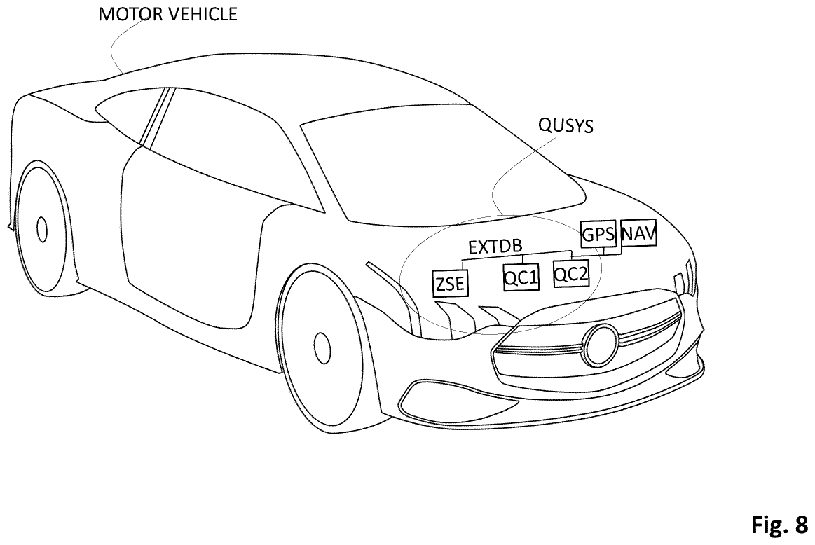

### FIG. 8

FIG. 8 shows an exemplary vehicle according to an optional embodiment with a first quantum computer QC1, a second quantum computer QC2, a central control unit ZSE and an external data bus EXTDB, which connects these to form a quantum computer system QUSYS. In the example in FIG. 8, the vehicle is an exemplary motor vehicle KFZ. As exemplary sensors SENS, the vehicle comprises a GPS receiver GPS for determining the current position on the earth's surface and a navigation system NAV. The vehicle may comprise one or more quantum computers QC and/or one or more quantum computer systems QUSYS, which may be interconnected via one or more external data buses EXTDB. The one or more external data buses may connect the one or more quantum computer QC and/or one or more quantum computer systems QUSYS to one or more actuators and/or one or more sensors. The sensors may also be sensor systems. For example, they may be acceleration and position sensors, impact sensors, ultrasonic measurement systems, radar systems, LIDAR systems, sensor systems of the drive and energy storage systems, etc. The actuators can be transmitters, lasers, motors, etc.

In the example of FIG. 8, for example, one or more quantum computers QC and/or one or more quantum computer systems QUSYS on board the vehicle, in this case a car KFZ, for example in cooperation with a central control unit ZSE of the vehicle, can process the NP-complete problem of risk assessment of objects in the environment of the vehicle, in this case exemplarily the car KFZ, and/or along the route to the destination of the vehicle, the destination selection and destination determination and the sequence of the destination approach and the fastest and at the same time lowest-risk route of the vehicle to the destination. In the example of FIG. 8, the quantum computers QC1, QC2 of the vehicle, here exemplified by the car KFZ, and the other device parts of the vehicle, here exemplified by the car KFZ, are optionally connected to the central control unit ZSE of the vehicle, here exemplified by the car KFZ, via an external data bus EXTDB within the vehicle, here exemplified by the car KFZ. The quantum computers QC1, QC2 and the other parts of the device optionally correspond to a quantum computer QC of FIG. 1 or the preceding description.

### FIG. 9

FIG. 9 shows a method according to an optional embodiment for solving an NP-complete problem. The elaboration of the proposal presented here showed that a problem can be solved with a quantum computer in four steps.

Computer programs that run on conventional computers with Harvard or Von Neumann architecture solve problems optionally with the steps analysis, elaboration and synthesis.

In the analysis step (step A), the computer adapts the problem to the way the computer works. For example, a read-in routine translates a text file with readable numbers into binary data that is stored in the computer's memory.

In a second step, the elaboration (step B), the computer then performs a calculation, for example, in which this binary data is used as input data, and determines binary result data.

In a third step, the synthesis step (step D), the computer adapts this result to the intended use. For example, in the example described here, the computer could convert the binary result data into readable digits of the corresponding numbers in an output text file.

The elaboration now revealed that, particularly in safety-relevant applications, after a solution to an NP-complete problem in the elaboration step B) by means of a quantum computer QC, the quantum computer system QUSYS must perform a check in a step C). In this check step C), the quantum computer system QUSYS or the quantum computer QC optionally uses a conventional computer core CPU or a central control unit ZSE to check whether the solution determined in the elaboration is actually a solution, because quantum operations are usually statistical operations that can also produce incorrect results. If necessary, the QUSYS quantum computer system repeats the calculation.

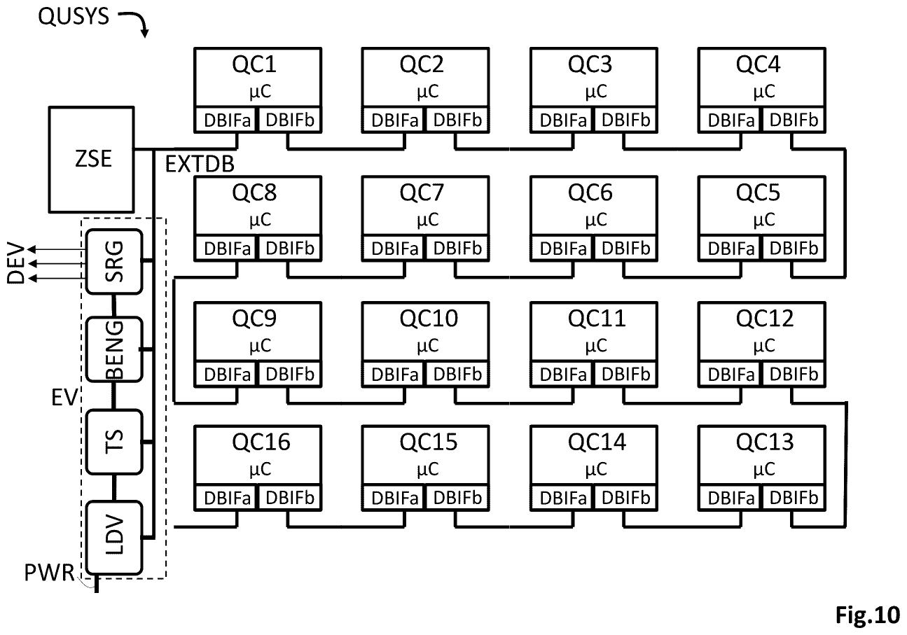

### FIG. 10

FIG. 10 corresponds to FIG. 4, wherein according to the embodiment shown in FIG. 10, exemplary 16 quantum computers QC1 to QC16 of the quantum computer system QUSYS are inserted into the external data bus EXTDB according to an optional embodiment. The control device μC, for example of each quantum computer QC1 to QC16, has, for example, two external data interfaces DBIFa and DBIFb instead of one data bus interface DBIF, as shown in FIG. 1. This allows, for example, the central control device ZSE to assign a unique bus node address to each of the quantum computers QC. Typically, the control devices μC of the quantum computers QC1 to QC16 only pass on data that they receive from the data bus side with the central control device ZSE to quantum computers and bus nodes of the other data bus half if they themselves have already received a valid bus node address from the central control device ZSE. In this way, the central control device ZSE can gradually assign a quantum computer address as the bus node address of the external data bus EXTDB to all quantum computers of the quantum computers QC1 to QC16, starting with the first quantum computer QC1. After switching on or a system reset, all quantum computers QC1 to QC16 optionally have an invalid default quantum computer address, which is typically the same for all quantum computers, as the initial bus node address. This allows the central control device to assign a valid bus node address to the quantum computer of the quantum computers QC1 to QC16 that does not yet have a valid bus node address and is closest to it. This allows the central control device ZSE to reach and initialize the quantum computer of the quantum computers QC1 to QC16 behind it in the next step and so on until all quantum computers of the quantum computers QC1 to QC16 have received a valid quantum computer address as bus node address. Optionally, the quantum computer system QSYS initializes the quantum computers QC1 to QC16 of the quantum computer system QUSYS after it is switched on. Optionally, the initialization of the quantum computer system QUSYS also includes the execution of an auto-addressing procedure for assigning bus node addresses to the bus nodes of the external data bus EXTDB. In the example in FIG. 10, the bus nodes are the quantum computers QC1 to QC16. In the example in FIG. 10, the central control device ZSE optionally assumes the role of a bus master, which generates and assigns the bus node addresses and controls the quantum computers QC1 to QC16.

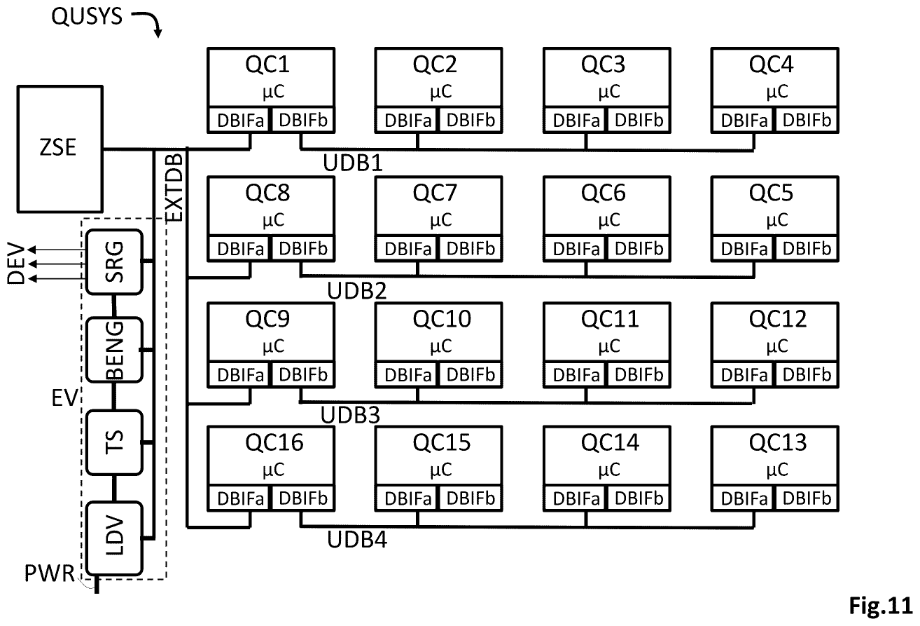

### FIG. 11

FIG. 11 shows a quantum computer system QUSYS according to an optional embodiment with four sub-quantum computer systems.

The first quantum computer QC1 forms a first sub-quantum computer system with the second quantum computer QC2, the third quantum computer QC3 and the fourth quantum computer QC4. A first sub-data bus UDB1 connects the quantum computers QC1, QC2, QC3, QC4 of the first sub-quantum computer system. The first quantum computer QC1 can serve as a bus master for the other quantum computers QC2, QC3, QC4 of the first sub-quantum computer system.

The fifth quantum computer QC5 forms a second sub-quantum computer system with the sixth quantum computer QC6, the seventh quantum computer QC7 and the eighth quantum computer QC8. A second sub-data bus UDB2 connects the quantum computers QC5, QC6, QC7, QC8 of the second sub-quantum computer system. The fifth quantum computer QC5 can serve as bus master for the other quantum computers QC6, QC7, QC8 of the second sub-quantum computer system.

The ninth quantum computer QC9 forms a third sub-quantum computer system with the tenth quantum computer QC10, the eleventh quantum computer QC11 and the twelfth quantum computer QC12. A third sub-data bus UDB3 connects the quantum computers QC9, QC10, QC11, QC12 of the third sub-quantum computer system. The ninth quantum computer QC9 can serve as bus master for the other quantum computers QC10, QC11, QC12 of the third sub-quantum computer system.

The thirteenth quantum computer QC13 forms a fourth sub-quantum computer system with the fourteenth quantum computer QC14 and the fifteenth quantum computer QC15 and the sixteenth quantum computer QC16. A fourth sub-data bus UDB4 connects the quantum computers QC13, QC14, QC15, QC16 of the fourth sub-quantum computer system. The thirteenth quantum computer QC13 can serve as a bus master for the other quantum computers QC14, QC15, QC16 of the fourth sub-quantum computer system.

In the example in FIG. 11, the external data bus EXTDB connects the first quantum computer QC1 and the fifth quantum computer QC5 and the ninth quantum computer QC9 and the thirteenth quantum computer QC13 and the central control unit ZSE.

### FIG. 12

FIG. 12 shows a method according to an optional embodiment for solving an NP-complete problem using a mobile relocatable quantum computer QC according to an optional embodiment. Such a method starts with the acquisition of environment data by the quantum computer system QUSYS in a step A). The environment data is optionally acquired by means of suitable sensors, which may be part of the quantum computer system QUSYS or which are connected to this quantum computer system QUSYS via data links and transmit environment data to the quantum computer system QUSYS. In a step B), the quantum computer system QUSYS identifies objects in the environment of the quantum computer system QUSYS, whereby this environment can also be remote from the quantum computer system QUSYS. In a step C), the quantum computer system QUSYS classifies the identified objects in the environment of the quantum computer system QUSYS. Typically, in step C), the quantum computer system QUSYS classifies the objects according to dangerousness and/or vulnerability and/or strategic effect in order to maximize a weapon effect. Optionally, this classification is carried out in step C) by means of a neural network model, which the quantum computer system QUSYS optionally executes. Optionally, for this step C), the quantum computer system QUSYS uses one or more quantum operations to manipulate the quantum state of one or more quantum dots NV1, NV2, NV3 of one or more quantum computers QC1 to QC16 of the quantum computer system QUSYS to perform the classification of the objects. In a step D), the quantum computer system QUSYS determines the weapons and/or the ammunition and/or the configuration and/or the sequence of the attacked objects, and/or the objects to be attacked and/or the objects not to be attacked. Optionally, this determination is made in step D) by means of a neural network model, which the quantum computer system QUSYS optionally executes. Optionally, in step D), the quantum computer system QUSYS uses one or more quantum operations to manipulate the quantum state of one or more quantum dots NV1, NV2, NV3 of one or more quantum computers QC1 to QC16 of the quantum computer system QUSYS in order to carry out these determinations. In a step E), the quantum computer system QUSYS optionally suggests one or more of these determined attack scenarios to an operator, for example one or more pilots and/or one or more fire control officers or the like. If they give the order to fire, the quantum computer system QUSYS can, for example, implement the approved attack scenario in a step F).

This exemplary application can be generalized for the solution of NP-complete problems. Such a generalized method starts with the acquisition of data by the quantum computer system QUSYS in a step A). The acquisition of data is typically performed by means of suitable sensors and/or databases or other data sources, which may be part of the quantum computer system QUSYS or which are connected to this quantum computer system QUSYS via data links and transmit the data to the quantum computer system QUSYS. In a step B), the quantum computer system QUSYS identifies suitable data objects. In a step C), the quantum computer system QUSYS classifies the identified data objects. Typically, in step C), the quantum computer system QUSYS classifies the objects according to categories that are relevant for solving the respective problem in order to maximize the effect. Optionally, this classification is carried out in step C) by means of a neural network model, which the quantum computer system QUSYS optionally executes. Optionally, for this step C), the quantum computer system QUSYS uses one or more quantum operations to manipulate the quantum state of one or more quantum dots NV1, NV2, NV3 of one or more quantum computers QC1 to QC16 of the quantum computer system QUSYS to perform the classification of the data objects. In a step D), the quantum computer system QUSYS determines the means for achieving the purpose and the parameters and means configurations in the application of these means and/or the order of the processed or unprocessed data objects and/or the order of the applied means. Optionally, this determination is made in step D) by means of a neural network model which the quantum computer system QUSYS optionally executes. Optionally, in step D), the quantum computer system QUSYS uses one or more quantum operations to manipulate the quantum state of one or more quantum dots NV1, NV2, NV3 of one or more quantum computers QC1 to QC16 of the quantum computer system QUSYS in order to carry out these determinations. In a step E), the quantum computer system QUSYS optionally suggests one or more of these determined scenarios to an operator or the same. If they give a start signal, the quantum computer system QUSYS can, for example, implement the approved scenario in a step F).

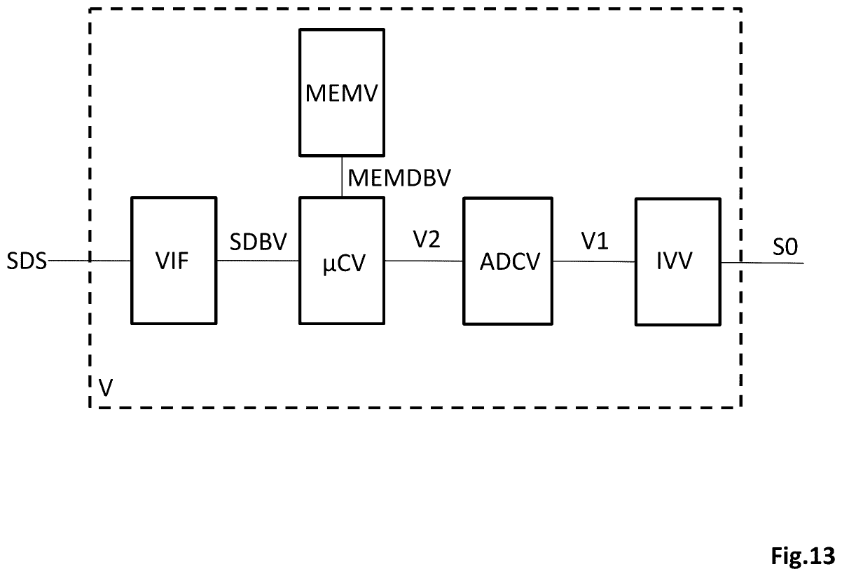

### FIG. 13

FIG. 13 shows an exemplary structure of an amplifier V according to an optional embodiment, as shown in FIG. 1. An internal amplifier IVV of the amplifier V amplifies and filters the receiver output signal S0 to an output signal V1 of the internal amplifier IVV of the amplifier V. An analog-to-digital converter ADCV of the amplifier V converts the output signal V1 of the internal amplifier IVV of the amplifier V to digitized samples on a data line V2 between the control device μCV of the amplifier V and the analog-to-digital converter ADCV of the amplifier V. The control device μCV of the amplifier V optionally stores these samples in a memory. The control device μCV of amplifier V optionally stores these sampled values in a memory MEMV of amplifier V via a memory data bus MEMDBV between the control device μCV of amplifier V and the memory MEMV of amplifier V. The control device μC of the relocatable quantum computer QC can then access the data in the memory MEMV of the amplifier V via the control data bus SDB, the data interface VIF of the amplifier V, the internal control data bus SDBV of the amplifier V and the control device μCV of the amplifier V and process it further.

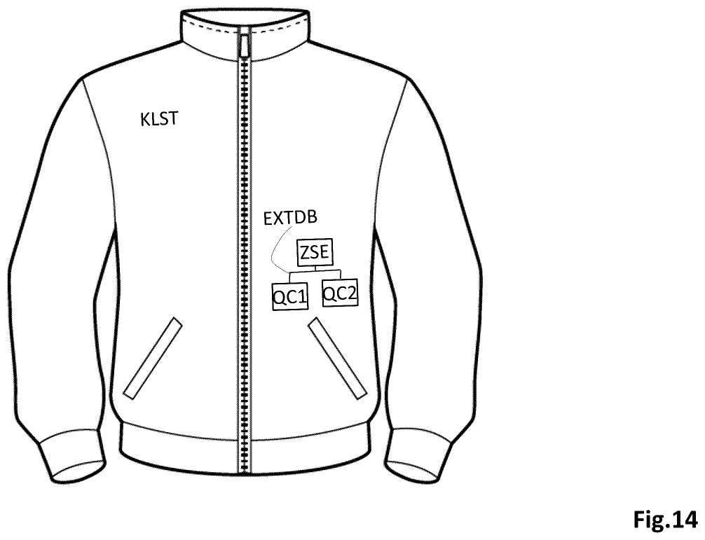

### FIG. 14

FIG. 14 shows an example of a garment according to an optional embodiment with a relocatable quantum computer system QUSYS according to an optional embodiment. For rework, the present document refers by way of example to WO 2020 239 172 A1, which discloses a method for CMOS integration.

The present document proposes to incorporate one or more quantum computers QC1, QC2 and a central control unit ZSE into the material of a garment KLST. Optionally, the quantum computer system QUSYS corresponds to the quantum computer system QUSYS of FIG. 4, 10 or 11 or the like. The garment may also be a wristwatch or the like.

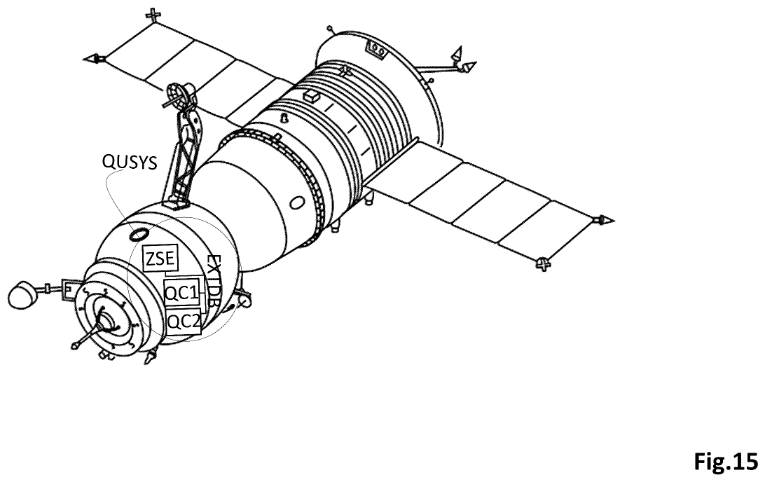

### FIG. 15

FIG. 15 shows an example of a satellite or spacecraft as an example of a vehicle according to an optional embodiment with a relocatable quantum computer system QUSYS according to an optional embodiment. The present disclosure proposes to integrate one or more quantum computers QC1, QC2 and a central control unit ZSE into the satellite or spacecraft. Optionally, the quantum computer system QUSYS corresponds to the quantum computer system QUSYS of FIG. 4, 10 or 11 or the like.

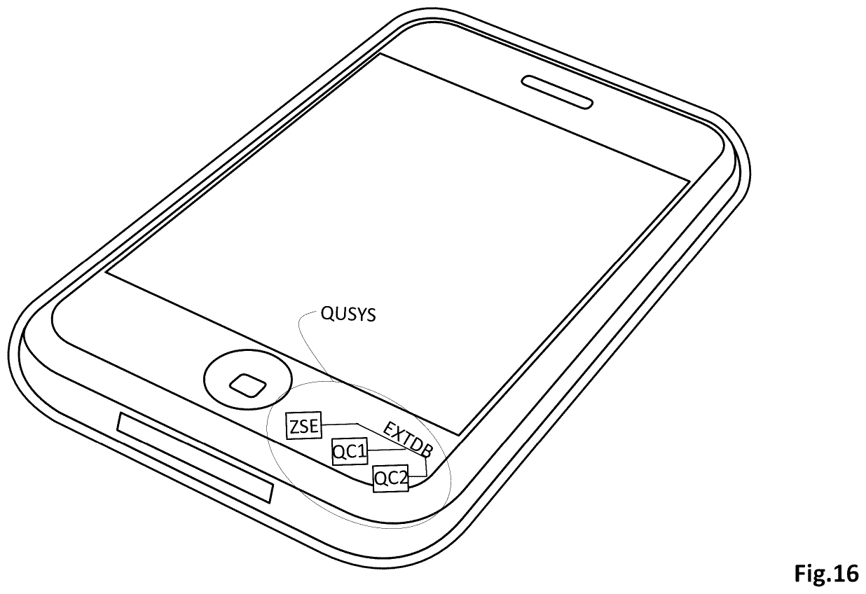

### FIG. 16

FIG. 16 shows an example of a smartphone according to an optional embodiment with a relocatable quantum computer system QUSYS according to an optional embodiment. The present document proposes to integrate one or more quantum computers QC1, QC2 and a central control unit ZSE into the smartphone. For reworking, the paper presented here refers by way of example to WO 2020 239 172 A1, which discloses a method for CMOS integration. Optionally, the quantum computer system QUSYS corresponds to the quantum computer system QUSYS of FIG. 4, 10 or 11 or the like.

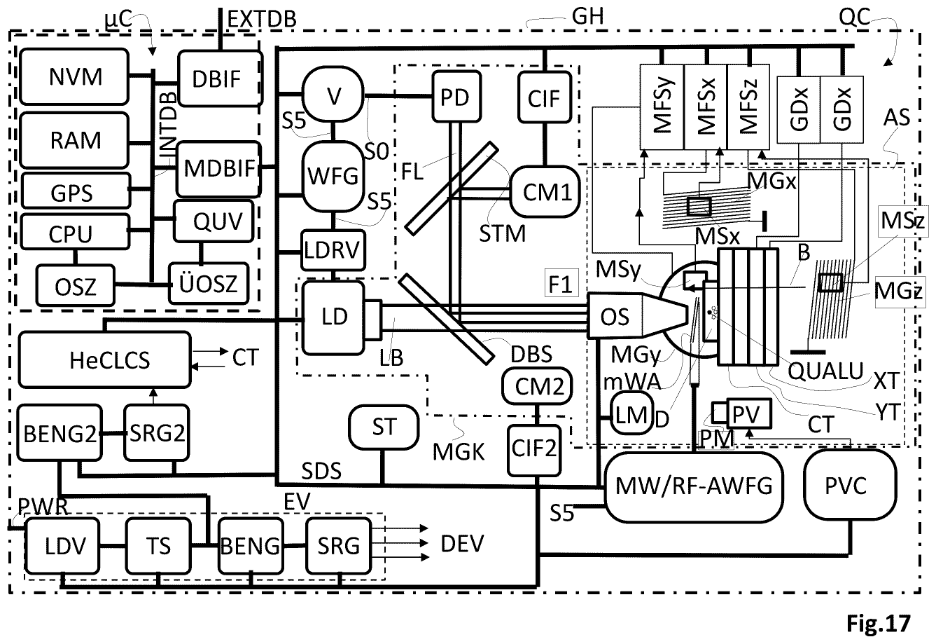

### FIG. 17

FIG. 17 corresponds in many aspects to FIG. 1, but a basic mechanical structure MGK is also shown. Optionally, the basic mechanical structure MGK shown schematically in FIG. 17 connects the optical functional elements (LD, DBS, OS, D, KV, XT, YT, MWA, MGX, MGy, MGz, MGz, PM, PV, MSy, MSx, MSz, STM, PD, CM1, CM2) of the quantum computer QC with each other. Optionally, the mechanical base structure MGK is mechanically connected to the housing GH of the quantum computer QC via fourth means, for example vibration dampers. The fourth means prevent or dampen the transmission of structure-borne noise etc. from the housing GH of the quantum computer QC or other device parts of the quantum computer QC to the mechanical base structure MGK with the optical functional elements (LD, DBS, OS, D, KV, XT, YT, MWA, MGX, MGy, MGz, MGz, PM, PV, MSy, MSx, MSz, STM, PD, CM1, CM2) of the quantum computer QC. Optionally, the quantum computer QC itself is mechanically damped by corresponding fourth means and attached to or in the mobile device, for example a vehicle. The present document refers to the diverse definition of the term vehicle in this context in this document.

The supply lines from device parts of the quantum computer QC which are not directly mechanically connected to the mechanical base structure MGK to device parts (LD, DBS, OS, D, KV, XT, YT, MWA, MGX, MGy, MGz, MGz, PM, PV, MSy, MSx, MSz, STM, PD, CM1, CM2) which are directly connected to the mechanical base structure MGK optionally have fifth means, which are arranged to minimize the transmission of structure-borne noise and forces from the device parts of the quantum computer QC which are not directly mechanically connected to the mechanical base structure MGK to device parts (LD, DBS, OS, D, KV, XT, YT, MWA, MGX, MGy, MGz, MGz, PM, PV, MSy, MSx, MSz, STM, PD, CM1, CM2).

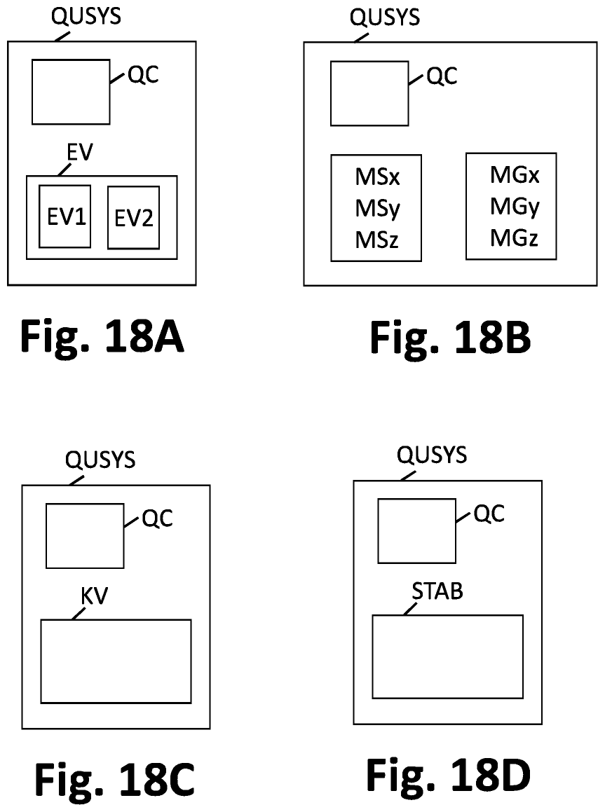

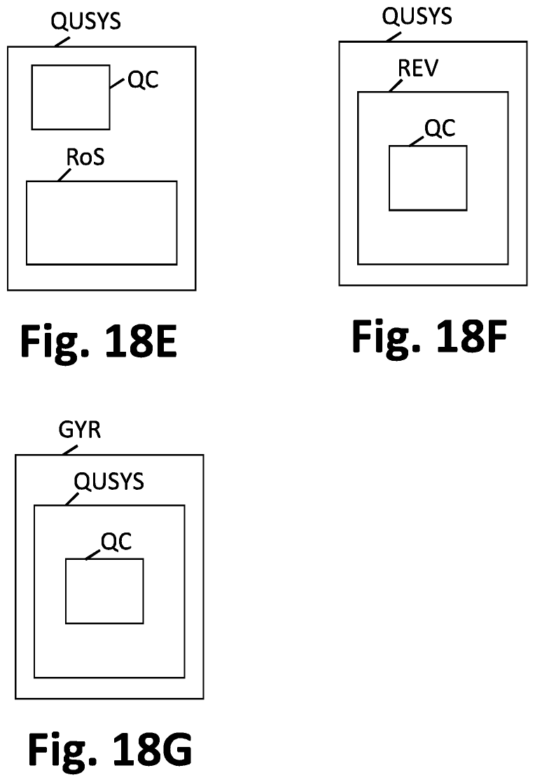

### FIG. 18A

FIG. 18A shows a schematic representation of a relocatable quantum computer system QUSYS, comprising a relocatable quantum computer QC and a power supply device EV for at least partially supplying the quantum computer QC with electrical energy. The quantum computer system QUSYS is characterized in that the energy supply device EV is designed to be relocatable, and

in that the energy supply device EV has a first voltage regulation stage EV1 and a second voltage regulation stage EV2 and is set up to regulate an electrical energy provided by an energy source to a predetermined voltage value by means of a multi-stage voltage regulation by means of the first voltage regulation stage EV1 and the second voltage stage EV2 for at least partially supplying the quantum computer QC.

### FIG. 18B

FIG. 18B shows a schematic representation of a relocatable quantum computer system QUSYS according to an optional embodiment, comprising a relocatable quantum computer QC. The relocatable quantum computer system QUSYS is characterized in that the quantum computer system QUSYS further comprises at least one magnetic field sensor system MSx, MSy, MSz and at least one magnetic field generator MGx, MGy, MGz. In this case, the quantum computer system QUSYS is set up to determine a change in a prevailing magnetic field by means of the at least one magnetic field sensor system MSx, MSy, MSz and to at least partially compensate for the determined change in the magnetic field at the location of the quantum computer QC by means of the magnetic field generator MGx, MGy, MGz.

### FIG. 18C

FIG. 18C shows a schematic representation of a relocatable quantum computer system QUSYS according to an optional embodiment, comprising a quantum computer QC and a cooling device KV, which is set up for this purpose, a temperature of quantum dots NV1, NV2, NV3 of the quantum computer and/or the temperature of nuclear quantum dots CI1₁, CI1₂, CI1₃, CI2₁, CI2₂, CI2₃, CI3₁, CI3₂, CI3₃ of the quantum computer QC and/or a temperature of a substrate D of the quantum computer. The quantum computer system is characterized in that the cooling device KV is designed to be relocatable.

### FIG. 18D

FIG. 18D shows a schematic representation of a relocatable quantum computer system QUSYS according to an optional embodiment, comprising a relocatable quantum computer QC. The quantum computer system QUSYS is characterized in that the quantum computer system QUSYS further comprises a stabilization device STAB, wherein the quantum computer system is arranged to at least partially compensate a mechanical effect on the quantum computer by means of the stabilization device STAB.

### FIG. 18E

FIG. 18E shows a schematic representation of a quantum computer system (QUSYS) according to an optional embodiment comprising a relocatable quantum computer (QC) and a rotation sensor (RoS). The quantum computer system is set up to determine a rotational movement and/or an orientation of the quantum computer and/or the quantum computer system by means of the rotation sensor.

### FIG. 18F

FIG. 18F shows a schematic representation of a quantum computer system (QUSYS) according to an optional embodiment comprising a relocatable quantum computer (QC) and a rotational decoupling device (REV) in which the quantum computer is rotatably mounted. The quantum computer system is arranged to at least partially compensate for or avoid the effect of a rotational movement and/or orientation of the quantum computer at least during operation of the quantum computer by decoupling the quantum computer from its environment by means of the rotational decoupling device.

### FIG. 18G

FIG. 18G shows a schematic representation of a gyroscope (GYR) according to an optional embodiment comprising a quantum computer system (QUSYS) with a quantum computer (QC). The gyroscope is set up to measure a rotational movement by means of the quantum computer.

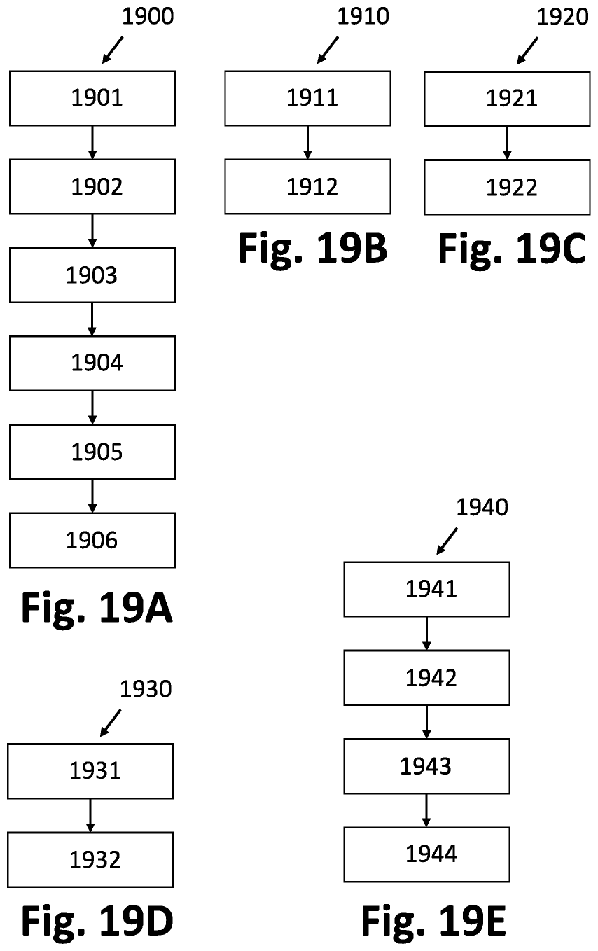

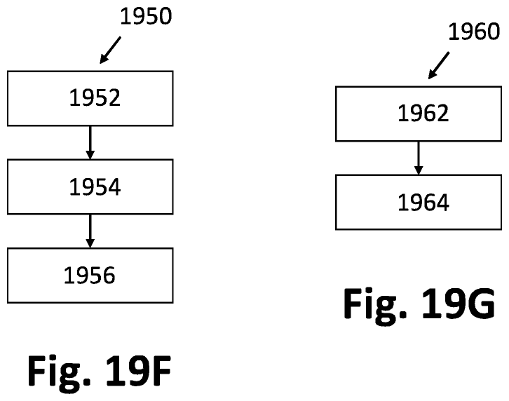

### FIG. 19A

FIG. 19A shows a schematic representation of method 1900 according to an optional embodiment for operating a relocatable quantum computer QC. In a step 1901, the method comprises providing a relocatable energy reserve as an energy source for electrical energy.

The method 1900 is characterized in that the method 1900 comprises, in a further step 1902, providing a relocatable power supply device with a first voltage regulation stage and a second voltage regulation stage.

Furthermore, in a step 1903, the method 1900 comprises connecting the energy reserve to the energy supply device EV and providing the electrical energy from the energy reserve to the energy supply device EV.

In addition, in a further step 1904, the method 1900 comprises regulating a voltage of the provided electrical energy to a first voltage value by means of the first voltage regulation stage EV1 of the energy supply device EV.

In a step 1905, the method 1900 comprises controlling the electrical energy provided by the first voltage control stage EV1 with the first voltage value to a second voltage value by means of a second voltage control stage EV2.

In a step 1906, the method 1900 comprises operating the quantum computer QC with the electrical energy provided by the second voltage regulation stage EV2 with the second voltage value, and performing a quantum operation and/or a quantum computer program product by means of the quantum computer QC.

### FIG. 19B

FIG. 19B shows a schematic representation of the method 1910 according to an optional embodiment for operating a relocatable quantum computer QC. The method 1910 is characterized in that the method 1910 comprises, in a step 1911, determining a change in a prevailing magnetic field by means of a magnetic field sensor system MSx, MSy, MSz.

Further, in a step 1912, the method 1910 comprises at least partially compensating for the change in the magnetic field at the location of the quantum computer QC by means of a magnetic field generator MGx, MGy, MGz.

### FIG. 19C

FIG. 19C shows in a schematic representation the method 1920 according to an optional embodiment for operating a relocatable quantum computer QC having a substrate D and one or more quantum dots arranged in the substrate D. The method 1920 comprises, in a step 1921, providing a relocatable cooling device KV and, in a step 1922, lowering a temperature of the at least one quantum dot in the substrate D by means of the relocatable cooling device KV such that a number of quantum dots available to the quantum computer QC for executing a quantum operation and/or a quantum computer program is increased.

### FIG. 19D

FIG. 19D shows a schematic representation of the method 1930 according to an optional embodiment for operating a relocatable quantum computer QC. The method 1930 comprises, in a step 1931, determining an acceleration of the quantum computer QC and, in a step 1932, at least partially compensating for the acceleration of the quantum computer QC and/or mitigating an effect of the acceleration on the quantum computer QC.

### FIG. 19E

FIG. 19E shows a schematic representation of the method 1940 according to an optional embodiment for controlling a relocatable weapon system with a quantum computer QC. In a step 1941, the method 1940 comprises acquiring environmental data of the weapon system by means of a sensor.

In a step 1942, the method 1940 comprises evaluating the environment data and identifying one or more objects in the environment of the weapon system using the quantum computer QC.

In a step 1943, the method 1940 comprises classifying the one or more identified objects with respect to a dangerousness and/or vulnerability and/or strategic effect of the one or more objects using the quantum computer QC.

In a step 1944, the method 1940 comprises determining one of the following parameters: a weapon of the weapon system to be used, a munition of the weapon system to be used, a configuration of the weapon system to be used, a selection of one or more targets to be engaged from the one or more classified objects, and a sequence of a planned engagement of the plurality of targets to be engaged.

### FIG. 19F

FIG. 19F schematically shows a method (1950) according to an optional embodiment for measuring a rotational movement.

The method (1950) comprises, in a step (1952), providing a quantum computer which is subjected to the rotational motion.

In a step (1954), the method (1950) comprises determining a change in one or more of the following parameters:
a coupling fundamental frequency and/or a coupling fundamental phase position for a coupling between pairs of couplable quantum bits (QUB1, QUB2);
a coupling fundamental frequency and/or a coupling fundamental phase position for a coupling between couplable pairs each consisting of a quantum bit (QUB) and a nuclear quantum bit (CQUB);
a coupling fundamental frequency and/or a coupling fundamental phase position for a coupling between pairs of couplable two nuclear quantum bits (CQUB1, CQUB2) with each other.

In a step (1956), the method (1950) comprises determining the rotational movement based on the determined change in the one or more parameters.

### FIG. 19G

FIG. 19G shows a schematic representation of a method (1960) according to an optional embodiment for operating a relocatable quantum computer.

The method (1960) comprises in a step (1962) a stretchable mounting of the quantum computer in a rotational decoupling device.

In a step (1964), the method (1960) comprises avoiding or reducing an effect of a rotational movement of the quantum computer on the quantum computer by decoupling the quantum computer from its environment by means of the rotational decoupling device.

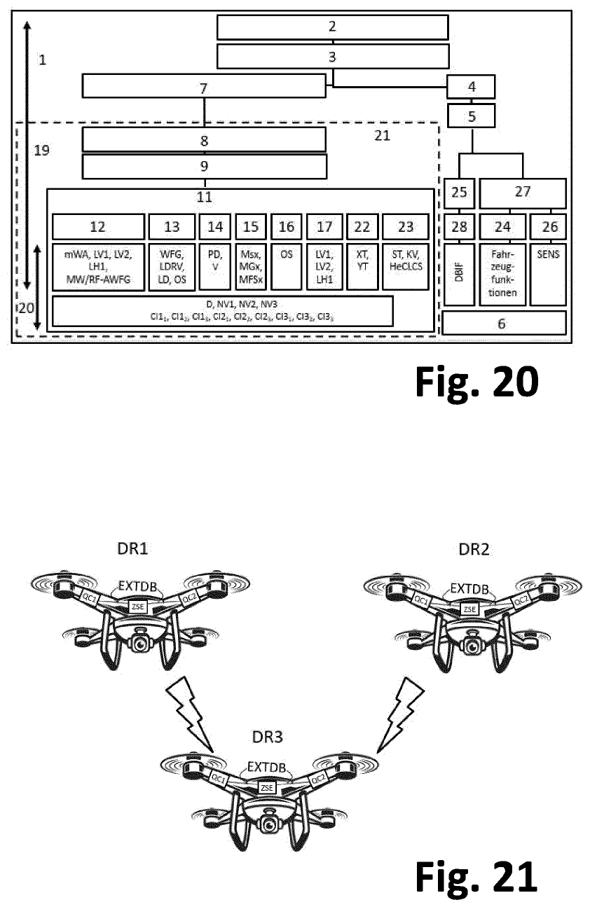

### FIG. 20

FIG. 20 shows an exemplary structure diagram of an exemplary software stack 1 according to an optional embodiment, as it can be used in the form of information of optional contents of the memory RAM, NVM of the control device μC of the quantum computer QC

An application program 2 of the proposed quantum computer QC optionally comprises hybrid quantum/classical programs and software 3.

The hybrid quantum/classical programs and the software 3 optionally comprise classical algorithms 4. These classical algorithms 4 are optionally present in the form of classical programs and software 5 in the memories RAM, NVM of the control device μC of the quantum computer QC. These programs and software 5 in the memories RAM, NVM of the control device μC of the quantum computer QC are optionally present there in the form of binary codes which encode the classical hardware instructions which the classical computer hardware 6, in particular in Von Neumann or Harvard architecture, then executes. The classical computer hardware 6, in particular in Von Neumann or Harvard architecture, is optionally the computer core CPU of the control device μC of the quantum computer QC.

The classical programs and software 5 may comprise, for example, in addition to other software components which serve to solve the problem of the application program 2 of the control device μC, for example, a cryptography program 25 which the control device μC uses for communication and for encrypting and/or decrypting data which the quantum computer QC and/or the control device μC receive or send via the data interface DBIF and/or for encrypting and/or decrypting other data of the quantum computer QC. Optionally, the method used by the control device when executing the cryptographic program 25 is a PQC-secure cryptographic method. The binary-coded classical instructions of the cryptographic program 25 for the computer core CPU of the control device μC are optionally part of the contents of the memories RAM, NVM of the control device μC of the quantum computer QC.

Optionally, the control device for data communication with other quantum computers QC1 to QC16 and/or other computer systems, e.g. a central control unit ZSE, executes a data interface program 28 for controlling and monitoring one or more data interfaces DBIF. The binary-coded classical instructions of the data interface program 28 for the computer core CPU of the control device μC are optionally part of the contents of the memories RAM, NVM of the control device μC of the quantum computer QC.

The classical programs and software 5 may comprise, for example, in addition to other software components which may serve to solve the problem of the application program 2 of the control device μC, for example, a vehicle state determination program 27 which the control device μC uses for the situation assessment of the overall state of the vehicle and/or the environment of the vehicle as a function of measured values. The binary-coded classical instructions of the vehicle status determination program 27 for the computer core CPU of the control device μC are optionally part of the contents of the memories RAM, NVM of the control device μC of the quantum computer QC.

For example, the vehicle status determination program 27 may comprise calling a data interface program 28 for controlling and monitoring one or more data interfaces DBIF. The binary coded classical instructions of the data interface program 28 for the computer core CPU of the control device μC are optionally part of the contents of the memories RAM, NVM of the control device μC of the quantum computer QC.

Optionally, the vehicle status determination program 27 can comprise the call of one or more measured value acquisition programs 26 for querying the measured values and for controlling and monitoring the associated measuring systems and/or sensors SENS. The binary-coded classical instructions of the measured value acquisition program 26 for the computer core CPU of the control device μC are optionally part of the contents of the memories RAM, NVM of the control device μC of the quantum computer QC.

The hybrid quantum technological/classical programs and the software 3 optionally comprise quantum technological algorithms 7. Quantum technological algorithms 7 are optionally characterized in that they change and/or manipulate and/or read out the quantum state of at least one or more of the quantum dots NV1, NV2, NV3 and/or the quantum state of one or more nuclear quantum dots CI1₁, CI1₂, CI1₃, CI2₁, CI2₂, CI2₃, CI3₁, CI3₂, CI3₃.

The quantum technological algorithms 7 optionally comprise abstract quantum gate models 8. Optionally, these quantum gate models 8 are present within the quantum technological algorithms 7 as binary-coded quantum technological instructions. The binary-coded quantum technological instructions of quantum technological algorithms 7 encode the execution instructions for quantum operations and quantum gates corresponding to the quantum gate models 8. These binary-coded quantum technological instructions are optionally part of the contents of the memories RAM, NVM of the control device μC of the quantum computer QC.

Optionally, the information in the memory RAM, NVM of the control device μC of the quantum computer QC comprises classical instructions and commands for the computer core CPU of the control device μC of the quantum computer QC, which are the program data of a transcompiler 9 with an optimizer and quantum error correction function. The control device μC of the quantum computer QC optionally executes this transcompiler 9. By executing the transcompiler 9, the control device μC can identify the binary-coded quantum technological instructions of the currently processed quantum technological algorithm 7 and assign them to the corresponding quantum gate models 8. Depending on the identified quantum gate model 8 for a quantum gate, the control device then optionally executes one or more control programs of the control programs (12 to 17, 22, 23). Optionally, the quantum computer QC executes the control programs of the control programs (12 to 17, 22,23) synchronized in time. For this reason, the control device μC optionally programs the means (WFG, LDRV, LD, DBS, OS, MW/RF-AWFG, MWA, LH1, LV1, LV2, PD, V) for influencing and/or reading out the quantum states of the quantum dots (NV1, NV2, NV3) and nuclear quantum dots (CI1₁, CI1₂, CI1₃, CI2₁, CI2₂, CI2₃, CI3₁, CI3₂, CI3₃), and then signals all means (WFG, LDRV, LD, DBS, OS, MW/RF-AWFG, MWA, LH1, LV1, LV2, PD, V) to influence and/or read out the quantum states of the quantum dots (NV1, NV2, NV3) and nuclear quantum dots (CI1₁, CI1₂, CI1₃, CI2₁, CI2₂, CI2₃, CI3₁, CI3₂, CI3₃) to start the execution of a quantum gate operation in the form of a quantum gate, so that the means (WFG, LDRV, LD, DBS, OS, MW/RF-AWFG, MWA, LH1, LV1, LV2, PD, V) for influencing and/or reading out the quantum states of the quantum dots (NV1, NV2, NV3) and nuclear quantum dots (CI1₁, CI1₂, CI1₃, CI2₁, CI2₂, CI2₃, CI3₁, CI3₂, CI3₃) optionally execute the corresponding quantum gate autonomously. Optionally, the control computer μC of the quantum computer QC optimizes the execution of the quantum technological algorithm 7 and the execution of the corresponding quantum gate model 8. Optionally, the control computer μC of the quantum computer QC performs an error correction of any quantum computer calculation results obtained in this context by means of subroutines of the transcompiler 9. The binary, typically classical binary, instruction codes of the transcompiler 9 are typically part of the contents of the memories RAM, NVM of the control device μC of the quantum computer QC.

The control programs (12 to 17, 22, 23) of the quantum gate hardware model 11 optionally include a control program 12 for monitoring and controlling the one or more microwave and/or radio wave frequency generators MW/RF-AWFG for generating an electromagnetic wave field by means of one or more microwave and/or radio wave antennas mWA, in particular vertical lines LV1, LV2 or horizontal lines LH1 at the respective location of the quantum dots NV1, NV2, NV3, for acting on the quantum states of the quantum dots NV1, NV2, NV3 of the quantum computer QC and/or the quantum states of the nuclear quantum dots CI1₁, CI1₂, CI1₃, CI2₁, CI2₂, CI2₃, CI3₁, CI3₂, CI3₃ of the quantum computer QC.

The control programs (12 to 17, 22, 23) of the quantum gate hardware model 11 optionally include an SPc laser control program 13 for controlling and controlling the waveform generator WFG and the light source driver LDRV and thus the light source LD for generating light pulses by means of the waveform generator WFG and the light source driver LDRV and the light source LD.

The control programs (12 to 17, 22, 23) of the quantum gate hardware model 11 optionally include a control program 14 for controlling the readout of the quantum states of the quantum dots NV1, NV2, NV3 of the quantum computer QC and/or the quantum states of the nuclear quantum dots CI1₁, CI1₂, CI1₃, CI2₁, CI2₂, CI2₃, CI3₁, CI3₂, CI3₃ of the quantum computer QC by means of the control device μC. Optionally, this is a control program 14 for driving, controlling and reading out values of the means PD, V for optically reading out the quantum dots NV1, NV2, NV3 of the quantum computer QC and/or the quantum states of the nuclear quantum dots CI1₁, CI1₂, CI1₃, CI2₁, CI2₂, CI2₃, CI3₁, CI3₂, CI3₃ of the quantum computer QC by the control device μC and/or by a control program 14 for driving, controlling and reading out values of the means for electrically reading out the quantum dots NV1, NV2, NV3 of the quantum computer QC and/or the quantum states of the nuclear quantum dots CI1₁, CI1₂, CI1₃, CI2₁, CI2₂, CI2₃, CI3₁, CI3₂, CI3₃ of the quantum computer QC.

The control programs (12 to 17, 22, 23) of the quantum gate hardware model 11 optionally include a control program 15 for detecting the magnetic flux density B in the region of the quantum dots NV1, NV2, NV3 of the quantum computer QC and/or the quantum states of the nuclear quantum dots CI1₁, CI1₂, CI1₃, CI2₁, CI2₂, CI2₃, CI3₁, CI3₂, CI3₃ of the quantum computer QC by means of magnetic field sensors MSx for the magnetic flux density Bₓ in the direction of the X-axis and/or by means of magnetic field sensors MSy for the magnetic flux density B_{y} in the direction of the Y-axis and/or by means of magnetic field sensors MSz for the magnetic flux density B2 in the direction of the Z-axis and/or for the control and monitoring of magnetic field controllers MFSx, MFSy, MFSz and/or for the control and monitoring of magnetic field generating means MGx, MGy, MGz.

The control programs (12 to 17, 22, 23) of the quantum gate hardware model 11 optionally include a control program 16 for controlling the optical system OS in order to optimize the irradiation of the laser beam LB into the substrate D as required. This may involve, for example, setting the focus and/or adjusting the apertures.

The control programs (12 to 17, 22, 23) of the quantum gate hardware model 11 optionally include a control program 17 for execution by the control device μC and for controlling and setting DC current levels and/or DC voltage levels for influencing certain quantum dots NV1, NV2, NV3 of the quantum computer QC and/or certain nuclear quantum dots CI1₁, CI1₂, CI1₃, CI2₁, CI2₂, CI2₃, CI3₁, CI3₂, CI3₃ of the quantum computer QC in such a way that they possibly participate in a hardware operation or do not participate in a hardware operation.

The control programs (12 to 17, 22, 23) of the quantum gate hardware model 11 optionally include a position control program 22 for monitoring and controlling a positioning device XT, YT for positioning and possibly aligning the substrate D with respect to the optical system OS.

The control programs (12 to 17, 22, 23) of the quantum gate hardware model 11 optionally include a temperature control program 23 for controlling one or more cooling devices KV and/or one or more closed loop helium gas cooling systems HeCLCS.

The binary, typically classical binary, instruction codes of the control programs (12 to 17, 22, 23) of the quantum gate hardware model 11 are optionally part of the contents of the memories RAM, NVM of the control device μC of the quantum computer QC.

The software stack within the meaning of the document presented here optionally comprises a hardware part 20 of the software stack 1 and a software part 19 of the software stack 1. Among other things, in the means (WFG, LDRV, LD, DBS, OS, MW/RF-AWFG, MWA, LH1, LV1, LV2, PD, V) for electrically and/or optically reading out the quantum states of the quantum dots (NV1, NV2, NV3) and nuclear quantum dots (CI1₁, CI1₂, CI1₃, CI2₁, CI2₂, CI2₃, CI3₁, CI3₂, CI3₃) and the means (XT, YT) for aligning and positioning the substrate D relative to the optical system OS and in the means (ST, KV, HeCLCS) for detecting, adjusting and controlling the temperature, the hardware part 20 of the software stack 1 and a software part 19 of the software stack 1 overlap.

In addition, the software stack 1 as defined in the present document optionally comprises further exemplary hardware parts (DBIF, vehicle functions, SENS) of the quantum computer QC and further associated software parts (4, 5, 25,27, 28, 24, 26) software part 19 of the software stack 1.

The quantum technological algorithms 7, the abstract quantum gate models 8 and/or the transcompiler 9 with optimizer and quantum error correction are optionally typical quantum technological components of the software part 19 of the software stack 1.

The application programs 2 and the hybrid quantum/classical programs and the software 3 (?) are optional hybrid components of the software stack 1.

### FIG. 21

FIG. 21 shows an exemplary drone swarm according to an optional embodiment with a first drone DR1 and a second drone DR2 and a third drone DR3. The drones are optionally unmanned aerial vehicles. The principle can also be transferred to swarms of unmanned floating bodies and unmanned robots, as an example for land vehicles. Mixtures of these are also conceivable.

Accordingly, FIG. 21 shows a further example of use of the relocatable quantum computer system according to the disclosure in the drones DR1, DR2, DR3 of a drone swarm. In the example of FIG. 21, the drones DR1, DR2, DR3 are exemplary quadrocopters.

In the example of FIG. 21, each drone of the example comprises a first quantum computer QC1 and a second quantum computer QC2. The quantum computers QC1, QC2 can, for example, in cooperation with a central control unit ZSE of the respective drone of the drones DR1, DR2, DR3, process the NP-complete problem of risk assessment of objects in the vicinity of the aircraft and along the route to the target, the target selection and target designation and the order of target engagement of the ammunition and weapon selection and the fastest and at the same time lowest-risk route to the target and the suitable formation of the drone swarm on the way there. In the example of FIG. 21, the quantum computers QC1, QC2 are connected via an external data bus EXTDB within the respective drone of the drones DR1, DR2, DR3 to the central control unit ZSE within the respective drone of the drones DR1, DR2, DR3. In the example in FIG. 18, the central control unit ZSE is inserted into the external data bus EXTDB. The networks of the drones DR1, DR2, DR3 are optionally connected to each other by means of wireless connections, so that the quantum computers of the drones DR1, DR2, DR3 form a common quantum computer system QUSYS with the central control units ZSE of the drones DR1, DR2, DR3. The quantum computers QC1, QC2 of the drones DR1, DR2, DR3 each optionally correspond to a quantum computer QC of FIG. 1 or the preceding description.

### FIG. 21

In the example shown in FIG. 21, the drones DR1, DR2 and DR3 are each equipped with a camera as a payload. Instead of such a payload, arming with missiles RKT and/or arming with other weapons such as automatic cannons, jammers, reconnaissance devices, etc. is also conceivable. In this respect, the cameras are only examples of additional equipment that can be transported as payload by the DR1, DR2, DR3 drones. In this respect, the DR1, DR2, DR3 drones are just one example of a swarm controlled by a quantum computer in the broadest sense.

In the example of FIG. 21, the drones of the drones DR1, DR2, DR3 have a respective quantum computer system QUSYS similar to FIG. 4 with one or more central control devices ZSE, which are connected to one or more quantum computers QC1, QC2 via one or more external data buses EXTDB.

In the state shown, the drone swarm therefore has several quantum computer systems QUSYS in the respective drones DR1, DR2, DR3.

A first quantum computer system QUSYS of a first drone DR1 comprises at least one central control unit ZSE of the first drone DR1 and at least one external data bus EXTDB of the first drone DR1 and at least one first quantum computer QC1 of the first drone DR1 and, in the example, a second quantum computer QC2 of the first drone DR1.

A second quantum computer system QUSYS of a second drone DR2 comprises at least one central control unit ZSE of the second drone DR2 and at least one external data bus EXTDB of the second drone DR2 and at least one first quantum computer QC1 of the second drone DR2 and, in the example, a second quantum computer QC2 of the second drone DR2.

A third quantum computer system QUSYS of a third drone DR3 comprises at least one central control unit ZSE of the third drone DR3 and at least one external data bus EXTDB of the third drone DR3 and at least one first quantum computer QC1 of the third drone DR3 and in this example (for reference?) a second quantum computer QC2 of the third drone DR3.

The paper presented here proposes that a radio link connects the three external data buses EXTDB of the three drones DR1, DR2, DR3 and thus the first quantum computer system optionally with the second and third quantum computer system QUSYS.

### FIG. 21

FIG. 21 thus discloses a vehicle swarm according to an optional embodiment with swarm members—here the drones DR1, DR2, DR3—wherein at least some of the swarm members each comprise at least one quantum computer QC1 as described above.

Optionally, at least some of the swarm members each comprise at least one such quantum computer QC1 in a quantum computer system QUSYS and at least one further such quantum computer QC2 and/or at least one central control unit ZSE in the form of a conventional computer system.

Optionally, the quantum computer systems QUSYS of at least two swarm members, preferably of several swarm members, even better of all swarm members are coupled to each other by means of a wireless data transmission link. For the purposes of this document, wireless transmission paths can be acoustic and/or optical and/or electromagnetic and/or particle-based or the like. This has the advantage that the drone swarm can reconfigure itself even if an individual drone fails.

For the purposes of the present document, a swarm member may also, but optionally, be a vehicle, a motor vehicle, a two-wheeler, a tricycle or a truck, a commercial vehicle, a robot, a transport vehicle, a drone, a robot drone, a flying body, a floating body, a diving body, a ship, a submarine, a sea mine, a land mine, a missile, a projectile, a satellite, a space station, a trailer, a barge, a container, in particular a sea container and/or smartphone and/or an article of clothing and/or a piece of jewelry and/or a portable quantum computer system and/or a mobile quantum computer system and/or vehicle and/or a robot and/or an aircraft and/or a spacecraft and/or an underwater vehicle and/or a surface float and/or underwater float and/or a mobile medical device and/or a relocatable weapon system and/or a warhead and/or a surface or underwater vehicle and/or projectile and/or another mobile device and/or mobile device and/or the like.

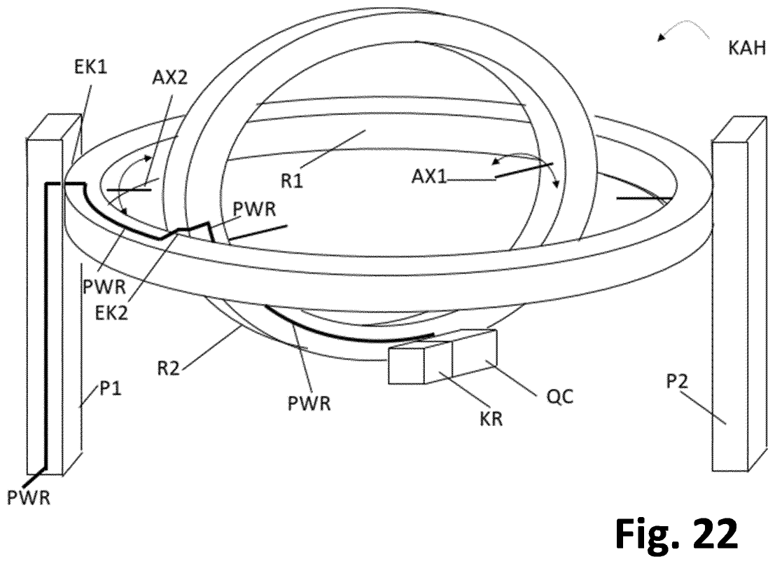

### FIG. 22

FIG. 22 shows a schematic representation of a quantum computer system according to an optional embodiment, comprising a quantum computer mounted in a gimbal KAH. The gimbal KAH enables the quantum computer QC to be protected against rotational accelerations and/or rotations about the first axis AX1 and the second axis AX2. In the example of FIG. 22, the exemplary gimbal suspension KAH comprises a first post P1 and a second post P2. On the first post P1 and the second post P2 of the gimbal suspension KAH, a first suspension ring R1 is suspended rotatably about a first axis AX1. A first energy coupling EK1 connects the line of the energy supply PWR of the first post P1 to the line of the energy supply PWR of the first suspension ring R1 in an electrically conductive manner so as to rotate about the first axis. A second suspension ring R2 is mounted in the first suspension ring R1 of the Cardanic suspension KAH so that it can rotate about a second axis AX2. A second energy coupling EKe connects the power supply cable PWR of the first suspension ring R1 to the power supply cable PWR of the second suspension ring R2 in an electrically conductive manner and rotatably about the second axis AX2.

The quantum computer QC according to the optional embodiment shown is firmly mounted on the second suspension ring R2. As a result, the quantum computer QC is mounted on the Cardanic suspension KAH so that it can rotate about the first axis AX1 and about the second axis AX2. Optionally, the power supply cable PWR of the second suspension ring R2 supplies the quantum computer QC with electrical energy.

The KR gyroscope is optionally fixed to the second suspension ring R2. As a result, the gyroscope KR is mounted on the Cardanic suspension KAH so that it can rotate about the first axis AX1 and about the second axis AX2. Preferably, a drive of the gyroscope KR drives the gyroscope KR with electrical energy from the line of the power supply PWR of the second suspension ring R2.

For the purposes of the present document, the gimbal KAH of the quantum computer QC and the gyroscope KR may optionally form parts of the quantum computer system.

Optionally, the Cardanic suspension KAH has a first drive which can rotate the first suspension ring R1 relative to the first post P1 and/or the second post P2 about the first axis AX1 by a first angle of rotation. It is conceivable that the first drive rotates the first suspension ring R1 about the first axis AX1 by a predetermined first angle of rotation as a function of a signal from the quantum computer QC and/or the control device μC.

Optionally, a first rotation angle sensor of the Cardanic suspension KAH can detect the rotation in the form of a first value of the first rotation angle of the first suspension ring R1 relative to the first post P1 and/or the second post P2 about the first axis AX1 and report it to the quantum computer QC and/or its control device μC via a first rotation angle signal line and, if necessary, intermediate signal couplings. Here, a signal coupling can enable a rotation of the first suspension ring R1 relative to the first post P1 by any first rotation angle without the rotation angle signal line being twisted or interrupted.

Optionally, the Cardanic suspension KAH can have a second drive which can rotate the second suspension ring R2 about the second axis AX2 by a second angle of rotation relative to the first suspension ring R1. Optionally, the second drive can rotate the second suspension ring R2 about the second axis AX2 by a predetermined second angle of rotation as a function of a signal from the quantum computer QC and/or the control device μC.

The first axis AX1 is optionally arranged perpendicular to the first axis AX1.

Optionally, a second angle of rotation sensor of the Cardanic suspension KAH can detect the rotation of the second suspension ring R1 relative to the first suspension ring R1 and report it to the quantum computer QC and/or its control device μC via a second angle of rotation signal line and, if necessary, intermediate signal couplings. Here, a signal coupling optionally enables the second suspension ring R2 to be rotated relative to the first suspension ring R1 by any second angle of rotation without the second angle of rotation signal line being twisted or interrupted.

The gyroscope or the gyroscopes KR can position themselves in such a way that when the first drives and second drives of the quantum computer QC are disengaged, not present or not driven, the quantum computer QC does not change its orientation even when the gimbal suspension KAH rotates about the first axis AX1 and/or second axis AX2.

Preferably, the Cardanic suspension KAH comprises one gyroscope KR per axis (AX1, AX2) of the Cardanic KAH. Optionally, the axes of different gyroscopes KR are perpendicular to each other.

Optionally, instead of the quantum computer QC, only parts of the quantum computer QC, such as the substrate D with the quantum bits QUB and/or nuclear quantum bits CQUB, can be located at the position of the quantum computer QC. The signals of the other device parts of the quantum computer must then be transported to these device parts or transported away from them without twisting by means of suitable signal couplings.

### LIST OF REFERENCE SYMBOLS

ADCV analog-to-digital converter of the amplifier V;
AS shielding;
BENFirst energy reserve;
BENG2 second energy reserve;
B_{NV} rotating magnetic field;
BSC back side contact;
BTR energy reserve of the vehicle (submarine, motor vehicle, etc.);
CBA control unit A;
CBB control unit B;
CECEQUREG nuclear electron nuclear electron quantum register;
CEQUREG1 first nuclear electron quantum register;
CEQUREG2 second nuclear electron quantum register;
CI1 first nuclear quantum dot. Optionally, the exemplary first nuclear quantum dot CI1 is an isotope with a nuclear magnetic moment in the substrate D, wherein the substrate D in the region of the nuclear quantum dot CI1 optionally comprises essentially or optionally absolutely no isotopes with a nuclear magnetic moment. In this context, the paper presented here refers to the technical teaching of DE 10 2020 007 977 B4 already cited;
CI1₁ first nuclear quantum dot CI1₁ of the first quantum ALU QUALU1. Optionally, the exemplary first nuclear quantum dot CI1₁ of the first quantum ALU QUALU1 is an isotope with a nuclear magnetic moment in the substrate D, wherein the substrate D in the region of the nuclear quantum dot CI1₁ optionally comprises essentially or optionally absolutely no isotopes with a nuclear magnetic moment. In this context, the paper presented here refers to the technical teaching of DE 10 2020 007 977 B4 already cited. The first nuclear quantum dot CI1₁ of the first quantum ALU QUALU1 is not shown in FIG. 3 for the sake of clarity. The reader should assume that in FIG. 3 the first nuclear quantum dot CI1₁ of the first quantum ALU QUALU1 is coupled to the first quantum dot NV1 in the same way as the first nuclear quantum dot CI1₁ of the first quantum ALU QUALU1 is coupled to the first quantum dot NV1 in FIG. 2;
CI12 second nuclear quantum dot CI12 of the first quantum ALU QUALU1. Optionally, the exemplary second nuclear quantum dot CI12 of the first quantum ALU QUALU1 is an isotope with a nuclear magnetic moment in the substrate D, wherein the substrate D in the region of the nuclear quantum dot CI12 optionally comprises essentially or optionally absolutely no isotopes with a nuclear magnetic moment. In this context, the paper presented here refers to the technical teaching of DE 10 2020 007 977 B4 already cited. The second nuclear quantum dot CI12 of the first quantum ALU QUALU1 is not shown in FIG. 3 for the sake of clarity. The reader should assume that in FIG. 3 the second nuclear quantum dot CI12 of the first quantum ALU QUALU1 is coupled to the first quantum dot NV1 in the same way as the second nuclear quantum dot CI12 of the first quantum ALU QUALU1 is coupled to the first quantum dot NV1 in FIG. 2;
CI13 third nuclear quantum dot CI13 of the first quantum ALU QUALU1 Optionally, the exemplary third nuclear quantum dot CI13 of the first quantum ALU QUALU1 is an isotope with a nuclear magnetic moment in the substrate D, wherein the substrate D optionally comprises essentially or optionally absolutely no isotopes with a nuclear magnetic moment in the region of the nuclear quantum dot CI13. In this context, the paper presented here refers to the technical teaching of DE 10 2020 007 977 B4 already cited. The third nuclear quantum dot CI13 of the first quantum ALU QUALU1 is not shown in FIG. 3 for the sake of clarity. The reader should assume that in FIG. 3 the third nuclear quantum dot CI13 of the first quantum ALU QUALU1 is coupled to the first quantum dot NV1 in the same way as the third nuclear quantum dot CI13 of the first quantum ALU QUALU1 is coupled to the first quantum dot NV1 in FIG. 2;
CI2 second nuclear quantum dot. Optionally, the exemplary second nuclear quantum dot CI2 is an isotope with a nuclear magnetic moment in the substrate D, wherein the substrate D optionally comprises essentially or optionally absolutely no isotopes with a nuclear magnetic moment in the region of the nuclear quantum dot CI2. In this context, the paper presented here refers to the technical teaching of DE 10 2020 007 977 B4 already cited;
CI21 first nuclear quantum dot CI21 of the second quantum ALU QUALU2. Optionally, the exemplary first nuclear quantum dot CI21 of the second quantum ALU QUALU2 is an isotope with a nuclear magnetic moment in the substrate D, wherein the substrate D in the region of the nuclear quantum dot CI21 optionally comprises essentially or optionally absolutely no isotopes with a nuclear magnetic moment. In this context, the paper presented here refers to the technical teaching of DE 10 2020 007 977 B4 already cited. The first nuclear quantum dot CI21 of the second quantum ALU QUALU2 is not shown in FIG. 3 for the sake of clarity. The reader should assume that in FIG. 3 the first nuclear quantum dot CI21 of the second quantum ALU QUALU2 is coupled to the second quantum dot NV2 in the same way as the first nuclear quantum dot CI21 of the second quantum ALU QUALU2 is coupled to the second quantum dot NV2 in FIG. 2;
CI22 second nuclear quantum dot CI22 of the second quantum ALU QUALU2. Optionally, the exemplary second nuclear quantum dot CI22 of the second quantum ALU QUALU2 is an isotope with a nuclear magnetic moment in the substrate D, wherein the substrate D in the region of the nuclear quantum dot CI22 optionally comprises essentially or optionally absolutely no isotopes with a nuclear magnetic moment. In this context, the paper presented here refers to the technical teaching of DE 10 2020 007 977 B4 already cited. The second nuclear quantum dot CI22 of the second quantum ALU QUALU2 is not shown in FIG. 3 for the sake of clarity. The reader should assume that in FIG. 3 the second nuclear quantum dot CI22 of the second quantum ALU QUALU2 is coupled to the second quantum dot NV2 in the same way as the second nuclear quantum dot CI22 of the second quantum ALU QUALU2 is coupled to the second quantum dot NV2 in FIG. 2;
CI23 third nuclear quantum dot CI23 of the second quantum ALU QUALU2. Optionally, the exemplary first nuclear quantum dot CI23 of the second quantum ALU QUALU2 is an isotope with a nuclear magnetic moment in the substrate D, wherein the substrate D in the region of the nuclear quantum dot CI23 optionally comprises essentially or optionally absolutely no isotopes with a nuclear magnetic moment. In this context, the paper presented here refers to the technical teaching of DE 10 2020 007 977 B4 already cited. The third nuclear quantum dot CI23 of the second quantum ALU QUALU2 is not shown in FIG. 3 for the sake of clarity. The reader should assume that in FIG. 3 the third nuclear quantum dot CI23 of the second quantum ALU QUALU2 is coupled to the second quantum dot NV2 in the same way as the third nuclear quantum dot CI23 of the second quantum ALU QUALU2 is coupled to the second quantum dot NV2 in FIG. 2;
CI3 third nuclear quantum dot. Optionally, the exemplary third nuclear quantum dot CI3 is an isotope with a nuclear magnetic moment in the substrate D, wherein the substrate D optionally comprises essentially or optionally absolutely no isotopes with a nuclear magnetic moment in the region of the nuclear quantum dot CI3. In this context, the paper presented here refers to the technical teaching of DE 10 2020 007 977 B4 already cited;
CI31 first nuclear quantum dot CI31 of the third quantum ALU QUALU3. Optionally, the exemplary first nuclear quantum dot CI31 of the third quantum ALU QUALU3 is an isotope with a nuclear magnetic moment in the substrate D, wherein the substrate D in the region of the nuclear quantum dot CI31 optionally comprises essentially or optionally absolutely no isotopes with a nuclear magnetic moment. In this context, the paper presented here refers to the technical teaching of DE 10 2020 007 977 B4 already cited. The first nuclear quantum dot CI31 of the third quantum ALU QUALU3 is not shown in FIG. 3 and in FIG. 2 for the sake of clarity. The reader should assume that in FIG. 3, the first nuclear quantum dot CI31 of the third quantum ALU QUALU3 is coupled to the third quantum dot NV3 in the same way as the first nuclear quantum dot CI11 of the first quantum ALU QUALU1 is coupled to the first quantum dot NV1 in FIG. 2;
CI32 second nuclear quantum dot CI32 of the third quantum ALU QUALU3. Optionally, the exemplary second nuclear quantum dot CI32 of the third quantum ALU QUALU3 is an isotope with a nuclear magnetic moment in the substrate D, wherein the substrate D in the region of the nuclear quantum dot CI32 optionally comprises essentially or optionally absolutely no isotopes with a nuclear magnetic moment. In this context, the paper presented here refers to the technical teaching of DE 10 2020 007 977 B4 already cited. The second nuclear quantum dot CI32 of the third quantum ALU QUALU3 is not shown in FIG. 3 and in FIG. 2 for the sake of clarity. The reader should assume that in FIG. 3 the second nuclear quantum dot CI32 of the third quantum ALU QUALU3 is coupled to the third quantum dot NV3 in the same way as the second nuclear quantum dot CI12 of the first quantum ALU QUALU1 is coupled to the first quantum dot NV1 in FIG. 2;
CI33 third nuclear quantum dot CI3₃ of the third quantum ALU QUALU3. Optionally, the exemplary first nuclear quantum dot CI3₃ of the third quantum ALU QUALU3 is an isotope with a nuclear magnetic moment in the substrate D, wherein the substrate D in the region of the nuclear quantum dot CI3₃ optionally comprises essentially or optionally absolutely no isotopes with a nuclear magnetic moment. In this context, the paper presented here refers to the technical teaching of DE 10 2020 007 977 B4 already cited. The third nuclear quantum dot CI3₃ of the third quantum ALU QUALU3 is not shown in FIG. 3 and in FIG. 2 for the sake of clarity. The reader should assume that in FIG. 3 the third nuclear quantum dot CI3₃ of the third quantum ALU QUALU3 is coupled to the third quantum dot NV3 in the same way as the first nuclear quantum dot CI11 of the first quantum ALU QUALU1 is coupled to the first quantum dot NV1 in FIG. 2;
CIF first camera interface;
CIF2 second camera interface;
CM1 first camera;
CM2 second camera;
CPU computer core;
D substrate;
d1 first distance at which the first quantum dot NV1 is located below the surface OF of the substrate D;
d2 second distance at which the second quantum dot NV2 is located below the surface OF of the substrate D;
DBIF data interface;
DBIFa data interface A;
DBIFb data interface B;
DBS dichroic mirror;
DEP power supply of other device parts of the quantum computer QC, whereby this typically also concerns device parts with other reference signs. For a better overview, the power supply lines of the other device parts of the quantum computer QC are not shown in FIG. 1;
ENG motor of the vehicle;
ERS energy system;
EXDB external data bus;
EV Energy supply;
EV1 first voltage regulation stage
EV2 second voltage regulation stage
λ_{fl} Fluorescence radiation wavelength;
λ_{pmp.} Pump radiation wavelength;
FHB fabrication hall or stationary device;
f_{HF} microwave and/or radio wave frequency;
FL fluorescent radiation;
FLC fire control station. The fire control station can be a central control unit ZSE.
FLR flight position control system;
FZ aircraft;
FZT aircraft carrier;
GDX X-control device for the translatory positioning device in X direction XT;
GDY Y-control device for the translatory positioning device in the Y direction YT;
GH housing;
GPS navigation system or device for determining the position and/or orientation of the quantum computer QC. The navigation system may also determine translational velocities and/or rotational velocities of the quantum computer QC and report them to the computer core CPU of the control device μC of the quantum computer QC via the internal data bus INTDB. If necessary, the navigation system can also determine translational accelerations and/or rotational accelerations of the quantum computer QC and report them to the computer core CPU of the control device μC of the quantum computer QC via the internal data bus INTDB;
HD1 first horizontal driver stage for controlling the first quantum dot NV1 to be controlled;
HD2 second horizontal driver stage for controlling the second quantum dot NV2 to be controlled;
HD3 third horizontal driver stage for controlling the third quantum dot NV3 to be controlled;
HeCLCS Closed Loop Helium Gas Cooling System;
HS1 first horizontal receiver stage HS1, which can form a unit with the first horizontal driver stage HD1, for driving the first quantum dot NV1 to be driven;
HS2 second horizontal receiver stage HS2, which can form a unit with the second horizontal driver stage HD2, for controlling the second quantum dot NV2 to be controlled;
HS3 third horizontal receiver stage HS3, which can form a unit with the third HS3 horizontal driver stage HD3, for controlling the third quantum dot NV3 to be controlled;
IH1 first horizontal current. The first horizontal current is the electric current that flows through the first horizontal line LH1.
IH2 second horizontal current. The second horizontal current is the electric current that flows through the second horizontal line LH2.
IH3 third horizontal current. The third horizontal current is the electric current that flows through the third horizontal line LH3.
Ip intensity of the pulses of the pulsed pump radiation LB of the light source LD;
IpHF amplitude IpHF of a pulse of the temporal envelope of the radiation of an electromagnetic field by the one or more devices MW/RF-AWFG for generating an electromagnetic wave field at the respective location of the quantum dots NV1, NV2, NV3 and at the respective location of the nuclear quantum dots CI11, CI12, CI13, CI21, CI22, CI23, CI31, CI32, CI33;
IS isolation;
ISH1 first horizontal shielding current flowing through the first horizontal shielding line SH1;
ISH2 second horizontal shielding current flowing through the second horizontal shielding cable SH2;
ISH3 third horizontal shielding current flowing through the third horizontal shielding cable SH3;
ISH4 fourth horizontal shielding current flowing through the fourth horizontal shielding line SH4;
ISV1 first vertical shielding current flowing through the first vertical shielding line SV1;
ISV2 second vertical shielding current flowing through the second vertical shielding line SV2;
IV1 first vertical current. The first vertical current is the electric current that flows through the first vertical line LV1;
IVV internal amplifier within the amplifier V;
KFZ car as an example of a vehicle;
KH1 first horizontal contact of the first quantum bit QUB1 with the first quantum dot NV1. The first horizontal contact of the first quantum bit QUB1 electrically connects, for example, the first horizontal shielding line SH1 in the first quantum bit QUB1 to the substrate D or the epitaxial layer DEPI. Optionally, in the case of diamond as substrate material, the contact comprises titanium or is made of titanium;
KH2 second horizontal contact of the first quantum bit QUB1 with the first quantum dot NV1 and first horizontal contact of the second quantum bit QUB2 with the second quantum dot NV2. The first quantum bit QUB1 and the second quantum bit QUB2 share this contact in the example of FIG. 3. The contact electrically connects, for example, the second horizontal shielding line SH2 in the first quantum bit QUB1 and in the second quantum bit QUB2 to the substrate D or the epitaxial layer DEPI. Optionally, in the case of diamond as the substrate material, the contact comprises titanium or is made of titanium;
KH3 second horizontal contact of the second quantum bit QUB2 with the second quantum dot NV2 and first horizontal contact of the third quantum bit QUB3 with the third quantum dot NV3. The second quantum bit QUB2 and the third quantum bit QUB3 share this contact in the example of FIG. 3. The contact electrically connects, for example, the third horizontal shielding line SH3 in the second quantum bit QUB2 and in the third quantum bit QUB3 to the substrate D or the epitaxial layer DEPI. Optionally, in the case of diamond as the substrate material, the contact comprises titanium or is made of titanium;
KH4 second horizontal contact of the third quantum bit QUB3 with the third quantum dot NV3. The contact electrically connects, for example, the fourth horizontal shielding line SH3 in the third quantum bit QUB3 to the substrate D or the epitaxial layer DEPI. Optionally, in the case of diamond as the substrate material, the contact comprises titanium or is made of titanium;
KV11 first vertical contact of the first quantum bit QUB1 with the first quantum dot NV1. The first vertical contact of the first quantum bit QUB1 electrically connects the first vertical shielding line SV1 in the first quantum bit QUB1 to the substrate D or the epitaxial layer DEPI. Optionally, in the case of diamond as the substrate material, the contact comprises titanium or is made of titanium;
KV12 second vertical contact of the first quantum bit QUB1 with the first quantum dot NV1. The second vertical contact of the first quantum bit QUB1 optionally electrically connects the second vertical shielding line SH2 with the substrate D or the epitaxial layer DEPI. Optionally, in the case of diamond as the substrate material, the contact comprises titanium or is made of titanium;
KV21 first vertical contact of the second quantum bit QUB2 with the second quantum dot NV2. The first vertical contact of the second quantum bit QUB2 electrically connects the first vertical shielding line SV1 in the second quantum bit QUB2 to the substrate D or the epitaxial layer DEPI. Optionally, in the case of diamond as substrate material, the contact comprises titanium or is made of titanium;
KV22 second vertical contact of the second quantum bit QUB2 with the second quantum dot NV2. The second vertical contact of the second quantum bit QUB2 optionally electrically connects the second vertical shielding line SH2 to the substrate D or the epitaxial layer DEPI. Optionally, in the case of diamond as the substrate material, the contact comprises titanium or is made of titanium;
KV31 first vertical contact of the third quantum bit QUB3 with the third quantum dot NV3. The first vertical contact of the third quantum bit QUB3 electrically connects the first vertical shielding line SV1 in the third quantum bit QUB3 to the substrate D or the epitaxial layer DEPI. Optionally, in the case of diamond as the substrate material, the contact comprises titanium or is made of titanium;
KV32 second vertical contact of the third quantum bit QUB3 with the third quantum dot NV3. The second vertical contact of the third quantum bit QUB3 optionally electrically connects the second vertical shielding line SH2 to the substrate D or the epitaxial layer DEPI. Optionally, in the case of diamond as the substrate material, the contact comprises titanium or is made of titanium;
KV relocatable cooling device;
LB pump radiation;
LD light source;
LDRV light source driver;
LDV loading device;
LH1 first horizontal line;
LH2 second horizontal line;
LH3 third horizontal line;
LM luminaire with one light source;
LV1 first vertical line;
μC control device;
μC1 first control device of the first quantum computer QC1;
μC1a first control device A of the first quantum computer QC1;
μC1b first control device B of the first quantum computer QC1;
μC2 second control device of the second quantum computer QC2;
μC3 third control device of the third quantum computer QC3;
μC4 fourth control device of the fourth quantum computer QC4;
μC5 fifth control device of the fifth quantum computer QC5;
μC6 sixth control device of the sixth quantum computer QC6;
μC7 seventh control device of the seventh quantum computer QC7;
μC8 eighth control device of the eighth quantum computer QC8;
μC9 ninth control device of the ninth quantum computer QC9;
μC10 tenth control device of the tenth quantum computer QC10;
μC11 eleventh control device of the eleventh quantum computer QC11;
μC12 twelfth control device of the twelfth quantum computer QC12;
μC13 thirteenth control device of the thirteenth quantum computer QC13;
μC14 fourteenth control device of the fourteenth quantum computer QC14;
μC15 fifteenth control device of the fifteenth quantum computer QC15;
μC16 sixteenth control device of the sixteenth quantum computer QC16;
μCV control device of the amplifier V;
MDBIF internal data interface MDBIF;
MEMDBV Memory data bus between control device μCV of amplifier V and memory
MEMV of amplifier V;
MEMV memory of the amplifier V;
MFSx first magnetic field control;
MFSy second magnetic field control;
MFSz third magnetic field control;
MGx first magnetic field generating means, which optionally generates a magnetic flux density Bx, which optionally has essentially one direction, which optionally corresponds to the first direction, for example the direction of the X-axis;
MG second magnetic field generating means, which optionally generates a magnetic flux density By, which optionally has essentially one direction, which optionally corresponds to the second direction, for example the direction of the Y-axis;
MGz third magnetic field generating means, which optionally generates a magnetic flux density Bz, which optionally has essentially one direction, which optionally corresponds to the third direction, for example the direction of the Z-axis;
MSx magnetic field sensor for the magnetic flux density Bx in the direction of the X-axis;
MSy magnetic field sensor for the magnetic flux density By in the direction of the Y-axis;
MSz magnetic field sensor for the magnetic flux density Bz in the direction of the Z-axis;
mWA microwave and/or radio wave antenna;
MW/RF-AWFG microwave and/or radio wave frequency generator for generating largely freely definable waveforms (arbitrary waveform generator);
NAV navigation system and/or autopilot;
NV1 first quantum dot. Optionally, the exemplary first quantum dot NV1 is a paramagnetic center in the substrate D. Optionally, the exemplary first quantum dot NV1 is an NV center or an SiV center or an ST1 center in the substrate D;
NV2 second quantum dot. Optionally, the exemplary second quantum dot NV2 is a paramagnetic center in the substrate D. Optionally, the exemplary second quantum dot NV2 is an NV center or an SiV center or an ST1 center in the substrate D;
NV3 third quantum dot. Optionally, the exemplary third quantum dot NV3 is a paramagnetic center in the substrate D. Optionally, the exemplary third quantum dot NV3 is an NV center or an SiV center or an ST1 center in the substrate D;
NVM non-volatile memory;
OF surface;
OS optical system;
OSZ clock generator of the computer core CPU of the control device μC of the quantum computer QC;
PD photodetector;
PM permanent magnet;
PV positioning device for the permanent magnet PM;
PVC control device for the PV positioning device for the permanent magnet PM;
PWR power supply of the LDV charger;
QC Quantum computer;
QC1 first quantum computer;
QC2 second quantum computer;
QC3 third quantum computer;
QC4 fourth quantum computer;
QC5 fifth quantum computer;
QC6 sixth quantum computer;
QC7 seventh quantum computer;
QC8 eighth quantum computer;
QC9 ninth quantum computer;
QC10 tenth quantum computer;
QC11 eleventh quantum computer;
QC12 twelfth quantum computer;
QC13 thirteenth quantum computer;
QC14 fourteenth quantum computer;
QC15 fifteenth quantum computer;
QC16 sixteenth quantum computer;
QCTV quantum computer system separator. The quantum computer system separation device optionally separates an external data bus EXTDB, which, for example, connects a first quantum computer system QUSYS to a second quantum computer system QUSYS if necessary, so that the quantum computer system QUSYS, which previously comprised the first and the second quantum computer system QUSYS, breaks up into two separate quantum computer systems QUSYS as a result of the separation. However, the quantum computer system separating device can also connect a previously separate first quantum computer system QUSYS to a previously separate second quantum computer system QUSYS and couple them if necessary, so that the quantum computer system QUSYS is created, which then comprises the first and the second quantum computer system QUSYS and merges into a quantum computer system QUSYS by connecting these two quantum computer systems via the quantum computer system separating device;
QUALU1 first quantum ALU. The exemplary first quantum ALU consists of a first quantum dot NV1 and a first nuclear quantum dot CI11 of the first quantum ALU and a second nuclear quantum dot CI12 of the first quantum ALU and a third nuclear quantum dot CI13 of the first quantum ALU (FIG. 2);
QUALU2 second quantum ALU. The exemplary second quantum ALU consists of a second quantum dot NV2 and a first nuclear quantum dot CI21 of the second quantum ALU and a second nuclear quantum dot CI22 of the second quantum ALU and a third nuclear quantum dot CI23 of the second quantum ALU (FIG. 2);
QUSYS relocatable quantum computer system;
RAM volatile memory;
RKT rocket. The rocket is just one example of a possible payload. The payload can itself comprise one or more QUSYS quantum computer systems. Optionally, the quantum computer system QUSYS of the payload is connected to the quantum computer system QUSYS of the vehicle FZ, or of the object in which the payload is set up or stored, for example via an external data bus EXTDB, during the time of the payload;
RKT missile launch control;
S0 receiver output signal;
S1 receive signal;
S4 measured value signal;
S5 transmit signal;
SC sea container. The sea container is just one example of a transportable container in which one or more QUSYS quantum computer systems or one or more QC quantum computers can be operated;
SCHRS ship propeller;
SDB control data bus;
SDB internal control data bus within the amplifier V;
SENS one or more sensors;
SH1 first horizontal shielding cable;
SH2 second horizontal shielding cable;
SH3 third horizontal shielding cable;
SH4 fourth horizontal shielding cable;
SR first power conditioning device, in particular a voltage converter or a voltage regulator or a current regulator;
SRG2 second power conditioning device, in particular a voltage converter or a voltage regulator or a current regulator;
ST temperature sensor;
STAB stabilization device
STM semi-transparent mirror;
SUB Submarine (submarine);
SV1 first horizontal shielding cable;
SV2 second vertical shielding cable;
TL low loader. The low-loader is an example of a vehicle without its own drive.
TRP torpedoes;
TRPC torpedo launch control;
TT separator;
t0HF Reference time of a pulse of the pulsed electromagnetic field with microwave and/or radio wave frequency fHF. Optionally, the reference time t0HF is the same as the reference time t0p for a pulse sequence or at a fixed time interval from the reference time for a pulse sequence top;
t0p Reference time for a pulse sequence. Optionally, the reference time top for a pulse sequence is the same as the reference time t0HF or at a fixed time interval from the reference time t0HF;
tdp the time duration tdp of the pulses of the pulsed pump radiation LB from the light source LD;
tdHF temporal pulse duration of the pulse of the pulsed electromagnetic field with microwave and/or radio wave frequency fHF. This is the temporal pulse duration of the temporal envelope of the radiation of an electromagnetic field by the one or more MW/RF-AWFG devices for generating an electromagnetic wave field at the respective location of the quantum dots NV1, NV2, NV3 and at the respective location of the nuclear quantum dots CI11, CI12, CI13, CI21, CI22, CI23, CI31, CI32, CI33 in pulse form;
tsp time position of the pulses of the pulsed pump radiation LB of the light source LD in relation to a reference time t0. As a rule, the time position tsp of a pulse indicates the start time of the pulse in question;
tspHF pulse start time tspHF relative to the reference time t0HF of a pulse of the temporal envelope of the radiation of an electromagnetic field by the one or more devices MW/RF-AWFG for generating an electromagnetic wave field at the respective location of the quantum dots NV1, NV2, NV3 and at the respective location of the nuclear quantum dots CI11, CI12, CI13, CI21, CI22, CI23, CI31, CI32, CI33;
UDB1 first sub-data bus;
UDB2 second sub-data bus;
UDB3 third sub-data bus;
UDB4 four sub-data bus;
ÜOSZ monitoring clock generation of the quantum computer monitoring device QUV of the quantum computer QC;
US underside of the substrate D;
V amplifier;
V1 output signal of the internal amplifier IVV of amplifier V and input signal of the analog-to-digital converter ADCV of amplifier V;
V2 data line between the control device μCV of amplifier V and the analog-to-digital converter ADCV of amplifier V;
Vbatext electrical energy from an external power supply, for example an external power supply;
VD1 first vertical driver stage for controlling the quantum dots NV1, NV2, NV3;
VIF Data interface of the amplifier V to the control data bus SDB;
VS1 first vertical receiver stage, which can form a unit with the first vertical driver stage VD1, for controlling the first quantum dots NV1, NV2, NV3 to be controlled;
WFG waveform generator;
XT translatory positioning device in the X direction;
YT translatory positioning device in Y-direction;
ZM traction engine. The tractor is an example of a drive for a container with one or more quantum computers QC and/or one or more quantum computer systems QUSYS, which can be separated from the container or can be added to the container. In the example of FIG. 6b, the receptacle is an exemplary low loader TL with a sea container SC;
ZSE central control unit;
1910, 1920, 1930, 1940, 1950, 1960 procedure
1901-1906 procedural steps
1911-1912 procedural steps
1921-1922 procedural steps
1931-1932 procedural steps
1941-1944 procedural steps
1952-1956 procedural steps
1962-1964 procedural steps
RoS rotation sensor
REV rotational decoupling device
GYR gyroscope

### LIST OF CITED DOCUMENTS

To the extent that, in the context of the nationalization of a subsequent international application, the law of the respective legal system of the country in which the nationalization of the international application of the document presented here takes place permits disclosure by reference, the content of the following documents forms an integral part of the disclosure presented here. The disclosure of each of the following patent documents are incorporated herein by reference in their entirety.
CN 103 855 907 B,
CN 108 831 576 B,
CN 20 634 1126 U,
DE 1 240 967 B,
DE 1 564 070 B1,
DE 2 124 465 B2,
EN 7 219 216 U,
DE 69 411 078 T2,
DE 19 602 875 A1,
DE 19 738 066 A1,
DE 19 957 669 A1,
DE 19 782 844 538 B1,
EN 10 2014 225 346 A1,
EN 10 2018 127 394.0,
EN 10 2019 130 114.9,
EN 10 2019 120 076.8,
EN 10 2019 121 137,
DE 10 2020 125 189 A1,
DE 10 2020 101 784 B3,
DE 10 2020 007 977 B4,
DE 10 2020 008 157 B3,
EN 10 2021 110 964.7,
DE 20 2021 101 169 U1,
EP 2 874 292 B1,
EP 2 986 852 B1,
EP 3 007 350 B1,
EP 3 075 064 A1,
EP 3 093 966 B1,
EP 3 279 603 B1,
EP 3 345 290 B1,
EP 3 400 642 B1,
EP 3 646 452 B1,
EP 3 863 165 A1,
RU 126 229 U1,
RU 2 566 620 C2,
RU 2014 143 858 A,
U.S. Pat. No. 5,443,657 A,
U.S. Pat. No. 5,859,484 A,
U.S. Pat. No. 8,552,616 B2,
U.S. Pat. No. 2,016,377 029 A1,
U.S. Pat. No. 2,018,226 165 A1,
U.S. Pat. No. 2,019,368 464 A1,
U.S. Pat. No. 2,021,147 061 A1,
WO 2009 103 974 A1,
WO 2014 031 037 A2,
WO 2016 100 008 A2,
WO 2019 143 396 A2,
WO 2021 159 117 A1,
https://de.wikipedia.org/wiki/Daisy_Chain
https://en.wikipedia.org/wiki/Cryocooler
https://www.youtube.com/watch?v=j0SZirc7TO8

The contents of each of the following publications are incorporated herein by reference in their entirety.
P. Balasubramanian, M. H. Metsch, Reddy, R. Prithvi, J. Lachlan, N. B. Manson, M. W. Doherty, F. Jelezko, “Discovery of ST1 centers in natural diamond” Nanophotonics, Vol. 8, No. 11, 2019, pages 1993-2002. https://doi.org/10.1515/nanoph-2019-0148.
Castelletto and Alberto Boretti, “Silicon carbide color centers for quantum applications” 2020 J. Phys. Photonics 2 022001.
Carlo Bradac, Weibo Gao, Jacopo Forneris, Matt Trusheim, Igor Aharonovich, “Quantum Nanophotonics with Group IV defects in Diamond”, DOI: 10.1038/s41467-020-14316-x, arXiv: 1906.10992
Ovidiu Calin, “Deep Learning Architectures: A Mathematical Approach (Springer Series in the Data Sciences)”, Springer; 1st ed. 2020 Edition (Feb. 14, 2021), ISBN-10:3030367231, ISBN-13:978-3030367237.
Franklin R. Chang Diaz, F. Wall y Baitty, Jared P. Squire, Richard H. Goulding, Edgar A. Bering, Roger D. Bengtson, “The Vasimr Engine: Project Status and Recent Accomplishments”, downloadable on Mar. 5, 2023 from https://ntrs.nasa.gov/api/citations/20110011201/downloads/20110011201.pdf.
J. Davidsson, V. Ivády, R. Armiento, N. T. Son, A. Gali, I. A. Abrikosov, “First principles predictions of magneto-optical data for semiconductor point defect identification: the case of divacancy defects in 4H—SiC”, New J. Phys., 2018, 20, 023035.
J. Davidsson, V. Ivády, R. Armiento, T. Ohshima, N. T. Son, A. Gali, I. A. Abrikosov “Identification of divacancy and silicon vacancy qubits in 6H—SiC”, Appl. Phys. Lett. 2019, 114, 112107.
J. Foglszinger, A. Denisenko, T. Kornher, M. Schreck, W. Knolle, B. Yavkin, R. Kolesov, J. Wrachtrup “ODMR on Single TR12 Centers in Diamond” arXiv: 2104.04746v1 [physics.optics].
M. Hollenbach, Y. Berencén, U. Kentsch, M. Helm, G. V. Astakhov “Engineering telecom single-photon emitters in silicon for scalable quantum photonics” Opt. Express 28, 26111 (2020), DOI: 10.1364/OE.397377, arXiv: 2008.09425 [physics.app-ph].
V. Ivády, J. Davidsson, N. T. Son, T. Ohshima, I. A. Abrikosov, A. Gali, “Identification of Si-vacancy related room-temperature qubits in 4H silicon carbide”, Phys. Rev. B, 2017, 96, 161114.
Takayuki Iwasaki, Yoshiyuki Miyamoto, Takashi Taniguchi, Petr Siyushev, Mathias H. Metsch, Fedor Jelezko, Mutsuko Hatano, “Tin-Vacancy Quantum Emitters in Diamond”, Phys. Rev. Lett. 119, 253601 (2017), DOI: 10.1103/PhysRevLett. 119.253601, arXiv: 1708.03576 [quant-ph].
Rasmus Høy Jensen, Erika Janitz, Yannik Fontana, Yi He, Olivier Gobron, Ilya P. Radko, Mihir Bhaskar, Ruffin Evans, Cesar Daniel Rodriguez Rosenblueth, Lilian Childress, Alexander Huck, Ulrik Lund Andersen, “Cavity-Enhanced Photon Emission from a Single Germanium-Vacancy Center in a Diamond Membrane”, arXiv: 1912.05247v3 [quant-ph] 25 May 2020.
Hugo K. Messerle (Author), “Magnetohydrodynamic Electrical Power Generation (UNESCO Energy Engineering Series)”, John Wiley & Sons Ltd (Aug. 1, 1995), ISBN-10:0471942529, ISBN-13:978-0471942528.
Steven Prawer (Editor), Igor Aharonovich (Editor), “Quantum Information Processing with Diamond: Principles and Applications”, Woodhead Publishing Series in Electronic and Optical Materials, Volume 63, Woodhead Publishing, May 8, 2014, ISBN-10:0857096567, ISBN-13:978-0857096562.
Marina Radulaski, Matthias Widmann, Matthias Niethammer, Jingyuan Linda Zhang, Sang-Yun Lee, Torsten Rendler, Konstantinos G. Lagoudakis, Nguyen Tien Son, Erik Janzén, Takeshi Ohshima, Jörg Wrachtrup, Jelena Vučković, “Scalable Quantum Photonics with Single Color Centers in Silicon Carbide”, Nano Letters 17 (3), 1782-1786 (2017), DOI: 10.1021/acs.nanolett.6b05102, arXiv: 1612.02874.
Petr Siyushev, Milos Nesladek, Emilie Bourgeois, Michal Gulka, Jaroslav Hruby, Takashi Yamamoto, Michael Trupke, Tokuyuki Teraji, Junichi Isoya, Fedor Jelezko, “Photoelectrical imaging and coherent spin-state readout of single nitrogen-vacancy centers in diamond”, Science 363, 728-731 (2019) 15 Feb. 2019.
Akinori Tanaka, Akio Tomiya, Koji Hashimoto, “Deep Learning and Physics (Mathematical Physics Studies)” Feb. 21, 2021, Publisher: Springer; 1st ed. 2021 Edition, ISBN-10:9813361077, ISBN-13:978-9813361072.
Björn Tegetmeyer, “Luminescence properties of SiV-centers in diamond diodes” PhD thesis, University of Freiburg, 30 Jan. 2018.
Matthew E. Trusheim, Noel H. Wan, Kevin C. Chen, Christopher J. Ciccarino, Ravishankar Sundara-raman, Girish Malladi, Eric Bersin, Michael Walsh, Benjamin Lienhard, Hassaram Bakhru, Prineha Narang, Dirk Englund, “Lead-Related Quantum Emitters in Diamond” Phys. Rev. B 99, 075430 (2019), DOI: 10.1103/PhysRevB.99.075430, arXiv: 1805.12202 [quant-ph].
Vasily Y. Ushakov (Author), “Electrical Power Engineering: Current State, Problems and Perspectives (Green Energy and Technology)”, Paperback-Aug. 18, 2018, Springer; 1st ed. 2018 Edition (Aug. 18, 2018), ISBN-10:3319872850, ISBN-13:978-3319872858.
C. Wang, C. Kurtsiefer, H. Weinfurter, and B. Burchard, “Single photon emission from SiV centers in diamond produced by ion implantation” J. Phys. B: At. Mol. Opt. Phys., 39(37), 2006
S. A. Zargaleh, S. Hameau, B. Eble, F. Margaillan, H. J. von Bardeleben, J. L. Cantin, W. Gao, “Nitrogen vacancy center in cubic silicon carbide: a promising qubit in the 1.5 μm spectral range for photonic quantum networks” Phys. Rev.B, 2018, 98, 165203.
S. A. Zargaleh et al “Evidence for near-infrared photoluminescence of nitrogen vacancy centers in 4H—SiC” Phys. Rev.B, 2016, 94, 060102.

1. a quantum computer system, comprising:
a relocatable quantum computer; and
an energy supply device for at least partially supplying the quantum computer with electrical energy,
characterized in that
the energy supply device is designed to be relocatable, and
in that the energy supply device has a first voltage regulation stage and a second voltage regulation stage and is set up to regulate an electrical energy provided by an energy source to a predetermined voltage value by means of multi-stage voltage regulation by means of the first voltage regulation stage and the second voltage stage for at least partially supplying the quantum computer.

2. A quantum computer system according to claim 1, wherein the first voltage regulation stage comprises a voltage converter and/or a voltage regulator and/or a current regulator or is designed as a voltage converter or voltage regulator or current regulator.

3. A quantum computer system according to claim 1 or 2, wherein the second voltage regulation stage comprises a linear regulator or is designed as such.

4. A quantum computer system according to one of the preceding claims, wherein the second voltage regulation stage is connected downstream of the first voltage regulation stage.

5. A quantum computer system according to any one of the preceding claims, further comprising:
at least one energy reserve, the at least one energy reserve being designed to serve as an energy source and to provide the electrical energy for the energy supply device for multi-stage voltage regulation;
a charging device, wherein the charging device is adapted to charge the at least one energy reserve; and
a disconnecting device designed to connect and disconnect the energy reserve and the charging device in a controllable manner.

6. A quantum computer system according to claim 5, wherein the charging device comprises a switching power supply or is designed as such.

7. A quantum computer system according to claim 5 or 6, wherein the at least one power reserve comprises one or more of the following elements:
a battery;
an accumulator;
a capacitor;
an interconnection of at least one battery and/or at least one accumulator and/or at least one capacitor.

8. A quantum computer system according to any one of claims 5 to 7, wherein the quantum computer system is operable in a first operating mode, and wherein the quantum computer system is configured in the first operating mode such that:
the disconnecting device connects the charging device and the energy reserve; and
the charging device charges the energy reserve with electrical energy from an external power supply.

9. A quantum computer system according to claim 8, wherein the quantum computer system in the first operating mode is configured such that the charging device in conjunction with the external power supply serves as a power source providing the electrical energy of the external power supply to the power supply device for the multi-level voltage regulation.

10. A quantum computer system according to any one of claims 5 to 9, wherein the quantum computer system is operable in a second operating mode, and wherein the quantum computer system is configured in the second operating mode such that:
the disconnecting device separates the charging device and the energy reserve from each other;
the disconnecting device isolates the charging device and the energy supply device from each other; and
the energy reserve serves as an energy source and provides the power supply unit with the electrical energy for multi-stage voltage regulation.

11. A quantum computer system according to claim 10, wherein the quantum computer system is adapted to be operated in the second mode of operation while the quantum computer is performing a quantum operation and/or executing a quantum computer program.

12. a quantum computer system according to any one of the preceding claims, wherein the quantum computer comprises one or more of the following sub-devices:
a photodetector;
an amplifier;
a light source driver;
a light source;
devices (mWA, MW/RF-AWFG) for generating an electromagnetic wave field;
a waveform generator; and
a microwave and/or radio wave frequency generator for generating predeterminable waveforms;
wherein at least one of the sub-devices and optionally all of the sub-devices have internal voltage stabilization.

13. A quantum computing system according to any one of the preceding claims, wherein the power supply device is arranged to supply the quantum computing system with electrical power during a relocation of the quantum computing system.

14. A quantum computer system according to one of the preceding claims, wherein the quantum computer system is designed to be relocatable.

15. A quantum computer system according to any one of the preceding claims, characterized in that the quantum computer system further comprises:
at least one magnetic field sensor system; and
at least a magnetic field generator;
wherein the quantum computer system is set up to determine a change in a prevailing magnetic field by means of the at least one magnetic field sensor system and to at least partially compensate for the determined change in the magnetic field at the location of the quantum computer by means of the magnetic field generator.

16. Quantum computer system, comprehensive:
a relocatable quantum computer;
characterized in that the quantum computer system further comprises:
at least one magnetic field sensor system; and
at least a magnetic field generator;
wherein the quantum computer system is set up to determine a change in a prevailing magnetic field by means of the at least one magnetic field sensor system and to at least partially compensate for the determined change in the magnetic field at the location of the quantum computer by means of the magnetic field generator.

17. A quantum computing system according to any one of claims 15 and 16, wherein the magnetic field sensor system is adapted to detect the magnetic field in three spatial directions and wherein the quantum computing system is adapted to determine the three-dimensional change in the prevailing magnetic field.

18. A quantum computer system according to claim 17, wherein the magnetic field sensor system is adapted to measure a three-dimensional vector of a magnetic flux density B at the location of the quantum computer and/or in the immediate vicinity of the quantum computer.

19. A quantum computing system according to any one of claims 15 to 18, wherein the at least one magnetic field generator comprises at least one magnetic field generating means.

20. A quantum computing system according to claim 19, wherein said at least one magnetic field generating means comprises one or more of the following elements:
at least a permanent magnet;
at least an electromagnet;
at least a Helmholtz coil;
at least one pair of Helmholtz coils.

21. a quantum computer system according to claim 19 or 20, wherein the at least one magnetic field generating means forms a magnetic circuit.

22. A quantum computing system according to any one of claims 19 to 21, wherein the magnetic field generator comprises at least one positioning device adapted to change a position and/or orientation of the at least one magnetic field generating means relative to the quantum computer.

23. A quantum computing system according to any one of claims 15 to 22, wherein the quantum computing system is further adapted to at least partially compensate for a geomagnetic field at the location of the quantum computing system.

24. A quantum computer system according to claim 23, further comprising:
a positioning device;
wherein the quantum computer system is set up to determine a position and/or orientation of the quantum computer relative to the earth using the position determination device and to determine the earth's magnetic field to be compensated at the location of the quantum computer on the basis of the determined position and/or orientation of the quantum computer relative to the earth.

25. A quantum computer system according to claim 24, wherein the quantum computer system is further adapted to determine a change in position and/or orientation of the quantum computer and to generate a prediction for an expected change in the geomagnetic field to be compensated at the location of the quantum computer.

26. A quantum computing system according to any one of the preceding claims, further comprising a shielding, wherein the quantum computing system is adapted to shield at least some sub-devices of the quantum computing system at least partially from electric fields and/or magnetic fields by means of the shielding.

27. A quantum computing system according to claim 26, further comprising a housing, wherein the shielding is at least partially disposed within the housing and/or at least partially integrated into the housing.

28. A quantum computer system according to claim 27, wherein the housing is adapted to form a Faraday cage around the quantum computer.

29. A quantum computing system according to claim 28, wherein the shielding is configured such that the shielding shields the quantum computer from other components of the quantum computing system.

30. A quantum computing system of claim 29, wherein the housing comprises a plurality of sub-housings, wherein the quantum computer is disposed in one of the plurality of sub-housings, and wherein the sub-housing in which the quantum computer is disposed comprises at least a portion of the shielding that shields the quantum computer from other components of the quantum computing system.

31. A quantum computer according to any one of claims 26 to 31, wherein the shielding and/or the housing is formed at least partly of a μ-metal or comprises a μ-metal.

32. A quantum computer system according to any one of claims 26 to 31, wherein a power supply device of the quantum computer system is arranged at least partially within the shielding.

33. A quantum computer system according to any one of the preceding claims, further comprising a cooling device adapted to cool a temperature of quantum dots NV1, NV2, NV3 of the quantum computer and/or the temperature of nuclear quantum dots CI1₁, CI1₂, CI1₃, CI2₁, CI2₂, CI2₃, CI3₁, CI3₂, CI3₃ of the quantum computer and/or a temperature of a substrate D of the quantum computer, wherein the cooling device is designed to be relocatable.

34. A quantum computer system, comprising:
a quantum computer; and
a cooling device which is set up to reduce a temperature of quantum dots NV1, NV2, NV3 of the quantum computer and/or the temperature of nuclear quantum dots CI1₁, CI1₂, CI1₃, CI2₁, CI2₂, CI2₃, CI3₁, CI3₂, CI3₃ of the quantum computer and/or a temperature of a substrate D of the quantum computer,
characterized in that
the cooling device is designed to be relocatable.

35. A quantum computer system according to claim 33 or 34, wherein the cooling device comprises at least one closed loop helium gas cooling system or is designed as such.

36. A quantum computing system according to any one of claims 33 to 35, wherein the quantum computing system is adapted to supply electrical power to the cooling device by means of a relocatable power supply device of the quantum computing system.

37. A quantum computer system according to any one of the preceding claims, further comprising a stabilization device, wherein the quantum computer system is arranged to at least partially compensate mechanical effects on the quantum computer by means of the stabilization device.

38. A quantum computer system, comprehensive
a relocatable quantum computer;
characterized in that the quantum computer system also has a stabilization device, the quantum computer system being set up to at least partially compensate for a mechanical effect on the quantum computer by means of the stabilization device.

39. A quantum computing system according to any one of claims 37 and 38, wherein the stabilizing device is adapted thereto:
to determine an acceleration of the quantum computer; and/or
to predict an expected acceleration of the quantum computer; and/or
to at least partially compensate for an acceleration of the quantum computer; and/or
to mitigate the effect of an acceleration on the quantum computer.

40. A quantum computing system according to any one of claims 37 to 39, wherein the stabilizing device comprises one or more of the following elements:
one or more acceleration sensors and/or one or more acceleration sensor systems for determining an acceleration of the quantum computer;
one or more position displacement sensors for determining a position displacement of the quantum computer;
one or more position control systems for controlling a position of the quantum computer;
one or more positioning tables and/or one or more positioning devices for positioning the quantum computer;
one or more image capturing devices and/or one or more image processing devices for capturing and/or processing images of the quantum computer;
fluorescent defect centers in a substrate of the quantum computer, which have a different fluorescence wavelength than quantum dots of the quantum computer, which are intended for use as quantum bits in the quantum computer.

41. A quantum computing system according to any one of claims 37 to 40, wherein the quantum computing system comprises a plurality of sub-devices, and wherein the stabilizing device is further adapted to attenuate and/or dampen a transmission of mechanical shocks and/or mechanical vibrations to at least some of the sub-devices, and/or
wherein the stabilizing device is further designed to attenuate and/or dampen a transmission of mechanical shocks and/or mechanical vibrations of at least some of the sub-devices relative to each other.

42. A quantum computing system according to any one of claims 37 to 41, wherein the stabilizing device for attenuating and/or damping a transmission of mechanical shocks and/or vibrations to the at least some sub-devices comprises means which
are inserted in supply lines to optical device parts (D, OS, DBS, STM, PD, CM1, LD) of the quantum computer (QC) and/or to the other auxiliary device parts (KV, XT, YT, MGx, MGy, MGz, MSx, MSy, MSz, MWA, CM2, LM, HECLCS);
are inserted in data lines (SDA) to optical device parts (D, OS, DBS, STM, PD, CM1, LD) of the quantum computer (QC) and/or to the other auxiliary device parts (KV, XT, YT, MGx, MGy, MGz, MSx, MSy, MSz, MWA, CM2, LM, HECLCS);
comprise special mechanical formations, at least in sections, of supply lines to optical device parts (D, OS, DBS, STM, PD, CM1, LD) of the quantum computer (QC) and/or to the other auxiliary device parts (KV, XT, YT, MGx, MGy, MGz, MSx, MSy, MSz, MWA, CM2, LM, HECLCS); and/or
comprise special mechanical, at least sectional formations of data lines (SDA) to optical device parts (D, OS, DBS, STM, PD, CM1, LD) of the quantum computer (QC) and/or to the other auxiliary device parts (KV, XT, YT, MGx, MGy, MGz, MSx, MSy, MSz, MWA, CM2, LM, HECLCS).

43. A quantum computer system according to any one of claims 37 to 42, wherein the quantum computer system is further adapted to detect a presence of a non-statistical error and/or a non-statistical quantum error of the quantum computer and optionally to perform and/or initiate a countermeasure and/or output a hint signal upon detected presence of a non-statistical error and/or a non-statistical quantum error of the quantum computer.

44. A quantum computer system according to any one of the preceding claims, wherein the quantum computer comprises a substrate having one or more quantum dots arranged in the substrate.

45. A quantum computer system of claim 44, wherein the one or more quantum dots are each formed by one or more paramagnetic centers or comprise a paramagnetic center.

46. A quantum computer system according to claim 45, wherein the one or more paramagnetic centers are each formed as NV center and/or as SiV center and/or as TiV center and/or as GeV center and/or as SnV center and/or as NiN4 center and/or as PbV center and/or as TR1 center and/or as TR12 center.

47. A quantum computer system according to any one of claims 44 to 46, wherein the substrate is at least partially formed of diamond.

48. A quantum computer system according to any one of claims 44 to 47, wherein the quantum computing system comprises one or more nuclear quantum dots.

49. A quantum computer system according to any one of the preceding claims, wherein the quantum computer comprises:
a substrate (D);
one or more quantum dots (NV1, NV2, NV3) arranged in the substrate;
a light source (LD);
a light source driver (LDRV);
one or more devices (mWA, MW/RF-AWFG) for generating an electromagnetic wave field at the respective location of the quantum dots (NV1, NV2, NV3);
a control device (μC);
one or more memories (RAM, NVM) of the control device (μC);
a waveform generator (WFG);
an optical system (OS);
a quantum state readout device
wherein the quantum state readout device optionally comprises a photodetector (PD) and an amplifier (V) and/or a device for electronically reading out the states of the quantum dots (NV1, NV2, NV3);
whereby
the substrate (D) is doped in such a way that the Fermi level in the substrate is shifted in the region of the quantum dots (NV1, NV2, NV3) in such a way that the quantum dots (NV1, NV2, NV3) are electrically charged;
the waveform generator (WFG) is set up to generate a light source control signal (S5);
the light source driver (LDRV) is set up to supply the light source (LD) with electrical energy depending on the light source control signal (S5);
the control device (μC) is set up to control the waveform generator (WFG);
the light source (LD) is set up to irradiate the one or more quantum dots (NV1, NV2, NV3) with pump radiation (LB) of a pump radiation wavelength (λₚₘₚ) by means of the optical system (OS);
the one or more quantum dots (NV1, NV2, NV3) are designed to emit fluorescence radiation (FL) with a fluorescence radiation wavelength (Auf) when irradiated with the pump radiation (LB);
the photodetector (PD) is set up to detect at least part of the fluorescence radiation (FL) by means of the optical system (OS) and to convert it into a receiver output signal (S0), wherein the amplifier (V) is set up to amplify and filter the receiver output signal into a received signal (S1) and/or wherein the device for electronically reading out the states of the quantum dots (NV1, NV2, NV3) is set up to generate a received signal (S1);
the control device (μC) is set up to control the one or more devices (mWA, MW/RF-AWFG) for generating an electromagnetic wave field at the respective location of the quantum dots (NV1, NV2, NV3);
wherein the control device (C) is set up to change and/or couple states of the quantum dots (NV1, NV2, NV3) by controlling the one or more devices (mWA, MW/RF-AWFG) for generating an electromagnetic wave field at the respective location of the quantum dots (NV1, NV2, NV3) and/or by controlling the emission of the pump radiation (LB) by the light source (LD);
wherein the control device (μC) is set up to generate a measured value signal (S4) with one or more measured values from one or more received signals (S1), wherein the measured value signal (S4) depends on states of the quantum dots (NV1, NV2, NV3).

50. A quantum computing system according to any one of claims 1 to 49, further comprising a rotation sensor, wherein the quantum computing system is adapted to determine a rotational movement and/or an orientation of the quantum computer by means of the rotation sensor.

51. A quantum computer system, comprehensive:
a relocatable quantum computer;
characterized in that the quantum computer system further comprises:
a rotation sensor;
and in that the quantum computer system is arranged to determine a rotational movement and/or an orientation of the quantum computer and/or the quantum computer system by means of the rotation sensor.

52. A quantum computer according to claim 50 or 51, wherein the rotation sensor is adapted to determine an orientation and/or a rotational movement and/or a rotational acceleration of the quantum computer.

53. A quantum computer system according to any one of claims 50 to 52, wherein the quantum computer system is further arranged to at least partially compensate or avoid an effect of the determined rotational movement and/or orientation on the quantum computer.

54. A quantum computer system according to claim 53, wherein the quantum computer system is set up to at least partially compensate for the effect of the determined rotational movement and/or orientation during an operation of the quantum computer by adjusting an actuation of the quantum computer.

55. A quantum computer system according to claim 54, wherein the adjustment of the driving of the quantum computer comprises one or more adjustments of parameters for a manipulation of a quantum bit and/or a nuclear quantum bit of the quantum computer.

56. A quantum computer system according to claim 54 or 55, wherein the adjustment of the driving of the quantum computer comprises one or more adjustments of the following parameters:
a coupling fundamental frequency and/or a coupling fundamental phase position for a coupling between pairs of couplable quantum bits (QUB1, QUB2);
a coupling fundamental frequency and/or coupling fundamental phase position for a coupling between couplable pairs each consisting of a quantum bit (QUB) and a nuclear quantum bit (CQUB);
a coupling fundamental frequency and/or coupling fundamental phase position for a coupling between pairs of couplable two nuclear quantum bits (CQUB1, CQUB2) with each other.

57. A quantum computer system, comprising:
a relocatable quantum computer;
characterized in that the quantum computer system further comprises:
a rotational decoupling device in which the quantum computer is rotatably mounted;
wherein the quantum computer system is arranged to at least partially compensate or avoid the effect of a rotational movement and/or orientation of the quantum computer at least during an operation of the quantum computer by decoupling the quantum computer from its environment by means of the rotational decoupling device.

58. A quantum computer system according to claim 57, wherein the rotational decoupling device comprises a gimbal.

59. A quantum computer system according to claim 58, wherein the rotation decoupling device comprises one or more gyroscopes and/or is connected to one or more gyroscopes and is arranged to at least partially reduce or avoid rotation of the quantum computer relative to its environment by means of the one or more gyroscopes and the rotation decoupling device.

60. A quantum computer system according to any one of claims 57 to 59, wherein the quantum computer is rotatable relative to a power supply device of the quantum computer system.

61. A quantum computer system according to claim 60, further comprising at least one slip ring, wherein the at least one slip ring connects the quantum computer to the power supply device.

62. A quantum computing system according to any one of claims 50 to 52, wherein the quantum computing system is further adapted to provide a measurement value characterizing the determined rotational motion and/or orientation of the quantum computer.

63. A quantum computer system according to any one of claims 50 to 52 and 62, wherein the quantum computer system is designed as a gyrometer or forms part of a gyrometer.

64. A mobile data processing device, characterized in that the mobile data processing device comprises a quantum computer system according to one of the preceding claims.

65. A mobile data processing apparatus according to claim 64, wherein the mobile data processing apparatus is configured as one of the following devices:
a portable quantum computer system;
a mobile quantum computer system;
a smartphone;
a tablet computer;
a personal computer;
a laptop computer;
a games console.

66. A vehicle, characterized in that the vehicle comprises a quantum computer system according to any one of claims 1 to 63.

67. A vehicle according to claim 66, wherein the vehicle is configured as one of the following vehicles:
a motor vehicle;
a land vehicle;
a rail-bound land vehicle;
a passenger car;
a truck;
a bus;
a motorcycle;
a tactical vehicle;
a bicycle;
an electric vehicle;
an unmanned vehicle;
a watercraft;
a ship;
a boat;
an unmanned watercraft;
an underwater vehicle;
a floating body;
an underwater floating body;
a buoy;
a torpedo;
an aircraft;
an airplane;
a helicopter;
a rocket;
an unmanned aerial vehicle;
a drone;
a robot drone;
a balloon;
a robot;
a space missile;
a satellite; and
a space station.

68. A weapon system, characterized in that the weapon system is relocatable and comprises a quantum computer system according to one of the preceding claims.

69. A weapon system according to claim 68, wherein the weapon system is configured as one of the following weapon systems or comprises one or more of the following elements:
a storey;
a warhead;
a landmine;
a rocket;
a torpedo;
a sea mine;
a tank;
an artillery piece;
a fire control vehicle;
a fighter plane;
a combat helicopter;
a tactical vehicle;
a military watercraft;
a satellite;
a balloon;

70. A weapon system according to claim 68 or 69, further comprising a fire control system, wherein the fire control system is adapted to perform target detection and/or target identification and/or target classification and/or target assignment and/or munition selection and/or providing a suggestion for target engagement using the quantum computer system.

71. A use of a relocatable power supply device for at least partially supplying a relocatable quantum computer with electrical power, characterized in that the relocatable power supply device has a first voltage regulation stage and a second voltage regulation stage, and is arranged to regulate an electrical energy provided by a power source to a predetermined voltage value by means of a multi-stage voltage regulation by means of the first voltage regulation stage and the second voltage stage for at least partially supplying the quantum computer.

72. A method of operating a relocatable quantum computer, the method comprising:
providing a relocatable energy reserve as an energy source for electrical energy;
characterized in that the method further comprises:
providing a relocatable power supply device with a first voltage regulation stage and a second voltage regulation stage;
connecting the energy reserve to the energy supply device and providing the electrical energy from the energy reserve for the energy supply device;
regulating a voltage of the supplied electrical energy to a first voltage value by means of the first voltage regulation stage of the energy supply device;
regulating the electrical energy provided by the first voltage regulation stage with the first voltage value to a second voltage value by means of a second voltage regulation stage;
operating the quantum computer with the electrical energy provided by the second voltage regulation stage with the second voltage value and executing a quantum operation and/or a quantum computer program product by means of the quantum computer.

73. A method of operating a relocatable quantum computer, characterized in that the method comprises:
detecting a change in a prevailing magnetic field by means of a magnetic field sensor system; and
at least partially compensating of the change in the magnetic field at the location of the quantum computer using a magnetic field generator.

74. A method according to claim 73, further comprising:
determining a change in position and/or orientation of the quantum computer relative to the earth; and
generating a prediction for an expected change in the earth's magnetic field to be compensated at the location of the quantum computer due to the change in position and/or orientation;
whereby the at least partial compensation of the change in the magnetic field at the location of the quantum computer is carried out taking into account the generated prediction.

75. A method according to claim 74, wherein the generating of the prediction is performed using a cartographic information about the earth's magnetic field.

76. A use of a cartographic information about the earth's magnetic field to determine a magnetic field to be compensated at the location of a relocatable quantum computer and/or to generate a prediction for an expected change in the earth's magnetic field to be compensated at the location of the quantum computer.

77. A method of operating a relocatable quantum computer having a substrate and one or more quantum dots disposed in the substrate, the method comprising:
provision of a relocatable cooling device;
lowering a temperature of the at least one quantum dot in the substrate by means of the displaceable cooling device such that a number of quantum dots available to the quantum computer for performing a quantum operation and/or a quantum computer program is increased.

78. A method according to claim 77, wherein the relocatable cooling device comprises at least one closed loop helium gas cooling system or is designed as such.

79. A use of a closed loop helium gas cooling system for lowering a temperature of at least one quantum dot in a substrate of a relocatable quantum computer.

80. A method of operating a relocatable quantum computer, the method comprising:
determining an acceleration of the quantum computer;
at least partially compensating of the acceleration of the quantum computer and/or attenuating the effect of the acceleration on the quantum computer.

81. a method according to claim 80, further comprising:
generating a prediction regarding an expected acceleration and/or change in acceleration of the quantum computer;
whereby the at least partial compensation of the acceleration of the quantum computer takes place using the generated prediction.

82. A method of controlling a relocatable weapon system with a quantum computer, the method comprising:
recording of environmental data of the weapon system by means of a sensor;
evaluating the environment data and identificating one or more objects in the vicinity of the weapon system using the quantum computer;
classifying the one or more identified objects with respect to a dangerousness and/or vulnerability and/or strategic effect of the one or more objects by means of the quantum computer;
specifying one of the following parameters:
a weapon of the weapon system to be used;
an ammunition of the weapon system to be used;
a configuration of the weapon system to be used;
a selection of one or more targets to be engaged from the one or more classified objects;
a sequence of a planned combat of several targets to be fought.

83. A method of claim 82, wherein the classifying of the one or more identified objects is performed by the quantum computer using artificial intelligence.

84. A use of a quantum computer to measure a rotational movement.

85. A use of a quantum computer as a gyrometer.

86. A method of measuring a rotational motion, the method comprising:
providing a quantum computer that is exposed to rotational motion;
determining a change in one or more of the following parameters:
a coupling fundamental frequency and/or a coupling fundamental phase position for a coupling between pairs of couplable quantum bits (QUB1, QUB2);
a coupling fundamental frequency and/or a coupling fundamental phase position for a coupling between couplable pairs each consisting of a quantum bit (QUB) and a nuclear quantum bit (CQUB);
a coupling fundamental frequency and/or a coupling fundamental phase position for a coupling between pairs of couplable two nuclear quantum bits (CQUB1, CQUB2) with each other;
determining the rotational movement based on the determined change in one or more parameters.

87. A method according to claim 86, wherein the determination of the rotational movement is based on the fact that the determined change in the one or more parameters is proportional to the magnitude of the rotational movement.

88. A method of operating a relocatable quantum computer, the method comprising:
determining a rotational movement and/or an orientation of the quantum computer;
compensating for at least part of an effect of the determined rotational movement and/or orientation on the quantum computer.

89. A method according to claim 88, wherein the at least partial compensation of the determined rotational movement and/or alignment to the quantum computer is performed during an operation of the quantum computer.

90. A method according to claim 88 or 89, wherein compensating the determined rotational motion and/or orientation to the quantum computer comprises adjusting one or more of the following parameters depending on the determined rotational motion:
a coupling fundamental frequency and/or a coupling fundamental phase position for a coupling between pairs of couplable quantum bits (QUB1, QUB2);
a coupling fundamental frequency and/or a coupling fundamental phase position for a coupling between couplable pairs each consisting of a quantum bit (QUB) and a nuclear quantum bit (CQUB);
a coupling fundamental frequency and/or a coupling fundamental phase position for a coupling between pairs of couplable two nuclear quantum bits (CQUB1, CQUB2) with each other.

91. A method of operating a relocatable quantum computer, the method comprising:
rotatable mounting of the quantum computer in a rotational decoupling device;
avoiding or reducing an effect of a rotational movement of the quantum computer on the quantum computer by decoupling the quantum computer from its environment by means of the rotational decoupling device.

92. A method according to claim 91, wherein the rotational decoupling device comprises a gimbal suspension.
